(19) United States
(12) Patent Application Publication
(10) Pub. No.: US 2024/0176663 A1
(43) Pub. Date: May 30, 2024

(54) TENSOR MAP CACHE STORAGE

(71) Applicant: NVIDIA Corporation, Santa Clara, CA (US)

(72) Inventors: Gokul Ramaswamy HIRISAVE CHANDRA SHEKHARA, Bangalore (IN); Alexander Lev Minkin, Los Altos, CA (US); Harold Carter Edwards, Campbell, CA (US); Yashwardhan Narawane, San Jose, CA (US)

(21) Appl. No.: 18/219,622

(22) Filed: Jul. 7, 2023

(30) Foreign Application Priority Data
Nov. 28, 2022 (IN) 202211068451

(51) Int. Cl. G06F 9/50; G06F 12/0802

(52) U.S. Cl. CPC G06F 9/5027; G06F 12/0802; G06F 2212/302

(57) ABSTRACT

Apparatuses, systems, and techniques to store one or more tensor maps in one or more cache storages. In at least one embodiment, a processor includes one or more tensor acceleration logic circuits to cause one or more tensor maps to be stored in one or more cache storages.

### TECHNICAL FIELD

At least one embodiment, pertains to processing resources used to perform one or more programs written for a parallel computing platform and application interface. For example, at least one embodiment pertains to processors or computing systems that store one or more tensor maps according to various novel techniques described herein.

### BACKGROUND

Performing operations with tensors can use significant time, power, or computing resources. The amount of time, power, or computing resources can be improved.

### BRIEF DESCRIPTION OF THE DRAWINGS

FIG. 1 is block diagram that illustrates a system, according to at least one embodiment;

FIG. 2 is a block diagram that illustrates a computing environment, according to at least one embodiment;

FIG. 3 illustrates performing an API to cause a tensor map to be prefetched, according to at least one embodiment;

FIG. 4 is a flowchart of a technique of prefetching a tensor map, according to at least one embodiment;

FIG. 5 is a block diagram illustrating an example of a processor, according to at least one embodiment;

FIG. 6 is a block diagram illustrating a driver and/or runtime environment, according to at least one embodiment;

FIG. 7 illustrates a GPU architecture including a parallel processing unit in which each streaming multiprocessor is coupled to a tensor memory access unit (“TMAU”) which provides specialized hardware circuitry for memory address calculations and moving multidimensional data structures or data blocks in/out of several types of memories, according to at least one embodiment;

FIG. 8 illustrates interactions between a streaming multiprocessor, tensor memory access unit circuitry coupled to streaming multiprocessor, external memory, and local shared memory of streaming multiprocessor when loading a block of data from external memory to shared memory, according to at least one embodiment;

FIGS. 9A and 9B (collectively FIG. 9) illustrate tensor parameters that are applicable to addressing of tensors that are stored in external memory and that are accessed by tensor memory access unit, according to at least one embodiment;

FIGS. 10A and 10B (collectively FIG. 10) show aspects such as out-of-bounds conditions that may be detected by tensor memory access unit when reading tensor data from external memory, according to at least one embodiment;

FIGS. 11A and 11B (collectively FIG. 11) show example descriptors used to access data, according to at least one embodiment;

FIG. 12 is a schematic depiction of a memory access request processing pipeline in tensor memory access unit, according to at least one embodiment;

FIG. 13A shows example parameters that affect reading of tensor data by a tensor memory access unit, according to at least one embodiment;

FIG. 13B illustrates example high level pseudo code of processing by tensor memory access unit, according to at least one embodiment;

FIG. 13C illustrates example high level pseudo code showing a streaming multiprocessor using TMAU to load and to store tensor data for GEMM (General Matrix Multiplications) calculations, according to at least one embodiment;

FIGS. 14A-14K (collectively FIG. 14) show use of example data loading modes, specifically tile mode and image-to-column mode, according to at least one embodiment;

FIGS. 15A-15D (collectively FIG. 15) show examples of data swizzling that can be handled by tensor memory access unit, according to at least one embodiment;

FIG. 16 illustrates an example parallel processing unit of a GPU, according to at least one embodiment;

FIG. 17A illustrates an example general processing cluster (GPC) within parallel processing unit of FIG. 16 with each streaming multiprocessor in general processing cluster being coupled to a tensor memory access unit, according to at least one embodiment;

FIG. 17B illustrates an example memory partition unit of parallel processing unit of FIG. 16, according to at least one embodiment;

FIG. 18 illustrates an example streaming multiprocessor of FIG. 17A, according to at least one embodiment;

FIG. 19A is an example conceptual diagram of a processing system implemented using parallel processing unit (PPU) of FIG. 16, according to at least one embodiment;

FIG. 19B is a block diagram of an exemplary system in which various architecture and/or functionality of various embodiments may be implemented, according to at least one embodiment;

FIG. 20 illustrates an exemplary data center, in accordance with at least one embodiment;

FIG. 21 illustrates a processing system, in accordance with at least one embodiment;

FIG. 22 illustrates a computer system, in accordance with at least one embodiment;

FIG. 23 illustrates a system, in accordance with at least one embodiment;

FIG. 24 illustrates an exemplary integrated circuit, in accordance with at least one embodiment;

FIG. 25 illustrates a computing system, according to at least one embodiment;

FIG. 26 illustrates an APU, in accordance with at least one embodiment;

FIG. 27 illustrates a CPU, in accordance with at least one embodiment;

FIG. 28 illustrates an exemplary accelerator integration slice, in accordance with at least one embodiment;

FIGS. 29A-29B illustrate exemplary graphics processors, in accordance with at least one embodiment;

FIG. 30A illustrates a graphics core, in accordance with at least one embodiment;

FIG. 30B illustrates a GPGPU, in accordance with at least one embodiment;

FIG. 31A illustrates a parallel processor, in accordance with at least one embodiment;

FIG. 31B illustrates a processing cluster, in accordance with at least one embodiment;

FIG. 31C illustrates a graphics multiprocessor, in accordance with at least one embodiment;

FIG. 32 illustrates a graphics processor, in accordance with at least one embodiment;

FIG. 33 illustrates a processor, in accordance with at least one embodiment;

FIG. 34 illustrates a processor, in accordance with at least one embodiment;

FIG. 35 illustrates a graphics processor core, in accordance with at least one embodiment;

FIG. 36 illustrates a PPU, in accordance with at least one embodiment;

FIG. 37 illustrates a GPC, in accordance with at least one embodiment;

FIG. 38 illustrates a streaming multiprocessor, in accordance with at least one embodiment;

FIG. 39 illustrates a software stack of a programming platform, in accordance with at least one embodiment;

FIG. 40 illustrates a CUDA implementation of a software stack of FIG. 39, in accordance with at least one embodiment;

FIG. 41 illustrates a ROCm implementation of a software stack of FIG. 39, in accordance with at least one embodiment;

FIG. 42 illustrates an OpenCL implementation of a software stack of FIG. 39, in accordance with at least one embodiment;

FIG. 43 illustrates software that is supported by a programming platform, in accordance with at least one embodiment;

FIG. 44 illustrates compiling code to execute on programming platforms of FIGS. 39-42, in accordance with at least one embodiment;

FIG. 45 illustrates in greater detail compiling code to execute on programming platforms of FIGS. 39-42, in accordance with at least one embodiment;

FIG. 46 illustrates translating source code prior to compiling source code, in accordance with at least one embodiment;

FIG. 47A illustrates a system configured to compile and execute CUDA source code using different types of processing units, in accordance with at least one embodiment;

FIG. 47B illustrates a system configured to compile and execute CUDA source code of FIG. 47A using a CPU and a CUDA-enabled GPU, in accordance with at least one embodiment;

FIG. 47C illustrates a system configured to compile and execute CUDA source code of FIG. 47A using a CPU and a non-CUDA-enabled GPU, in accordance with at least one embodiment;

FIG. 48 illustrates an exemplary kernel translated by CUDA-to-HIP translation tool of FIG. 47C, in accordance with at least one embodiment;

FIG. 49 illustrates non-CUDA-enabled GPU of FIG. 47C in greater detail, in accordance with at least one embodiment;

FIG. 50 illustrates how threads of an exemplary CUDA grid are mapped to different compute units of FIG. 49, in accordance with at least one embodiment;

FIG. 51 illustrates how to migrate existing CUDA code to Data Parallel C++ code, in accordance with at least one embodiment; and

FIG. 52 illustrates components of a system to access a large language model, according to at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

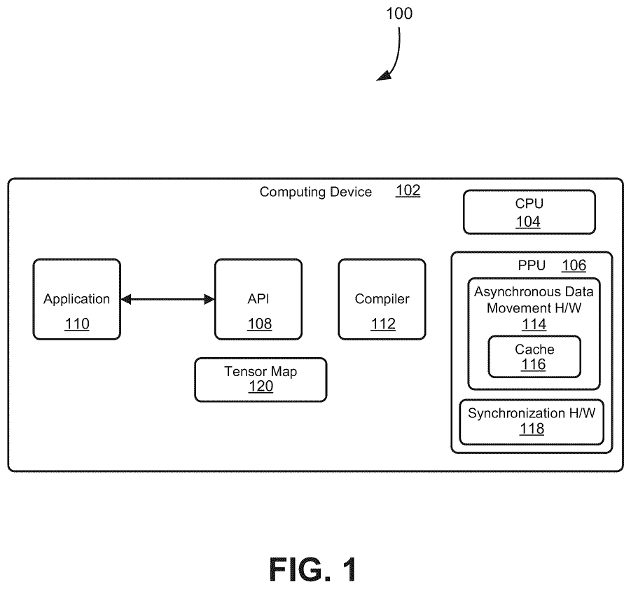

FIG. 1 is a block diagram that illustrates a system 100, according to at least one embodiment. In at least one embodiment, system 100 includes a computing device 102 that includes a central processing unit (CPU) 104 and a parallel processing unit (PPU) 106 (e.g., an accelerator such as a graphics processing unit (GPU), field programmable gate array (FPGA), application specific integrated circuit (ASIC), and/or some other suitable device). In at least one embodiment, computing device 102 includes one or more other components, not shown for clarity, such as main memory used by CPU 104, memory on PPU 106 (e.g., global memory, shared memory), a storage device, one or more networking components, one or more additional CPUs, and/or one or more additional PPUs. In at least one embodiment, an API 108 provides at least one function accessible to an application 110. In at least one embodiment, a compiler 112 translates requests received via API 108 into instructions (e.g., instructions that are part of an instruction set architecture for PPU 106) that can be executed on PPU 106.

In at least one embodiment, PPU 106 includes asynchronous data movement hardware (H/W) 114. In at least one embodiment, asynchronous data movement hardware is referred to as a tensor memory accelerator (TMA), a tensor memory access unit (TMAU), and/or some other suitable name. In at least one embodiment, asynchronous data movement H/W 114 includes a cache 116. In at least one embodiment, PPU 106 includes synchronization hardware 118. In at least one embodiment, synchronization hardware 118 is referred to as a SyncUnit or some other suitable name.

In at least one embodiment, a user (e.g., a thread performing computer program code being performed by PPU 106) initiates an asynchronous data movement operation (e.g., a copy and/or reduction operation) using one or more functions of API 108. In at least one embodiment, asynchronous data movement H/W 114 performs data movement operation in response to function of API initiated by thread. In at least one embodiment, asynchronous data movement H/W 114 performs one or more operations (e.g., copy and/or reduction operations using tensors) based, at least in part, on a tensor map 120 prefetched to cache 116. In at least one embodiment, API 108 include a function and/or instruction to prefetch tensor map 120 to cache 116. In at least one embodiment, API 108 includes a function and/or instruction to prefetch tensor map 120 to a cache in some other suitable location and/or some other suitable type of cache. In at least one embodiment, cache to which tensor map 120 is to be prefetched is a multi-line cache, a single line cache, or has some other suitable cache structure.

In at least one embodiment, API 108 includes a function to generate tensor map 120. In at least one embodiment, tensor map 120 is referred to as a tensor descriptor. In at least one embodiment, rather than being referred to as being same, tensor descriptor is a data structure that includes a tensor map (e.g., tensor map 120), and API 108 includes a function to generate tensor descriptor that includes tensor map. In at least one embodiment, API 108 includes functions to generate more than one type of tensor descriptor (e.g., a first function to generate a tensor descriptor to be used with a tiled tensor mapping, and a second function to generate a tensor descriptor to be used with an image-to-column tensor mapping).

In at least one embodiment, API 108 provides one or more functions that use manual transaction accounting. In at least one embodiment, manual transaction accounting is referred to as manual tracking. In at least one embodiment, manual transaction accounting is when a user (e.g., computer program code, such as a kernel running on PPU 106) performs one or more aspects of tracking data to be asynchronously moved (e.g., tracking a count of data in bytes, transactions, or some other suitable count). In at least one embodiment, user provides this count to one or more APIs. In at least one embodiment, user is a program that calls and/or uses one or more API functions. In at least one embodiment, API 108 provides one or more functions to be used to generate and/or use one or more thread synchronization objects (e.g., barriers and/or pipelines) with one or more asynchronous operations that use manual transaction accounting. In at least one embodiment, API 108 provides one or more functions that use automatic transaction accounting.

In at least one embodiment, when using manual transaction accounting, user tracks an expected count (e.g., in bytes, transactions, or some other suitable amount) of data to be moved (e.g., copied), and provides expected count using one or more functions of API 108. In at least one embodiment, expected count is previously defined and/or otherwise known to user. In at least one embodiment, expected count is provided to synchronization H/W 118 using a function of API 108 (e.g., a barrier arrive using manual transaction accounting function, or a consumer commit function, not shown for clarity). In at least one embodiment, asynchronous data movement H/W 114 indicates to synchronization H/W 118 when data movement operation is complete. In at least one embodiment, synchronization H/W 118 generates an indication of when a sequence of data movement operations to be performed by a group of threads are complete based, at least in part, on balancing a sum of completed data movement operations received from asynchronous data movement H/W 114 and a sum of expected counts of data to be moved received via one or more functions of API 108 from one or more users (e.g., computer program code being performed by PPU 106) performing manual transaction accounting.

In at least one embodiment, asynchronous data movement operations between memories (e.g., between global and shared memory) on a GPU are useful because threads that initiate asynchronous data movement can perform other operations while data is being moved. In at least one embodiment, a thread can perform an instruction to perform a data movement operation and, because operation is asynchronous, that thread can continue to perform additional instructions before data movement operation is complete.

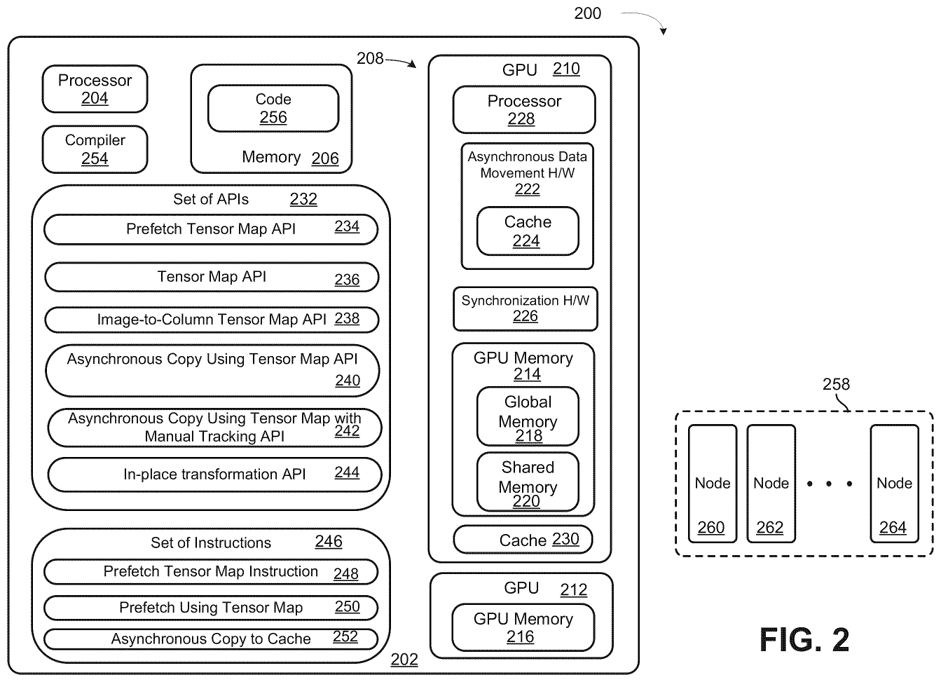

FIG. 2 is a block diagram that illustrates a computing environment 200, according to at least one embodiment. In at least one embodiment, a computer system 202 includes a processor 204, a memory 206, and a set of graphics processing units (GPUs) 208. In at least one embodiment, computer system 202 includes one or more components of system 100 of FIG. 1. In at least one embodiment, set of GPUs 208 includes a GPU 210 and a GPU 212. In at least one embodiment, set of GPUs 208 includes a different number of GPUs (e.g., fewer or more than two GPUs). In at least one embodiment, GPU 210 includes a GPU memory 214 and GPU 212 includes a GPU memory 216. In at least one embodiment, GPU memory 214 and/or GPU memory 216 includes more than one level and/or type of memory (e.g., global memory accessible by entire GPU, memory accessible by a subset of processors on GPU, cache memory accessible by an individual processor on GPU, shared memory accessible by a particular group of threads). In at least one embodiment, GPU memory 214 includes global memory 218 and shared memory 220. In at least one embodiment, GPU memory 214 includes a different number of shared memories (e.g., more than one shared memory).

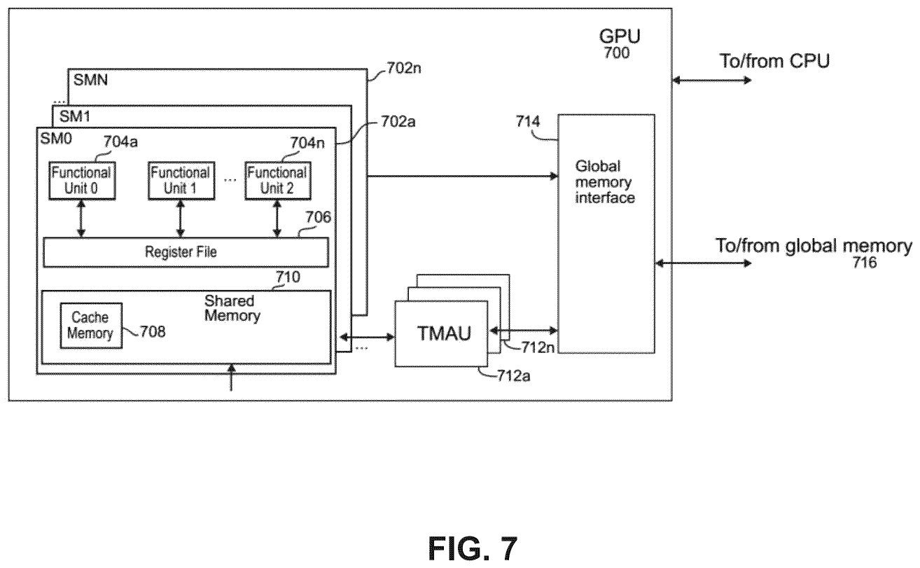

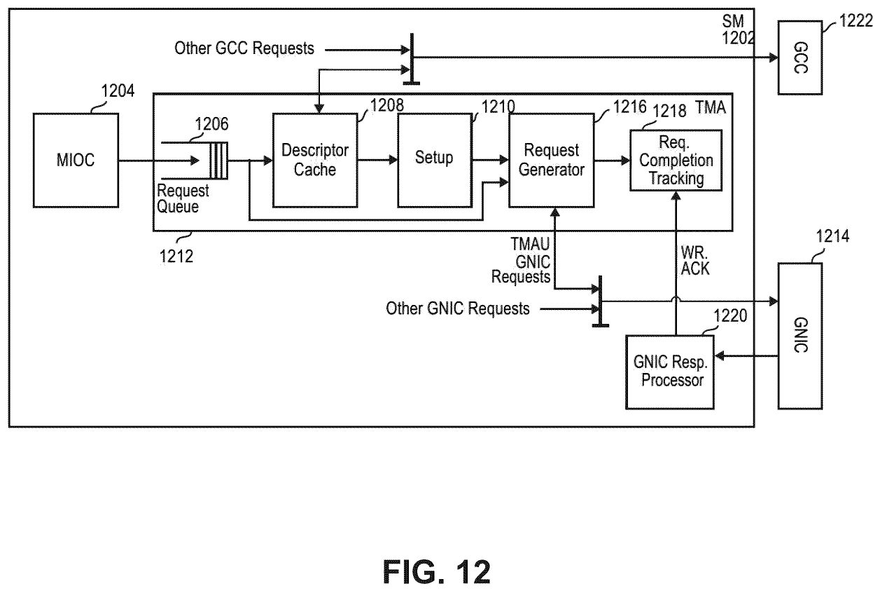

In at least one embodiment, GPU 210 includes asynchronous data movement hardware (H/W) 222 (e.g., an NVIDIA tensor memory accelerator (TMA), a tensor memory access unit (TMAU), and/or one or more other suitable asynchronous data movement hardware components). In at least one embodiment, asynchronous data movement H/W 222 is asynchronous data movement H/W 114 of FIG. 1. In at least one embodiment, asynchronous data movement H/W 222 is TMAU 712 of FIG. 7 and/or TMAU 1212 of FIG. 12. In at least one embodiment, asynchronous data movement H/W 222 includes a cache 224. In at least one embodiment cache 224 is cache 116 of FIG. 1 and/or cache 1208 of FIG. 12. In at least one embodiment, GPU 210 includes synchronization H/W 226 (e.g., an NVIDIA SyncUnit, and/or one or more other suitable synchronization hardware components). In at least one embodiment, cache 224 is a multi-line cache, a single-line cache, or has some other suitable structure.

In at least one embodiment, GPU 210 includes one or more processors 228. In at least one embodiment, GPU 210 includes one or more caches (e.g., a cache 230). In at least one embodiment, cache 230 is an L2 cache. In at least one embodiment, GPU 212 includes one or more processors, one or more data movement H/W components, and/or one or more synchronization H/W components, not shown for clarity. In at least one embodiment, a different number of processors (e.g., more than one processor 204) and/or a different number of memories (e.g., more than one memory 206) are included in computer system 202. In at least one embodiment, processor 204 is a central processing unit (CPU). In at least one embodiment, computer system 202 includes one or more other components not shown for clarity (e.g., a network interface card, persistent storage device, one or more input devices, one or more output devices, and/or one or more other suitable components).

In at least one embodiment, processor 204 is a single-core processor. In at least one embodiment, processor 204 is a multi-core processor. In at least one embodiment, processor 204 is an element of a processing system such as processing system 2100 described herein. In at least one embodiment, processor 204 is an element of a computer system such as computer system 2200 described herein. In at least one embodiment, processor 204 is an element of a system such as system 2300 described herein. In at least one embodiment, processor 204 is an element of a computing system such as computing system 2500 described herein. In at least one embodiment, processor 204 is an element of a compute unit such as compute unit 4940 described herein. In at least one embodiment, processor 204 is some other processor shown and/or described herein.

In at least one embodiment, one or more GPUs (e.g., GPU 210) in set of GPUs 208 is a graphics processor 2910 described herein. In at least one embodiment, one or more GPUs (e.g., GPU 210) in set of GPUs 208 is a graphics processor 2940 described herein. In at least one embodiment, one or more GPUs (e.g., GPU 210) in set of GPUs 208 is a graphics multiprocessor 3134 described herein. In at least one embodiment, one or more GPUs (e.g., GPU 210) in set of GPUs 208 is a graphics processor 3200 described herein. In at least one embodiment, one or more GPUs (e.g., GPU 210) in set of GPUs 208 is a graphics processor 3408 described herein. In at least one embodiment, one or more GPUs (e.g., GPU 210) in set of GPUs 208 is a GPU 4792 described herein. In at least one embodiment, one or more GPUs (e.g., GPU 210) in set of GPUs 208 is some other GPU shown and/or described herein. In at least one embodiment, computer system 202 includes one or more accelerators (e.g., one or more parallel processing units (PPUs), FPGAs, ASICS, and/or other suitable accelerators) instead of or in addition to GPUs in set of GPUs 208.

In at least one embodiment, computer system 202 includes a set of APIs 232. In at least one embodiment, when one or more APIs are referred to as performing an action or an aspect of a technique, one or more hardware components (e.g., a CPU, GPU, and/or other hardware component) of a computer system running an API perform that action or aspect of technique. In at least one embodiment, set of APIs 232 is a set of APIs for GPUs in set of GPUs 208. In at least one embodiment, one or more operations described with respect to GPUs in set of GPUs 208 and/or APIs in set of APIs 232 are performed by one or more accelerators, not shown for clarity, that are not GPUs. In at least one embodiment, set of APIs 232 is referred to as an API (e.g., a driver API) that includes multiple callable functions. In at least one embodiment, set of APIs 232 is implemented in a dynamic library. In at least one embodiment, set of APIs 232 is a handle-based, imperative API. In at least one embodiment, set of APIs 232 is a parallel processing framework API (e.g., a Compute Unified Device Architecture (CUDA) driver API, a Heterogeneous-Compute Interface for Portability (HIP) API, or some other API).

In at least one embodiment, one or more APIs in set of APIs 232 are high-level APIs (e.g., accessed using a high-level programming language such as C++, Python, Java, Fortran, C, or some other suitable language). In at least one embodiment, one or more APIs in set of APIs 232 are low-level APIs (e.g., accessed using instructions of a programming frameworks such as CUDA PTX instructions or some other suitable intermediate representation that can be compiled to a machine-level binary representation for a particular hardware architecture). In at least one embodiment, one or more APIs of set of APIs 232 can also be implemented as instructions, such as PTX, assembly, x86, GPU instruction set architecture (ISA), machine-level, or some other suitable type of instructions. In at least one embodiment, set of APIs 232 is a set of APIs for a programming platform. In at least one embodiment, a programming platform may be, but is not limited to, CUDA, Radeon Open Compute Platform (“ROCm”), OpenCL (OpenCL™ is developed by Khronos group), SYCL, or Intel One API. In at least one embodiment, although some aspects of APIs and/or techniques for combining operations are discussed in relation to CUDA, including CUDA APIs and/or CUDA kernels, it should be understood that ROCm, OpenCL, SYCL, One API, and/or any other suitable APIs and/or kernels may be used. In at least one embodiment, one or more APIs in set of APIs 232 are accessed, at least in part, by including a header file in one or more portions of code that defines one or more functions of one or more APIs. In at least one embodiment, one or more APIs in set of APIs are functions (e.g., defined in a function library).

In at least one embodiment, set of APIs 232 includes a prefetch tensor map API 234. In at least one embodiment, prefetch tensor map API 234 is referred to as a tensor mapping prefetch API. In at least one embodiment, tensor mapping prefetch API (e.g., prefetch tensor map API 234) is to prefetch (e.g., by asynchronously copying) a tensor mapping to a cache. In at least one embodiment, cache is a cache of asynchronous data movement hardware of a GPU (e.g., cache 224 and/or cache of a tensor memory accelerator (TMA) such as descriptor cache 1208 of FIG. 12). In at least one embodiment, cache is in some other suitable location and/or is some other suitable type of cache. In at least one embodiment, cache is a multi-line cache, a single-line cache, or has some other suitable structure. In at least one embodiment, tensor memory accelerator is referred to as a tensor memory access unit (TMAU). In at least one embodiment, tensor mapping is referred to as a tensor map (e.g., tensor map 120 of FIG. 1) and/or a tensor descriptor. In at least one embodiment, tensor mapping is referred to as tensor information and/or tensor data. In at least one embodiment, a tensor mapping, a tensor map, and/or a tensor descriptor is a data structure that indicates how to obtain second tensor from tensor data (e.g., a tile or subtensor) of first tensor. In at least one embodiment, tensor mapping, tensor map, and/or tensor descriptor indicates how to obtain second tensor from first tensor based, at least in part, on tensor information such as one or more parameters, other data structures, addresses, and/or other suitable information. In at least one embodiment, a TMA-tensor descriptor is a type of tensor descriptor. In at least one embodiment, address of tensor mapping (e.g., in global memory 218 of GPU 210, shared memory 220, constant (const) memory, and/or some other suitable memory) is to be used as an input to prefetch tensor map API 234 and/or a tensor mapping prefetch instruction (e.g., prefetch tensor map instruction 248). In at least one embodiment, a pointer to a source location of tensor mapping in memory and/or some other suitable source identifier is to be used as input to prefetch tensor map API 234 and/or prefetch tensor map instruction 248. In at least one embodiment, prefetched tensor mapping is to be used to perform a subsequent asynchronous tensor data copy instruction and/or API (e.g., that uses tensor mapping). In at least one embodiment, prefetching tensor map to cache enables acceleration of one or more subsequent tensor operations that use prefetched tensor map. In at least one embodiment, prefetched tensor map is available to be used by one or more tensor operations more quickly than if tensor map had not been prefetched.

In at least one embodiment, set of APIs 232 includes a tensor map API 236. In at least one embodiment, tensor map API 236 is referred to as cuTensorMapEncodeTiled( ), or by some other suitable API name. In at least one embodiment, tensor map API 236 is to generate a data structure that indicates a transformation between a first tensor in global memory (e.g., global memory 218) of a GPU and a second tensor in shared memory (e.g., shared memory 220) of that GPU. In at least one embodiment, transformation is between a tile of first tensor and second tensor. In at least one embodiment, transformation is between a tile of first tensor and a tile of second tensor. In at least one embodiment, generated data structure is referred to as a tensor map (e.g., tensor map 120 of FIG. 1) and/or tensor mapping. In at least one embodiment, tensor map is referred to as a tensor descriptor. In at least one embodiment, a tensor map is a data structure that indicates how to obtain second tensor from tensor data (e.g., a tile or subtensor) of first tensor. In at least one embodiment, performing tensor map API 236 causes a tensor map to be generated at a location specified by an input to tensor map API 236. In at least one embodiment, one or more other inputs to tensor map API 236 are used to perform transformation of tensor data. In at least one embodiment, inputs to tensor map API 236 include a location to store a generated tensor map data structure, a tensor data type, a tensor rank, a global address, global tensor dimensions, global strides, box dimensions, element strides, an interleave data structure, a swizzle data structure, an L2 promotion data structure, an out of bounds fill data structure, and/or other suitable inputs. In at least one embodiment, tensor map API 236 returns an indication of whether tensor map generation was successful. In at least one embodiment, tensor mapping prefetch API (e.g., prefetch tensor map API 234) and/or prefetch tensor map instruction 248 is to prefetch tensor mapping generated by tensor map API 236.

In at least one embodiment, set of APIs 232 includes an image to column (I2C) tensor map API 238. In at least one embodiment, image to column tensor map API 238 is referred to as cuTensorMapEncodeIm2Col( ), or by some other suitable API name. In a least one embodiment, performing image to column tensor map API 238 causes a tensor map (e.g., tensor map 120 of FIG. 1) that includes one or more I2C transformations to be generated. In at least one embodiment, tensor map generated by image to column tensor map API 238 also includes one or more additional types of transformations (e.g., as described with respect to tensor map API 236). In at least one embodiment, an I2C transformation rearranges data in a tensor into columns of a matrix (e.g., such as to allow a convolution operation to be performed as a matrix multiplication operation). In at least one embodiment, I2C tensor map API 238 takes, as inputs, one or more inputs described with respect to tensor map API 236. In at least one embodiment, I2C tensor map API 238 includes one or more additional inputs that indicate which data of input tensor to arrange in columns of output matrix. In at least one embodiment, tensor mapping prefetch API (e.g., prefetch tensor map API 234) and/or prefetch tensor map instruction 248 is to prefetch tensor mapping generated by I2C tensor map API 238.

In at least one embodiment, set of APIs 232 includes an asynchronous copy using tensor map API 240. In at least one embodiment, asynchronous copy using tensor map API 240 is referred to as memcpy_tensor_async( ), or some other suitable API name. In at least one embodiment, asynchronous copy using tensor map API 240 is to perform asynchronous data copy operations using a tensor map (e.g., generated by tensor map API 236 or I2C tensor map API 238) that has been prefetched to cache using prefetch tensor map API 234 and/or prefetch tensor map instruction 248. In at least one embodiment, performing asynchronous copy using tensor map API 240 causes a tensor to be generated and stored in memory according to a tensor map (e.g., tensor map 120 of FIG. 1 and/or a tensor map generated by tensor map API 236 or I2C tensor map API 238). In at least one embodiment, asynchronous copy using tensor map API 240 uses automatic transaction accounting (e.g., uses a synchronization object that is not later updated by another API with an expected transaction count). In at least one embodiment, inputs to asynchronous copy using tensor map API 240 are a destination memory location (e.g., a pointer to a location in shared memory), an identifier of a tensor map data structure (e.g., a data structure that includes tensor map), a data structure that indicates a location (e.g., coordinates) of a subset of data (e.g., a tile or subtensor) in a tensor in global memory that is to be copied, and an identifier of a synchronization object that tracks asynchronous data copy operations. In at least one embodiment, asynchronous copy using tensor map API 240 returns an indication of whether a particular hardware unit (e.g., asynchronous data movement H/W 222) on GPU was used to perform asynchronous copy using tensor map operation.

In at least one embodiment, set of APIs 232 includes an asynchronous copy using tensor map with manual tracking API 242. In at least one embodiment, asynchronous copy using tensor map with manual tracking API 242 is referred to as memcpy_tensor_async_tx( ), or some other suitable API name. In at least one embodiment, asynchronous copy using tensor map with manual tracking API 242 is to perform asynchronous data copy operations using a tensor map (e.g., generated by tensor map API 236 or I2C tensor map API 238) that has been prefetched to cache using prefetch tensor map API 234 and/or prefetch tensor map instruction 248. In at least one embodiment, performing asynchronous copy using tensor map with manual tracking API 242 causes a tensor to be generated and stored in memory according to a tensor map (e.g., tensor map 120 of FIG. 1 and/or a tensor map generated by tensor map API 236 or I2C tensor map API 238). In at least one embodiment, asynchronous copy using tensor map with manual tracking API 242 uses manual transaction accounting. In at least one embodiment, inputs to asynchronous copy using tensor map with manual tracking API 242 are a destination memory location (e.g., a pointer to a location in shared memory), an identifier of a tensor map data structure (e.g., a data structure that includes tensor map), a data structure that indicates a location (e.g., coordinates) of a subset of data (e.g., a tile or subtensor) in a tensor in global memory that is to be copied, and an identifier of a synchronization object that tracks asynchronous data copy operations. In at least one embodiment, identified thread synchronization object is to be updated by another API that provides an expected transaction count (e.g., an amount of data to be used in asynchronous copy using tensor map with manual tracking operation). In at least one embodiment, asynchronous copy using tensor map with manual tracking API 242 returns an indication of whether a particular hardware unit (e.g., asynchronous data movement H/W 222) on GPU was used to perform asynchronous copy using tensor map operation.

In at least one embodiment, set of APIs 232 includes an in-place transformation API 244. In at least one embodiment, in-place transformation API 244 is referred to as inplace_transform_tensor_async( ), or some other suitable API name. In at least one embodiment, performing in-place transformation API 244 is to perform an in-place transformation using a tensor map. In at least one embodiment, in-place transformation of a tensor is a transformation of tensor that stores result of transformation in same memory in which untransformed tensor is stored. In at least one embodiment, in-place transformation is a reduction operation performed on a first tensor using a second tensor and a tensor map (e.g., generated by tensor map API 236 or I2C tensor map API 238) that has been prefetched to cache using prefetch tensor map API 234 and/or prefetch tensor map instruction 248. In at least one embodiment, performing in-place transformation API 244 can cause a first tensor to be transformed to a second tensor that is stored in memory, then cause second tensor to be transformed into a third tensor that uses memory that stores second tensor (e.g., by overwriting second tensor with third tensor). In at least one embodiment, in-place transformation API takes, as input, one or more of a pointer to a tensor map data structure, a parameter data structure (e.g., that includes one or more additional parameters such as an identifier of a reduction operation to be performed and/or coordinate information for a portion of a tensor to be used), an identifier of a source location, an identifier of a synchronization object to be used, and/or other suitable parameters. In at least one embodiment, in-place transformation API 244 returns an indication of whether a particular hardware unit (e.g., asynchronous data movement H/W 222) on GPU was used to perform in-place transformation operation. In at least one embodiment, in-place transformation API 244 is to perform multiple asynchronous reduction operations using tensors in multiple destination locations (e.g., by using a data structure that includes multiple destination locations rather than a single location as destination memory location input, such as described with respect to asynchronous multicast copy API 238) using data from source location.

In at least one embodiment, computer system 202 includes a set of instructions 246. In at least one embodiment, set of instructions 246 includes low-level and/or intermediate level instructions (e.g., CUDA PTX instructions). In at least one embodiment, one or more instructions included set of instructions 246 are included in set of APIs 232. In at least one embodiment, set of instructions 246 includes a prefetch tensor map instruction 248. In at least one embodiment, prefetch tensor map instruction 248 is referred to as a tensor mapping prefetch instruction. In at least one embodiment, prefetch tensor map instruction 248 is referred to as prefetch.tensormap, or some other suitable instruction name. In at least one embodiment, prefetch tensor map instruction 248 is to prefetch a tensor map by copying a tensor map from global memory of a GPU (e.g., global memory 218) to cache memory. In at least one embodiment, prefetch tensor map instruction 248 is to prefetch a tensor map by copying a tensor map from some other type of memory (e.g., shared memory 220, constant (const) memory, and/or some other suitable memory). In at last one embodiment, cache memory is a cache of asynchronous data movement H/W (e.g., cache 224). In at least one embodiment, prefetch tensor map instruction 248 uses a particular format (e.g., prefetch{.tensormap_space}.tensormap [a]), where {tensormap_space} is optional and [a] is an address of tensor mapping to be prefetched. In at least one embodiment, tensormap_space is a subset of memory (e.g., designated as .const or .param) in which tensor map is stored and is to be prefetched from. In at least one embodiment, tensor mapping prefetch instruction is included in set of APIs 232.

In at least one embodiment, set of instructions 246 includes a prefetch using tensor map 250. In at least one embodiment, prefetch using tensor map 250 is referred to as prefetch.bulk.tensor.dim.global.L2, or some other suitable instruction name. In at least one embodiment, prefetch using tensor map 250 is to prefetch data by asynchronously copying data from global memory of a GPU (e.g., global memory 218) to cache memory (e.g., cache 230) of GPU using a tensor map (e.g., generated by tensor map API 236) that has been prefetched to cache using prefetch tensor map API 234 and/or prefetch tensor map instruction 248. In at least one embodiment, cache memory is L2 cache memory. In at least one embodiment, inputs to prefetch using tensor map 250 are a pointer to tensor map data structure (e.g., a tensor map and/or tensor descriptor), and a parameter that indicates a portion of tensor to which tensor map is to be applied (e.g., coordinates). In at least one embodiment, tensor map data structure includes a source location of data to be copied (e.g., a pointer to a tensor in global memory). In at least one embodiment, prefetch using tensor map 250 with representation of inputs to be provided is referred to as prefetch.bulk.tensor.dim.global.L2 [srcPtr], coord. In at least one embodiment, performing prefetch using tensor map 250 causes a tensor in global memory of a GPU to be transformed according to a tensor map and result to be stored in L2 cache memory of GPU.

In at least one embodiment, set of instructions 246 includes asynchronous copy to cache 252. In at least one embodiment, asynchronous copy to cache 252 is referred to as prefetch.bulk.tensor.dim.im2col.global.L2, or some other suitable instruction name. In at least one embodiment, asynchronous copy to cache 252 is to asynchronously copy data from global memory of a GPU (e.g., global memory 218) to cache memory (e.g., cache 230) of GPU based on a tensor map data structure (e.g., generated by I2C tensor map API 238) that includes image-to-column transformation information that has been prefetched to cache using prefetch tensor map API 234 and/or prefetch tensor map instruction 248. In at least one embodiment, asynchronous copy to cache is referred to as a prefetch. In at least one embodiment, cache memory is L2 cache memory. In at least one embodiment, inputs to asynchronous copy to cache 252 are a pointer to a tensor map data structure, a parameter indicating a portion of a tensor to which tensor map is to apply (e.g., coordinates), and an offset value used in image-to-column transformation. In at least one embodiment, asynchronous copy to cache 252 with representation of inputs to be provided is referred to as prefetch.bulk.tensor.dim.im2col.global.L2 [srcPtr], coord, i2cOff. In at least one embodiment, performing asynchronous copy to cache 252 causes a tensor in global memory of a GPU to be transformed according to tensor map including one or more image-to-column transformations, and result to be stored in L2 cache memory of GPU.

In at least one embodiment, a compiler 254 translates requests received via APIs in set of APIs 232 into instructions (e.g., generates instructions that are part of an instruction set architecture for GPU 210) that can be executed on GPU 210. In at least one embodiment, generated instructions are stored as code 256 that is copied to one or more GPUs in set of GPUs 208 (e.g., GPU 210) to be performed. In at least one embodiment, one or more threads use one or more APIs in set of APIs 232, and can pass one or more arguments to APIs in set of APIs. In at least one embodiment, set of APIs 232 includes one or more APIs that can be used by code implemented at a higher level (e.g., C++ style implementation) and/or that can be used by code implemented at an intermediate level (e.g., as PTX style instructions). In at least one embodiment, compiler 254 translates requests received via instructions in set of instructions 246 into lower-level instructions (e.g., that are part of an instruction set architecture) stored as code 256 (e.g., as part of a kernel) that can be executed on GPU 210.

In at least one embodiment, computer system 202 includes a set of nodes 258. In at least one embodiment, set of nodes 258 includes a node 260, a node 262, and a node 264. In at least one embodiment, set of nodes 258 includes a different number of nodes. In at least one embodiment, nodes in set of nodes 258 include one or more GPUs. In at least one embodiment, kernel information (e.g., based, at least in part, on code 256) is copied to one or more GPUs included in one or more nodes in set of nodes 258. In at least one embodiment, one or more components and/or aspects of computer system 202 and/or set of nodes 258 are implemented with one or more hardware components, one or more software components, one or more circuits, dedicated hardware such as fixed function circuitry, and/or any other suitable type of hardware, software, or combination thereof. In at least one embodiment, one or more aspects shown or described with respect to FIG. 2 are implementations of, or same as, one or more aspects shown or described with respect to FIG. 1. In at least one embodiment, set of APIs 232 is included in API 108 of FIG. 1, set of instructions 246 is included in API 108 of FIG. 1, GPU 210 is PPU 106 of FIG. 1, asynchronous data movement H/W 222 is asynchronous data movement H/W 114 of FIG. 1, synchronization H/W 226 is synchronization H/W 118 of FIG. 1, processor 204 is CPU 104 of FIG. 1, and/or compiler 254 is compiler 112 of FIG. 1. In at least one embodiment, set of APIs 232 includes one or more other APIs, not shown for clarity (e.g., one or more synchronization APIs such as a barrier arrive API, a commit API, a wait API and/or a wait priority API, one or more cooperative thread group APIs, one or more pipeline APIs, and/or some other suitable APIs).

In at least one embodiment, as used in any implementation described herein, unless otherwise clear from context or stated explicitly to contrary, terms such as “module” and nominalized verbs (e.g., compiler, and/or other terms) each refers to any combination of software logic, firmware logic, hardware logic, and/or circuitry configured to provide functionality described herein. In at least one embodiment, software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth.

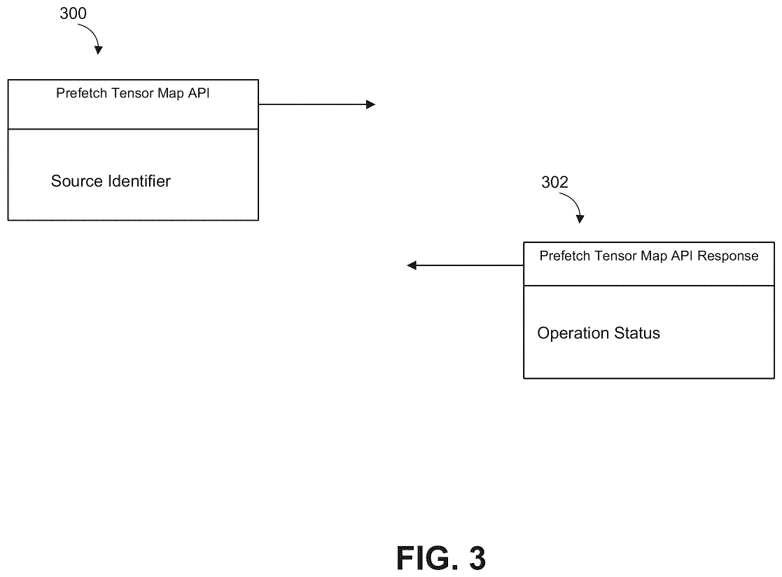

FIG. 3 illustrates performing an API 300 to prefetch a tensor map, according to at least one embodiment. In at least one embodiment, API 300 is to cause a tensor map to be prefetched from global memory (e.g., global memory 218 of FIG. 2) to a cache (e.g., cache 224 of FIG. 2). In at least one embodiment, API 300 is to cause a tensor map to be prefetched from some other type of memory (e.g., shared memory 220, constant (const) memory, and/or some other suitable memory) to a cache. In at least one embodiment, cache is a multi-line cache, a single line cache, or has some other suitable structure. In at least one embodiment, one or more processors (e.g., processor 228, asynchronous data movement H/W 222, and/or processor 204 of FIG. 2) are to perform API 300. In at least one embodiment, API 300 is to be performed using prefetch tensor map API 234 of FIG. 1. In at least one embodiment, performing API 300 includes performing an instruction to prefetch a tensor map (e.g., prefetch tensor map instruction 248 of FIG. 2). In at least one embodiment, API 300 includes one or more parameters. In at least one embodiment, parameters of API 300 include an identifier of a source location of a tensor map to be copied (e.g., a pointer to source memory location in global memory or an address of a source location in global memory). In at least one embodiment, API 300 includes a different number and/or a different type of parameters. In at least one embodiment, a response 302 to performing API 300 includes an indication of whether performance of API 300 was successful (e.g., an operation status). In at least one embodiment, response 302 is not present (e.g., when API 300 has a void return type, or when API 300 is performed as an instruction where no return value is used).

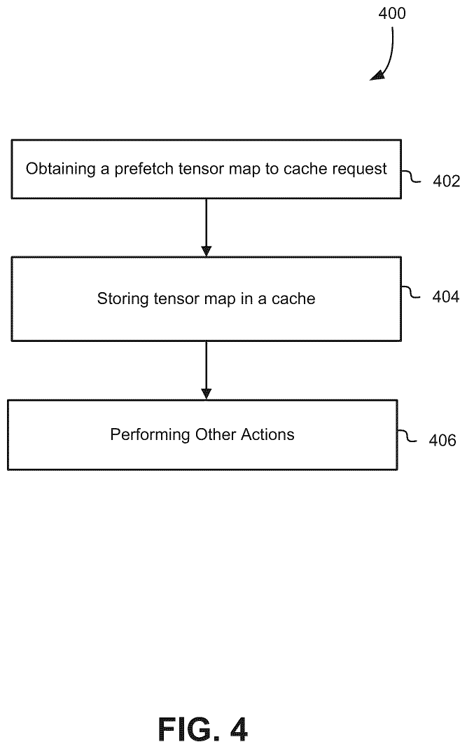

FIG. 4 is a flowchart of a technique 400 of prefetching a tensor map, according to at least one embodiment. In at least one embodiment, one or more aspects of technique 400 are performed by one or more aspects shown or described with respect to FIG. 1 and/or FIG. 2 (e.g., CPU 104, PPU 106, API 108, compiler 112 of FIG. 1, prefetch tensor map API 234, prefetch tensor map instruction 248, processor 204, compiler 254, processor 228, and/or asynchronous data movement H/W 222 of FIG. 2) and/or one or more components, techniques, and/or other aspects shown or described with respect to other figures herein. In at least one embodiment, technique 400 includes performing one or more aspects of API 300 of FIG. 3.

In at least one embodiment, at a block 402, technique 400 includes obtaining a prefetch tensor map to cache request (e.g., via an API such as prefetch tensor map API 234 of FIG. 2 or instruction such as prefetch tensor map instruction 248 of FIG. 2). In at least one embodiment, at a block 404, technique 400 includes performing prefetch tensor map to cache operation (e.g., performing prefetch tensor map API 234 of FIG. 2, prefetch tensor map instruction 248 of FIG. 2 and/or API 300 of FIG. 3). In at least one embodiment, at a block 406, technique 400 includes performing other actions (e.g., returning an indication that prefetch tensor map to cache operation was successfully performed and/or returning to block 402 to obtain another prefetch tensor map to cache request. In at least one embodiment, performing other actions at block 406 includes performing one or more operations that use tensor map prefetched to cache.

In at least one embodiment, at least one aspect of technique 400 includes storing one or more tensor maps (e.g., tensor map 120 of FIG. 1) in one or more cache storages (e.g., cache 116 of FIG. 1, cache 224 of FIG. 2, and/or descriptor cache 1208 of FIG. 12) using one or more tensor acceleration logic circuits (e.g., of asynchronous data movement H/W 114 of FIG. 1, asynchronous data movement H/W 222 of FIG. 2, TMAU 712 of FIG. 7, and/or TMAU 1212 of FIG. 12. In at least one embodiment, storing one or more tensor maps in one or more cache storages includes performing an API (e.g., prefetch tensor map API 234 of FIG. 2 and/or API 300 of FIG. 3) to cause one or more tensor maps to be stored. In at least one embodiment, storing one or more tensor maps in one or more cache storages includes performing an instruction (e.g., prefetch tensor map instruction 248 of FIG. 2) to cause one or more tensor maps to be stored in an asynchronous data movement hardware cache. In at least one embodiment, one or more tensor maps include a first tensor map that includes information that indicates a structure of a first tensor in a first memory (e.g., global memory 216 of FIG. 2), and indicates a structure of a second tensor to be stored in a second memory (e.g., shared memory 220 of FIG. 2) based, at least in part, on first tensor map and first tensor. In at least one embodiment, storing one or more tensor maps in one or more cache storages includes performing an API to cause one or more tensor maps to be stored in an asynchronous data movement hardware cache of a GPU based, at least in part, on one or more addresses of one or more tensor maps in global memory (e.g., global memory 218 of FIG. 2) of GPU, shared memory 220, constant (const) memory, and/or some other suitable memory. In at least one embodiment, storing one or more tensor maps in one or more cache storages includes performing an instruction based, at least in part, on one or more addresses of one or more tensor maps in memory accessible by a GPU. In at least one embodiment, a non-transitory computer-readable medium having stored thereon a set of instructions, which if performed by one or more processors, cause one or more processors to at least perform one or more aspects of technique 400.

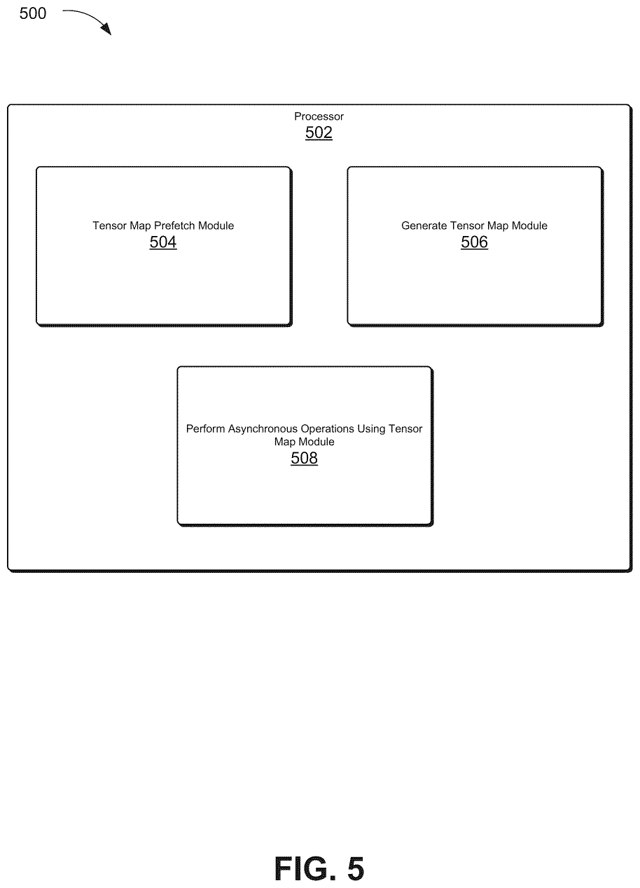

FIG. 5 is a block diagram illustrating an example of a processor 500, according to at least one embodiment. In at least one embodiment, a processor 502 performs one or more processes such as those described herein to cause a tensor map to be stored in a cache storage. In at least one embodiment, processor 502 performs one or more processes such as those described herein to prefetch a tensor map stored in global memory to a cache of asynchronous data movement hardware. In at least one embodiment, processor 502 performs one or more processes such as those described herein to prefetch a tensor map stored in some other type of memory (e.g., shared memory, constant (const) memory, and/or some other type of suitable memory) to a cache of asynchronous data movement hardware.

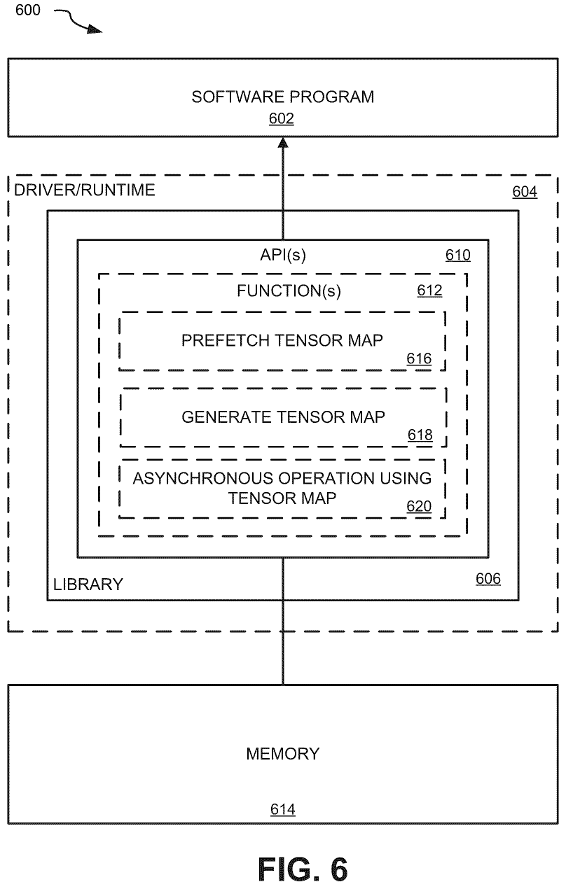

In at least one embodiment, processor 502 performs one or more aspects described with respect to CPU 104, PPU 106, and/or asynchronous data movement H/W 114 of FIG. 1, processor 204, GPU 210, GPU 212 asynchronous data movement H/W 222, one or more APIs of set of APIs 232, and/or one or more instructions of set of instructions 246 of FIG. 2, API 300 of FIG. 3, technique 400 of FIG. 4, and/or one or more APIs 610 of FIG. 6. In at least one embodiment, processor 502 performs one or more processes such as those described in connection with FIGS. 1-4.

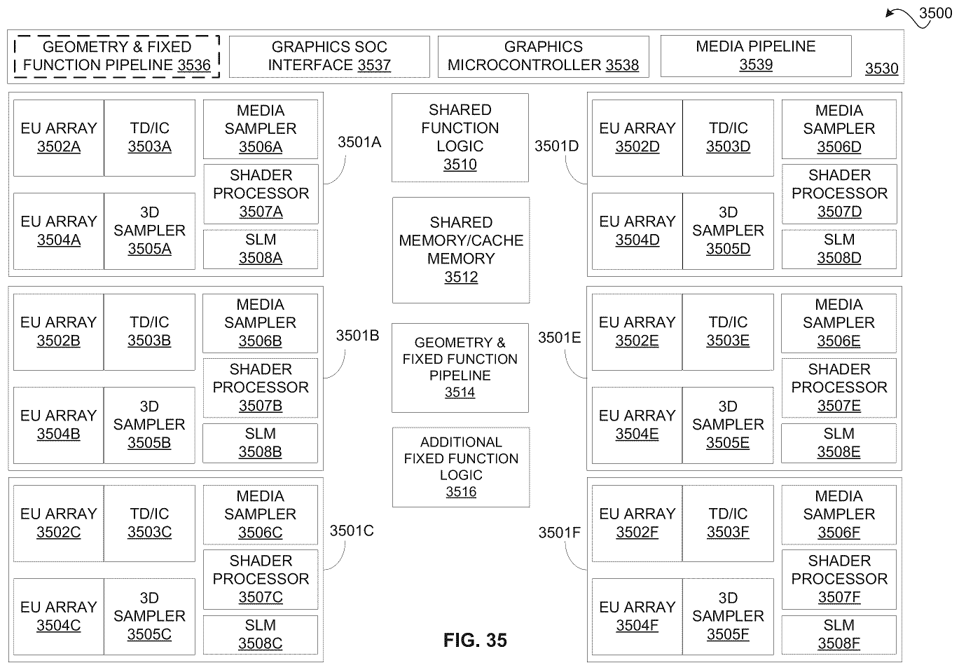

In at least one embodiment, processor 502 comprises one or more processors such as those described in connection with one or more of FIGS. 35-50. In at least one embodiment, processor 502 is any suitable processing unit and/or combination of processing units, such as one or more CPUs, GPUs, GPGPUs, PPUs, and/or variations thereof. In at least one embodiment, processor 502 comprises a tensor map prefetch module 504, a generate tensor map module 506, and a perform asynchronous operations using tensor map module 508. In at least one embodiment, tensor map prefetch module 504, generate tensor map module 506, and/or perform asynchronous operations using tensor map module 508 are part of processor 502 and/or one or more other processors. In at least one embodiment, tensor map prefetch module 504, generate tensor map module 506, and/or perform asynchronous operations using tensor map module 508 are distributed among multiple processors that communicate over a bus, network, by writing to shared memory, and/or any suitable communication process such as those described herein.

In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed and/or performed by programmable circuitry. In at least one embodiment, modules may, collectively or individually, be embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof.

In at least one embodiment, tensor map prefetch module 504 is a module that prefetches a tensor map to a cache. In at least one embodiment, tensor map prefetch module 504 performs one or more processes such as those described herein by at least including or otherwise encoding instructions that cause performance of or otherwise can be utilized to perform said one or more processes (e.g., by processor 502). In at least one embodiment, tensor map prefetch module 504 prefetches a tensor map to cache based, at least in part, on receiving information that specifies a location of tensor map (e.g., an address in global memory) via an API. In at least one embodiment, tensor map prefetch module 504 performs one or more aspects shown or described with respect to API 108 of FIG. 1, prefetch tensor map API 234 and/or prefetch tensor map instruction 248 of FIG. 2, API 300 of FIG. 3, and/or technique 400 of FIG. 4.

In at least one embodiment, generate tensor map module 506 is a module that generates a tensor map (e.g., tensor map 120 of FIG. 1). In at least one embodiment, generate tensor map module 506 performs one or more processes such as those described herein by at least including or otherwise encoding instructions that cause performance of or otherwise can be utilized to perform said one or more processes (e.g., by processor 502). In at least one embodiment, generate tensor map module 506 performs one or more aspects shown or described with respect to tensor map API 236 and/or image-to-column tensor map API 238 of FIG. 2.

In at least one embodiment, perform asynchronous operations using tensor map module 508 is a module that performs one or more asynchronous operations using a tensor map (e.g., a tensor map stored in a cache using tensor map prefetch module 504). In at least one embodiment, perform asynchronous operations using tensor map module 508 performs one or more processes such as those described herein by at least including or otherwise encoding instructions that cause performance of or otherwise can be utilized to perform said one or more processes (e.g., by processor 502). In at least one embodiment, perform asynchronous operations using tensor map module 508 performs one or more aspects shown or described with respect to asynchronous copy using tensor map API 240, asynchronous copy using tensor map with manual tracking API 242, in-place transformation API 244, prefetch using tensor map instruction 250, and/or asynchronous copy to cache instruction 252 of FIG. 2.

In at least one embodiment, a processor (e.g., asynchronous data movement H/W 114 of FIG. 1, asynchronous data movement H/W 222 of FIG. 2, TMAU 712 of FIG. 7, TMAU 1212 of FIG. 12, processor 204 of FIG. 2, and/or processor 228 of FIG. 2) includes one or more tensor acceleration logic circuits to cause one or more tensor maps (e.g., tensor map 120 of FIG. 1) to be stored in one or more cache storages (e.g., cache 116 of FIG. 1, cache 224 of FIG. 2, and/or descriptor cache 1208 of FIG. 12). In at least one embodiment, tensor acceleration logic circuits are to cause one or more tensor maps to be stored in one or more cache storages based, at least in part, on an instruction (e.g., prefetch tensor map instruction 248 of FIG. 2). In at least one embodiment, one or more tensor acceleration logic circuits are to cause one or more tensor maps to be stored in one or more cache storages based, at least in part, on an API (e.g., prefetch tensor map API 234 of FIG. 2 and/or API 300 of FIG. 3). In at least one embodiment, one or more tensor acceleration logic circuits are to cause one or more tensor maps to be stored in one or more cache storages based, at least in part, on one or more addresses of one or more tensor maps in global memory (e.g., global memory 218 of FIG. 2) of a GPU. In at least one embodiment, one or more tensor acceleration logic circuits are to cause one or more tensor maps to be stored in one or more cache storages based, at least in part, on one or more addresses of one or more tensor maps in some other type of memory (e.g., shared memory 220 of FIG. 2, constant (const) memory, and/or some other suitable type of memory). In at least one embodiment, one or more cache storages include an asynchronous data movement hardware cache (e.g., cache 116 of FIG. 1, cache 224 of FIG. 2, and/or descriptor cache 1208 of FIG. 12). In at least one embodiment, one or more cache storages include one or more single line cache storages. In at least one embodiment, one or more cache storages include one or more multiple line cache storages. In at least one embodiment, one or more tensor maps include a first tensor map that includes information that indicates a structure of a first tensor stored in a first memory (e.g., global memory 218 of FIG. 2) of a GPU, and indicates a structure of a second tensor to be stored in a second memory (e.g., shared memory 220 of FIG. 2) of GPU based, at least in part, on first tensor map and first tensor. In at least one embodiment, one or more tensor maps include one or more image-to-column transformations.

In at least one embodiment, a system includes one or more processors (e.g., CPU 104, PPU 066, and/or asynchronous data movement H/W 114 of FIG. 1, and/or processor 204, processor 228, and/or asynchronous data movement H/W 222 of FIG. 2) to cause one or more tensor maps (e.g., tensor map 120 of FIG. 1) to be stored in one or more cache storages. In at least one embodiment, one or more processors are to cause one or more tensor maps to be stored in one or more cache storages based, at least in part, on an API (e.g., prefetch tensor map API 234 of FIG. 2) that uses one or more addresses of one or more tensor maps in memory. In at least one embodiment, one or more processors are to cause one or more tensor maps to be stored in one or more cache storages of a GPU (e.g., GPU 210 of FIG. 2). In at least one embodiment, one or more processors are to cause one or more tensor maps to be stored in one or more cache storages based, at least in part, on an instruction (e.g., prefetch tensor map instruction 248 of FIG. 2) that uses one or more addresses of one or more tensor maps. In at least one embodiment, one or more cache storages include a GPU asynchronous data movement hardware cache (e.g., cache 116 of FIG. 1, cache 224 of FIG. 2, and/or descriptor cache 1208 of FIG. 12). In at least one embodiment, one or more tensor maps include a first tensor map that includes information that indicates a structure of a first tensor stored in a first memory (e.g., global memory 218 of FIG. 2), and indicates a structure of a second tensor to be stored in a second memory (e.g., shared memory 220 of FIG. 2) based, at least in part, on first tensor map and first tensor.

FIG. 6 is a block diagram illustrating a driver and/or runtime environment 600 comprising one or more libraries to provide one or more application programming interfaces (APIs) according to at least one embodiment. In at least one embodiment, a software program 602 is a software module. In at least one embodiment, a software program 602 comprises one or more software modules including, but not limited to, those described herein at least in connection with FIG. 5. In at least one embodiment, a software module is as further described non-exclusively in FIG. 5. In at least one embodiment, one or more APIs 610 are sets of software instructions that, if performed, cause one or more processors to perform one or more computational operations. In at least one embodiment, performing software instructions includes executing software instructions. In at least one embodiment, one or more aspects of one or more software modules shown or described in connection with FIG. 5 are included partially in software program 602 (e.g., instructions and/or code to call a function when performed by a processor), and partially in one or more APIs 610 and/or functions 612 (e.g., instructions and/or code that implements called function when performed by a processor).

In at least one embodiment, one or more APIs 610 are distributed or otherwise provided as a part of one or more libraries 606, drivers and/or runtimes 604, and/or any other grouping of software, non-transitory computer readable instructions, and/or executable code further described herein. In at least one embodiment, one or more APIs 610 perform one or more computational operations in response to invocation by software programs 602. In at least one embodiment, a software program 602 is a collection of software code, commands, instructions, or other sequences of text to instruct a computing device to perform one or more computational operations and/or invoke one or more other sets of instructions, such as APIs 610 or API functions 612, to be performed. In at least one embodiment, functionality provided by one or more APIs 610 includes software functions 612, such as those usable to accelerate one or more portions of software programs 602 using one or more parallel processing units (PPUs), such as graphics processing units (GPUs). In at least one embodiment, APIs 610 and/or API functions 612 include APIs and/or functions to perform one or more aspects shown or described with respect to API 108 of FIG. 1, one or more APIs of set of APIs 232 of FIG. 2, one or more instructions of set of instructions 246 of FIG. 2, API 300 of FIG. 3, and/or technique 400 of FIG. 4.

In at least one embodiment, APIs 610 are hardware interfaces to one or more circuits to perform one or more computational operations. In at least one embodiment, one or more software APIs 610 described herein are implemented as one or more circuits to perform one or more techniques described herein in conjunction with FIGS. 1-5. In at least one embodiment, one or more software programs 602 comprise instructions that, if performed, cause one or more hardware devices and/or circuits to perform one or more techniques described herein in conjunction with FIGS. 1-5. In at least one embodiment, one or more software programs 602 utilize one or more APIs 610 provided by a driver and/or runtime 604 to manage virtual memory and/or to allocate or otherwise reserve one or more blocks of memory 614 of one or more PPUs, such as GPUs. In at least one embodiment, one or more software programs 602 utilize one or more APIs 610 provided by a driver and/or runtime 604 to manage virtual memory and/or allocate or otherwise reserve blocks of memory.

In at least one embodiment, software programs 602, such as user-implemented software programs (e.g., application 110 of FIG. 1), utilize one or more application programming interfaces (APIs) 610 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 610 provide a set of callable functions 612, referred to herein as APIs, API functions, and/or functions, that individually perform one or more computing operations, such as computing operations related to parallel computing. In at least one embodiment, a processor uses an API that includes a prefetch tensor map function 616. In at least one embodiment, prefetch tensor map function 616 performs one or more aspects of API 108 of FIG. 1, prefetch tensor map API 234 of FIG. 2, prefetch tensor map instruction 248 of FIG. 2, API 300 of FIG. 3, technique 400 of FIG. 4, and/or tensor map prefetch module 504 of FIG. 5. In at least one embodiment, a processor uses an API that includes a generate tensor map function 618. In at least one embodiment, generate tensor map function 618 performs one or more aspects of tensor map API 236 of FIG. 2, image-to-column tensor map API 238 of FIG. 2, and/or generate tensor map module 506 of FIG. 5. In at least one embodiment, a processor uses an API that includes an asynchronous operation using tensor map function 620. In at least one embodiment, asynchronous operation using tensor map function 620 performs one or more aspects of asynchronous copy using tensor map API 240 of FIG. 2, asynchronous copy using tensor map with manual tracking API 242 of FIG. 2, in-place transformation API 244 of FIG. 2, prefetch using tensor map instruction 250 of FIG. 2, asynchronous copy to cache 252 of FIG. 2, and/or perform asynchronous operations using tensor map module 508 of FIG. 5.

In at least one embodiment, one or more software programs 602 interact or otherwise communicate with one or more APIs 610 to perform one or more computing operations using one or more PPUs, such as GPUs. In at least one embodiment, one or more computing operations using one or more PPUs comprise at least one or more groups of computing operations to be accelerated by performance at least in part by said one or more PPUs. In at least one embodiment, one or more software programs 602 interact with one or more APIs 610 to facilitate parallel computing using a remote or local interface.

In at least one embodiment, an interface is software instructions that, if performed, provide access to one or more functions 612 provided by one or more APIs 610. In at least one embodiment, a software program 602 uses a local interface when a software developer compiles one or more software programs 602 in conjunction with one or more libraries 606 comprising or otherwise providing access to one or more APIs 610. In at least one embodiment, one or more software programs 602 are compiled statically in conjunction with pre-compiled libraries 606 or uncompiled source code comprising instructions to perform one or more APIs 610. In at least one embodiment, one or more software programs 602 are compiled dynamically and said one or more software programs utilize a linker to link to one or more pre-compiled libraries 606 comprising one or more APIs 610.

In at least one embodiment, a software program 602 uses a remote interface when software program utilizes or otherwise communicates with a library 606 comprising one or more APIs 610 over a network or other remote communication medium. In at least one embodiment, one or more libraries 606 comprising one or more APIs 610 are to be performed by a remote computing service, such as a computing resource services provider. In another embodiment, one or more libraries 606 comprising one or more APIs 610 are to be performed by any other computing host providing said one or more APIs 610 to one or more software programs 602.

In at least one embodiment, a processor performing or using one or more software programs 602 call, use, perform, or otherwise implement one or more APIs 610 to allocate and otherwise manage memory to be used by said software programs 602. In at least one embodiment, one or more software programs 602 utilize one or more APIs 610 to allocate and otherwise manage memory to be used by one or more portions of said software programs 602 to be accelerated using one or more PPUs, such as GPUs or any other accelerator or processor further described herein.

In at least one embodiment, an API of one or more APIs 610 is an API to facilitate parallel computing. In at least one embodiment, one or more APIs 610 include any other API further described herein. In at least one embodiment, one or more APIs 610 are provided by driver and/or runtime 604. In at least one embodiment, an API of one or more APIs 610 is provided by a CUDA user-mode driver. In at least one embodiment, an API of one or more APIs 610 is provided by a CUDA runtime. In at least one embodiment, a driver 604 is data values and software instructions that, if performed, perform or otherwise facilitate operation of one or more functions 612 of an API 610 during load and performance of one or more portions of a software program 602. In at least one embodiment, drivers and/or runtimes 604 is data values and software instructions that, if performed, perform or otherwise facilitate operation of one or more functions 612 of an API 610 during performance of a software program 602. In at least one embodiment, one or more software programs 602 utilize one or more APIs 610 implemented or otherwise provided by a driver and/or runtime 604 to perform combined arithmetic operations by one or more software programs 602 during performance by one or more PPUs, such as GPUs.

In at least one embodiment, TMA-Tensor descriptor (e.g., tensor mapping) encodings target TMA functionality in one or more particular GPU architectures (e.g., NVIDIA GH100 architecture). In at least one embodiment, with respect to descriptor versioning, TMA descriptors support a version field. In at least one embodiment, TMA on one or more architectures will verify that value of that field is compatible with architecture. In at least one embodiment, with respect to architecture specialized encoding, CUDA Driver encoding functions query device architecture, encode TMA descriptors according to that architecture, or generate an error for unsupported architectures. In at least one embodiment, with respect to emulation, a TMA-Tensor operation in device code executing on an architecture without compatible TMA hardware provides a fallback implementation. In at least one embodiment, fallback uses a cooperating group of threads to perform fallback and meta-data for fallback code.

In at least one embodiment, one or more techniques are to encode TMA-Tensor descriptor in host memory using an API (e.g., a particular API of CUDA Driver API). In at least one embodiment, one or more techniques are to copy that TMA-Tensor descriptor to code that is to use descriptor (e.g., copy to a CUDA kernel through_constant_object or as _grid_constant_parameter). In at least one embodiment, one or more techniques are to use _constant_or_grid_constant_copy of TMA-Tensor descriptor in TMA_device_functions.

In at least one embodiment, one or more techniques are to encode and re-use TMA-Tensor descriptor. In at least one embodiment, one or more techniques are to encode TMA-Tensor descriptor in host memory using CUDA Driver API. In at least one embodiment, just prior to kernel launch, one or more techniques are to update device memory address within TMA-Tensor descriptor. In at least one embodiment, one or more techniques are to copy that TMA-Tensor descriptor to a CUDA kernel through_constant_object or as_grid_constant_parameter. In at least one embodiment, one or more techniques are to use_constant_or_grid_constant_copy of TMA-Tensor descriptor in TMA_device_functions.

In at least one embodiment, with respect to opaque type and encoding, a TMA-Tensor descriptor has many packed bit-fields to define shape and mapping between tensors in global and shared memory. In at least one embodiment, one or more techniques use one or more opaque types and encoding operations for generating values of those types. In at least one embodiment, descriptor encoding results in a valid descriptor or returns an error.

In at least one embodiment, with respect to CUDA Driver target-architecture specific encoding, a TMA-Tensor descriptor has architecture dependent encodings. In at least one embodiment, architecture dependencies are managed through CUDA driver. In at least one embodiment, a TMA-Tensor descriptor is 64 bytes in size and 64 byte aligned.

In at least one embodiment, with respect to transaction accounting metadata, asynchronous data movement operations with automatic transaction accounting are used to automatically update a SyncUnit barrier with an expected transaction count value balancing asynchronous operation's actual transaction count update. In at least one embodiment, TMA-Tensor asynchronous operations update “N” bytes in distributed shared memory and update corresponding SyncUnit barriers with an actual transaction count of “N”. In at least one embodiment, value “N” is non-trivially determinable from TMA-Tensor descriptor. In at least one embodiment, publicly exposed TMA-Tensor descriptor is increased in size to 128 bytes, bit-encoding also computes “N”, and that value is stored in adjacent 64 bytes.

In at least one embodiment, with respect to updating address of global memory tensor in opaque type, one or more techniques are to update address of global memory tensor within TMA-Tensor descriptor. In at least one embodiment, descriptor encoding results in a valid descriptor or returns an error.

In at least one embodiment, an opaque data type for TMA descriptor is defined. In at least one embodiment, opaque data type is suitable to be passed host to device through_constant_or_grid_constant_variables. In at least one embodiment, opaque data type object is compatible with use in device code TMA instructions. In at least one embodiment, encoding functions query device architecture and encode TMA descriptor accordingly. In at least one embodiment, opaque data type is sufficiently large to accommodate additional meta-data for usability and cross-architecture compatibility. In at least one embodiment, encoding functions include identified meta-data. In at least one embodiment, encoding functions observe and return error for invalid combination of input parameters.

In at least one embodiment, opaque data type is at least 64 byte aligned for correct use in device code TMA instructions, and is 128 bytes in size to accommodate both 64 byte (e.g., to be used on one or more architectures) TMA descriptor and an additional 64 bytes to hold current and future meta-data. In at least one embodiment TMA descriptor, also referred to as a tensor map (e.g., tensor map 120 of FIG. 1), can be further illustrated as follows:

```
struct cuTensorMap { alignas(64) uint64_t opaque[16]; }
enum cuTensorMapDataType {
  /* standard types */
  cuTensorMapDataType_uint8,
  cuTensorMapDataType_uint16,
  cuTensorMapDataType_uint32,
  cuTensorMapDataType_int32,
  cuTensorMapDataType_uint64,
  cuTensorMapDataType_int64,
  cuTensorMapDataType_float16,
  cuTensorMapDataType_float32,
  cuTensorMapDataType_float64,
  /* specialized types and treatments */
  cuTensorMapDataType_bfloat16,
  cuTensorMapDataType_float32ftz, /* f32, GMEM RED ftz */
  cuTensorMapDataType_tfloat32, /* GMEM f32, SMEM tf32 */
  cuTensorMapDataType_tfloat32ftz /* GMEM f32, SMEM tf32, GMEM RED
ftz */
};
enum cuTensorMapInterleave {
  cuTensorMapInterleave_none,
  cuTensorMapInterleave_16B,
  cuTensorMapInterleave_32B };
enum cuTensorMapSwizzle {
  cuTensorMapSwizzle_none,
  cuTensorMapSwizzle_32B,
  cuTensorMapSwizzle_64B,
  cuTensorMapSwizzle_128B };
enum cuTensorMapFloatOOBfill {
  cuTensorMapFloatOOBfill_none,
  cuTensorMapFloatOOBfill_nan_request_zero_fma };
enum cuTensorMapL2promotion {
  cuTensorMapL2promotion_none,
  cuTensorMapL2promotion_L2_64B,
  cuTensorMapL2promotion_L2_128B,
  cuTensorMapL2promotion_L2_256B };
```

In at least one embodiment, an encode tiled descriptor type can be further illustrated as follows:

| CUresult cuTensorMapEncodeTiled( | |
|---|---|
| struct cuTensorMap * tensor_map, | |
| cuTensorMapDataType tensor data type, | |
| uint32_t | tensor_rank, |
| void | * global_address, |
| const uint64_t | * global_dimensions, |
| const uint64_t | * global_strides, |
| const uint32_t | * box_dimensions, |
| const uint32_t | * element_strides |

```
  cuTensorMapInterleave interleave,
  cuTensorMapSwizzle swizzle,
  cuTensorMapL2promotion l2promotion,
  cuTensorMapFloatOOBfill oobfill
);
```

In at least one embodiment, cuTensorMapEncodeTiled( ), above, is an API (e.g., tensor map API) that generates a tensor descriptor, also referred to as a tensor map at *tensor map, and returns CUresult.

In at least one embodiment, one or more techniques are to query a device architecture, encode TMA-Tensor descriptor according to that architecture, and encode derived meta-data. In at least one embodiment, derived meta-data includes one or more of shared memory asynchronous data movement byte count and shared memory required alignment. In at least one embodiment, tiled descriptor type encoding for a particular architecture (e.g., NVIDIA GH100) can be further illustrated as follows:

Tiled Descriptor Type encoding for GH100

| Tensor Descriptor Field | Encoding |
|---|---|
| tensorGlobalAddress = | globalAddress |
| descriptorType = | tiled |
| version = | 0 |
| dimensionality = | Dim |
| format = | tensor_data_type |
| interleaved = | elemInterleaveSize == 32 ? interleaved_32B |
| | elemInterleaveSize == 16 ? interleaved_16B |
| | : disable |
| SMEMswizzleMode = | sharedSwizzle |
| OOBfillMode = | oobfill |
| F32toTF32 = | via tensor_data_type |
| L2sectorPromotion = | l2Promote |
| tensorStride[ k ] = | globalStride[ k ] , k = 0..Dim-2 |
| tensorSize[ k ] = | globalSize[ k ] , k = 0..Dim-1 |
| traversalStride[ k ] = | elemStride[ k ] , k = 0..Dim-1 |
| boxSize[ k ] = | boxSize[ k ] , k = 0..Dim-1 |

In at least one embodiment, an encode IM2COL descriptor type can be further illustrated as follows:

```
CUresult cuTensorMapEncodeIm2col(
  struct cuTensorMap * tensor_map,
  cuTensorMapDataType tensor_data_type,
```

| | |
|---|---|
| uint32_t | tensor_rank, |
| void | * global_address, |
| const uint64_t | * global_dimensions, |
| const uint64_t | * global_strides, |
| const int32_t | * pixelBoxLowerCorner, /* DHW dimensions */ |
| const int32_t | * pixelBoxUpperCorner, |
| uint32_t | channelsPerPixel, |
| uint32_t | pixelsPerColumn, |
| const uint32_t | * element_strides, |

```
  cuTensorMapInterleave interleave,
  cuTensorMapSwizzle swizzle,
  cuTensorMapL2promotion l2promotion,
  cuTensorMapFloatOOBfill oobfill
);
```

In at least one embodiment, cuTensorMapEncodeIm2col( ), above, is an API (e.g., image-to-column tensor map API) that generates a tensor descriptor, also referred to as a tensor map at *tensor_map, and returns CUresult.

In at least one embodiment, one or more techniques are to query a device architecture, encode TMA-Tensor descriptor according to that architecture, and encode derived meta-data. In at least one embodiment, derived meta-data includes one or more of shared memory asynchronous data movement byte count and shared memory required alignment. In at least one embodiment, for IM2COL TMA-Tensor descriptors, a channel slice dimension is limited when combined with interleave mode. In at least one embodiment, TMA-Tensor descriptor encoding returns an error when this limit is violated. In at least one embodiment, IM2COL descriptor type encoding for a particular architecture (e.g., NVIDIA GH100) can be further illustrated as follows:

IM2COL Descriptor Type encoding for GH100

| Tensor Descriptor Field | Encoding |
|---|---|
| tensorGlobalAddress = | globalAddress |
| descriptorType = | im2col |
| version = | 0 |
| dimensionality = | Dim |
| format = | tensor_data_type |
| interleaved = | channelInterleave ? interleave_xxB : disable |
| SMEMswizzleMode = | sharedSwizzle |
| OOBfillMode = | oobfill |
| F32toTF32 = | tensor_data_type |
| tensorStride[ k ] = | globalStride[ k ] , k = 0..Dim-2 |
| tensorSize[ k ] = | globalSize[ k ] , k = 0..Dim-1 |
| traversalStride[ k ] = | elemStride[ k ] , k = 0..Dim-1 |
| rangeNDHW | pixelsPerColumn |
| rangeC | channelsPerPixel |
| boxBaseCornerDHW.D = | boxLowerOffset[0] |
| boxBaseCornerDHW.H = | boxLowerOffset[1] |
| boxBaseCornerDHW.W = | boxLowerOffset[2] |
| boxFarCornerDHW.D = | boxUpperOffset[0] |
| boxFarCornerDHW.H = | boxUpperOffset[1] |
| boxFarCornerDHW.W = | boxUpperOffset[2] |

In at least one embodiment, techniques described and suggested herein include APIs and instructions to prefetch tensor information. In at least one embodiment, tensor information is a tensor map. In at least one embodiment, following table provides information regarding an API in accordance with at least one embodiment:

| | |
|---|---|
| prefetch, prefetchu | Prefetch line containing a generic address at a specified level of memory |
| | hierarchy, in specified state space. |
| Syntax | prefetch{.space}.level [a]; // prefetch to data cache |
| | prefetch.global.level::eviction_priority [a]; // prefetch to data cache |
| | prefetchu.Ll [a]; // prefetch to uniform cache |
| | prefetch{. tensormap_space}.tensormap [a]; // prefetch tensormap |
| | .space= { .global, .local}; |
| | .level= { .Ll, .L2 }; |
| | .level: :eviction_priority= { .L2::evict last, .L2::evict_normal} |
| | .tensormap_space ={ . const, .param } |
| Description | In at least one embodiment, prefetch API or instruction, brings cache line |
| | containing specified address in global or local memory state space into |
| | specified cache level. |
| | In at least one embodiment, if.tensormap qualifier is specified then |
| | prefetch instruction brings cache line containing specified address |
| | in.const or .param memory state space for subsequent use by |
| | cp.async.bulk.tensor instruction. |
| | In at least one embodiment, if no state space is given, prefetch uses |
| | Generic Addressing |
| | In at least one embodiment, eviction priority to be applied on prefetched |
| | cache line can be specified by modifier .level::eviction_priority. |
| | In at least one embodiment, supported addressing modes for operand a |
| | and alignment requirements are described in Addresses as Operands |
| | In at least one embodiment, prefetchu instruction brings cache line |
| | containing specified generic address into specified uniform cache level. |
| | In at least one embodiment, a prefetch to a shared memory location |
| | performs no operation. |
| | In at least one embodiment, a prefetch into uniform cache requires a |
| | generic address, and no operation occurs if address maps to a const, |
| | local, or shared memory location. |
| Target ISA Notes | prefetch and prefetchu require sm_20 or higher. |
| | Support for .level::eviction_priority qualifier requires sm_80 or higher. |
| Example | prefetch.global.Ll [ptr]; |
| | prefetch.global.L2::evict_last [ptr]; |
| | prefetchu.Ll [addr]; |
| | prefetch.global.tensormap [ptr]; |

In at least one embodiment, an API or instruction is to prefetch tensor information to a cache of a processor, such as a graphics processing unit (GPU). In at least one embodiment, cache is a cache of a hardware unit of a GPU, such as a descriptor cache (e.g. descriptor cache 1208 of FIG. 12). In at least one embodiment, while details described herein may specify API, it should be noted that features of this API can be also found in an instruction in at least one embodiment. In at least one embodiment, an API includes a function to generate a tensor map. In at least one embodiment, a tensor map is referred to as a tensor descriptor. In at least one embodiment, rather than being referred to as being same, tensor descriptor is a data structure that includes a tensor map (e.g., tensor map), and this API includes a function to generate tensor descriptor that includes tensor map. In at least one embodiment, this API includes functions to generate more than one type of tensor descriptor (e.g., a first function to generate a tensor descriptor to be used with a tiled tensor mapping, and a second function to generate a tensor descriptor to be used with an image-to-column tensor mapping).

In at least one embodiment, one or more techniques provide and/or use streaming multiprocessors (SMs) or other parallel processor cores in a parallel processing system with closely coupled dedicated hardware circuitry for moving data in and out of memories. In at least one embodiment, one or more techniques include each parallel processor core to be closely coupled to a tensor memory access unit (TMAU) hardware circuitry for moving large data blocks between shared memory of parallel processor core and external memory such as, for example, global memory of parallel processing system.

In at least one embodiment, one or more computational applications use very large (e.g., megabytes or even gigabytes) data movements between global memory and compute cores of parallel processor cores such as SMs. In at least one embodiment, data is arranged in global memory as complicated multidimensional structures with non-sequential access patterns and is to be transferred to shared or other memory (SMEM) local to SM(s) prior to being consumed by SM(s). In at least one embodiment, when a multiplication of two very large matrices such as those used in deep learning (DL) applications and/or other suitable applications is to be performed by a plurality of threads running on one or more SMs, data of those two matrices is to be copied from global memory to shared memory of that one or more SMs before one or more SMs can operate on data.

In at least one embodiment, one or more techniques use a specialized memory access unit coupled to an SM. In at least one embodiment, specialized memory access unit includes capabilities helpful to tensor or other multidimensional data structure data movement and/or is referred to as a Tensor Memory Access Unit (TMAU). In at least one embodiment, a type of data which TMAU can move is not limited to tensor data and target computation core using data need not be a tensor core but could be any kind of processing core. In at least one embodiment, TMAU enables improvements and/or reduction of computation overhead in accessing such multidimensional structures, which when accessed in global memory without using TMAU exacts a significant computation overhead. In at least one embodiment, reasons for this computation overhead include sophisticated address calculations, handling of out-of-bounds conditions, resolving SMEM read/write bank conflicts, and/or other complex operations. In at least one embodiment, this type of overhead may negatively impact performance of a kernel executing on an SM and induce significant software development costs. In at least one embodiment, such computation overheads are often clearly evident in applications such as DL, for example, in convolutional kernels. In at least one embodiment, a typical convolution kernel accesses multidimensional data structures (matrices that may represent tensors or other information sets) that may be arranged according to different types of standard layouts in global memory. In at least one embodiment, performance loss related to address calculations in DL kernels may be attributed to register file (RF) bandwidth consumption, extra RF capacity requirements, out-of-bound conditions handling, limited instruction cache capacity, challenges in instructions scheduling, and/or other issues.

In at least one embodiment, a TMAU provides coupled SM(s) with efficient data transfer mechanisms to move large amounts of data between memory locations, such as, for example, a global memory location and a shared memory location. In at least one embodiment, TMAU enables SM(s) to be more computationally efficient by offloading a significant portion of related data access operations from kernels running on SM(s) to TMAU. In at least one embodiment, in contrast to kernels that rely on per thread load/store instructions that operate with relatively small data quanta, TMAU is configured to accept requests for substantially bigger data blocks or other data structures. In at least one embodiment, by issuing a single request to TMAU, multiple kilobytes or megabytes of data can be transferred for subsequent use by SM(s). In at least one embodiment, also, although request to TMAU may be issued by a single thread running on a single SM, fetched data can be consumed by multiple threads executing on that SM or on multiple SMs.

In at least one embodiment, an apparatus according to technology described in this disclosure may feed SM core math units at rates faster than techniques that rely on SM for calculating memory addresses in data to be copied and to track progress of copying large blocks of data. In at least one embodiment, example non-limiting embodiments provide techniques of block data transfer that result in reduced data transfer and memory access overheads. In at least one embodiment, reduced data transfer and memory access overheads may lead to significantly reduced multi-processor (e.g., SM-level) energy consumption and improved processing efficiency. In at least one embodiment, by way of analogy, consider a line chef responsible for grilling steaks and chops in a restaurant. Line chef can grill and plate steaks and chops very quickly. But in a busy restaurant, line chef is generally not also responsible for leaving their station to get meat from restaurant's big walk-in refrigerator, cutting meat into portions, trimming fat from meat, etc. Rather, line chef relies on their commis (assistant) chefs to do that work. Line chef can then concentrate on what only they can do; grill steaks and chops to perfection according to customer's order.

In at least one embodiment, LDGST instruction, which was mentioned above, reduces data access latency by moving data from global memory to shared memory of SMs and without intermediate writes to L1 cache and/or register file. In at least one embodiment, however, using that instruction, movement of large data blocks requires numerous complex address calculations to be performed by SM before it can issue memory access requests to memory system. In at least one embodiment, TMAU, in contrast to LDGST instruction executed by SM, enables SM to asynchronously transfer a much larger block of data with a single instruction and to also offload associated address calculations and other operations from threads on SM to TMAU. In at least one embodiment, in contrast to each parallel executing thread issuing its own instruction to obtain a small portion (e.g., tile) of data from global memory such as is done with LDGST instruction or other conventional load/store instructions, TMAU enables a single thread in a thread group, such as a cooperative thread array (“CTA”) to issue an instruction to obtain data for access by all other threads in group.

In at least one embodiment, TMAU may be considered similar to a direct memory access (DMA) engine in that TMAU can handle reads and writes to global memory independently of a requesting processor. In at least one embodiment, a key differentiation is in TMAU's capability to have knowledge of and traverse multidimensional data layouts whereas DMA typically works with linearly arranged data. In at least one embodiment, TMAU does not require requesting processor to include a memory address(es) in request for memory access. In at least one embodiment, TMAU can instead generate appropriate memory address(es) based on a coordinate of a multidimensional structure provided by requesting processing core.

In at least one embodiment, each TMAU is closely coupled to an SM, and each TMAU is coupled to a respective SM in a one-to-one relationship. In at least one embodiment, close coupling to a particular SM may enable TMAU to more efficiently service memory access requests with less contention than if it had to service requests from multiple processors. In at least one embodiment, each TMAU, in contrast to DMA engines that receive commands from a driver, receives memory access requests from coupled SM. In at least one embodiment, in contrast to DMA engines which are limited to reading from global memory, TMAU can copy data from global memory to shared memory, from shared memory to global memory, from global memory source addresses to global memory destination addresses and/or from shared (local) memory source addresses to shared (local) memory destination addresses. In at least one embodiment, in copying within shared memory, a TMAU coupled to a first SM may move data between shared/local memory of first SM and a shared/local memory of any other SM in GPU. In at least one embodiment, TMAU can copy data from distributed shared memory local to first SM to distributed shared memory local to another SM.

In at least one embodiment, TMAU may further include capabilities to detect data reads that are out of bounds of a tensor. In at least one embodiment, in contrast to techniques by which each thread on an SM loads a quantum of data from global memory, TMAU can load data for any number or group of threads in coupled SM. In at least one embodiment, in response to a single request for a data block from requesting SM, TMAU is capable of generating multiple requests each for a respective (different) portion of requested block.

In at least one embodiment, a single TMAU can serve multiple SMs where each SM can send independent requests to single TMAU. In at least one embodiment, an arbiter, implemented in hardware, may operate to accept requests from multiple SMs and forward requests serially to single TMAU. In at least one embodiment, single TMAU services requests received from different SMs by transferring data to local shared memories of respective requesting SMs.

### Parallel Processing System Including TMAU Circuitry

FIG. 7 schematically illustrates a parallel processing unit, for example, a GPU, according to at least one embodiment. In at least one embodiment, as shown in FIG. 7, GPU 700 includes a plurality of processors. In at least one embodiment, plurality of processors comprises multicore processors for example, streaming multiprocessors (SM), 702a . . . 702n (collectively 702). In at least one embodiment, each SM 702 includes a plurality of processing cores such as functional units 704a . . . 704m (collectively 704). In at least one embodiment, these functional units 704 can perform a variety of different types of computations, for example floating point 32-bit precision arithmetic, floating point 16-bit precision arithmetic, integer arithmetic of different precisions, etc. In at least one embodiment, some of these functional units 704 can comprise tensor cores designed to carry a number of GEMMs per clock cycle on N×N matrices, containing floating point values for floating point multiplication and addition. In at least one embodiment, number of SMs in GPU and number of functional units in an SM are not limited. In at least one embodiment, each functional unit 704 in an SM has access to register file 706 for that SM, an L1 cache 708, and a shared/local memory 710 for that SM. In at least one embodiment, as in embodiment illustrated in FIG. 7, L1 cache 708 may be a part of shared/local memory 710. In at least one embodiment, in some other embodiments, L1 cache and shared memory 710 may be separate from each other. In at least one embodiment, shared memory 710 may be part of a distributed shared memory (DSMEM) arrangement that threads executing on other SMs can also access. In at least one embodiment, U.S. application Ser. No. ______ (20-AU-0561; Distributed Shared Memory) describes distributed shared memory.

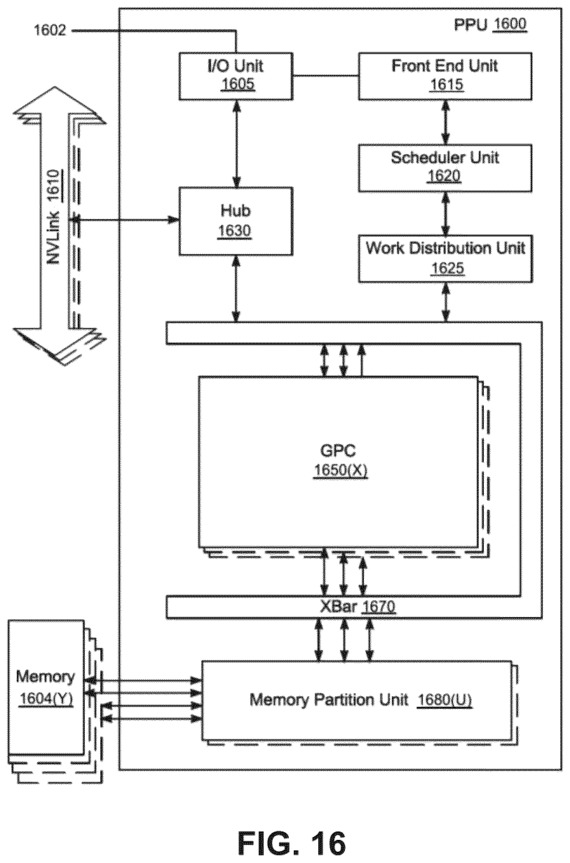

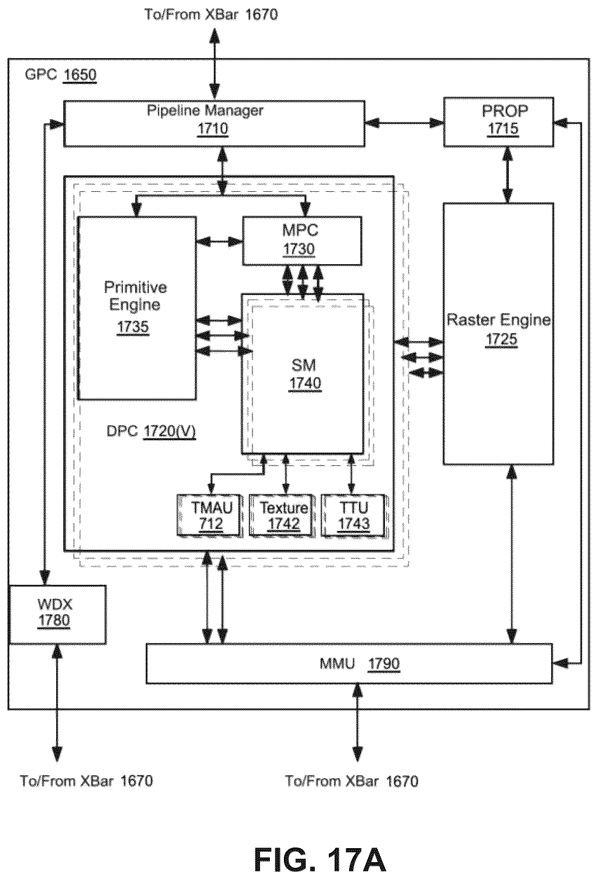

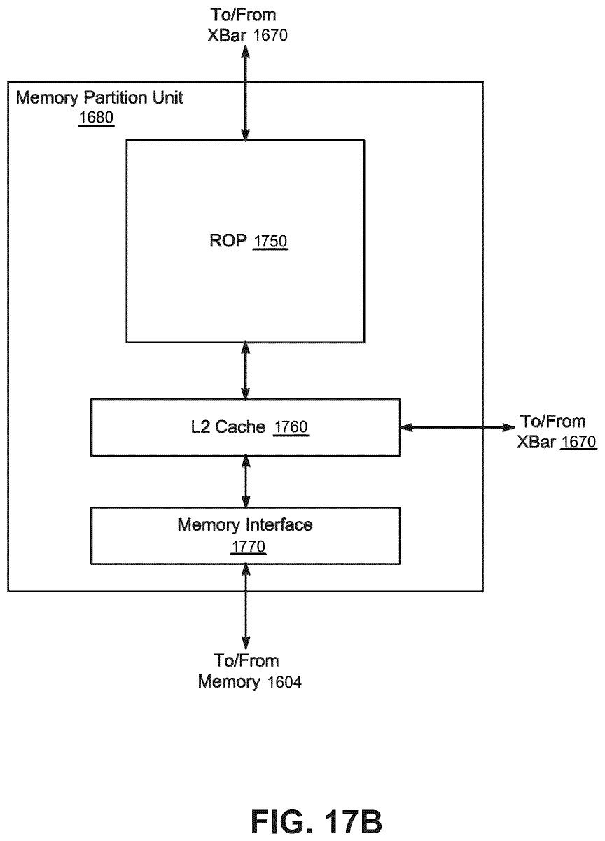

In at least one embodiment, plurality of SMs 702 may access global memory 716 that is external to GPU 700 through a global memory interface 714. In at least one embodiment, global memory 716 may include a hierarchical cache memory (e.g., L2 cache and/or L3 cache) and dynamic random access memory (DRAM). In at least one embodiment, global memory 716 may include a memory management unit (MMU), an X-Bar or hierarchical cross-bar interconnect network, a memory partition unit, and/or memory described with reference to FIGS. 16, 17A, and 17B.

In at least one embodiment, multiple cores, such as functional units 704, in each of SMs 702 are configured to process a plurality of threads in parallel. In at least one embodiment, a thread (e.g., a thread of execution) is an instantiation of a set of instructions or a kernel configured to be executed by functional units 704 on a particular data set. In at least one embodiment, threads of a thread block can be executed concurrently, and multiple thread blocks can be executed concurrently. In at least one embodiment, single-instruction multiple-data (SIMD) instruction issue techniques are used to support parallel execution of a large number of threads without providing multiple independent instruction units. In at least one embodiment, in other embodiments, single-instruction multiple-thread (SIMT) techniques are used to support parallel execution of a large number of generally synchronized threads, using a common instruction unit configured to issue instructions to a set of cores.

In at least one embodiment, each of functional units 704 may connect to a cache memory 708, shared memory 710, and a register file 704 via an interconnect network, for example, a hierarchical cross-bar with one or more read and/or write crossbars. In at least one embodiment, cache memory 708, which may be a L1 cache, and shared memory 710 provide low-latency on-chip memory near functional units 704 of an SM 702. In at least one embodiment, register file 706 may include data registers assignable by software to a different functional unit of plurality of functional units 704 and/or different warps being executed by SM 702. In at least one embodiment, register file 706 provides temporary storage for functional units 704 on SM.

In at least one embodiment, GPU 700 may support multiple address spaces including local, shared and global to support data visibility for threads. In at least one embodiment, additional read only address spaces including constants and textures may be supported. In at least one embodiment, each thread has its own per thread local or private memory which can be controlled by allocation of registers (see e.g., U.S. Pat. Nos. 8,555,035 and 7,634,621 which are hereby incorporated herein by reference as if expressly set forth).

In at least one embodiment, each thread in same thread block or different thread blocks can access global memory 716 using hierarchical cache memories. In at least one embodiment, each thread in same thread block can access an assigned portion of shared memory 710, which can be considered per-block shared memory. In at least one embodiment, each executing block of threads may have an allocated portion of shared memory 710. In at least one embodiment, shared memory 710 is a software managed cache used to load data from global memory so that number of off-chip memory accesses by executing threads are reduced. In at least one embodiment, software explicitly allocates and accesses shared memory 710. In at least one embodiment, threads in a thread block are synchronized (e.g., after cooperatively loading data from global memory into shared memory) to avoid critical resource use conflicts.

In at least one embodiment, when multiple threads in a thread block are expected to use same data from global memory 716, shared memory 710 can be used to store this data so that number of requests to global memory 716 by individual threads for same data is reduced. In at least one embodiment, shared memory 710 can also be used to avoid uncoalesced memory accesses by loading and storing data in a coalesced pattern from global memory 716 and then reordering it in shared memory 710 to improve access to data by threads.

In at least one embodiment, such as that shown in FIG. 7, where shared memory 710 includes L1 cache 708, shared memory may be referred to as a unified memory or unified cache. In at least one embodiment, unified cache may be provided in same on-chip memory (e.g., SRAM) used for both L1 cache and shared memory and include a mechanism to allocate how much of unified memory is dedicated to L1 cache versus shared memory for each kernel call. In at least one embodiment, unified cache may also include a dynamically configurable register file (e.g., register file 706). In at least one embodiment, for more information about unified cache system and how it can be configured, see for example following references that are incorporated herein by reference as if expressly set forth: U.S. Patent Application Publication No. 2018/0322078; and CUDA C Programming Guide, PG-02829-001_v10.1 | May 2019 https://docs.nvidia.com/cuda/cuda-c-programming-guide/index.html #shared-memory.

In at least one embodiment, plurality of SM 702a-702n can access global memory 716 through a plurality of TMAUs 712a-712n (collectively 712). In at least one embodiment, each SM 702 is closely coupled to a respective TMAU 712 which is configured to access global memory 716 via global memory interface 714. In at least one embodiment, close coupling between an SM 702 and a TMAU 712 is one-to-one, and each SM has its own dedicated TMAU 712, but embodiments are not limited thereto. In at least one embodiment, each TMAU 712 has read/write access to shared memory 710 and L1 cache 708 of corresponding closely coupled SM 702 by issuing requests to memory subsystem, and also to global memory 716. In at least one embodiment, a TMAU 712 may, in addition to read/write access to shared memory 710 of its coupled SM, also have read and/or write access to shared memory on other SMs by issuing requests to memory subsystem. In at least one embodiment, a distributed shared memory that can be utilized by TMAU of one SM to access shared memory on another SM is described in U.S. application Ser. No. ______ (20-AU-0561; Distributed Shared Memory) filed on ______, which is herein incorporated by reference in its entirety. In at least one embodiment, TMAU may transfer multidimensional data structures or other data between bulk global memory and linear shared global memory accessible by Cooperative Group Arrays (CGAs) executing on one or plural SMs.

In at least one embodiment, when software running on one or more of functional units 704 needs data that is stored in global memory 716, software initiates a thread with a “load” from memory command. In at least one embodiment, load from memory command may load data from global memory 716 and store data in shared memory 710, making it visible to all threads (e.g., all threads in a thread block). In at least one embodiment, after data is stored in shared memory, threads can access data multiple times.

In at least one embodiment, each TMAU 712 enables circuitry of processing cores in corresponding SM to continue math and other processing of application program kernels while address calculations and memory access operations are outsourced to closely coupled circuitry dedicated to address calculations and memory accesses. In at least one embodiment, as described below, a TMAU 712, coupled to an SM 702 and having its own hardware circuitry to calculate memory addresses and to read and write shared memory and global memory, enables coupled SM 702 to improve overall application program kernel performance by outsourcing to TMAU accesses to any type of data. In at least one embodiment, in case of accesses to large multidimensional data structures or blocks of data, which typically consumes hundreds or even more clock cycles, capability for SM to outsource such data accesses and to asynchronously proceed with processing provides particularly substantial improvement in performance.

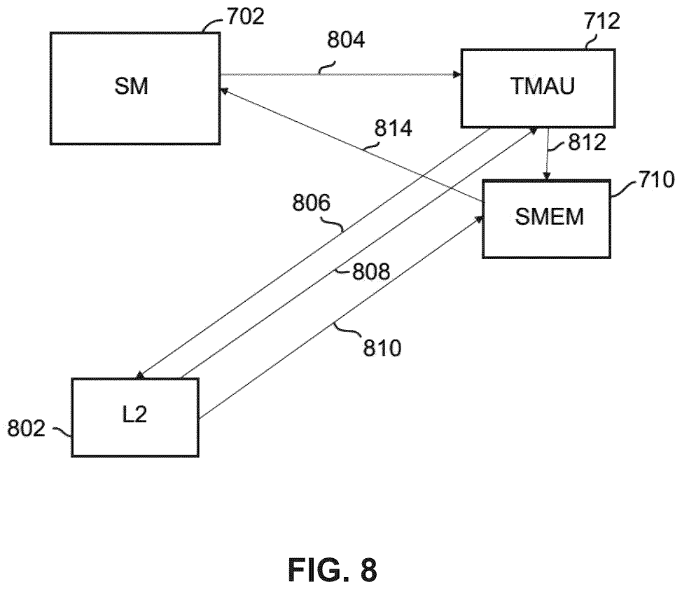

FIG. 8 illustrates example interactions between an SM 102, a TMAU 712 coupled to SM 702, a shared memory 710 and a L2 cache 802 of global memory 716 during a memory access by a thread running on SM 702, according to at least one embodiment.

In at least one embodiment, when a thread running on SM 702 needs access to a block of data, SM determines access parameters for block of data in global memory and, at operation 804, commands TMAU 712, by transmission of a single memory access request, to obtain block of data. In at least one embodiment, type of access parameters required to be provided from SM to TMAU may be different based on, as described in detail below, whether or not requested block of data is a tensor or not a tensor. In at least one embodiment, as described below in more detail, requests for non-tensor block data may, in addition to global memory address and shared memory address for requested data, include size of block to be loaded. In at least one embodiment, requests for tensor data includes a pointer to a tensor descriptor, a location coordinate associated with block being requested, and a shared memory address.

In at least one embodiment, request from SM may request data that is larger in size than that can be requested and/or obtained from global memory by a single load/store request. In at least one embodiment, memory subsystem may handle only requests for sizes up to a maximum of one L2 cache line. In at least one embodiment, thus, in response to single memory access request received from SM requesting a large amount of data (a data structure or block larger than maximum size allowed for a single request to memory subsystem) of data, TMAU 712 forms and issues multiple memory access requests to obtain entirety of requested data. In at least one embodiment, TMAU 712 operates asynchronously to requesting SM 702 and proceeds to, at operation 806, generate multiple memory access requests, each with a respectively different address for a respective subblock in requested data. In at least one embodiment, multiple memory access requests are transmitted from TMAU 712 to L2 cache 802.

In at least one embodiment, operation 808 represents responses from L2 cache 802 (or global memory) to each of multiple memory access requests sent by operation 806. In at least one embodiment, subblocks may be written to shared memory 710 in operation 810 and/or by TMAU 712 in operation 812. In at least one embodiment, operations 812 and 814 may provide for synchronizing requesting SM 702 and status of completion of data request. In at least one embodiment, for example, upon each subblock being written to shared memory, a counter may be incremented by TMAU. In at least one embodiment, each subblock request generated from TMAU includes counter address in shared memory, and updating (incrementing) of counter may be performed by shared memory. In at least one embodiment, SM may monitor counter to determine when entire requested block of data has been written to shared memory. In at least one embodiment, request transmitted from SM includes address counter address and SM includes hardware dedicated t monitoring counter for synchronization.

In at least one embodiment, between issuing of memory access request for data at operation 806 and subsequent synchronization with data written to shared memory at operation 814 many clock cycles may pass. In at least one embodiment, in particular, for requests for large amounts of data, this interval may be several thousands of clock cycles. In at least one embodiment, since SM 702 can request entire block of data in a single request 804 to TMAU 712 and thereafter continue with processing instructions while TMAU 712 asynchronously, and independently of SM 712, obtains data by issuing one or more requests to global memory (e.g., via L2 cache 802), SM's processing efficiency may be enhanced. In at least one embodiment, by delegating to hardware in TMAU numerous address calculations necessary for obtaining a large amount of data of a data structure or block and associated coordination of loads and stores of respective subblocks of large amount of data, SM's power consumption may also be reduced.

In at least one embodiment, one or more techniques enable one thread in group of threads on SM to request entire data for all threads in group from TMAU. In at least one embodiment, one or more techniques enable threads to proceed processing tasks asynchronously with TMAU until requested transfer is completed by TMAU. In at least one embodiment, this provides advantages over legacy techniques that do not enable this capability.

### Accessing Tensors

In at least one embodiment, although TMAU 712 can be used to access any type of a data block arrangement, TMAU includes capabilities that are specific to tensors. In at least one embodiment, in applications such as deep learning (DL), large amounts of data may be stored in tensors. In at least one embodiment, tensors can be of any dimension ranging from a one dimensional tensor such as a one dimensional array to an n-dimensional tensor such as a n-dimensional array, where n is a positive number. In at least one embodiment, only tensors of dimensions 1-5 are supported. In at least one embodiment, dimensions of tensors are not limited to dimensions 1-5. In at least one embodiment, size and dimensionality of tensor is limited only by memory and TMAU 712 does not impose a limit on size and/or dimensionality of tensor that can be requested as a block by SM.

In at least one embodiment, TMAU circuitry enables kernel developers to access subblocks within a tensor by using coordinates (e.g., (x, y) in a two-dimensional tensor) which are computationally simpler than memory addresses. In at least one embodiment, TMAU will convert coordinate to one or more corresponding memory addresses before issuing request to external memory.

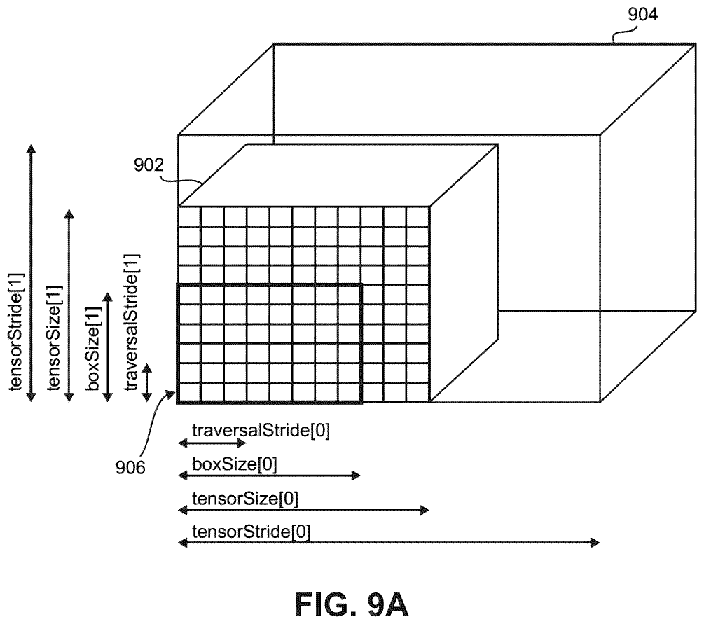

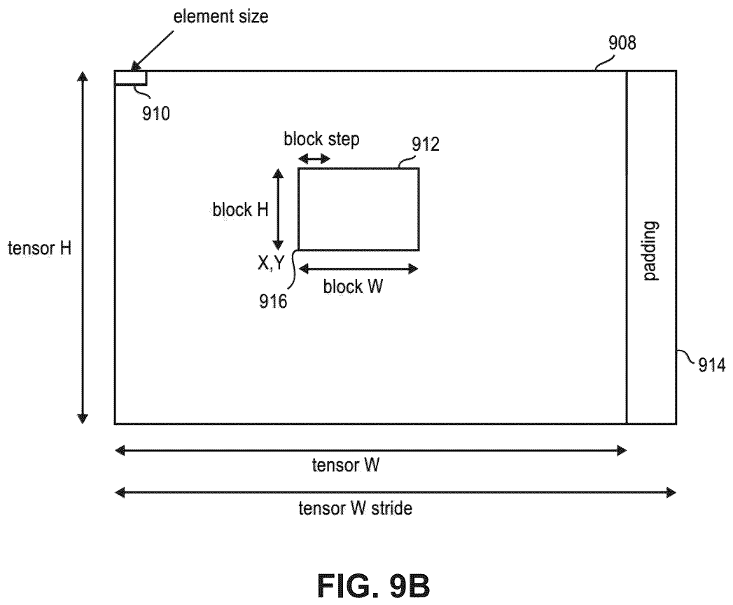

FIGS. 9A-9B (collectively FIG. 9) illustrate parameters that can be used by SM for accessing tensor data, according to at least one embodiment. In at least one embodiment, FIG. 9A illustrates a three-dimensional tensor 902 stored in global memory. In at least one embodiment, tensor 902 may be written to global memory by a process executing on a CPU, GPU or other processor in a computer system. In at least one embodiment, threads executing on one or more SMs of a GPU are able to read from and/or write to tensor 902 in global memory.

In at least one embodiment, tensor 902 is accessed by SM in blocks of a size smaller than entire tensor, such as, for example, box 906. In at least one embodiment, tensor parameters shown in FIG. 9A include number of dimensions of tensor, size of each dimension, stride for each dimension, and element size in tensor. In at least one embodiment, block to be accessed within tensor is characterized by size of each dimension of block. In at least one embodiment, number of dimensions of block is same as number of dimensions of tensor. In at least one embodiment, tensor may have padding along some dimensions as illustrated with area above and to right of tensor 902 within padded tensor 904. In at least one embodiment, padding could be indicated through tensor strides in tensor definition, where stride of tensor in a particular dimension is defined as size of tensor in particular dimension plus size of padding in that dimension. In at least one embodiment, same tensor could be accessed with blocks of different sizes. In at least one embodiment, for each tensor, all required parameters are defined in a “tensor descriptor” that combines both tensor and access block properties. In at least one embodiment, before memory access requests to TMAU are issued, required parameters have to be defined in descriptor.

In at least one embodiment, tensor descriptor is a data structure that is defined in global memory and which can be uniquely identified by its address in global memory. In at least one embodiment, it may be defined either on host side prior to kernel execution, or on GPU while kernel is running. In at least one embodiment, typical tensor access pattern assumes that multiple blocks are loaded from same tensor. In at least one embodiment, loading tensor descriptor from global memory for each new TMAU request for a block would be inefficient because global memory latency would negatively impact performance. In at least one embodiment, TMAU has a dedicated descriptor cache (see FIG. 12) in order to take advantage of temporal tensor access coherency in many kernels that are run on SMs. In at least one embodiment, using descriptor cache improves efficiency in comparison to loading tensor descriptor for each new TMAU request for a block.

FIG. 9B illustrates a two-dimensional padded tensor 908. In at least one embodiment, FIG. 9B illustrates an “element” 910 in tensor, a block 912 within tensor, and padding 914 in relation to illustrated dimension. In at least one embodiment, tensor height H and width W are defined, and also element size 910. In at least one embodiment, tensor 908 is padded with padding 914 in x-direction. In at least one embodiment, thus, tensor stride in x-direction includes width of padding. In at least one embodiment, block 912 is data that is required by a kernel, and also has its own height (block height) and width (block width). In at least one embodiment, SM may access block 912 by merely providing origin point 916 for block by its coordinates in tensor's coordinate system—coordinate pair x, y.

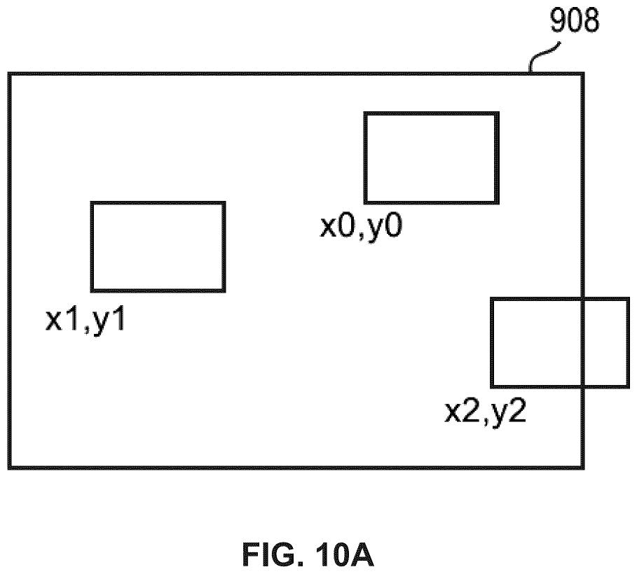

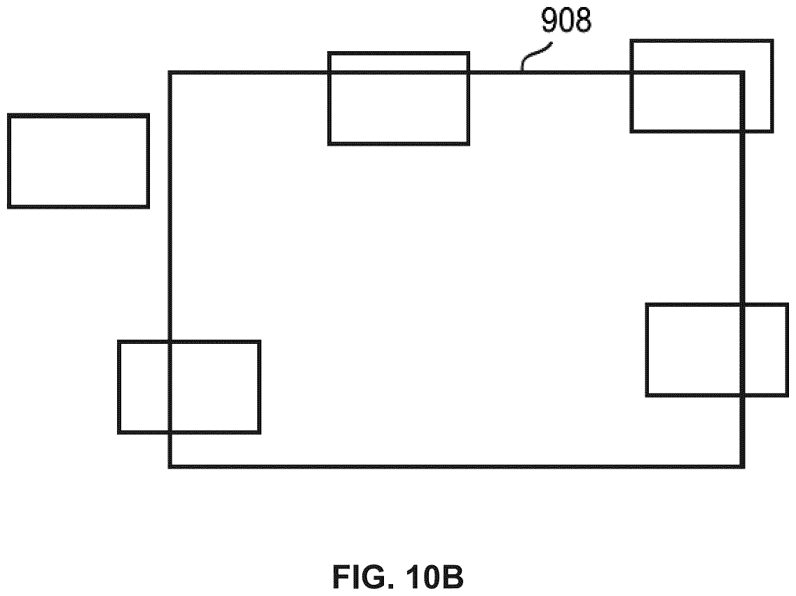

FIGS. 10A-10B (collectively FIG. 10) illustrate some aspects of processing that are handled by TMAU when accessing a tensor in external memory, according to at least one embodiment. In at least one embodiment, FIG. 10A illustrates that a block to be read from tensor 908, a two-dimensional tensor in this example, can be located at many different locations in which anchor for block is within tensor. In at least one embodiment, as shown, some of anchor locations may result in box encompassing a memory area that is out of bounds for tensor 908.

In at least one embodiment, FIG. 10B illustrates that out of bounds condition can occur in many areas of tensor 908. In at least one embodiment, for example, figure illustrates respective box positions in which left side of box, right side block, top and right side of block, top side of block, or entirety of block can be out of bounds of tensor in external memory.

In at least one embodiment, TMAU must properly handle out-of-bound conditions where requested block may cross tensor boundaries in global memory. In at least one embodiment, FIG. 10B illustrates some examples where requested blocks reach outside of 2D tensor. In at least one embodiment, if any requested element is located outside of tensor, then its value may be forced either to zero or some other predefined special constant (e.g., a not-a-number (NAN) value).

In at least one embodiment, manner in which out-of-bound access is handled depends on specific application. In at least one embodiment, in simplest case, zero is assigned to elements located outside of tensor. In at least one embodiment, an example is a convolution filter applied to pixels near an image boundary where some of filter locations may be outside of image.

In at least one embodiment, in more complicated applications, out-of-bound elements may need to be filled with dedicated non-zero constant. In at least one embodiment, one example is fusing of normalization layer with following convolution layer in a deep learning neural network. In at least one embodiment, normalization layer applies bias and scale to each element before it is processed by convolution. In at least one embodiment, out-of-bound elements must be set to zero for convolution filtering to work properly; however, as a result of normalization they are assigned bias value. In at least one embodiment, in order to handle this case, TMAU can be programmed to assign and recognize a special not-a-number (NaN) constant to indicate out-of-bound accesses. In at least one embodiment, special NaN constant may be written by TMAU to shared memory locations when tensor data from global memory is written to shared memory. In at least one embodiment, a kernel may be required to check each element from global memory for being equal to this special constant. In at least one embodiment, if special constant is detected, then zero is assigned to element, or otherwise scale and bias is applied. In at least one embodiment, this kind of processing may be relevant to floating-point formats only during training phase of DL. In at least one embodiment, special NaN encoding is format specific and is based tensor descriptor format setting. See, e.g., U.S. patent application Ser. No. 17/497,507 filed on Oct. 8, 2021 and titled “Neural Network Data Replacement”, entire contents of which is herein incorporated by reference.

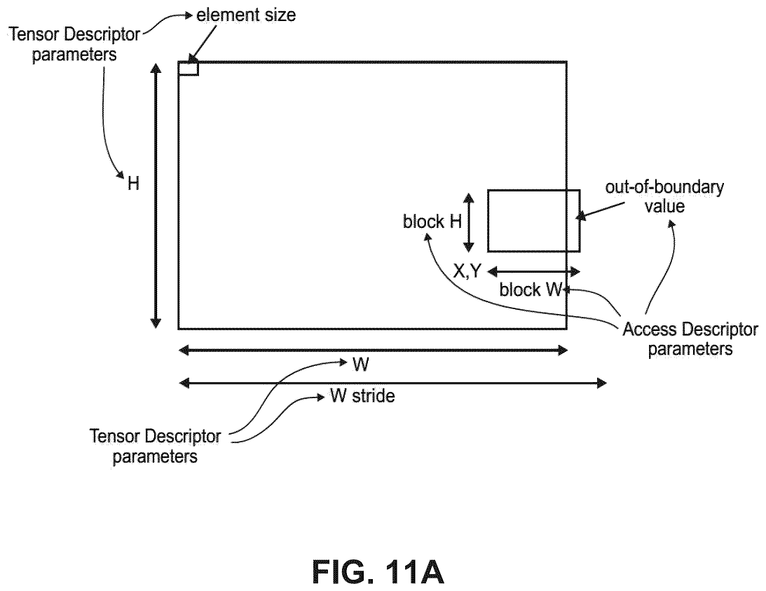

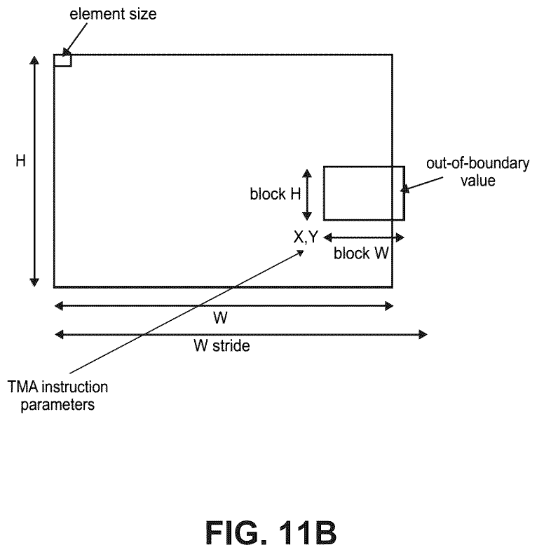

FIGS. 11A-11B (collectively FIG. 11) illustrate, in context of a two-dimensional tensor and a corresponding block, groupings of parameters used by TMAU to efficiently access tensor in memory, according to at least one embodiment. In at least one embodiment, parameters necessary for TMAU to uniquely identify a block within a tensor are divided to three groups: a group of “tensor descriptor” parameters that describes tensor as a whole, a group of “access descriptor” parameters that describes a block within tensor in general, and a TMAU “instruction parameter” that identifies a particular block. In at least one embodiment, tensor descriptor parameters and access descriptor parameters are shown in FIG. 11A, and TMAU instruction parameters are shown in FIG. 11B.

In at least one embodiment, as illustrated in FIG. 11A, tensor descriptor parameters include tensor height, tensor width, tensor stride, and element size. In at least one embodiment, tensor stride represents tensor size (height or width) plus padding in a particular dimension. In at least one embodiment, access descriptor parameters include block height, block width, and out-of-boundary value. In at least one embodiment, tensor height, tensor width, tensor stride, block height and block width are specified per dimension of tensor. In at least one embodiment, as shown in FIG. 11B, TMAU instruction parameters include just starting coordinate of block (e.g., (x, y)). In at least one embodiment, starting coordinate for an n-dimensional vector accordingly will be an n-dimensional tuple.

### TMAU Processing Path

FIG. 12 schematically illustrates an example data processing path of a TMAU, according to at least one embodiment. In at least one embodiment, in FIG. 12, TMAU 1212 is illustrated as being included within SM 1202. In at least one embodiment, however, it will be understood that TMAU 1212 may, while not physically located within SM 1202, be closely coupled to SM 1202.

In at least one embodiment, a memory input/output controller (MIOC) 1204 provides an interface between SM 1202 and request processing pipeline of TMAU 1212. In at least one embodiment, TMAU 1212 receives memory access requests issued by SM via MIOC 1204. In at least one embodiment, received memory access requests are input to internal request queue 1206. In at least one embodiment, requests in queue 1206 are processed in first in first out (FIFO) order. In at least one embodiment, however, requests in queue may be selected for further processing based on one or more characteristics of request, such as, request type, size of read or write request, requested type of data, memory to be accessed, and/or other suitable characteristics.

In at least one embodiment, two classes of requests may be received in request queue 1206: tensor (with tensor descriptor), and non-tensor (linear memory, without tensor descriptor). In at least one embodiment, requests may be of different request types such as, for example, loads, stores, reduction, prefetch, and/or other suitable request types. In at least one embodiment, for each request for tensor data, TMAU expects a pointer to descriptor that provides necessary information about tensor to access. In at least one embodiment, request queue 1206 is a single queue receiving both types of requests. In at least one embodiment, respective queues may service each type of request. In at least one embodiment, TMAU may only process requests for tensor data, and in some other embodiments may only process requests for only non-tensor block data.

In at least one embodiment, for performance reasons, in which TMAU is configured to receive memory access requests for tensor data, TMAU maintains a descriptor cache 1208 to hold recently used tensor descriptors. In at least one embodiment, because general access patterns often involve same tensor descriptor being accessed by many requests received in time proximity, descriptor cache may provide for reduced latency. In at least one embodiment, cache may be tagged by global addresses of tensor descriptors. In at least one embodiment, each received memory access request may specify global address of relevant tensor descriptor. In at least one embodiment, cache is connected to general cache controller (GCC) 1222 through an interface. In at least one embodiment, while processing a current request in internal request queue 1206, TMAU may check whether descriptor for next request is resident in cache 1208. In at least one embodiment, if not (i.e. if it is a miss), then a descriptor load request is issued to GCC in order to prefetch descriptor from global memory to cache 1208. In at least one embodiment, this parallel processing helps to hide latency of descriptor prefetch.

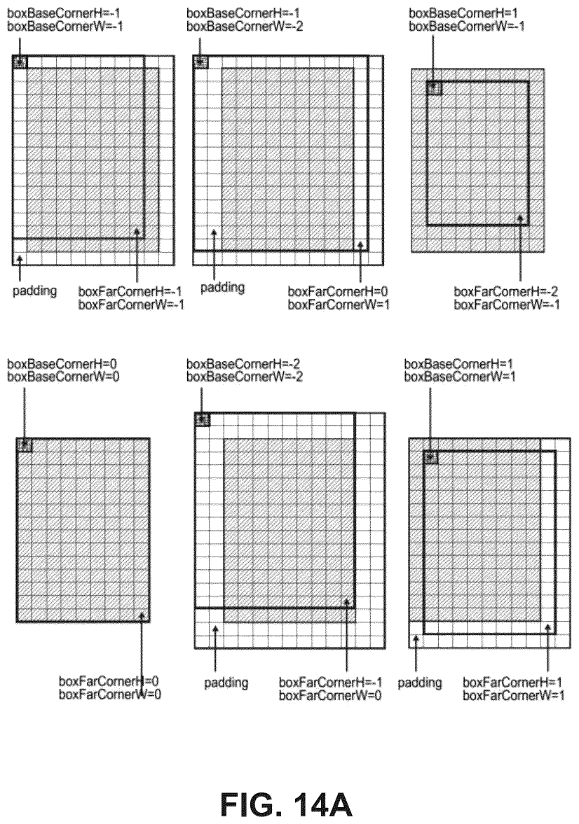

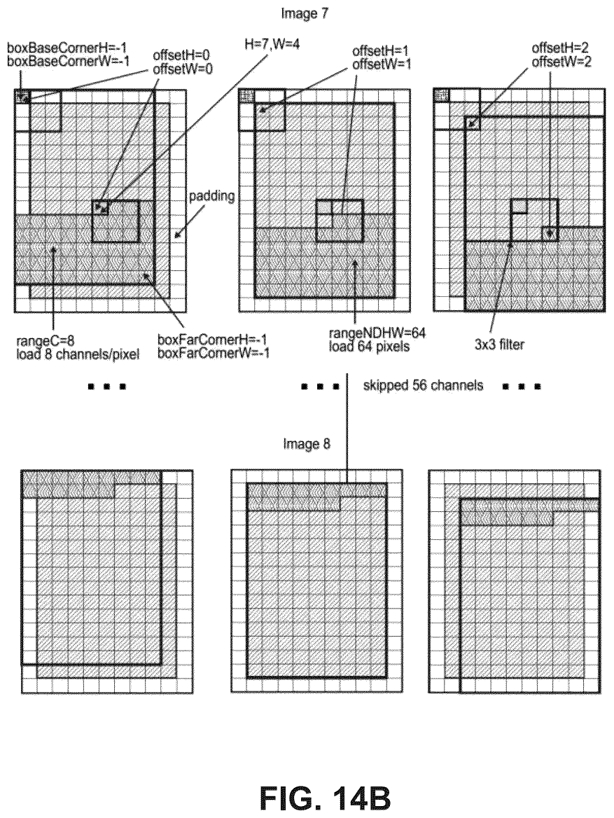

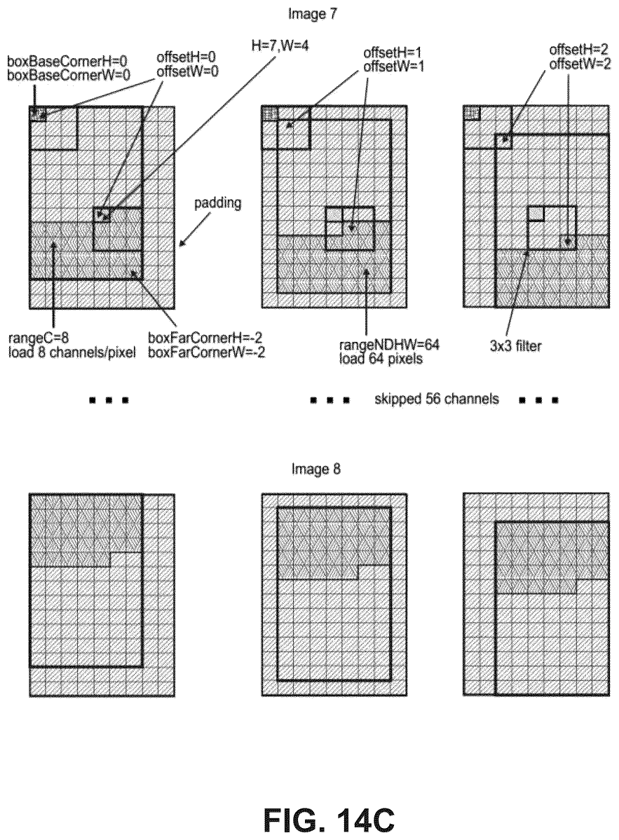

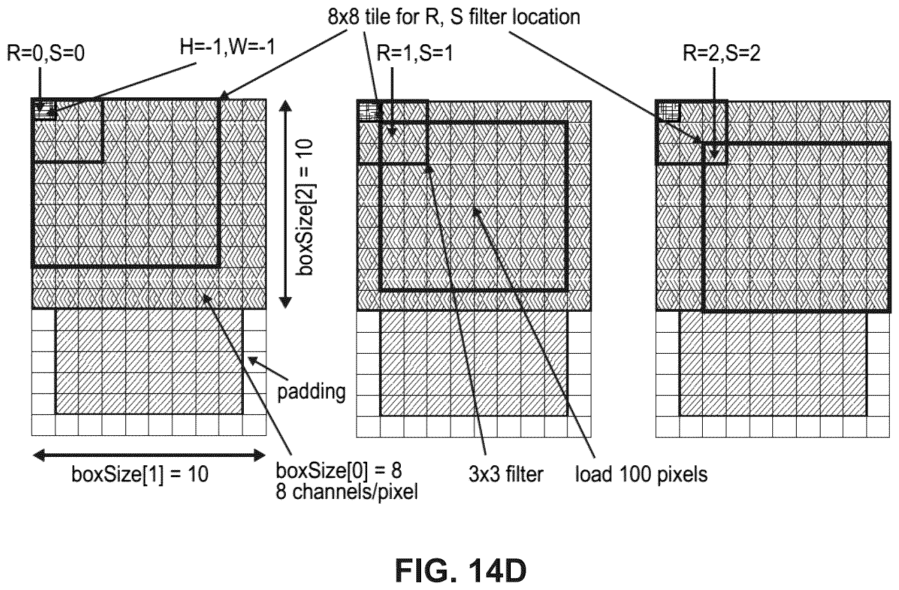

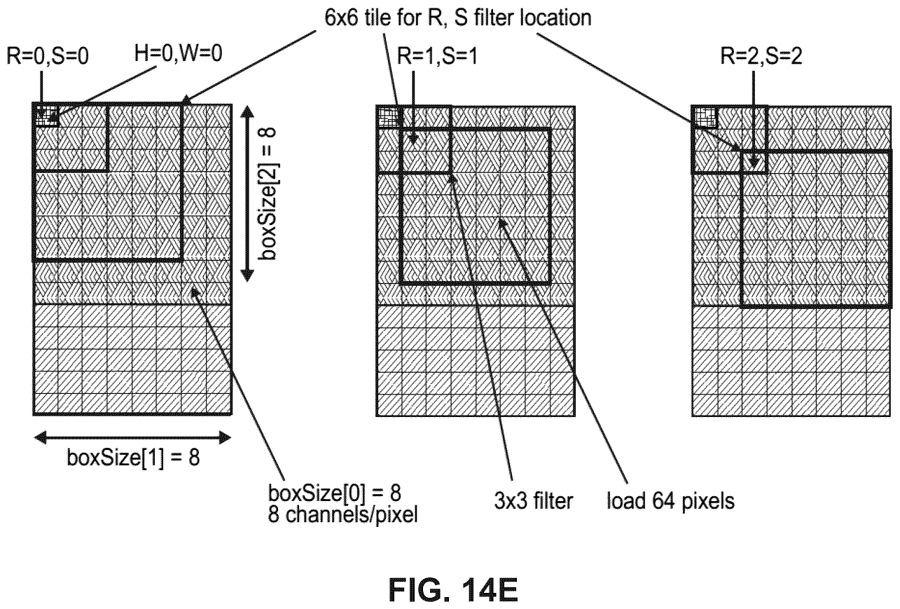

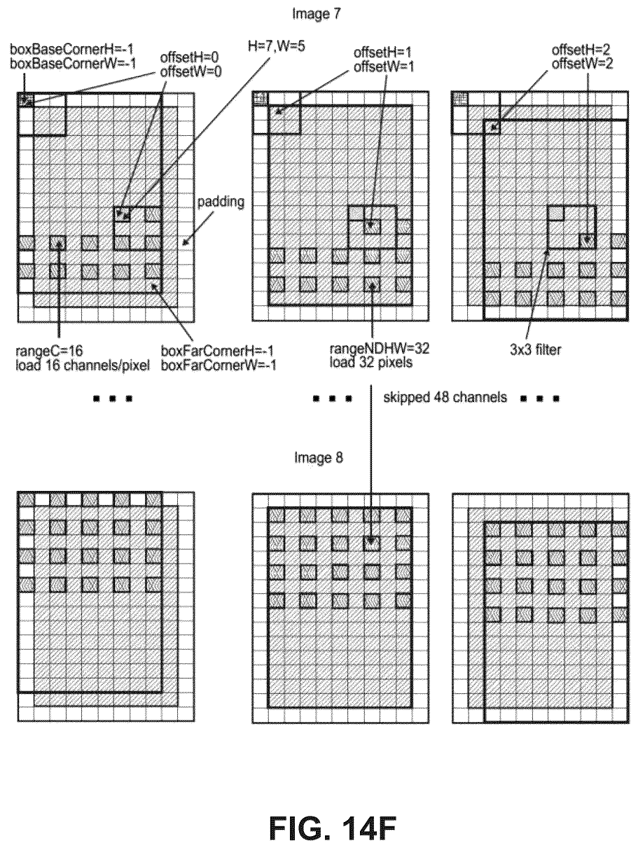

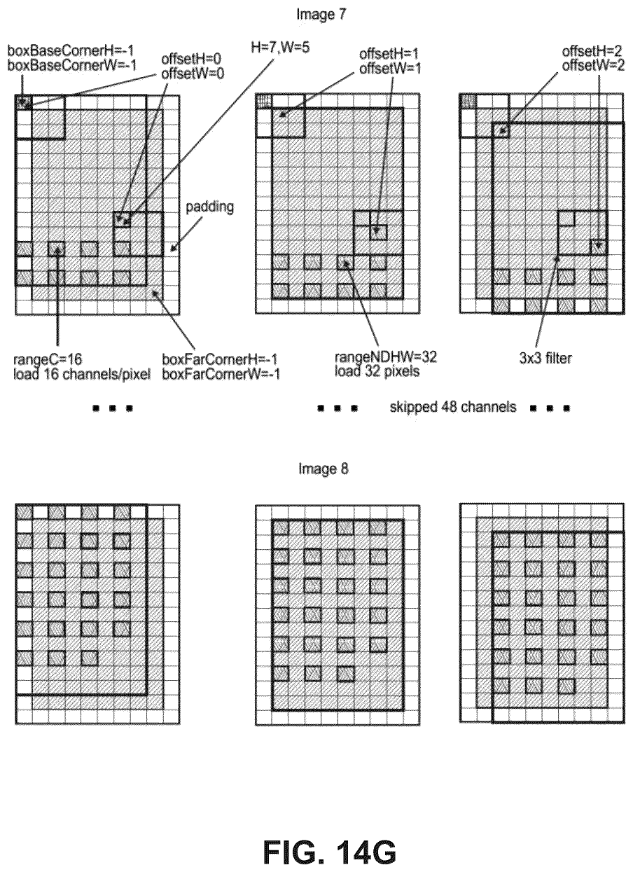

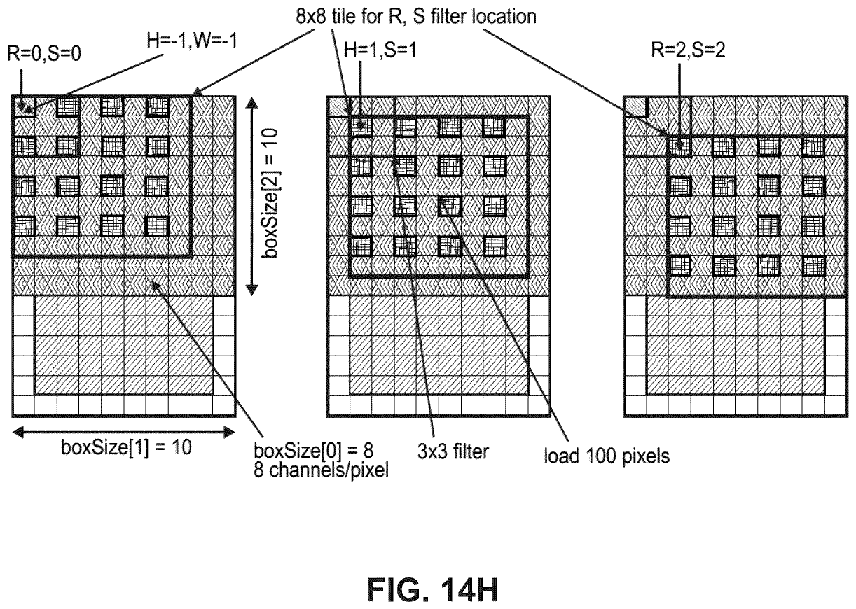

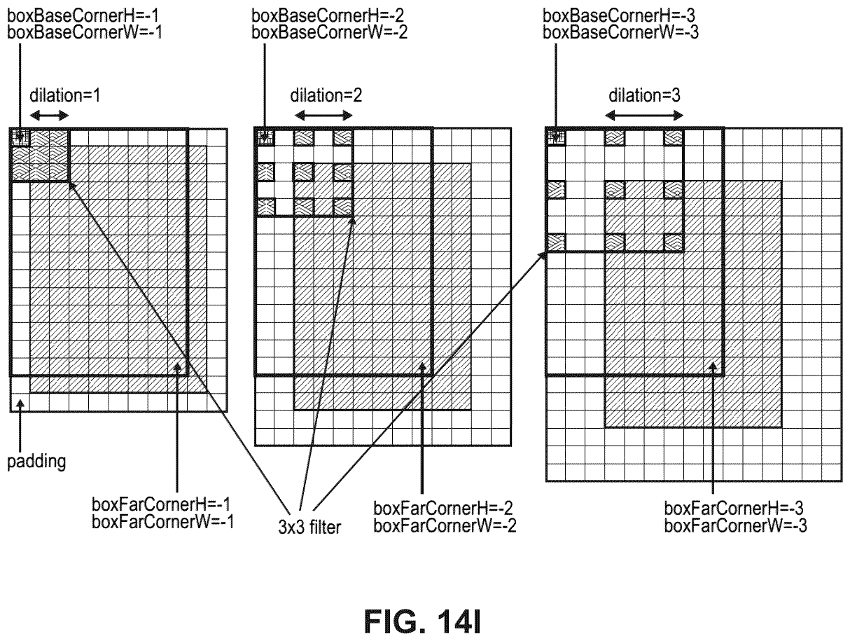

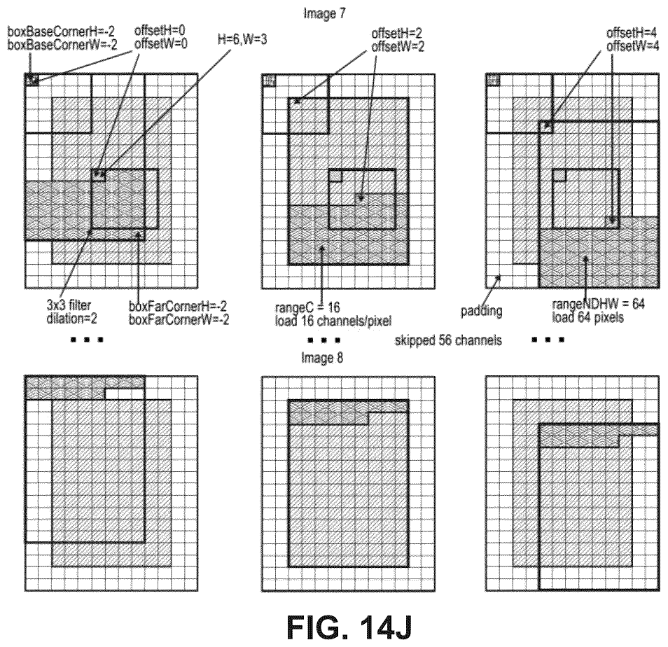

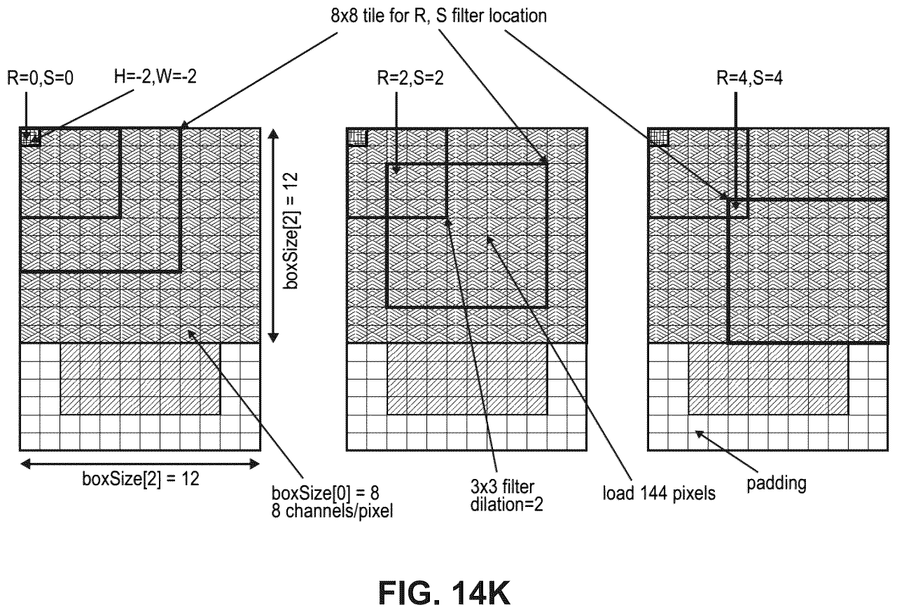

In at least one embodiment, when a request is selected from queue 1206 for processing in TMAU 1202, selected request is sent to setup block 1210 if request is for a tensor. In at least one embodiment, when a memory access request is received in setup block 1210, setup block 1210 obtains corresponding descriptor from descriptor cache 1208. In at least one embodiment, setup block 1210 collects and/or calculates necessary parameters that are used for request processing. In at least one embodiment, although many of parameters necessary for memory access are available in (are included in) descriptor, some other parameters are received with memory access request. In at least one embodiment, for example, setup unit circuitry may be configured to perform logic similar to that shown in table below with reference to FIG. 14 in order to populate parameters needed for address calculation etc. based on tensor descriptor. In at least one embodiment, it also checks correctness of request input parameters. In at least one embodiment, as noted above, by providing for parameters that are used by multiple memory access requests to be obtained from corresponding tensor descriptor and by providing for memory access request from SM to only carry parameters that are unique to particular request, bandwidth utilization for memory access requests from SM to TMAU is optimized. In at least one embodiment, parameters that are unique to memory access request such as coordinates or addresses for a block can be carried as immediate parameters with request. In at least one embodiment, setup block is configured to perform calculations and error checks on parameters. In at least one embodiment, an error is generated, and request is discarded if parameters do not satisfy predefined TMAU requirements. In at least one embodiment, setup block operates in parallel with request generator 1316, providing a pipeline for setting up generating requests thereby reducing latency.

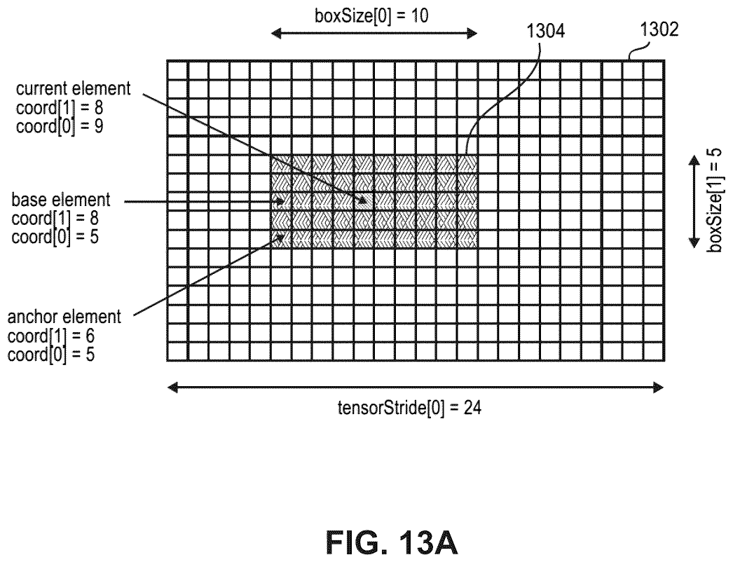

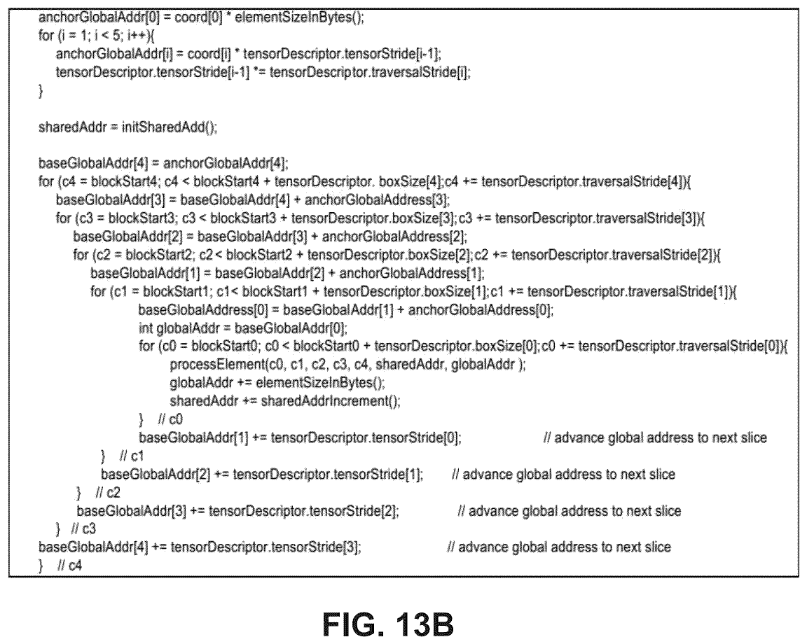

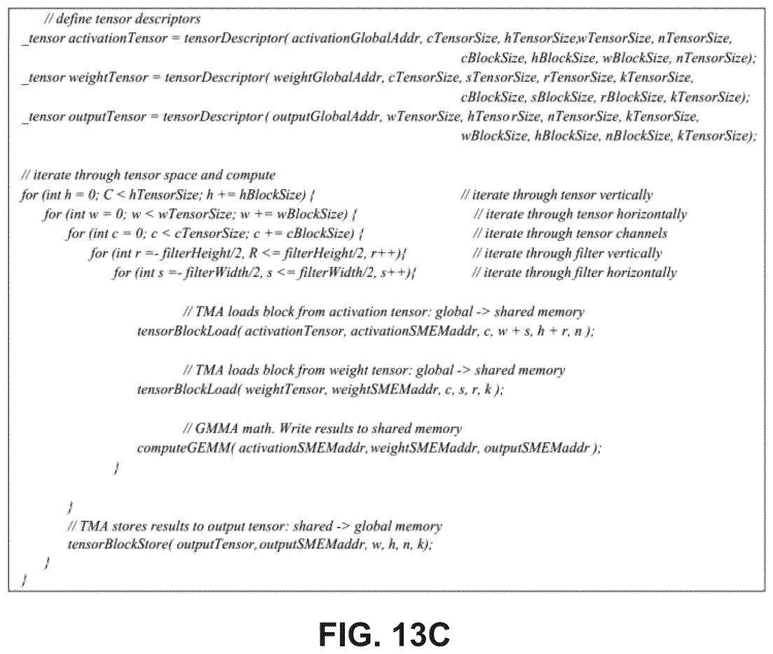

In at least one embodiment, request generator 1216 is main TMAU engine. In at least one embodiment, for a request for tensor data, it receives relevant parameters from setup block and traverses tensor space by iterating multidimensional coordinates, mapping coordinates to addresses, checking out-of-bound conditions, computing shared memory addresses, computing global memory addresses, and generating requests to memory subsystem. In at least one embodiment, request generator generates as many requests to memory system to load/store block of tensor data as necessary while adhering to maximum size of memory requests handled by memory subsystem. In at least one embodiment, one or more memory subsystems impose a maximum size of one cache line (e.g., size of one L2 cache line) for each request received at memory subsystem. In at least one embodiment, request generator optimizes requests to improve efficiency of memory subsystem. In at least one embodiment, processing by request generator 1216 provides automatic generation of access requests for an entire block by specialized hardware, thereby reducing power use. In at least one embodiment, high level example pseudocode illustrative of processing within request generator is shown in FIG. 13B.

In at least one embodiment, request for data is transmitted via general network interface controller (GNIC) interface 1214 to memory subsystem, and each request is kept track of in response completion circuit 1218. In at least one embodiment, tracking enables asynchronous processing with SM. In at least one embodiment, responses to requests are received at a GNIC response processor 1220, which communicates with request tracking circuitry 1218 to keep track of completion status of each request transmitted from request generator 1316.

In at least one embodiment, if memory access request received from SM is for block data that is not a tensor, request may be sent to request generator 1216 bypassing descriptor cache 1208. In at least one embodiment, in FIG. 12, for example, requests for non-tensor block data can be routed from queue 1204 to request generator bypassing descriptor cache 1208 and setup unit 1210. In at least one embodiment, however, such requests can be directed from queue 1206 to setup unit 1210 before being processed in request generator 1216. In at least one embodiment, request received from SM for a large non-tensor block of data may include a global memory address for block, shared memory address for block, and size of block in bytes. In at least one embodiment, request generator 1216 may, for a request received from SM for a large non-tensor block of data, automatically generate a sequence of requests to memory subsystem with each request being for a smaller sub-block of requested block. In at least one embodiment, request generator calculates global memory addresses for sub-blocks based on global memory address for block as included in request received from SM, and size of sub-block may be determined in accordance with maximum size of requests handled by memory subsystem. In at least one embodiment, request completion tracking circuitry 1218 tracks memory requests for sub-blocks and responses received from memory subsystem in same manner as described above with respect to tensor data blocks.

FIG. 13A and FIG. 13B illustrate example parameters using which a block 1304, shown in FIG. 13A, is kept track of when a tensor data structure 1302 is read by circuitry of TMAU, according to at least one embodiment. FIG. 13A illustrates examples of parameters including anchor, base, and current element that are used in example high level pseudocode shown in FIG. 13B of a portion of processing logic implemented in hardware of TMAU, according to at least one embodiment. FIG. 13C illustrates example high level pseudocode in which SM invokes tensor load operations in TMAU to copy data from global memory to shared memory, and subsequently write result data to global memory, according to at least one embodiment.

In at least one embodiment, pseudocode in FIG. 13B is a high level example of some of processing steps performed by TMAU in response to receiving a request from its coupled SM to obtain a block from a tensor in global memory. In at least one embodiment, pseudocode is arranged in five nested loops, with each loop corresponding to a respective one of five coordinate axes of tensor data space. In at least one embodiment, although example is for a tensor data space of five dimensions, some embodiments can support N nested loops for N-dimensional tensor data space where N may be any positive integer.

In at least one embodiment, current element is processed within innermost loop by specifying calculated coordinates in each of five dimensions (coordinates c0, c1, c2, c3 and c4), address in shared memory to which current element is to be loaded, and current element's global address. In at least one embodiment, after current element is obtained, global memory address and shared memory address for next element is calculated by incrementing global address by element size for tensor, and incrementing shared memory address by a predefined shared memory address increment (shared memory address increment may be defined in tensor descriptor and may be based on element size defined for tensor). In at least one embodiment, processing within innermost loop includes processing such as checking of out-of-bounds conditions etc. that are performed by TMAU for copying tensor data.

In at least one embodiment, innermost loop provides for iterating over elements along dimension 0 (of dimensions 0-4) by starting from requested block's coordinate in dimension 0 (blockstart0) and incrementing current coordinate c0 in dimension 0 by traversal stride for dimension 0 (“tensorDescriptor.traversalStride[0]”) to a dimension 0 coordinate that exceeds box size in dimension 0 (“blockStart0+tensorDescriptor.boxSize[0]”; block boundary is exceeded).

In at least one embodiment, when innermost loop (loop to iterate through tensor elements in dimension 0) is exited, base global address for next outer dimension (e.g., dimension 1) is incremented by tensor stride defined for dimension 0 (“baseGlobalAddr[1]+=tensorDescriptor.tensorStride[0]”). In at least one embodiment, this effectively advances global address to next slice. In at least one embodiment, base global address for each dimension is initially determined based on global address corresponding to anchor element of requested block.

In at least one embodiment, as illustrated in FIG. 13B, in a manner similar to that described above for dimension 0, each loop provides for iterating in a respective dimension for a number of times determined by a starting block coordinate, traversal stride along that dimension, and box size for that dimension. In at least one embodiment, traversal stride and box size for each dimension is defined in tensor descriptor for tensor.

In at least one embodiment, by performing processing involved in copying data blocks from a tensor in global memory in hardware, TMAU may significantly reduce computational load on SM for data movement thereby increasing processing efficiency of SM and also reducing power consumption of SM.

In at least one embodiment, above pseudo-code in FIG. 13B provides high level execution logic and omits details related to certain aspects such as, for example, efficient L2 requests generation, swizzling, and handling out-of-bound conditions that are carried out by TMAU in reading and/or writing tensors.

In at least one embodiment, in addition to L2 requests generation (requests to global memory), TMAU keeps track of return data in order to report TMAU transaction completion. In at least one embodiment, TMAU has to have dedicated counter that keeps track of issued L2 requests. In at least one embodiment, every time request is sent to L2 cache, counter is incremented. In at least one embodiment, when data come back from L2 cache, counter is decremented. In at least one embodiment, once counter reaches zero value, whole block is loaded to shared memory and TMAU can report transaction completion. In at least one embodiment, for efficiency purposes, TMAU may use single counter to track a group of multiple back-to-back transactions and report completion for last transaction in group. In at least one embodiment, counter(s) may be maintained in a predefined location in shared memory. In at least one embodiment, SM may include a synchronization circuit that monitors counter(s), and may implement a synchronization barrier or like based on counter.

FIG. 13C shows example pseudocode for a convolution filter with implicit GEMM performed by a kernel running on an SM, according to at least one embodiment. In at least one embodiment, GEMM, as also noted above, is generally defined as operation C=αAB+βC, with A and B as matrix inputs, a and R as scalar inputs, and C as a pre-existing matrix which is overwritten by output. In at least one embodiment, a plain matrix product AB is a GEMM with a equal to one and p equal to zero. In at least one embodiment, these type of calculations are required for many DL applications and/or other suitable applications. In at least one embodiment, an example Efficient matrix multiply and add implementation that may utilize TMAU is described in U.S. application Ser. No. ______ (21-DU-0028 “Efficient multiply and add”) filed on ______, which is hereby incorporated by reference in its entirety.

In at least one embodiment, kernel obtains pointers to tensor descriptors for three tensors: an activation tensor, a weight tensor and an output tensor, and size information for each of those tensors. In at least one embodiment, activation tensor, weight tensor, and output tensor may be represented as matrices A, B and C, respectively, in GEMM calculation. In at least one embodiment, kernel provides TMAU with pointers to tensor descriptors for activation tensor, weight tensor, and output tensor when it issues subsequent memory access request (tensorBlockLoad( )) to TMAU.

In at least one embodiment, logic is organized as a series of nested loops, so that a sequence of blocks of each tensor is copied by copying a respective block in each iteration of innermost loop. In at least one embodiment, in each iteration of innermost loop, kernel issues a respective tensorBlockLoad request to coupled TMAU to load a block from each of activation tensor and weight tensor. In at least one embodiment, tensorBlockLoad request takes as arguments address of tensor in global memory (as determined SM) and address in shared memory to which tensor data from global memory is to be written. In at least one embodiment, nested loops are arranged so that outer three loops iterate through vertically, horizontally and channel-wise, and innermost loops iterate through convolution filter.

In at least one embodiment, NHWC (N (dimension), Height, Width, Channel) layout is assumed for activation tensor and KNWC layout for weight tensor. In at least one embodiment, code iterates through W and H dimensions. In at least one embodiment, it accumulates for channels (C dimension) and each r and s location of convolution filter. In at least one embodiment, for simplicity, iterations through N and K dimensions are not shown. In at least one embodiment, for given [c, s, r] TMAU loads blocks of data from global memory to shared memory. In at least one embodiment, loads are done both for activation and weight tensors. In at least one embodiment, after data for two matrices is loaded to shared memory—SM may call GEMM calculation (computeGEMM( )). In at least one embodiment, GEMM calculation is performed by a specialized hardware circuit and result is accumulated into output matrix. In at least one embodiment, matrix multiplication is calculated in shared memory.

In at least one embodiment, after operations are completed using tensor data loaded in shared memory, TMAU is used by kernel on SM, by issuing a request (tensorBlockStore( )) and providing addresses for output matrix in which results from GEMM are stored and address in shared memory to which result is to be written, to save results from shared memory buffer to tensor in global memory.

### Support for Tensor Loading Modes

In at least one embodiment, TMAU supports multiple memory layouts for tensors. In at least one embodiment, for example, three-dimensional image tensors may have tensor layout format NDHWC in which innermost dimension C represents number of channels (e.g. in an image tensor, each channel may represent a color), D, H, W dimensions correspond to depth, height and width dimensions respectively and N represents batch size of tensor.

In at least one embodiment, in addition to supporting multiple tensor layout formats, TMAU also supports tensors that are stored in global memory in non-interleaved mode or in interleaved mode. In at least one embodiment, in interleaved mode, TMAU may support multiple slice sizes (e.g. 16 byte slices, 32 bytes sizes, etc.). In at least one embodiment, tensor descriptor for a tensor may specify whether that tensor is in non-interleaved mode or interleaved mode in global memory, and also size of slice in interleaved mode.

In at least one embodiment, TMAU supports more than one tensor loading mode. In at least one embodiment, for example, a tiled mode and an image-to-column (also referred to as “im2col”) mode are supported as tensor data loading modes.

In at least one embodiment, tiled mode is preferred in some instances for reasons such as data replication not being required in implicit general matrix multiply (GEMMs) implementation and therefore providing substantial memory bandwidth savings. In at least one embodiment, on other hand, in some cases, performance may be lost because of tile-quantization effects. In at least one embodiment, tiled mode is a general TMAU load mode that could be used in a wide range of different DL and high performance computing (HPC) applications. In at least one embodiment, an example of tensor traversal for tiled mode is described above in relation to FIG. 13A and FIG. 13B.

In at least one embodiment, im2col mode is primarily used in convolution kernels based on implicit GEMM. In at least one embodiment, if im2col mode is selected, then TMAU does image-to-column transformation when it loads tensor blocks from global memory. In at least one embodiment, this adds extra complexity to tensor traversal algorithm.

In at least one embodiment, in tiled mode, tensor parameter boxSize[ ] uniquely defines boundingBox size in tensor space that holds all elements that TMAU is supposed to load in response to an instruction from SM. In at least one embodiment, each element of boxSize[ ] specifies boundingBox size along a corresponding dimension: boundingBox[i]=boxSize[i]. In at least one embodiment, coordinates specified in a TMAU memory access request from SM uniquely define location of boundingBox in tensor space.

In at least one embodiment, in im2col mode, boundingBox size and location are defined differently. In at least one embodiment, number of boundingBox dimensions is one less than tensor dimensionality in tensor descriptor. In at least one embodiment, boxSize[ ] is not used in this mode, and instead there are alternative parameters in tensor descriptor to support im2col mode. In at least one embodiment, alternative parameters include following: rangeNDHW, rangeC, boxBaseCornerDHW, boxFarCornerDHW. In at least one embodiment, boxBaseCornerDHW and boxFarCornerDHW define boundingBox size and location in DHW (Depth, Height, Width) space. In at least one embodiment, boxBaseCornerDHW specifies initial coordinates of boundingBox origin which is box upper left corner. In at least one embodiment, boxFarCornerDHW specifies initial location of opposite right bottom corner. In at least one embodiment, corners' locations are defined as signed offsets from corresponding tensor corners. In at least one embodiment, bounding box corners could be specified both inside and outside of tensor boundaries.

In at least one embodiment, locations of bounding box corners are affected by convolution filter size and selected dilation factor. In at least one embodiment, corner coordinates may be calculated as half of filter size multiplied by dilation factor. In at least one embodiment, precision for bounding box corners is chosen to provide wide range of convolution kernel sizes and dilation factors. In at least one embodiment, based on real application analysis, higher precision may be desirable for tensors with smaller dimensionality. In at least one embodiment, for example, a speech processing application which uses 3D tensors may require dilation factor of up to 8K, while image processing applications that use 4D or 5D tensors need much smaller dilation factors of up to 128.

In at least one embodiment, boxBaseCornerDHW and boxFarCornerDHW define boundingBox sizes using following formulas: boundingBox{D,H,W}=tensorSize{D,H,W}−boxBaseCorner{D,H,W}+boxFarCorner{D,H,W}). In at least one embodiment, for C dimension, size is defined by rangeC parameter.

FIG. 14A illustrates how boundingBox depends on boxBaseCorner{D,H, W}, boxFarCorner{D,H, W} settings, according to at least one embodiment. In at least one embodiment, this shows that many types of borders may be used in data structures, and in im2col mode, quantization can be avoided.

In at least one embodiment, in tiled mode, number of elements to load depends on boxSize[ ] parameters. In at least one embodiment, when TMAU traverses a particular dimension, it uses corresponding value from boxSize[ ] to determine how many elements to load. In at least one embodiment, in im2col mode, rangeNDHW is used to determine how many elements to load along NDHW dimensions and rangeC for dimension C. In at least one embodiment, a single TMAU request may require TMAU to traverse multiple images from a batch (N dimension) in order to load a requested number of elements. In at least one embodiment, when TMAU switches from current image to next during traversal of multiple images, it may skip channels that are outside range defined by rangeC parameter.

In at least one embodiment, in tiled mode, TMAU request coordinates specify boundingBox location (origin) in tensor space. In at least one embodiment, in im2col mode, coordinates along C and N dimensions are used similar to tiled mode; however, coordinates along W, H, D dimensions specify base location of convolution filter (upper left corner) in tensor space. In at least one embodiment, for correct processing, TMAU requires that base location of filter is always be defined within boundingBox. In at least one embodiment, in addition, coordinate offsets for these dimensions have to be specified in TMAU request. In at least one embodiment, offsets allows position of block to be specified relative to tensor, and therefore using only a minimal number of bytes. In at least one embodiment, offsets are added to filter base location coordinates to determine starting locations in tensor space from where load operation must be initiated. In at least one embodiment, same offsets are used to position boundingBox relative to initial coordinates specified in boxBaseCornerDHW. In at least one embodiment, offsets are applied to subset of coordinates based on table defined above. In at least one embodiment, offsets are defined as unsigned integer with variable precision. In at least one embodiment, precision depends on tensor dimensionality and chosen based on earlier justification for bounding box coordinates precision.

In at least one embodiment, all offsets are packed in 16 bits within a single register. In at least one embodiment, number of offsets depends on tensor dimensionality; therefore, precision may vary accordingly. In at least one embodiment, in typical convolution kernel once filter base is calculated it could be reused for multiple TMAU requests with different coordinate offsets. In at least one embodiment, number of reuses depends on convolution filter size. In at least one embodiment, for example, for a 3×3 filter, nine requests are issued for same filter base location.

In at least one embodiment, for interleaved layouts, C coordinate must be specified in terms of channel slices rather than individual channels. In at least one embodiment, this applies to both tiled and im2col modes.

In at least one embodiment, table below shows example pseudocode at a high level for logic implemented in TMAU, more particularly, in setup block, to configure tensor and access parameters based on tensor descriptor identified in a received TMAU request, according to at least one embodiment.

```
if (tensorDescriptor.interleaving == disable){
  boundingBox[0] = rangeC;
  switch(tensorDescriptor.dimensionality){
    case 5: boundingBox[3] = tensorSize[3] − boxBaseCornerD +
  boxFarCornerD;
    case 4: boundingBox[2] = tensorSize[2] − boxBaseCornerH +
  boxFarCornerH;
    case 3: boundingBox[1] = tensorSize[1] − boxBaseCornerW +
  boxFarCornerW;
  }
}else{
  switch(tensorDescriptor.dimensionality){
    case 5: boundingBox[2] = tensorSize[2] − boxBaseCornerD +
  boxFarCornerD;
    case 4: boundingBox[1] = tensorSize[1] − boxBaseCornerH +
  boxFarCornerH;
    case 3: boundingBox[0] = tensorSize[0] − boxBaseCornerW +
  boxFarCornerW;
  }
  boundingBox[dimensionality − 2] = rangeC;
}
```

### Example Pseudocode for Initializing a Load Tensor (Dimensions 3D-5D)

In at least one embodiment, following examples illustrate use of im2col mode. In at least one embodiment, a 3×3 convolution filter is applied to a NHWC tensor (64×14×9×64). In at least one embodiment, each request loads 64 elements along N, H, W dimensions, and 8 elements along C.

In at least one embodiment, in a first example, shown in FIG. 14B, filter can step outside of tensor boundary accessing surrounding padding (border) that could be defined as zero or constant value. In at least one embodiment, tensor descriptor parameters are set up as following: tensorSize[0]=64; tensorSize[1]=9; tensorSize[2]=14; tensorSize[4]=64; rangeNDHW=64; rangeC=8; boxBaseCornerW=−1; boxBaseCornerH=−1; boxFarCornerW=−1; boxFarCornerH=−1. In at least one embodiment, FIG. 14B illustrates processing for requests with coordinates (7, 7, 4, 0) and different coordinate offset values: (0, 0), (1, 1), (2, 2). In at least one embodiment, this example shows loading different bounding areas of tensor. In at least one embodiment, they are defined as offsets. In at least one embodiment, requester specifies to TMAU bounding area and how many elements is required to be loaded (e.g., a range of elements—in this case 64). In at least one embodiment, this can be specified as a parameter in tensor descriptor. In at least one embodiment, another parameter, that may be provided at instruction level, may specify a starting location for block for loading request. In at least one embodiment, TMAU knows that it has to load tensor elements starting from specified starting location plus offsets, stay within rectangle shown and load a particular amount of data.

In next example, filter is configured such that it must stay within tensor boundaries, and therefore no padding/border is needed on tensor. In at least one embodiment, tensor descriptor parameters are set up as following: rangeNDHW=64; rangeC=8; boxBaseCornerW=0; boxBaseCornerH=0; boxFarCornerW=−2; boxFarCornerH=−2. In at least one embodiment, FIG. 14C illustrates processing for requests with coordinates (7, 7, 4, 0) and different coordinate offset values: (0, 0), (1, 1), (2, 2).

In at last one embodiment, for comparison, handling of similar convolution cases in tiled mode is illustrated in next examples. In at least one embodiment, a single TMAU request may load all pixels needed for convolution computation in all filter locations. In at least one embodiment, in order to achieve this, extra halo pixels have to be loaded. In at least one embodiment, number of halo pixels depends on filter size.

In at least one embodiment, a 3×3 convolution filter is applied to a NHWC tensor (64×14×8×64). In at least one embodiment, filter can step outside of tensor boundary accessing surrounding padding (border) that could be defined as zero or constant value. In at least one embodiment, single request loads a 10×10 tile along H, W dimensions, and 8 elements along C. In at least one embodiment, each loaded 10×10 tile has 2 halo rows and 2 columns. In at least one embodiment, tensor descriptor parameters are set up as following: tensorSize[0]=64; tensorSize[1]=8; tensorSize[2]=14; tensorSize[4]=64; boxSize[0]=8; boxSize[ ]=10; boxSize[2]=10; boxSize[3]=1. In at least one embodiment, for any given filter location only an 8×8 tile is used for convolution calculations. In at least one embodiment, FIG. 14D illustrates processing for requests with coordinates (0, −1, −1, 0). In at least one embodiment, negative W, H block coordinates are needed to access pixels outside of tensor boundary with zero or constant (padding). In at least one embodiment, 8×8 tiles are shown that are used to process different filter locations: (0, 0), (1, 1), (2, 2).

In at least one embodiment, following example is similar to previous one, but filter must stay within tensor boundaries, and no padding/border is allowed. In at least one embodiment, a single TMAU request loads a 8×8 tile along H, W dimensions, and 8 elements along C. In at least one embodiment, each loaded 8×8 tile has 2 halo rows and 2 columns. In at least one embodiment, tensor descriptor parameters are set up as follows: boxSize[0]=8; boxSize[1]=8; boxSize[2]=8; boxSize[3]=1. In at least one embodiment, for any given filter location, a 6×6 tile is used for convolution calculations. In at least one embodiment, only 36 pixels are used for math at any given time. In at least one embodiment, this is less than optimal 64 pixels. In at least one embodiment, this is an example of tile-quantization effect that may impact overall performance. In at least one embodiment, FIG. 14E illustrates processing for TMAU requests with coordinates (0, 0, 0, 0). In at least one embodiment, setting W, H block coordinates to zero prevents stepping outside of tensor boundary. In at least one embodiment, 6×6 tiles are shown that are used to process different filter locations: (0, 0), (1, 1), (2, 2).

In at least one embodiment, tensor descriptor traversalStride parameter impacts both tiled and im2col modes. In at least one embodiment, in tiled mode bigger traversalStride, smaller number of tensor locations visited for load, which reduces total number of loaded elements. In at least one embodiment, in im2col mode, for comparison, number of loaded elements along NDHW dimensions do not depend on traversalStride along these dimensions: it is equal to tensor descriptor rangeNDHW parameter. In at least one embodiment, however, like tiled mode, number of elements traversed along W, H, and D dimensions is impacted by traversalStride based on formula ceil(boundingBox{D,H,W} traversalStride{D,H,W}).

FIG. 14F illustrates traversalStride handling in im2col mode, according to at least one embodiment. In at least one embodiment, a 3×3 convolution filter is applied to NHWC tensor (64×14×9×64) with traversalStride equal two. In at least one embodiment, each request loads 32 elements along N, H, W dimensions, and 16 elements along C. In at least one embodiment, tensor descriptor parameters are set up as following: tensorSize[0]=64; tensorSize[1]=9; tensorSize[2]=14; tensorSize[4]=64; traversalStride=2; rangeNDHW=32; rangeC=16; boxBaseCornerW=−1; boxBaseCornerH=−1; boxFarCornerW=−1; boxFarCornerH=−1. In at least one embodiment, FIG. 14B illustrates processing for requests with coordinates (7, 7, 5, 0) and different coordinate offset values: (0, 0), (1, 1), (2, 2). In at least one embodiment, pixels are loaded from top row of boundingBox, but not from bottom row. In at least one embodiment, they are also loaded from both first and last columns.

FIG. 14G illustrates slightly modified example where tensor size along W and H dimensions are reduced by one pixel: NHWC (64×13×8×64), according to at least one embodiment. In at least one embodiment, pixels are loaded from both top and bottom rows of boundingBox. In at least one embodiment, they are not loaded from last column, though.

In at least one embodiment, a next example, shown in FIG. 14H, illustrates traversalStride handling in tiled mode. In at least one embodiment, a 3×3 convolution filter is applied to a NHWC tensor (64×14×8×64) with traversalStride equal two. In at least one embodiment, similar to earlier examples with traversalStride equal one (FIG. 14D), a single TMAU request can provide pixels for all convolution filter locations by loading extra halo pixels.

In at least one embodiment, TMAU may not have dedicated hardware for convolution dilation handling and other TMAU circuitry may provide necessary support for this feature. In at least one embodiment, however, precision of im2col coordinate offsets and bounding box corner coordinates is chosen to provide wide range of convolution kernel sizes and dilation factors. In at least one embodiment, FIG. 14I illustrates how dilation factor affects bounding box settings for 3×3 convolution filter. In at least one embodiment, dilation impacts box location but not size.

FIG. 14J illustrates how a dilation factor of two is handled in im2col mode, according to at least one embodiment. In at least one embodiment, a 3×3 convolution filter is applied to a NHWC tensor (64×14×9×64). In at least one embodiment, each request loads 64 elements along N, H, W dimensions, and 16 elements along C. In at least one embodiment, tensor descriptor parameters are set up as following: tensorSize[0]=64; tensorSize[1]=9; tensorSize[2]14; tensorSize[4]=64; rangeNDHW=64; rangeC=16; boxBaseCornerW=−2; boxBaseCornerH=−2; boxFarCornerW=−2; boxFarCornerH=−2. In at least one embodiment, FIG. 14J illustrates processing for requests with coordinates (7, 6, 3, 0) and different coordinate offset values: (0, 0), (2, 2), (4, 4).

FIG. 14K illustrates how a similar example to FIG. 14J is handled in tiled mode, according to at least one embodiment. In at least one embodiment, a single TMAU request can provide pixels for all convolution filter locations by loading extra halo pixels. In at least one embodiment, number of halo pixels depends on filter size and dilation factor. In at least one embodiment, a 3×3 convolution filter is applied to a NHWC tensor (64×14×8×64). In at least one embodiment, a single request loads 12×12 tiles along H, W dimensions, and 8 elements along C. In at least one embodiment, each loaded 12×12 tile has 4 halo rows and 4 columns. In at least one embodiment, tensor descriptor parameters are set up as following: tensorSize[0]=64; tensorSize[1]=8; tensorSize[2]=14; tensorSize[4]=64; boxSize[0]=8; boxSize[ ]=12; boxSize[2]=12; boxSize[3]=1. In at least one embodiment, for any given filter location only a 8×8 tile is used for convolution calculations. In at least one embodiment, FIG. 14K illustrates processing for requests with coordinates (0, −2, −2, 0). In at least one embodiment, negative W, H block coordinates needed to access pixels outside of tensor boundary with zero or constant (padding). In at least one embodiment, 8×8 tiles are shown that are used to process different filter locations: (0, 0), (2, 2), (4, 4).

### Support for Tensor Data Swizzling

In at least one embodiment in many applications, TMAU loads data in shared memory in same order as they are laid out in global memory. In at least one embodiment, however, there are applications when extra data movements are required to avoid performance degradation. In at least one embodiment, this may be implemented as an application dependent optimization. In at least one embodiment, TMAU supports a non-swizzled mode in which data is written to shared memory in same arrangement it is in global memory, and a swizzled mode in which data is written to shared memory in accordance with a predetermined or configurable swizzle pattern that that results in a different arrangement of data than that in global memory. In at least one embodiment, when TMAU processes a memory access request, it may generate multiple external memory requests, and for each of generated external memory requests it may generate a corresponding destination address and swizzling pattern for target shared memory. In at least one embodiment, two options for tracking destination addresses and swizzling patterns may be used in implementations—either sending all information through memory system with request and response, or store information in a tracking table in SM and send corresponding index into this table through memory system with request and response. In at least one embodiment, in either case memory system response may use this information to determine address and pattern for writing data in target shared memory.

In at least one embodiment, L2 cache lines are organized in four 32 B sectors. In at least one embodiment, shared memory is organized in groups of 8 banks, 4 groups total. In at least one embodiment, there is a flexibility in mapping four sectors in cache line to a specific bank groups: any sector could be mapped to any group, one sector per group. In at least one embodiment, in addition, 16 B sector halves could be swapped within sector. In at least one embodiment, this provides extra flexibility in mapping 16 B quantities to 4-bank subgroups.

In at least one embodiment, data are organized in specific order in global memory; however, it may not match order in which data are accessed by application in shared memory. In at least one embodiment, a good example is a row-first matrix organization versus column-first access. In at least one embodiment, this difference in data organization may cause bank conflicts when shared memory is accessed. In at least one embodiment, in order to avoid this problem data could be loaded to shared memory with shuffling across shared memory banks. In at least one embodiment, L2 cache line sectors are mapped to shared memory bank groups and subgroups based on predefined patterns that guaranty avoidance of bank conflicts both for reads and writes. In at least one embodiment, TMAU supports multiple patterns based on specific tensor layouts. In at least one embodiment, in turn data consumer must be aware of these patterns and access data accordingly.

In at least one embodiment, TMAU can swizzle data being loaded into a shared memory that is organized in terms of lines. In at least one embodiment, in an example, shared memory is organized in lines, where each line is 128 B (128 byte) and has a unique address. In at least one embodiment, shared memory bank swizzling pattern may be encoded in 8×8 tables where each entry represents bank sub-group ID for 16 B sub-blocks within a 128 B data block. In at least one embodiment, appropriate line from table is selected based on last 3 bits of destination shared memory address (line ID). In at least one embodiment, bits are taken from logical address within CTA shared memory region. In at least one embodiment, it's an offset from region base address. In at least one embodiment, it's not necessarily same as shared memory physical address.

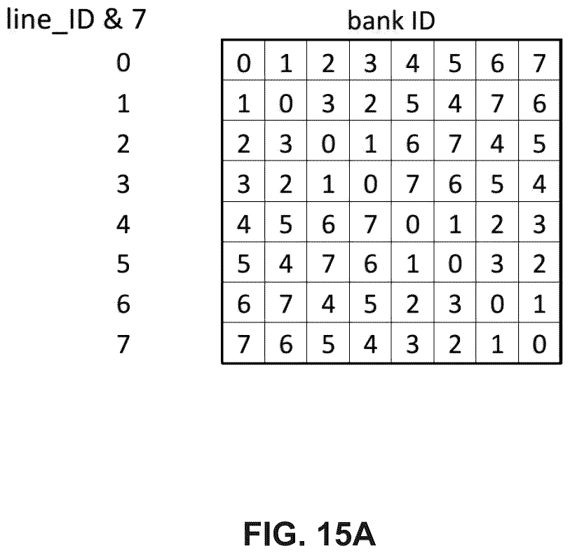

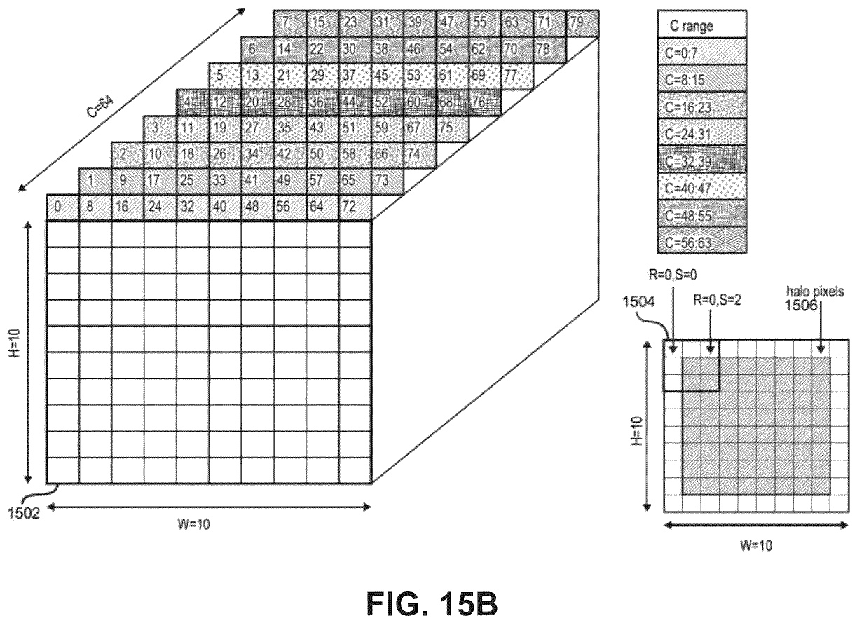

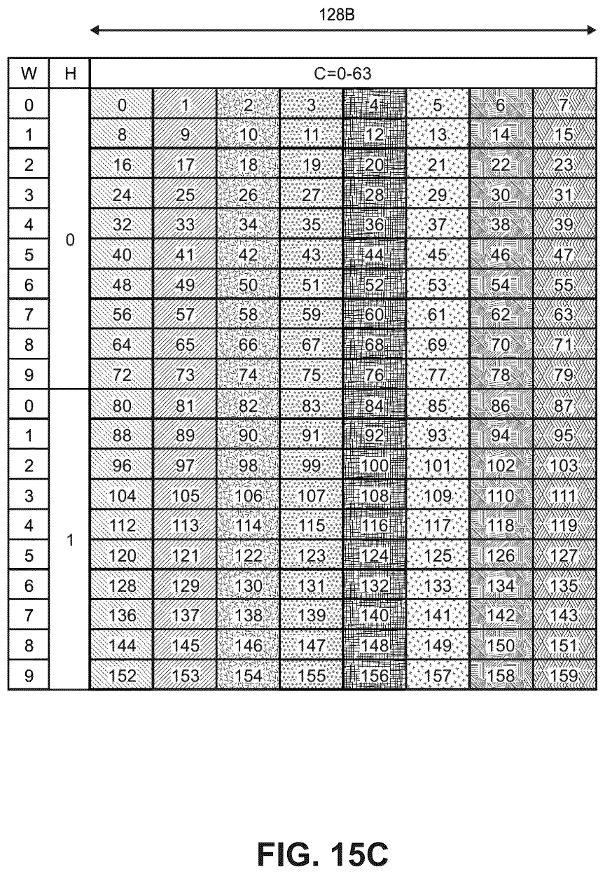

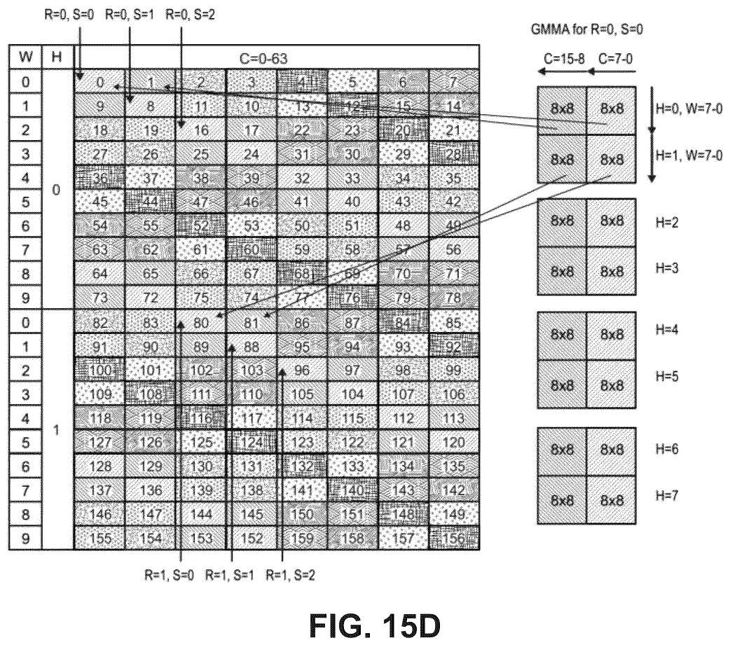

In FIG. 15A, an example bank allocation table for a swizzle_128B mode is shown, according to at least one embodiment.

FIGS. 15B-15D illustrate an example data layouts in global and shared memories for swizzle_128B mode in accordance with bank allocation table of FIG. 15A, according to at least one embodiment. In at least one embodiment, FIG. 15B shows a 4-dimensional NHWC tensor with 1×10×10×64 (i.e. N=1, H=10, W=10 and C=64) dimensions in global memory. In at least one embodiment, with 2 B/channel and 64 channels occupying 128 B. In at least one embodiment, each enumerated cell, sometimes also referred to as a pixel, represents 8 channels (16 B). In at least one embodiment, W and H sizes of an image 1502 are each 10 and includes halo pixels 1506 to support a 3×3 convolution filter 1504 along 8×8 image tile. In at least one embodiment, during processing convolution filter is moved left-right and top-bottom iteratively one pixel at a time. In at least one embodiment, cells are enumerated in FIGS. 15A-D in order they are stored in global memory. In at least one embodiment, channel ranges are presented in different hatch patterns.

FIG. 15C shows a part of tensor shown in FIG. 15B in global memory for H=0, and 1, according to at least one embodiment. In at least one embodiment, each row of cells in FIG. 15C represents single 128 B L2 cache line. FIG. 15D illustrates how same data are stored in shared memory according to an embodiment. In at least one embodiment, each row represents 128 B of data distributed across memory banks. In at least one embodiment, data are swizzled based on table for swizzle_128B mode. In at least one embodiment, on right in FIG. 15D, data view from GMMA application's perspective is shown for filter location R=0, S=−0. In at least one embodiment, GMMA must be aware of bank swizzling and strides to feed right data in 16 8×8 tiles.

In at least one embodiment, swizzling accommodates for implementations in which order in which data is stored in global memory is not same order in which that data is stored in shared memory. In at least one embodiment, when data is moved from global memory to shared memory, TMAU provides for scrambling data because SM, for some applications, reads data vertically (e.g. in columns of data). In at least one embodiment, memory bank layout in shared memory is taken into account by TMAU, when it is writing to shared memory, in order to optimize SM's subsequent read access to that data. In at least one embodiment, in illustrated example, shared memory is organized in banks, and specifically in 8 banks. In at least one embodiment, at any given clock, each bank is read but only a small piece of data from any given bank can be read. In at least one embodiment, each hatch pattern represents data written to a different bank in shared memory in accordance with swizzle pattern for tensor. In at least one embodiment, if data from H=0 W=0-7 is to be read from shared memory and if that data in shared memory is arranged in same manner as in global memory, it would take 8 clock cycles to read that data while avoiding bank conflict. In at least one embodiment, as shown in FIG. 15D on left side, data from H=0 W=0-7 is spread over all eight banks in shared memory so that all of that data (i.e. data from H=0 W=0-7) can be read in parallel across 8 banks. In at least one embodiment, this increases data throughput per clock.

On right side of FIG. 15D, right most column shows 8×8 tiles for each H when W=0, arrows indicating locations in shared memory at which tiles for H=0, W=0 and H=1, WO (enumerated tiles 0 and 80 respectively) are written, according to at least one embodiment. In at least one embodiment, similarly, in second column from right, 8×8 tiles for each H when W=1 are shown, arrows indicating locations in shared memory at which tiles for H=0, W=1 and H=1, W=1 (enumerated tiles 0 and 80 respectively) are written In at least one embodiment, swizzling is performed according to a preconfigured table such as table shown in FIG. 15A in TMAU.

In at least one embodiment, GMMA is a fixed function hardware unit in GPU tensor cores that is configured to perform matrix to matrix multiply into an accumulator. In at least one embodiment, for example, two 16×16 matrices may be multiplied by GMMA into an accumulation matrix. In at least one embodiment, GMMA may be limited to matrices smaller than a predefined size. In at least one embodiment, when two matrices are to be multiplied, GMMA is a consumer of data that is fed, in example embodiments, by TMAU. In at least one embodiment, when a matrix-matrix multiplication is required in a computational kernel running on an SM, kernel request may request TMAU to copy data for each of two matrices into shared memory, and then issue a request for a matrix-matrix multiplication to GMMA. In at least one embodiment, GMMA, in response, may perform its multiplication operation using data that has been loaded to shared memory by TMAU. In at least one embodiment, if swizzling is used, kernel may read data in shared memory according to swizzle pattern information, perform its calculation, and then write results back to shared memory. In at least one embodiment, swizzling is performed according to a preconfigured table such as table shown in FIG. 15A in TMAU.

In at least one embodiment, GMMA circuitry may be configured to read data from shared memory in 8×8 pixel tiles as shown on right side of FIG. 15D. In at least one embodiment, in order to obtain data for position R=0, S=0 (see FIG. 15B indication of R=0 S=0 in unswizzled image in global memory), all channels 0-63 for position R=0 S=0 need to be read from shared memory. In at least one embodiment, for first 8×8 pixel tile read by GMMA, as shown in top right tile on right side of FIG. 15D, for position R−0 S=0 pixels for channels C=0-7 of H=0 W=0-7 is read. In at least one embodiment, since data is swizzled in shared memory as shown in FIG. 15D, all channels 0-63 for eight positions including R=0, S=0 can be read in eight clock cycles.

In at least one embodiment, GMMA operation may be invoked by a convolution kernel over an image 1502 such as that shown in FIG. 15B using a 3×3 convolution filter 1504. In at least one embodiment, for each position, R=0 S=0 etc., filter requires matrix multiplication to be performed for 3×3 box in which that position is top left position as shown in FIG. 15B lower right. In at least one embodiment, however, GMMA circuitry may read an 8×8 tile for in each read.

### Multicast Support

In at least one embodiment, TMAU provides support for programmatic multicast where a single TMAU generates a load request, but data are delivered to multiple destinations (e.g., SMs). In at least one embodiment, for example, in response to a load request from a kernel executing on a first SM, TMAU coupled to first SM requests a block of tensor data or other data from global memory and, in addition to writing it to shared memory of first SM (it is not required in some embodiments that requesting SM receives requested data), also writes it to shared memories of one or more other SMs. In at least one embodiment, to support this, feature requesting TMAU is provided with list of receiving CTAs. In at least one embodiment, receiving CTA IDs may be encoded in a 16-bit mask where each bit corresponds to specific CTA ID. In at least one embodiment, a data request with multicast option initiates TMAU multicast requests. In at least one embodiment, mask for destination CTAs may be encoded in destination address that is provided to instructions.

In at least one embodiment, each receiver CTA needs to detect transaction completion. In at least one embodiment, completion detection may be based on an arrive/wait synchronization mechanism. In at least one embodiment, for example, each received packet may include shared memory address for corresponding arrive/wait structure location, and counter in structure can be updated in accordance with number of received data bytes. In at least one embodiment, receiver CTA may implement synchronization based on a barrier or like on counter.

In at least one embodiment, in order to support preemption, TMAU keeps track of received data packets in order to detect completion of transaction. In at least one embodiment, in typical case all book-keeping is organized locally inside TMAU. However, in at least one embodiment, in multicast case requesting TMAU must account for transaction completion at all receivers. In at least one embodiment, therefore, additional acknowledgement mechanism may be established across multiple TMAUs. In at least one embodiment, every time TMAU receives data it must communicate event to requesting TMAU. In at least one embodiment, requesting TMAU accounts for total number of received data packages across all receivers. In at least one embodiment, an example multicast implementation that can be implemented using TMAU is described in U.S. application Ser. No. ______ (ISF-20-SC-0612; “Programmatic Multicast”) filed on XXX, which is hereby incorporated by reference in its entirety.

### Prefetch Support

In at least one embodiment, in addition to loading tensor data, TMAU supports data prefetch requests to prefetch data from global memory DRAM to L2 cache. In at least one embodiment, this provides an opportunity to reduce tensor load latency and to improve overall performance. In at least one embodiment, prefetch may especially be advantageous for multicast operations where latency impacts execution of multiple CTAs. In at least one embodiment, prefetch request handling is similar to that of other load operations, but without TMAU having to perform any type of completion tracking or like. In at least one embodiment, for tensor data, prefetch requests handling is somewhat similar to load operation where tensor descriptor and coordinates define how to process request. In at least one embodiment, however, with respect to prefetch requests for tensor data, TMAU may not handle shared memory/global alignment and process requests at sector or cache line granularity.

### Store and Reduction Requests

In at least one embodiment, TMAU store request copies a block of data from shared to global memory. In at least one embodiment, data in shared memory are processed sequentially as a linear address space; however, destination memory is treated as multidimensional tensor. In at least one embodiment, maximum dimensionality is same as for load requests.

In at least one embodiment, like with TMAU loads, TMAU store requests are provided with tensor descriptor pointer, shared memory base address and coordinates of destination block in tensor space. In at least one embodiment, store requests can be executed in both tiled and im2col modes. In at least one embodiment, store requests may also support interleaved layouts, and shared memory bank swizzling patterns may be specified. In at least one embodiment, store with traversal stride may be supported. In at least one embodiment, store operation may also support handling of out-of-bound conditions with ZFILL/CFILL. In at least one embodiment, in addition, TMAU in certain embodiments supports store with reduction for data copying from shared to global or shared to shared memories. In at least one embodiment, supported reduction operations may include any of, but are not limited to, AND, ADD, XOR, MIN, MAX, DEC, OR, and INC.

### Descriptor-Less Requests

In at least one embodiment, a wide range of applications do memory-to-memory transactions that do not require knowledge of underlying data layouts. In at least one embodiment, in this case data are treated as sequential array of blocks of a predetermined size. In at least one embodiment, for example, a default block size of 16 B may be configured for TMAU operations. In at least one embodiment, memory access request for a non-tensor block of data is significantly simpler that a request for a tensor, and in some embodiments requires only a source address, destination address, and number of blocks to perform transfer. In at least one embodiment, all these parameters can be specified at instruction level (i.e. provided in request to TMAU) without need of an associated tensor descriptor stored in global memory. In at least one embodiment, this simplifies programming model since step of tensor descriptor definition can be eliminated for such memory access requests. In at least one embodiment, if number of blocks to transfer is zero, then these instructions as handled as a null operation (NOP).

In at least one embodiment, TMAU supports dedicated instructions for descriptor-less data transfers (also referred to as non-tensor data requests). In at least one embodiment, such instructions can be used to copy data from global to shared, shared to global, and shared to shared memories. In at least one embodiment, in another embodiment global to global copy may be implemented. In at least one embodiment, in addition, another instruction does reduction with data copy from shared to global or shared to shared memories. In at least one embodiment, supported reduction operations may include any of, but are not limited to, AND, ADD, XOR, MIN, MAX, DEC, OR, and INC. In at least one embodiment, TMAU supports descriptor-less data prefetch requests from DRAM to L2.

### Synchronization and Transaction Completion

In at least one embodiment, TMAU supports a request completion event. In at least one embodiment, an arrive/wait barrier is used as a completion detection mechanism. In at least one embodiment, each TMAU load request expects shared memory address where barrier structure is located. In at least one embodiment, TMAU includes this address in each L2 request. In at least one embodiment, when data arrives to destination SM barrier structure is updated accordingly. In at least one embodiment, TMAU itself is not involved in barrier update. In at least one embodiment, this mechanism may be used for both unicast and multicast requests.

In at least one embodiment, TMAU supports dedicated instruction that could be used to detect completion of all previously issued TMAU requests.

### Programming Model for TMAU

In at least one embodiment, TMAU is designed to move big blocks of tensor or other data between global and shared memories. In at least one embodiment, a single TMAU load request can bring kilobytes, megabytes or even larger amounts of data that could be processed by multiple threads and CTAs. In at least one embodiment, similarly, large blocks of shared memory data generated by a large thread array could be saved by a single TMAU store operation to global memory in tensor or other form.

In at least one embodiment, scalar nature of TMAU requests is not well aligned with multi-threaded nature of CUDA programming paradigm. In at least one embodiment, therefore, some embodiments provide an intuitive and non-disruptive programing model that can be integrated with CUDA environment to provide for utilizing TMAU in applications. In at least one embodiment, programming model provides flexibility for program development and is intuitive and easy to learn for application developers.

In at least one embodiment, in a DL application, it is expected that TMAU is used in an iterative way. In at least one embodiment, multiple CTAs iterate through tensors stored in global memory by accessing different tiles. In at least one embodiment, in each iteration tensor blocks (tiles) are extracted and processed. In at least one embodiment, for each block, application determines block location in tensor space by computing multidimensional coordinates. In at least one embodiment, in addition, application has to calculate shared memory addresses that used to store blocks.

In at least one embodiment, scalar nature of TMAU instructions makes Uniform Data Path (UDP) and Uniform Register File (URF) an efficient execution venue. In at least one embodiment, this applies not just to TMAU instructions but also surrounding code that generates necessary instruction parameters. In at least one embodiment, this approach would eliminate code execution redundancy, save RF capacity, bandwidth, save power and free vector data path. In at least one embodiment, because of iterative nature of TMAU related code it is important to keep iterated parameters resident in URF. In at least one embodiment, any URF/RF load/store would cause loss in performance and extra power consumption.

In at least one embodiment, a mechanism is provided that assists compiler to recognize warps-single semantics of nearby code-blocks and be expressed through CUDA and PTX (Parallel Thread Execution instruction set architecture). In at least one embodiment, a modification adds “.one” modifier. In at least one embodiment, in following code, proposed modifier forces single thread to be selected for execution:

_warpsync.exclusive.one mask, L1;
<code block executed by single thread>

In at least one embodiment, execution thread is selected from set of active threads defined by mask. In at least one embodiment, it is important that same thread is consistently selected every time code-block is executed. In at least one embodiment, _warpsync.exclusive causes all threads to be synchronized before and after code-block execution. In at least one embodiment, proposed programming model may simplify code analyzes and provides opportunity to generate TMAU-related code for UDP execution and keep relevant data resident in URF.

In at least one embodiment, CUDA-level model is on top of PTX structure where single thread is consistently selected for code-block execution. In at least one embodiment, in following code_one_sync(mask) function provides desirable functionality:

if (_{——}one_sync(mask) ) {
<code block executed by single thread>
} // no ‘else’ clause

In at least one embodiment, TMAU-based access is implemented through a set of functions. In at least one embodiment, four C-style groups are defined to cover following cases: tiled load with L2 descriptor, tiled load without tensor descriptor, im2col load with tensor descriptor, and im2col load without tensor descriptor. In at least one embodiment, functions may take as input parameters tensor descriptor pointer, shared memory destination address, shared memory address for arrive/wait barrier, set of tensor coordinates for access block origin, pipeline structure, and optional tensor descriptor. In at least one embodiment, im2col group also expects coordinate offsets within convolution kernel.

In at least one embodiment, a kernel executing on SM may issue a memory access request to TMAU to copy a tensor between global and shared memories with tensor copy instruction in a form such as:
copy_tensor.mode.dimensionality.destination,source{.multicast}{reduction_op}
   descriptor coordinates SMEM_data_address {SMEM_barrier_addr}
   {im2col_coordinate_offsets} multicast_destinations
      where mode={tiles, im2col}, dimensionality={1D-5D}, destination={shared, global}, source={shared, global}. In at least one embodiment, multicast, reduction_op={.AND, ADD, .XOR, .MIN, .MAX, .DEC, OR, .INC}.

In at least one embodiment, a memory access request to TMAU to prefetch tensor data to L2 cache may be issued with a tensor prefetch instruction in a form such as:
prefetch_tensor.mode.dimensionality descriptor coordinates
   im2col_coordinate_offsets}
      where mode={tiles, im2col} and dimensionality={1D-5D}.

In at least one embodiment, a memory access request to TMAU to copy a block of non-tensor data between global and shared memory may be issued with a block copy instruction in a form such as:
copy_block.destination,source{.multicast}{reduction_op} destination_address {barrieraddr}source address multicast_destinations number blocks
where destination={shared, global}, source={shared, global}, multicast, and
reduction_op={.AND, ADD, .XOR, MIN, .MAX, .DEC, .OR, .INC}.

In at least one embodiment, a memory access request to TMAU to prefetch a block of non-tensor data from global memory to L2 cache may be issued with a block prefetch instruction in a form such as:
prefetch_block address number_blocks.
   Example Parallel Processing GPU Architecture with TMAU

In at least one embodiment, an example illustrative architecture in which TMAU is incorporated can be described with respect to one or more aspects below. In at least one embodiment, following information is set forth for illustrative purposes and should not be construed as limiting in any manner. In at least one embodiment, any of following features may be optionally incorporated with or without exclusion of other features described.

FIG. 16 illustrates a parallel processing unit (PPU) 1600, according to at least one embodiment. In at least one embodiment, PPU 1600 is a multi-threaded processor that is implemented on one or more integrated circuit devices. In at least one embodiment, PPU 1600 is a latency hiding architecture designed to process many threads in parallel. In at least one embodiment, a thread (e.g., a thread of execution) is an instantiation of a set of instructions configured to be executed by PPU 1600. In at least one embodiment, in an embodiment, PPU 1600 is a graphics processing unit (GPU) configured to implement a graphics rendering pipeline for processing three-dimensional (3D) graphics data in order to generate two-dimensional (2D) image data for display on a display device such as a liquid crystal display (LCD) device. In at least one embodiment, PPU 1600 may be utilized for performing general-purpose computations. In at least one embodiment, PPU 1600 is configured to implement large neural networks in deep learning applications or other high performance computing applications.

In at least one embodiment, one or more PPUs 1600 may be configured to accelerate thousands of High Performance Computing (HPC), data center, and machine learning applications. In at least one embodiment, PPU 1600 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and/or other suitable systems and applications.

As shown in FIG. 16, PPU 1600 includes an Input/Output (I/O) unit 1605, a front end unit 1615, a scheduler unit 1620, a work distribution unit 1625, a hub 1630, a crossbar (Xbar) 1670, one or more general processing clusters (GPCs) 1650, and one or more partition units 1680. In at least one embodiment, PPU 1600 may be connected to a host processor or other PPUs 1600 via one or more high-speed NVLink 1610 interconnect. In at least one embodiment, PPU 1600 may be connected to a host processor or other peripheral devices via an interconnect 1602. In at least one embodiment, PPU 1600 may also be connected to a memory comprising a number of memory devices 1604. In at least one embodiment, in an embodiment, memory 1604 may comprise a number of dynamic random access memory (DRAM) devices. In at least one embodiment, DRAM devices may be configured as a high-bandwidth memory (HBM) subsystem, with multiple DRAM dies stacked within each device.

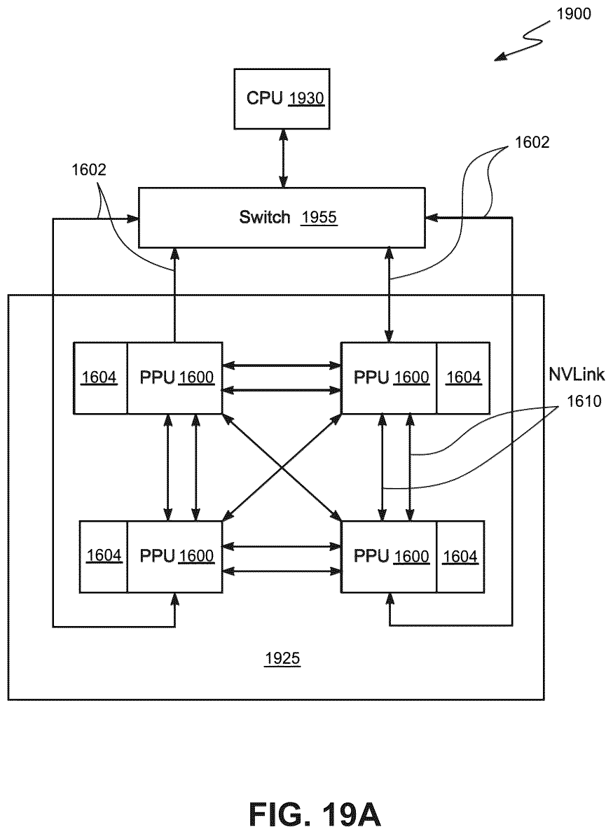

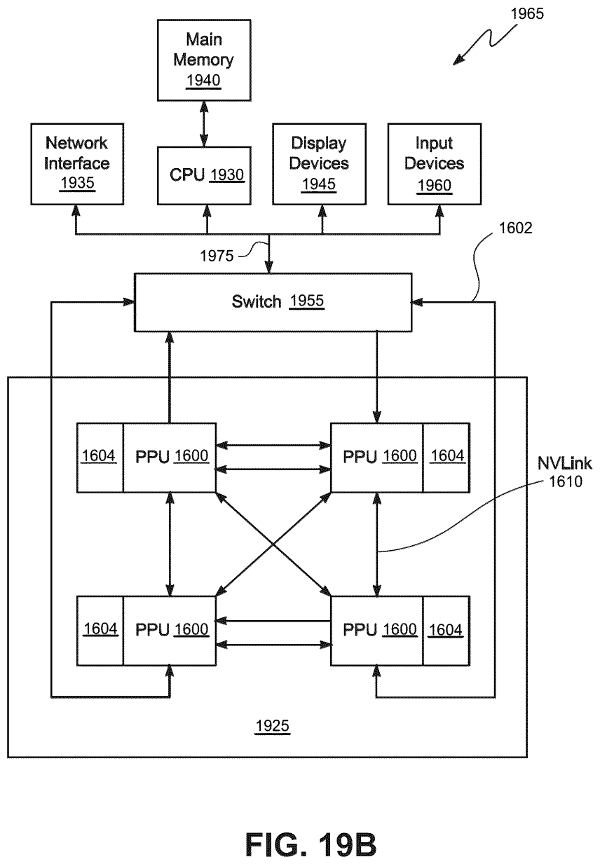

In at least one embodiment, NVLink 1610 interconnect enables systems to scale and include one or more PPUs 1600 combined with one or more CPUs, supports cache coherence between PPUs 1600 and CPUs, and CPU mastering. In at least one embodiment, data and/or commands may be transmitted by NVLink 1610 through hub 1630 to/from other units of PPU 1600 such as one or more copy engines, a video encoder, a video decoder, a power management unit, etc. (not explicitly shown). In at least one embodiment, NVLink 1610 is described in more detail in conjunction with FIG. 19A and FIG. 19B.

In at least one embodiment, I/O unit 1605 is configured to transmit and receive communications (e.g., commands, data, etc.) from a host processor (not shown) over interconnect 1602. In at least one embodiment, I/O unit 1605 may communicate with host processor directly via interconnect 1602 or through one or more intermediate devices such as a memory bridge. In at least one embodiment, in an embodiment, I/O unit 1605 may communicate with one or more other processors, such as one or more of PPUs 1600 via interconnect 1602. In at least one embodiment, in an embodiment, I/O unit 1605 implements a Peripheral Component Interconnect Express (PCIe) interface for communications over a PCIe bus and interconnect 1602 is a PCIe bus. In at least one embodiment, in alternative embodiments, I/O unit 1605 may implement other types of well-known interfaces for communicating with external devices.

In at least one embodiment, I/O unit 1605 decodes packets received via interconnect 1602. In at least one embodiment, in an embodiment, packets represent commands configured to cause PPU 1600 to perform various operations. In at least one embodiment, I/O unit 1605 transmits decoded commands to various other units of PPU 1600 as commands may specify. In at least one embodiment, for example, some commands may be transmitted to front end unit 1615. In at least one embodiment, other commands may be transmitted to hub 1630 or other units of PPU 1600 such as one or more copy engines, a video encoder, a video decoder, a power management unit, etc. (not explicitly shown). In at least one embodiment, in other words, I/O unit 1605 is configured to route communications between and among various logical units of PPU 1600.

In at least one embodiment, a program executed by host processor encodes a command stream in a buffer that provides workloads to PPU 1600 for processing. In at least one embodiment, a workload may comprise several instructions and data to be processed by those instructions. In at least one embodiment, buffer is a region in a memory that is accessible (e.g., read/write) by both host processor and PPU 1600. In at least one embodiment, for example, I/O unit 1605 may be configured to access buffer in a system memory connected to interconnect 1602 via memory requests transmitted over interconnect 1602. In at least one embodiment, host processor writes command stream to buffer and then transmits a pointer to start of command stream to PPU 1600. In at least one embodiment, front end unit 1615 receives pointers to one or more command streams. In at least one embodiment, front end unit 1615 manages one or more streams, reading commands from streams and forwarding commands to various units of PPU 1600.

In at least one embodiment, front end unit 1615 is coupled to a scheduler unit 1620 that configures various GPCs 1650 to process tasks defined by one or more streams. In at least one embodiment, scheduler unit 1620 is configured to track state information related to various tasks managed by scheduler unit 1620. In at least one embodiment, state may indicate which GPC 1650 a task is assigned to, whether task is active or inactive, a priority level associated with task, and so forth. In at least one embodiment, scheduler unit 1620 manages execution of a plurality of tasks on one or more GPCs 1650.

In at least one embodiment, scheduler unit 1620 is coupled to a work distribution unit 1625 that is configured to dispatch tasks for execution on GPCs 1650. In at least one embodiment, work distribution unit 1625 may track a number of scheduled tasks received from scheduler unit 1620. In at least one embodiment, work distribution unit 1625 manages a pending task pool and an active task pool for each of GPCs 1650. In at least one embodiment, pending task pool may comprise a number of slots (e.g., 32 slots) that contain tasks assigned to be processed by a particular GPC 1650. In at least one embodiment, active task pool may comprise a number of slots (e.g., 4 slots) for tasks that are actively being processed by GPCs 1650. In at least one embodiment, as a GPC 1650 finishes execution of a task, that task is evicted from active task pool for GPC 1650 and one of other tasks from pending task pool is selected and scheduled for execution on GPC 1650. In at least one embodiment, if an active task has been idle on GPC 1650, such as while waiting for a data dependency to be resolved, then active task may be evicted from GPC 1650 and returned to pending task pool while another task in pending task pool is selected and scheduled for execution on GPC 1650.

In at least one embodiment, work distribution unit 1625 communicates with one or more GPCs 1650 via XBar 970. In at least one embodiment, XBar 1670 is an interconnect network that couples many of units of PPU 1600 to other units of PPU 1600. In at least one embodiment, for example, XBar 1670 may be configured to couple work distribution unit 1625 to a particular GPC 1650. In at least one embodiment, although not shown explicitly, one or more other units of PPU 1600 may also be connected to XBar 1670 via hub 1630.

In at least one embodiment, tasks are managed by scheduler unit 1620 and dispatched to a GPC 1650 by work distribution unit 1625. In at least one embodiment, GPC 1650 is configured to process task and generate results. In at least one embodiment, results may be consumed by other tasks within GPC 1650, routed to a different GPC 1650 via XBar 1670, or stored in memory 1604. In at least one embodiment, results can be written to memory 1604 via partition units 1680, which implement a memory interface for reading and writing data to/from memory 1604. In at least one embodiment, results can be transmitted to another PPU 1604 or CPU via NVLink 1610. In at least one embodiment, PPU 1600 includes a number U of partition units 1680 that is equal to number of separate and distinct memory devices 1604 coupled to PPU 1600. In at least one embodiment, a partition unit 1680 will be described in more detail below in conjunction with FIG. 17B.

In at least one embodiment, a host processor executes a driver kernel that implements an application programming interface (API) that enables one or more applications executing on host processor to schedule operations for execution on PPU 1600. In at least one embodiment, multiple compute applications are simultaneously executed by PPU 1600 and PPU 1600 provides isolation, quality of service (QoS), and independent address spaces for multiple compute applications. In at least one embodiment, an application may generate instructions (e.g., API calls) that cause driver kernel to generate one or more tasks for execution by PPU 1600. In at least one embodiment, driver kernel outputs tasks to one or more streams being processed by PPU 1600. In at least one embodiment, each task may comprise one or more groups of related threads, referred to herein as a warp. In at least one embodiment, a warp comprises 32 related threads that may be executed in parallel. In at least one embodiment, cooperating threads may refer to a plurality of threads including instructions to perform task and that may exchange data through shared memory. In at least one embodiment, threads, cooperating threads and a hierarchical grouping of threads such as cooperating thread arrays (CTA) and cooperating group arrays (CGA) according to some embodiments are described in more detail in U.S. application Ser. No. ______(20-AU-0519 “CGAs . . . for strong scaling”) filed on ______, entire content of which is hereby incorporated by reference in its entirety.

FIG. 17A illustrates a GPC 1650 of PPU 1600 of FIG. 16, according to at least one embodiment. In at least one embodiment, as shown in FIG. 17A, each GPC 1650 includes a number of hardware units for processing tasks. In at least one embodiment, each GPC 1650 includes a pipeline manager 1710, a pre-raster operations unit (PROP) 1715, a raster engine 1725, a work distribution crossbar (WDX) 1780, a memory management unit (MMU) 1790, and one or more Data Processing Clusters (DPCs) 1720. In at least one embodiment, it will be appreciated that GPC 1650 of FIG. 17A may include other hardware units in lieu of or in addition to units shown in FIG. 17A.

In at least one embodiment, operation of GPC 1650 is controlled by pipeline manager 1710. In at least one embodiment, pipeline manager 1710 manages configuration of one or more DPCs 1720 for processing tasks allocated to GPC 1650. In at least one embodiment, pipeline manager 1710 may configure at least one of one or more DPCs 1720 to implement at least a portion of a graphics rendering pipeline, a neural network, and/or a compute pipeline. In at least one embodiment, for example, with respect to a graphics rendering pipeline, a DPC 1720 may be configured to execute a vertex shader program on programmable streaming multiprocessor (SM) 1740. In at least one embodiment, pipeline manager 1710 may also be configured to route packets received from work distribution unit 1625 to appropriate logical units within GPC 1650. In at least one embodiment, for example, some packets may be routed to fixed function hardware units in PROP 1715 and/or raster engine 7125 while other packets may be routed to DPCs 1720 for processing by primitive engine 1735 or SM 1740.

In at least one embodiment, PROP unit 1715 is configured to route data generated by raster engine 1725 and DPCs 1720 to a Raster Operations (ROP) unit, described in more detail in conjunction with FIG. 17B. In at least one embodiment, PROP unit 1715 may also be configured to perform optimizations for color blending, organize pixel data, perform address translations, and like.

In at least one embodiment, each DPC 1720 included in GPC 1650 includes an M-Pipe Controller (MPC) 1730, a primitive engine 1735, and one or more SMs 1740. In at least one embodiment, MPC 1730 controls operation of DPC 1720, routing packets received from pipeline manager 1710 to appropriate units in DPC 1720. In at least one embodiment, for example, packets associated with a vertex may be routed to primitive engine 1735, which is configured to fetch vertex attributes associated with vertex from memory 1604. In at least one embodiment, in contrast, packets associated with a shader program may be transmitted to SM 1740.

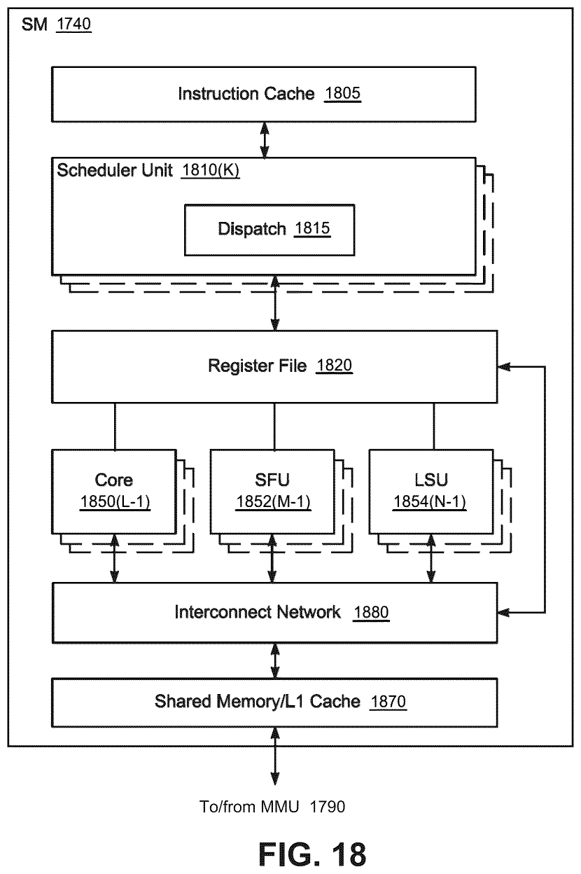

In at least one embodiment, SM 1740 comprises a programmable streaming processor that is configured to process tasks represented by a number of threads. In at least one embodiment, each SM 1740 is multi-threaded and configured to execute a plurality of threads (e.g., 32 threads) from a particular group of threads concurrently. In at least one embodiment, SM 1740 implements a SIMD (Single-Instruction, Multiple-Data) architecture where each thread in a group of threads (e.g., a warp) is configured to process a different set of data based on same set of instructions. In at least one embodiment, all threads in group of threads execute same instructions. In at least one embodiment, SM 1740 implements a SIMT (Single-Instruction, Multiple Thread) architecture where each thread in a group of threads is configured to process a different set of data based on same set of instructions, but where individual threads in group of threads are allowed to diverge during execution. In at least one embodiment, a program counter, call stack, and execution state is maintained for each warp, enabling concurrency between warps and serial execution within warps when threads within warp diverge. In at least one embodiment, a program counter, call stack, and execution state is maintained for each individual thread, enabling equal concurrency between all threads, within and between warps. In at least one embodiment, when execution state is maintained for each individual thread, threads executing same instructions may be converged and executed in parallel for maximum efficiency. In at least one embodiment, SM 1740 is described in more detail below in conjunction with FIG. 18A.

In at least one embodiment, MMU 1790 provides an interface between GPC 1650 and partition unit 1680. In at least one embodiment, MMU 1790 may provide translation of virtual addresses into physical addresses, memory protection, and arbitration of memory requests. In at least one embodiment, MMU 1790 provides one or more translation lookaside buffers (TLBs) for performing translation of virtual addresses into physical addresses in memory 1604.

FIG. 17B illustrates a memory partition unit 1680 of PPU 1600 of FIG. 16, according to at least one embodiment. In at least one embodiment, as shown in FIG. 17B, memory partition unit 1680 includes a Raster Operations (ROP) unit 1750, a level two (L2) cache 1760, and a memory interface 1770. In at least one embodiment, memory interface 1770 is coupled to memory 1604. In at least one embodiment, memory interface 1770 may implement 32, 64, 128, 1024-bit data buses, or like, for high-speed data transfer. In at least one embodiment, PPU 1600 incorporates U memory interfaces 1770, one memory interface 1770 per pair of partition units 1680, where each pair of partition units 1680 is connected to a corresponding memory device 1604. In at least one embodiment, for example, PPU 1600 may be connected to up to Y memory devices 1604, such as high bandwidth memory stacks or graphics double-data-rate, version 5, synchronous dynamic random access memory, or other types of persistent storage.

In at least one embodiment, memory interface 1770 implements an HBM2 memory interface and Y equals half U. In at least one embodiment, in an embodiment, HBM2 memory stacks are located on same physical package as PPU 1600, providing substantial power and area savings compared with conventional GDDR5 SDRAM systems. In at least one embodiment, each HBM2 stack includes four memory dies and Y equals 4, with HBM2 stack including two 128-bit channels per die for a total of 8 channels and a data bus width of 1024 bits.

In at least one embodiment, memory 1604 supports Single-Error Correcting Double-Error Detecting (SECDED) Error Correction Code (ECC) to protect data. In at least one embodiment, ECC provides higher reliability for compute applications that are sensitive to data corruption. In at least one embodiment, reliability is especially important in large-scale cluster computing environments where PPUs 1600 process very large datasets and/or run applications for extended periods.

In at least one embodiment, PPU 1600 implements a multi-level memory hierarchy. In at least one embodiment, memory partition unit 1680 supports a unified memory to provide a single unified virtual address space for CPU and PPU 900 memory, enabling data sharing between virtual memory systems. In at least one embodiment, frequency of accesses by a PPU 1600 to memory located on other processors is traced to ensure that memory pages are moved to physical memory of PPU 1600 that is accessing pages more frequently. In at least one embodiment, NVLink 1610 supports address translation services allowing PPU 1600 to directly access a CPU's page tables and providing full access to CPU memory by PPU 1600.

In at least one embodiment, copy engines transfer data between multiple PPUs 1600 or between PPUs 1600 and CPUs. In at least one embodiment, copy engines can generate page faults for addresses that are not mapped into page tables. In at least one embodiment, memory partition unit 1680 can then service page faults, mapping addresses into page table, after which copy engine can perform transfer. In at least one embodiment, with hardware page faulting, addresses can be passed to copy engines without worrying if memory pages are resident, and copy process is transparent.

In at least one embodiment, data from memory 1604 or other system memory may be fetched by memory partition unit 1680 and stored in L2 cache 1760, which is located on-chip and is shared between various GPCs 1650. In at least one embodiment, as shown, each memory partition unit 1680 includes a portion of L2 cache 1760 associated with a corresponding memory device 1604. In at least one embodiment, lower level caches may then be implemented in various units within GPCs 1650. In at least one embodiment, for example, each of SMs 1740 may implement a level one (L1) cache. In at least one embodiment, L1 cache is private memory that is dedicated to a particular SM 1740. In at least one embodiment, data from L2 cache 1760 may be fetched and stored in each of L1 caches for processing in functional units of SMs 1740. In at least one embodiment, L2 cache 1760 is coupled to memory interface 1770 and XBar 1670.

In at least one embodiment, ROP unit 1750 performs graphics raster operations related to pixel color, such as color compression, pixel blending, and like. In at least one embodiment, ROP unit 1050 also implements depth testing in conjunction with raster engine 1725, receiving a depth for a sample location associated with a pixel fragment from culling engine of raster engine 1725. In at least one embodiment, depth is tested against a corresponding depth in a depth buffer for a sample location associated with fragment. In at least one embodiment, if fragment passes depth test for sample location, then ROP unit 1750 updates depth buffer and transmits a result of depth test to raster engine 1725. In at least one embodiment, it will be appreciated that number of partition units 1680 may be different than number of GPCs 1650 and, therefore, each ROP unit 1750 may be coupled to each of GPCs 1650. In at least one embodiment, ROP unit 1750 tracks packets received from different GPCs 1650 and determines which GPC 1650 that a result generated by ROP unit 1750 is routed to through Xbar 1670. In at least one embodiment, although ROP unit 1750 is included within memory partition unit 1680 in FIG. 17B, in at least one embodiment, ROP unit 1750 may be outside of memory partition unit 1680. In at least one embodiment, for example, ROP unit 1750 may reside in GPC 1650 or another unit.

FIG. 18 illustrates streaming multiprocessor 1740 of FIG. 17A, according to at least one embodiment. In at least one embodiment, as shown in FIG. 18, SM 1740 includes an instruction cache 1805, one or more scheduler units 1810, a register file 1820, one or more processing cores 1850, one or more special function units (SFUs) 1852, one or more load/store units (LSUs) 1854, an interconnect network 1880, a shared memory/L1 cache 1870.

In at least one embodiment, work distribution unit 1625 dispatches tasks for execution on GPCs 1650 of PPU 1600. In at least one embodiment, tasks are allocated to a particular DPC 1720 within a GPC 1650 and, if task is associated with a shader program, task may be allocated to an SM 1740. In at least one embodiment, scheduler unit 1810 receives tasks from work distribution unit 1625 and manages instruction scheduling for one or more thread blocks assigned to SM 1740. In at least one embodiment, scheduler unit 1810 schedules thread blocks for execution as warps of parallel threads, where each thread block is allocated at least one warp. In at least one embodiment, each warp executes 32 threads. In at least one embodiment, scheduler unit 1810 may manage a plurality of different thread blocks, allocating warps to different thread blocks and then dispatching instructions from plurality of different cooperative groups to various functional units (e.g., cores 1850, SFUs 1852, and LSUs 1854) during each clock cycle.

In at least one embodiment, Cooperative Groups is a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms.

In at least one embodiment, Cooperative Groups enables programmers to define groups of threads explicitly at sub-block (e.g., as small as a single thread) and multi-block granularities, and to perform collective operations such as synchronization on threads in a cooperative group. In at least one embodiment, programming model supports clean composition across software boundaries, so that libraries and utility functions can synchronize safely within their local context without having to make assumptions about convergence. In at least one embodiment, cooperative Groups primitives enable new patterns of cooperative parallelism, including producer-consumer parallelism, opportunistic parallelism, and global synchronization across an entire grid of thread blocks. In at least one embodiment, hierarchical grouping of threads such as cooperating thread arrays (CTA) and cooperating group arrays (CGA) according to some embodiments are described in more detail in U.S. application Ser. No. ______ (20-AU-0519 “CGAs . . . for strong scaling”) filed on ______, entire content of which is hereby incorporated by reference in its entirety.

In at least one embodiment, a dispatch unit 1815 is configured to transmit instructions to one or more of functional units. In at least one embodiment, scheduler unit 1810 includes two dispatch units 1815 that enable two different instructions from same warp to be dispatched during each clock cycle. In at least one embodiment, each scheduler unit 1810 may include a single dispatch unit 1815 or additional dispatch units 1815.

In at least one embodiment, each SM 1740 includes a register file 1820 that provides a set of registers for functional units of SM 1740. In at least one embodiment, register file 1820 is divided between each of functional units such that each functional unit is allocated a dedicated portion of register file 1820. In at least one embodiment, register file 1820 is divided between different warps being executed by SM 1740. In at least one embodiment, register file 1820 provides temporary storage for operands connected to data paths of functional units.

In at least one embodiment, each SM 1740 comprises multiple processing cores 1850. In at least one embodiment, SM 1740 includes a large number (e.g., 128, etc.) of distinct processing cores 1850. In at least one embodiment, each core 1850 may include a fully-pipelined, single-precision, double-precision, and/or mixed precision processing unit that includes a floating point arithmetic logic unit and an integer arithmetic logic unit. In at least one embodiment, floating point arithmetic logic units implement IEEE 754-2008 standard for floating point arithmetic. In at least one embodiment, cores 1850 include 64 single-precision (32-bit) floating point cores, 64 integer cores, 32 double-precision (64-bit) floating point cores, and 8 tensor cores.

In at least one embodiment, tensor cores are configured to perform matrix operations, and, in an embodiment, one or more tensor cores are included in cores 1850. In at least one embodiment, in particular, tensor cores are configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

In at least one embodiment, matrix multiply inputs A and B are 16-bit floating point matrices, while accumulation matrices C and D may be 16-bit floating point or 32-bit floating point matrices. In at least one embodiment, tensor cores operate on 16-bit floating point input data with 32-bit floating point accumulation. In at least one embodiment, 16-bit floating point multiply requires 64 operations and results in a full precision product that is then accumulated using 32-bit floating point addition with other intermediate products for a 4×4×4 matrix multiply. In at least one embodiment, in practice, tensor cores are used to perform much larger two-dimensional or higher dimensional matrix operations, built up from these smaller elements. In at least one embodiment, an API, such as CUDA C++ API, exposes specialized matrix load, matrix multiply and accumulate, and matrix store operations to efficiently use Tensor cores from a CUDA-C++ program. In at least one embodiment, at CUDA level, warp-level interface assumes 16×16 size matrices spanning all 32 threads of warp.

In at least one embodiment, transposition hardware is included in processing cores 1850 or another functional unit (e.g., SFUs 1852 or LSUs 1854) and is configured to generate matrix data stored by diagonals and/or generate original matrix and/or transposed matrix from matrix data stored by diagonals. In at least one embodiment, transposition hardware may be provide inside of shared memory 1870 to register file 1820 load path of SM 1740.

In at least one embodiment, matrix data stored by diagonals may be fetched from DRAM and stored in shared memory 1870. In at least one embodiment, as instruction to perform processing using matrix data stored by diagonals is processed, transposition hardware disposed in path of shared memory 1870 and register file 1820 may provide original matrix, transposed matrix, compacted original matrix, and/or compacted transposed matrix. In at least one embodiment, up until very last storage prior to instruction, single matrix data stored by diagonals may be maintained, and matrix type designated by instruction is generated as needed in register file 1820.

In at least one embodiment, each SM 1740 also comprises multiple SFUs 1852 that perform special functions (e.g., attribute evaluation, reciprocal square root, and like). In at least one embodiment, SFUs 1852 may include a tree traversal unit (e.g., TTU 1743) configured to traverse a hierarchical tree data structure. In at least one embodiment, SFUs 1852 may include texture unit (e.g., Texture Unit 1742) configured to perform texture map filtering operations. In at least one embodiment, texture units are configured to load texture maps (e.g., a 2D array of texels) from memory 1604 and sample texture maps to produce sampled texture values for use in shader programs executed by SM 1740. In at least one embodiment, texture maps are stored in shared memory/L1 cache 1770. In at least one embodiment, texture units implement texture operations such as filtering operations using mip-maps (e.g., texture maps of varying levels of detail). In at least one embodiment, each SM 1740 includes two texture units.

In at least one embodiment, each SM 1740 also comprises multiple LSUs 1854 that implement load and store operations between shared memory/L1 cache 1870 and register file 1820. In at least one embodiment, each SM 1740 includes an interconnect network 1880 that connects each of functional units to register file 1820 and LSU 1854 to register file 1820, shared memory/L1 cache 1870. In at least one embodiment, interconnect network 1880 is a crossbar that can be configured to connect any of functional units to any of registers in register file 1820 and connect LSUs 1854 to register file 1820 and memory locations in shared memory/L1 cache 1870. In at least one embodiment, LSUs 1854 include a TMAU 712. In at least one embodiment, however, in, TMAU 712 may be separate from LSU. In at least one embodiment, each TMAU 712 may be closely coupled on a single SM or to more than one SM. In at least one embodiment, in embodiments in which TMAU 712 is closely coupled to multiple SMs, an arbiter may receive requests from SMs and forward them serially to TMAU 712.

In at least one embodiment, shared memory/L1 cache 1870 is an array of on-chip memory that allows for data storage and communication between SM 1740 and primitive engine 1735 and between threads in SM 1740. In at least one embodiment, shared memory/L1 cache 1870 comprises 128 KB of storage capacity and is in path from SM 1740 to partition unit 1680. In at least one embodiment, shared memory/L1 cache 1870 can be used to cache reads and writes. In at least one embodiment, one or more of shared memory/L1 cache 1870, L2 cache 1760, and memory 1604 are backing stores.

In at least one embodiment, combining data cache and shared memory functionality into a single memory block provides best overall performance for both types of memory accesses. In at least one embodiment, capacity is usable as a cache by programs that do not use shared memory. In at least one embodiment, for example, if shared memory is configured to use half of capacity, texture and load/store operations can use remaining capacity. In at least one embodiment, integration within shared memory/L1 cache 1870 enables shared memory/L1 cache 1870 to function as a high-throughput conduit for streaming data while simultaneously providing high-bandwidth and low-latency access to frequently reused data.

In at least one embodiment, in context of this disclosure, an SM or “streaming multiprocessor” means a processor architected as described in U.S. Pat. No. 7,447,873 to Nordquist including improvements thereto and advancements thereof, and as implemented for example in many generations of NVIDIA GPUs. In at least one embodiment, for example, an SM may comprise a plurality of processing engines or cores configured to concurrently execute a plurality of threads arranged in a plurality of single-instruction, multiple-data (SIMD) groups (e.g., warps), wherein each of threads in a same one of SIMD groups executes a same data processing program comprising a sequence of instructions on a different input object, and different threads in same one of SIMD group are executed using different ones of processing engines or cores. In at least one embodiment, an SM may typically also provide (a) a local register file having plural lanes, wherein each processing engine or core is configured to access a different subset of lanes; and instruction issue logic configured to select one of SIMD groups and to issue one of instructions of same data processing program to each of plurality of processing engines in parallel, wherein each processing engine executes same instruction in parallel with each other processing engine using subset of local register file lanes accessible thereto. In at least one embodiment, an SM typically further includes core interface logic configured to initiate execution of one or more SIMD groups. In at least one embodiment, as shown in figures, such SMs have been constructed to provide fast local shared memory enabling data sharing/reuse and synchronization between all threads of a CTA executing on SM.

In at least one embodiment, when configured for general purpose parallel computation, a simpler configuration can be used compared with graphics processing. In at least one embodiment, specifically, fixed function graphics processing units shown in FIG. 17A, are bypassed, creating a much simpler programming model. In at least one embodiment, in general purpose parallel computation configuration, work distribution unit 1625 assigns and distributes blocks of threads directly to DPCs 1720. In at least one embodiment, threads in a block execute same program, using a unique thread ID in calculation to ensure each thread generates unique results, using SM 1740 to execute program and perform calculations, shared memory/L1 cache 1870 to communicate between threads, and LSU 1854 to read and write global memory through shared memory/L1 cache 1870 and memory partition unit 1680. In at least one embodiment, when configured for general purpose parallel computation, SM 1740 can also write commands that scheduler unit 1620 can use to launch new work on DPCs 1720.

In at least one embodiment, PPU 1600 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and like. In at least one embodiment, PPU 1600 is embodied on a single semiconductor substrate. In at least one embodiment, PPU 1600 is included in a system-on-a-chip (SoC) along with one or more other devices such as additional PPUs 1600, memory 1604, a reduced instruction set computer (RISC) CPU, a memory management unit (MMU), a digital-to-analog converter (DAC), and like.

In at least one embodiment, PPU 1600 may be included on a graphics card that includes one or more memory devices 1604. In at least one embodiment, graphics card may be configured to interface with a PCIe slot on a motherboard of a desktop computer. In at least one embodiment, PPU 1600 may be an integrated graphics processing unit (iGPU) or parallel processor included in chipset of motherboard.

### Exemplary Computing System

In at least one embodiment, systems with multiple GPUs and CPUs are used in a variety of industries as developers expose and leverage more parallelism in applications such as artificial intelligence computing. In at least one embodiment, high-performance GPU-accelerated systems with tens to many thousands of compute nodes are deployed in data centers, research facilities, and supercomputers to solve ever larger problems. In at least one embodiment, as number of processing devices within high-performance systems increases, communication and data transfer mechanisms need to scale to support increased bandwidth.

FIG. 19A is a conceptual diagram of a processing system 1900 implemented using PPU 1600 of FIG. 16, according to at least one embodiment. In at least one embodiment, exemplary system 1900 may be configured to implement one or more aspects shown and/or described with respect to one or more components, techniques and/or methods (e.g., TMAU in FIG. 7, 8, 12 or 17A). In at least one embodiment, processing system 1900 includes a CPU 1930, switch 1955, and multiple PPUs 1600 each and respective memories 1604. In at least one embodiment, NVLink 1610 provides high-speed communication links between each of PPUs 1600. In at least one embodiment, although a particular number of NVLink 1610 and interconnect 1602 connections are illustrated in FIG. 19A, number of connections to each PPU 1600 and CPU 1930 may vary. In at least one embodiment, switch 1955 interfaces between interconnect 1602 and CPU 1930. In at least one embodiment, PPUs 1600, memories 1604, and NVLinks 1610 may be situated on a single semiconductor platform to form a parallel processing module 1925. In at least one embodiment, in an embodiment, switch 1955 supports two or more protocols to interface between various different connections and/or links.

In at least one embodiment (not shown for clarity), NVLink 1610 provides one or more high-speed communication links between each of PPUs 1600 and CPU 1930 and switch 1955 interfaces between interconnect 1602 and each of PPUs 1600. In at least one embodiment, PPUs 1600, memories 1604, and interconnect 1602 may be situated on a single semiconductor platform to form a parallel processing module 1925. In at least one embodiment, (not shown for clarity), interconnect 1602 provides one or more communication links between each of PPUs 1600 and CPU 1930 and switch 1955 interfaces between each of PPUs 1600 using NVLink 1610 to provide one or more high-speed communication links between PPUs 1600. In at least one embodiment, (not shown for clarity), NVLink 1610 provides one or more high-speed communication links between PPUs 1600 and CPU 1930 through switch 1955. In at least one embodiment, (not shown for clarity), interconnect 1602 provides one or more communication links between each of PPUs 1600 directly. In at least one embodiment, one or more of NVLink 1610 high-speed communication links may be implemented as a physical NVLink interconnect or either an on-chip or on-die interconnect using same protocol as NVLink 1610.

In at least one embodiment, in context of present description, a single semiconductor platform may refer to a sole unitary semiconductor-based integrated circuit fabricated on a die or chip. In at least one embodiment, it should be noted that term single semiconductor platform may also refer to multi-chip modules with increased connectivity which simulate on-chip operation and make substantial improvements over utilizing a conventional bus implementation. In at least one embodiment, of course, various circuits or devices may also be situated separately or in various combinations of semiconductor platforms per desires of user. In at least one embodiment, alternately, parallel processing module 1925 may be implemented as a circuit board substrate and each of PPUs 1600 and/or memories 1604 may be packaged devices. In at least one embodiment, CPU 1930, switch 1955, and parallel processing module 1925 are situated on a single semiconductor platform.

In at least one embodiment, signaling rate of each NVLink 1610 is 20 to 25 Gigabits/second and each PPU 1600 includes six NVLink 1610 interfaces (as shown in FIG. 19A, five NVLink 1610 interfaces are included for each PPU 1600). In at least one embodiment, each NVLink 1610 provides a data transfer rate of 25 Gigabytes/second in each direction, with six links providing 1600 Gigabytes/second. In at least one embodiment, NVLinks 1610 can be used exclusively for PPU-to-PPU communication as shown in FIG. 19A, or some combination of PPU-to-PPU and PPU-to-CPU, when CPU 1930 also includes one or more NVLink 1610 interfaces.

In at least one embodiment, NVLink 1610 allows direct load/store/atomic access from CPU 1930 to each PPU's 1600 memory 1604. In at least one embodiment, NVLink 1610 supports coherency operations, allowing data read from memories 1604 to be stored in cache hierarchy of CPU 1930, reducing cache access latency for CPU 1930. In at least one embodiment, NVLink 1610 includes support for Address Translation Services (ATS), allowing PPU 1600 to directly access page tables within CPU 1930. In at least one embodiment, one or more of NVLinks 1610 may also be configured to operate in a low-power mode.

FIG. 19B illustrates an exemplary system 1965 in which various architecture and/or functionality of various previous embodiments may be implemented, according to at least one embodiment. In at least one embodiment, exemplary system 1965 may be configured to implement one or more aspects of one or more components, techniques, and/or methods disclosed in this application (e.g., TMAU in FIG. 7, 8, 12 or 17A).

In at least one embodiment, as shown, a system 1965 is provided including at least one central processing unit 1930 that is connected to a communication bus 1975. In at least one embodiment, communication bus 1975 may be implemented using any suitable protocol, such as PCI (Peripheral Component Interconnect), PCI-Express, AGP (Accelerated Graphics Port), HyperTransport, or any other bus or point-to-point communication protocol(s). In at least one embodiment, system 1965 also includes a main memory 1940. In at least one embodiment, control logic (software) and data are stored in main memory 1940 which may take form of random access memory (RAM).

In at least one embodiment, system 1965 also includes input devices 1960, parallel processing system 1925, and display devices 1945, e.g. a conventional CRT (cathode ray tube), LCD (liquid crystal display), LED (light emitting diode), plasma display or like. In at least one embodiment, user input may be received from input devices 1960, e.g., keyboard, mouse, touchpad, microphone, and like. In at least one embodiment, each of foregoing modules and/or devices may even be situated on a single semiconductor platform to form system 1965. In at least one embodiment, alternately, various modules may also be situated separately or in various combinations of semiconductor platforms per desires of user.

In at least one embodiment, system 1965 may be coupled to a network (e.g., a telecommunications network, local area network (LAN), wireless network, wide area network (WAN) such as Internet, peer-to-peer network, cable network, or like) through a network interface 1935 for communication purposes.

In at least one embodiment, system 1965 may also include a secondary storage (not shown for clarity). In at least one embodiment, secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. In at least one embodiment, removable storage drive reads from and/or writes to a removable storage unit.

In at least one embodiment, computer programs, or computer control logic algorithms, may be stored in main memory 1940 and/or secondary storage. In at least one embodiment, computer programs, when executed, enable system 1965 to perform various functions. In at least one embodiment, memory 1940, storage, and/or any other storage are possible examples of computer-readable media.

In at least one embodiment, architecture and/or functionality of various previous figures may be implemented in context of a general computer system, a circuit board system, a game console system dedicated for entertainment purposes, an application-specific system, and/or any other desired system. In at least one embodiment, for example, system 1965 may take form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

In at least one embodiment, an application program may be implemented via an application executed by a host processor, such as a CPU. In at least one embodiment, in an embodiment, a device driver may implement an application programming interface (API) that defines various functions that can be utilized by application program in order to generate graphical data for display. In at least one embodiment, device driver is a software program that includes a plurality of instructions that control operation of PPU 1600. In at least one embodiment, API provides an abstraction for a programmer that lets a programmer utilize specialized graphics hardware, such as PPU 1600, to generate graphical data without requiring programmer to utilize specific instruction set for PPU 1600. In at least one embodiment, application may include an API call that is routed to device driver for PPU 1600. In at least one embodiment, device driver interprets API call and performs various operations to respond to API call. In at least one embodiment, in some instances, device driver may perform operations by executing instructions on CPU. In at least one embodiment, in other instances, device driver may perform operations, at least in part, by launching operations on PPU 1600 utilizing an input/output interface between CPU and PPU 1600. In at least one embodiment, device driver is configured to implement graphics processing pipeline 2000 utilizing hardware of PPU 1600.

In at least one embodiment, various programs may be executed within PPU 1600 in order to implement various stages of processing for application program. In at least one embodiment, for example, device driver may launch a kernel on PPU 1600 to perform one stage of processing on one SM 1740 (or multiple SMs 1740). In at least one embodiment, device driver (or initial kernel executed by PPU 1600) may also launch other kernels on PPU 1600 to perform other stages of processing. In at least one embodiment, if application program processing includes a graphics processing pipeline, then some of stages of graphics processing pipeline may be implemented on fixed unit hardware such as a rasterizer or a data assembler implemented within PPU 1600. In at least one embodiment, it will be appreciated that results from one kernel may be processed by one or more intervening fixed function hardware units before being processed by a subsequent kernel on an SM 1740.

All patents and printed publications referred to above are incorporated by reference herein as if expressly set forth. In at least one embodiment, following paragraphs describe additional systems, processors, and other computer hardware that, in addition to systems and processors described above, in at least one embodiment, perform an API and/or instruction, such as described above or, generally, an API and/or instruction to prefetch tensor data, such as a tensor map, into a cache of a GPU such as any of caches described above where, in at least one embodiment, API and/or instruction indicates cache into which tensor data is to be stored.

### Data Center

The following figure sets forth, without limitation, exemplary data center systems that can be used to implement at least one embodiment. In at least one embodiment, one or more data center components of following figure can implement one or more aspects of an embodiment described with respect to one or more of FIGS. 1-19B. In at least one embodiment, one or more data center components include one or more components of computing device 102 of FIG. 1 (e.g., CPU 104, PPU 106, asynchronous data movement H/W 114, cache 116, and/or API 108). In at least one embodiment, one or more data center components include one or more components of computer system 202 of FIG. 2 (e.g., processor 204, GPU 210, asynchronous data movement H/W 222, cache 224, set of APIs 232, prefetch tensor map API 234, set of instructions 246, prefetch tensor map instruction 248, and/or one or more components of set of nodes 258). In at least one embodiment, one or more data center components perform one or more aspects of API 300 of FIG. 3 and/or one or more aspects of technique 400 of FIG. 4. In at least one embodiment, one or more data center components include processor 500 of FIG. 5 and/or one or more modules shown or described with respect to FIG. 5. In at least one embodiment, one or more data center components include and/or perform one or more aspects of environment 600 of FIG. 6 (e.g., drivers and/or runtimes 604, one or more APIs 610, and/or one or more functions of functions 612).

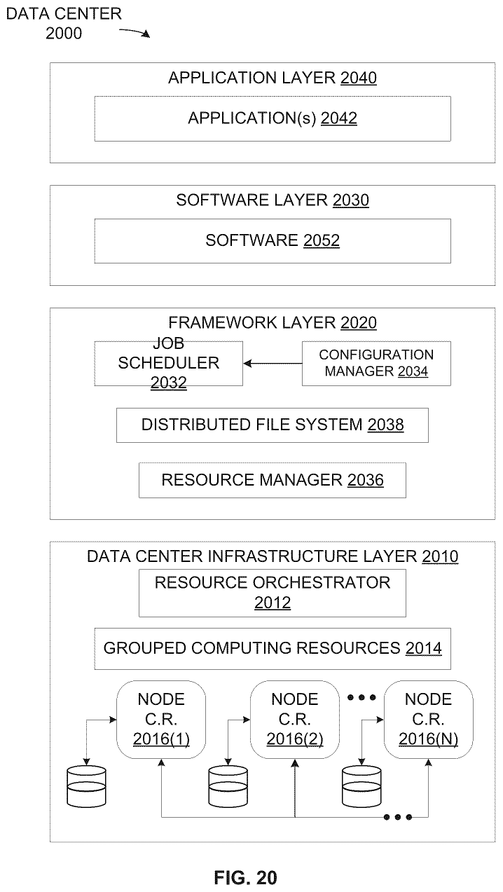

FIG. 20 illustrates an exemplary data center 2000, in accordance with at least one embodiment. In at least one embodiment, data center 2000 includes, without limitation, a data center infrastructure layer 2010, a framework layer 2020, a software layer 2030 and an application layer 2040.

In at least one embodiment, as shown in FIG. 20, data center infrastructure layer 2010 may include a resource orchestrator 2012, grouped computing resources 2014, and node computing resources (“node C.R.s”) 2016(1)-2016(N), where “N” represents any whole, positive integer. In at least one embodiment, node C.R.s 2016(1)-2016(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 2016(1)-2016(N) may be a server having one or more of above-mentioned computing resources.

In at least one embodiment, grouped computing resources 2014 may include separate groupings of node C.R.s housed within one or more racks (not shown), or many racks housed in data centers at various geographical locations (also not shown). Separate groupings of node C.R.s within grouped computing resources 2014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 2012 may configure or otherwise control one or more node C.R.s 2016(1)-2016(N) and/or grouped computing resources 2014. In at least one embodiment, resource orchestrator 2012 may include a software design infrastructure (“SDI”) management entity for data center 2000. In at least one embodiment, resource orchestrator 2012 may include hardware, software or some combination thereof.

In at least one embodiment, as shown in FIG. 20, framework layer 2020 includes, without limitation, a job scheduler 2032, a configuration manager 2034, a resource manager 2036 and a distributed file system 2038. In at least one embodiment, framework layer 2020 may include a framework to support software 2052 of software layer 2030 and/or one or more application(s) 2042 of application layer 2040. In at least one embodiment, software 2052 or application(s) 2042 may respectively include web-based service software or applications, such as those provided by Amazon Web Services, Google Cloud and Microsoft Azure. In at least one embodiment, framework layer 2020 may be, but is not limited to, a type of free and open-source software web application framework such as Apache Spark™ (hereinafter “Spark”) that may utilize distributed file system 2038 for large-scale data processing (e.g., “big data”). In at least one embodiment, job scheduler 2032 may include a Spark driver to facilitate scheduling of workloads supported by various layers of data center 2000. In at least one embodiment, configuration manager 2034 may be capable of configuring different layers such as software layer 2030 and framework layer 2020, including Spark and distributed file system 2038 for supporting large-scale data processing. In at least one embodiment, resource manager 2036 may be capable of managing clustered or grouped computing resources mapped to or allocated for support of distributed file system 2038 and job scheduler 2032. In at least one embodiment, clustered or grouped computing resources may include grouped computing resource 2014 at data center infrastructure layer 2010. In at least one embodiment, resource manager 2036 may coordinate with resource orchestrator 2012 to manage these mapped or allocated computing resources.

In at least one embodiment, software 2052 included in software layer 2030 may include software used by at least portions of node C.R.s 2016(1)-2016(N), grouped computing resources 2014, and/or distributed file system 2038 of framework layer 2020. One or more types of software may include, but are not limited to, Internet web page search software, e-mail virus scan software, database software, and streaming video content software.

In at least one embodiment, application(s) 2042 included in application layer 2040 may include one or more types of applications used by at least portions of node C.R.s 2016(1)-2016(N), grouped computing resources 2014, and/or distributed file system 2038 of framework layer 2020. In at least one or more types of applications may include, without limitation, CUDA applications.

In at least one embodiment, any of configuration manager 2034, resource manager 2036, and resource orchestrator 2012 may implement any number and type of self-modifying actions based on any amount and type of data acquired in any technically feasible fashion. In at least one embodiment, self-modifying actions may relieve a data center operator of data center 2000 from making possibly bad configuration decisions and possibly avoiding underutilized and/or poor performing portions of a data center.

### Computer-Based Systems

The following figures set forth, without limitation, exemplary computer-based systems that can be used to implement at least one embodiment. In at least one embodiment, one or more computer-based systems of following figures implement one or more aspects of one or more embodiments described with respect to one or more of FIGS. 1-19B. In at least one embodiment, one or more computer-based systems include one or more components of computing device 102 of FIG. 1 (e.g., CPU 104, PPU 106, asynchronous data movement H/W 114, cache 116, and/or API 108). In at least one embodiment, one or more computer-based systems include one or more components of computer system 202 of FIG. 2 (e.g., processor 204, GPU 210, asynchronous data movement H/W 222, cache 224, set of APIs 232, prefetch tensor map API 234, set of instructions 246, prefetch tensor map instruction 248, and/or one or more components of set of nodes 258). In at least one embodiment, one or more computer-based systems perform one or more aspects of API 300 of FIG. 3 and/or one or more aspects of technique 400 of FIG. 4. In at least one embodiment, one or more computer-based systems include processor 500 of FIG. 5 and/or one or more modules shown or described with respect to FIG. 5. In at least one embodiment, one or more computer-based systems include and/or perform one or more aspects of environment 600 of FIG. 6 (e.g., drivers and/or runtimes 604, one or more APIs 610, and/or one or more functions of functions 612).

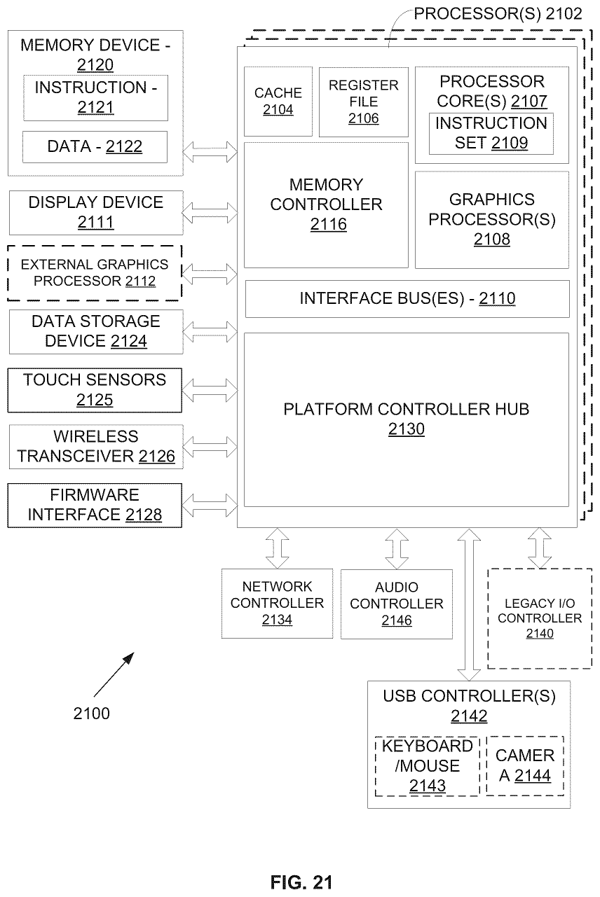

FIG. 21 illustrates a processing system 2100, in accordance with at least one embodiment. In at least one embodiment, processing system 2100 includes one or more processors 2102 and one or more graphics processors 2108, and may be a single processor desktop system, a multiprocessor workstation system, or a server system having a large number of processors 2102 or processor cores 2107. In at least one embodiment, processing system 2100 is a processing platform incorporated within a system-on-a-chip (“SoC”) integrated circuit for use in mobile, handheld, or embedded devices. In at least one embodiment, a processors core 2107 is referred to as a computing unit or compute unit.

In at least one embodiment, processing system 2100 can include, or be incorporated within a server-based gaming platform, a game console, a media console, a mobile gaming console, a handheld game console, or an online game console. In at least one embodiment, processing system 2100 is a mobile phone, smart phone, tablet computing device or mobile Internet device. In at least one embodiment, processing system 2100 can also include, couple with, or be integrated within a wearable device, such as a smart watch wearable device, smart eyewear device, augmented reality device, or virtual reality device. In at least one embodiment, processing system 2100 is a television or set top box device having one or more processors 2102 and a graphical interface generated by one or more graphics processors 2108.

In at least one embodiment, one or more processors 2102 each include one or more processor cores 2107 to process instructions which, when executed, perform operations for system and user software. In at least one embodiment, each of one or more processor cores 2107 is configured to process a specific instruction set 2109. In at least one embodiment, instruction set 2109 may facilitate Complex Instruction Set Computing (“CISC”), Reduced Instruction Set Computing (“RISC”), or computing via a Very Long Instruction Word (“VLIW”). In at least one embodiment, processor cores 2107 may each process a different instruction set 2109, which may include instructions to facilitate emulation of other instruction sets. In at least one embodiment, processor core 2107 may also include other processing devices, such as a digital signal processor (“DSP”).

In at least one embodiment, processor 2102 includes cache memory (‘cache”) 2104. In at least one embodiment, processor 2102 can have a single internal cache or multiple levels of internal cache. In at least one embodiment, cache memory is shared among various components of processor 2102. In at least one embodiment, processor 2102 also uses an external cache (e.g., a Level 3 (“L3”) cache or Last Level Cache (“LLC”)) (not shown), which may be shared among processor cores 2107 using known cache coherency techniques. In at least one embodiment, register file 2106 is additionally included in processor 2102 which may include different types of registers for storing different types of data (e.g., integer registers, floating point registers, status registers, and an instruction pointer register). In at least one embodiment, register file 2106 may include general-purpose registers or other registers.

In at least one embodiment, one or more processor(s) 2102 are coupled with one or more interface bus(es) 2110 to transmit communication signals such as address, data, or control signals between processor 2102 and other components in processing system 2100. In at least one embodiment interface bus 2110, in one embodiment, can be a processor bus, such as a version of a Direct Media Interface (“DMI”) bus. In at least one embodiment, interface bus 2110 is not limited to a DMI bus, and may include one or more Peripheral Component Interconnect buses (e.g., “PCI,” PCI Express (“PCIe”)), memory buses, or other types of interface buses. In at least one embodiment processor(s) 2102 include an integrated memory controller 2116 and a platform controller hub 2130. In at least one embodiment, memory controller 2116 facilitates communication between a memory device and other components of processing system 2100, while platform controller hub (“PCH”) 2130 provides connections to Input/Output (“I/O”) devices via a local I/O bus. In at least one embodiment, one or more Peripheral Component Interconnect buses include PCIe Gen 5, which provides an interface for processors.

In at least one embodiment, memory device 2120 can be a dynamic random access memory (“DRAM”) device, a static random access memory (“SRAM”) device, flash memory device, phase-change memory device, or some other memory device having suitable performance to serve as processor memory. In at least one embodiment memory device 2120 can operate as system memory for processing system 2100, to store data 2122 and instructions 2121 for use when one or more processors 2102 executes an application or process. In at least one embodiment, memory controller 2116 also couples with an optional external graphics processor 2112, which may communicate with one or more graphics processors 2108 in processors 2102 to perform graphics and media operations. In at least one embodiment, a display device 2111 can connect to processor(s) 2102. In at least one embodiment display device 2111 can include one or more of an internal display device, as in a mobile electronic device or a laptop device or an external display device attached via a display interface (e.g., DisplayPort, etc.). In at least one embodiment, display device 2111 can include a head mounted display (“HMD”) such as a stereoscopic display device for use in virtual reality (“VR”) applications or augmented reality (“AR”) applications.

In at least one embodiment, platform controller hub 2130 enables peripherals to connect to memory device 2120 and processor 2102 via a high-speed I/O bus. In at least one embodiment, I/O peripherals include, but are not limited to, an audio controller 2146, a network controller 2134, a firmware interface 2128, a wireless transceiver 2126, touch sensors 2125, a data storage device 2124 (e.g., hard disk drive, flash memory, etc.). In at least one embodiment, data storage device 2124 can connect via a storage interface (e.g., SATA) or via a peripheral bus, such as PCI, or PCIe. In at least one embodiment, touch sensors 2125 can include touch screen sensors, pressure sensors, or fingerprint sensors. In at least one embodiment, wireless transceiver 2126 can be a Wi-Fi transceiver, a Bluetooth transceiver, or a mobile network transceiver such as a 3G, 4G, or Long Term Evolution (“LTE”) transceiver. In at least one embodiment, firmware interface 2128 enables communication with system firmware, and can be, for example, a unified extensible firmware interface (“UEFI”). In at least one embodiment, network controller 2134 can enable a network connection to a wired network. In at least one embodiment, a high-performance network controller (not shown) couples with interface bus 2110. In at least one embodiment, audio controller 2146 is a multi-channel high definition audio controller. In at least one embodiment, processing system 2100 includes an optional legacy I/O controller 2140 for coupling legacy (e.g., Personal System 2 (“PS/2”)) devices to processing system 2100. In at least one embodiment, platform controller hub 2130 can also connect to one or more Universal Serial Bus (“USB”) controllers 2142 connect input devices, such as keyboard and mouse 2143 combinations, a camera 2144, or other USB input devices.

In at least one embodiment, an instance of memory controller 2116 and platform controller hub 2130 may be integrated into a discreet external graphics processor, such as external graphics processor 2112. In at least one embodiment, platform controller hub 2130 and/or memory controller 2116 may be external to one or more processor(s) 2102. For example, in at least one embodiment, processing system 2100 can include an external memory controller 2116 and platform controller hub 2130, which may be configured as a memory controller hub and peripheral controller hub within a system chipset that is in communication with processor(s) 2102.

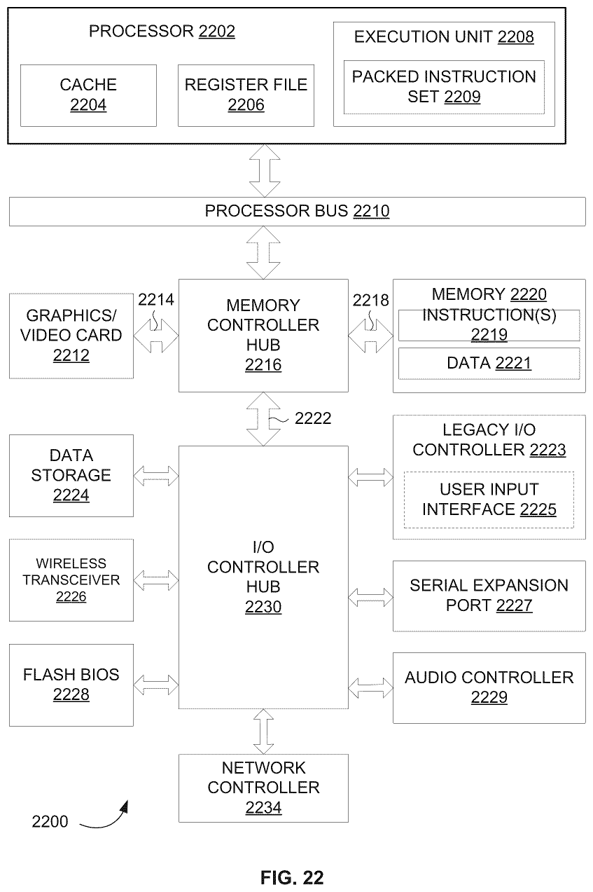

FIG. 22 illustrates a computer system 2200, in accordance with at least one embodiment. In at least one embodiment, computer system 2200 may be a system with interconnected devices and components, an SOC, or some combination. In at least on embodiment, computer system 2200 is formed with a processor 2202 that may include execution units to execute an instruction. In at least one embodiment, computer system 2200 may include, without limitation, a component, such as processor 2202 to employ execution units including logic to perform algorithms for processing data. In at least one embodiment, computer system 2200 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 2200 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 2200 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 2200 may include, without limitation, processor 2202 that may include, without limitation, one or more execution units 2208 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 2200 is a single processor desktop or server system. In at least one embodiment, computer system 2200 may be a multiprocessor system. In at least one embodiment, processor 2202 may include, without limitation, a CISC microprocessor, a RISC microprocessor, a VLIW microprocessor, a processor implementing a combination of instruction sets, or any other processor device, such as a digital signal processor, for example. In at least one embodiment, processor 2202 may be coupled to a processor bus 2210 that may transmit data signals between processor 2202 and other components in computer system 2200.

In at least one embodiment, processor 2202 may include, without limitation, a Level 1 (“L1”) internal cache memory (“cache”) 2204. In at least one embodiment, processor 2202 may have a single internal cache or multiple levels of internal cache. In at least one embodiment, cache memory may reside external to processor 2202. In at least one embodiment, processor 2202 may also include a combination of both internal and external caches. In at least one embodiment, a register file 2206 may store different types of data in various registers including, without limitation, integer registers, floating point registers, status registers, and instruction pointer register.

In at least one embodiment, execution unit 2208, including, without limitation, logic to perform integer and floating point operations, also resides in processor 2202. Processor 2202 may also include a microcode (“ucode”) read only memory (“ROM”) that stores microcode for certain macro instructions. In at least one embodiment, execution unit 2208 may include logic to handle a packed instruction set 2209. In at least one embodiment, by including packed instruction set 2209 in an instruction set of a general-purpose processor 2202, along with associated circuitry to execute instructions, operations used by many multimedia applications may be performed using packed data in a general-purpose processor 2202. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 2208 may also be used in microcontrollers, embedded processors, graphics devices, DSPs, and other types of logic circuits. In at least one embodiment, computer system 2200 may include, without limitation, a memory 2220. In at least one embodiment, memory 2220 may be implemented as a DRAM device, an SRAM device, flash memory device, or other memory device. Memory 2220 may store instruction(s) 2219 and/or data 2221 represented by data signals that may be executed by processor 2202.

In at least one embodiment, a system logic chip may be coupled to processor bus 2210 and memory 2220. In at least one embodiment, the system logic chip may include, without limitation, a memory controller hub (“MCH”) 2216, and processor 2202 may communicate with MCH 2216 via processor bus 2210. In at least one embodiment, MCH 2216 may provide a high bandwidth memory path 2218 to memory 2220 for instruction and data storage and for storage of graphics commands, data and textures. In at least one embodiment, MCH 2216 may direct data signals between processor 2202, memory 2220, and other components in computer system 2200 and to bridge data signals between processor bus 2210, memory 2220, and a system I/O 2222. In at least one embodiment, system logic chip may provide a graphics port for coupling to a graphics controller. In at least one embodiment, MCH 2216 may be coupled to memory 2220 through high bandwidth memory path 2218 and graphics/video card 2212 may be coupled to MCH 2216 through an Accelerated Graphics Port (“AGP”) interconnect 2214.

In at least one embodiment, computer system 2200 may use system I/O 2222 that is a proprietary hub interface bus to couple MCH 2216 to I/O controller hub (“ICH”) 2230. In at least one embodiment, ICH 2230 may provide direct connections to some I/O devices via a local I/O bus. In at least one embodiment, local I/O bus may include, without limitation, a high-speed I/O bus for connecting peripherals to memory 2220, a chipset, and processor 2202. Examples may include, without limitation, an audio controller 2229, a firmware hub (“flash BIOS”) 2228, a wireless transceiver 2226, a data storage 2224, a legacy I/O controller 2223 containing a user input interface 2225 and a keyboard interface, a serial expansion port 2227, such as a USB, and a network controller 2234. Data storage 2224 may comprise a hard disk drive, a floppy disk drive, a CD-ROM device, a flash memory device, or other mass storage device.

In at least one embodiment, FIG. 22 illustrates a system, which includes interconnected hardware devices or “chips.” In at least one embodiment, FIG. 22 may illustrate an exemplary SoC. In at least one embodiment, devices illustrated in FIG. 22 may be interconnected with proprietary interconnects, standardized interconnects (e.g., PCIe), or some combination thereof. In at least one embodiment, one or more components of system 2200 are interconnected using compute express link (“CXL”) interconnects.

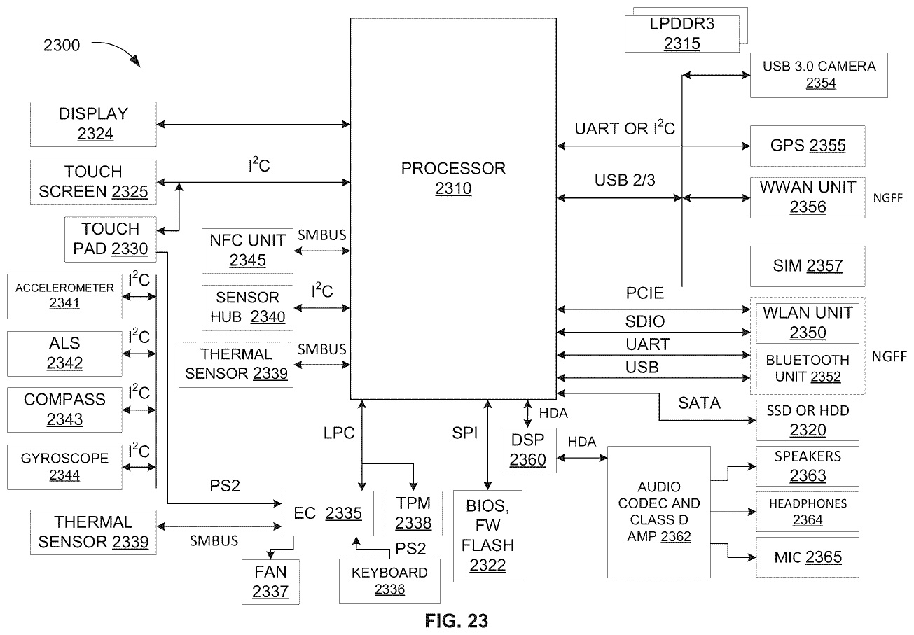

FIG. 23 illustrates a system 2300, in accordance with at least one embodiment. In at least one embodiment, system 2300 is an electronic device that utilizes a processor 2310. In at least one embodiment, system 2300 may be, for example and without limitation, a notebook, a tower server, a rack server, a blade server, an edge device communicatively coupled to one or more on-premise or cloud service providers, a laptop, a desktop, a tablet, a mobile device, a phone, an embedded computer, or any other suitable electronic device.

In at least one embodiment, system 2300 may include, without limitation, processor 2310 communicatively coupled to any suitable number or kind of components, peripherals, modules, or devices. In at least one embodiment, processor 2310 is coupled using a bus or interface, such as an I²C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 23 illustrates a system which includes interconnected hardware devices or “chips.” In at least one embodiment, FIG. 23 may illustrate an exemplary SoC. In at least one embodiment, devices illustrated in FIG. 23 may be interconnected with proprietary interconnects, standardized interconnects (e.g., PCIe) or some combination thereof. In at least one embodiment, one or more components of FIG. 23 are interconnected using CXL interconnects.

In at least one embodiment, FIG. 23 may include a display 2324, a touch screen 2325, a touch pad 2330, a Near Field Communications unit (“NFC”) 2345, a sensor hub 2340, a thermal sensor 2346, an Express Chipset (“EC”) 2335, a Trusted Platform Module (“TPM”) 2338, BIOS/firmware/flash memory (“BIOS, FW Flash”) 2322, a DSP 2360, a Solid State Disk (“SSD”) or Hard Disk Drive (“HDD”) 2320, a wireless local area network unit (“WLAN”) 2350, a Bluetooth unit 2352, a Wireless Wide Area Network unit (“WWAN”) 2356, a Global Positioning System (“GPS”) 2355, a camera (“USB 3.0 camera”) 2354 such as a USB 3.0 camera, or a Low Power Double Data Rate (“LPDDR”) memory unit (“LPDDR3”) 2315 implemented in, for example, LPDDR3 standard. These components may each be implemented in any suitable manner.

In at least one embodiment, other components may be communicatively coupled to processor 2310 through components discussed above. In at least one embodiment, an accelerometer 2341, an Ambient Light Sensor (“ALS”) 2342, a compass 2343, and a gyroscope 2344 may be communicatively coupled to sensor hub 2340. In at least one embodiment, a thermal sensor 2339, a fan 2337, a keyboard 2336, and a touch pad 2330 may be communicatively coupled to EC 2335. In at least one embodiment, a speaker 2363, a headphones 2364, and a microphone (“mic”) 2365 may be communicatively coupled to an audio unit (“audio codec and class d amp”) 2362, which may in turn be communicatively coupled to DSP 2360. In at least one embodiment, audio unit 2362 may include, for example and without limitation, an audio coder/decoder (“codec”) and a class D amplifier. In at least one embodiment, a SIM card (“SIM”) 2357 may be communicatively coupled to WWAN unit 2356. In at least one embodiment, components such as WLAN unit 2350 and Bluetooth unit 2352, as well as WWAN unit 2356 may be implemented in a Next Generation Form Factor (“NGFF”).

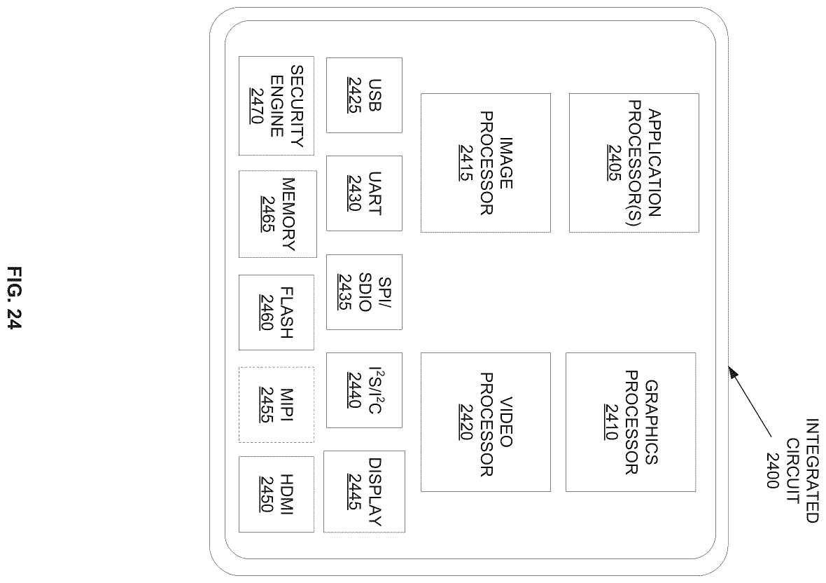

FIG. 24 illustrates an exemplary integrated circuit 2400, in accordance with at least one embodiment. In at least one embodiment, exemplary integrated circuit 2400 is an SoC that may be fabricated using one or more IP cores. In at least one embodiment, integrated circuit 2400 includes one or more application processor(s) 2405 (e.g., CPUs, DPUs), at least one graphics processor 2410, and may additionally include an image processor 2415 and/or a video processor 2420, any of which may be a modular IP core. In at least one embodiment, integrated circuit 2400 includes peripheral or bus logic including a USB controller 2425, a UART controller 2430, an SPI/SDIO controller 2435, and an I²S/I²C controller 2440. In at least one embodiment, integrated circuit 2400 can include a display device 2445 coupled to one or more of a high-definition multimedia interface (“HDMI”) controller 2450 and a mobile industry processor interface (“MIPI”) display interface 2455. In at least one embodiment, storage may be provided by a flash memory subsystem 2460 including flash memory and a flash memory controller. In at least one embodiment, a memory interface may be provided via a memory controller 2465 for access to SDRAM or SRAM memory devices. In at least one embodiment, some integrated circuits additionally include an embedded security engine 2470.

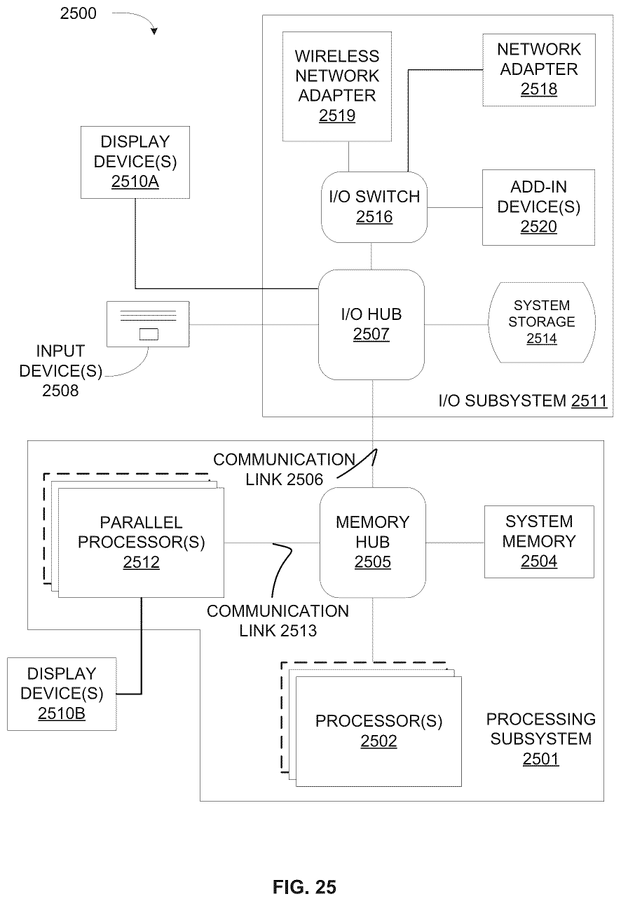

FIG. 25 illustrates a computing system 2500, according to at least one embodiment; In at least one embodiment, computing system 2500 includes a processing subsystem 2501 having one or more processor(s) 2502 and a system memory 2504 communicating via an interconnection path that may include a memory hub 2505. In at least one embodiment, memory hub 2505 may be a separate component within a chipset component or may be integrated within one or more processor(s) 2502. In at least one embodiment, memory hub 2505 couples with an I/O subsystem 2511 via a communication link 2506. In at least one embodiment, I/O subsystem 2511 includes an I/O hub 2507 that can enable computing system 2500 to receive input from one or more input device(s) 2508. In at least one embodiment, I/O hub 2507 can enable a display controller, which may be included in one or more processor(s) 2502, to provide outputs to one or more display device(s) 2510A. In at least one embodiment, one or more display device(s) 2510A coupled with I/O hub 2507 can include a local, internal, or embedded display device.

In at least one embodiment, processing subsystem 2501 includes one or more parallel processor(s) 2512 coupled to memory hub 2505 via a bus or other communication link 2513. In at least one embodiment, communication link 2513 may be one of any number of standards based communication link technologies or protocols, such as, but not limited to PCIe, or may be a vendor specific communications interface or communications fabric. In at least one embodiment, one or more parallel processor(s) 2512 form a computationally focused parallel or vector processing system that can include a large number of processing cores and/or processing clusters, such as a many integrated core processor or compute units. In at least one embodiment, one or more parallel processor(s) 2512 form a graphics processing subsystem that can output pixels to one of one or more display device(s) 2510A coupled via I/O Hub 2507. In at least one embodiment, one or more parallel processor(s) 2512 can also include a display controller and display interface (not shown) to enable a direct connection to one or more display device(s) 2510B.

In at least one embodiment, a system storage unit 2514 can connect to I/O hub 2507 to provide a storage mechanism for computing system 2500. In at least one embodiment, an I/O switch 2516 can be used to provide an interface mechanism to enable connections between I/O hub 2507 and other components, such as a network adapter 2518 and/or wireless network adapter 2519 that may be integrated into a platform, and various other devices that can be added via one or more add-in device(s) 2520. In at least one embodiment, network adapter 2518 can be an Ethernet adapter or another wired network adapter. In at least one embodiment, wireless network adapter 2519 can include one or more of a Wi-Fi, Bluetooth, NFC, or other network device that includes one or more wireless radios.

In at least one embodiment, computing system 2500 can include other components not explicitly shown, including USB or other port connections, optical storage drives, video capture devices, and the like, that may also be connected to I/O hub 2507. In at least one embodiment, communication paths interconnecting various components in FIG. 25 may be implemented using any suitable protocols, such as PCI based protocols (e.g., PCIe), or other bus or point-to-point communication interfaces and/or protocol(s), such as NVLink high-speed interconnect, or interconnect protocols.

In at least one embodiment, one or more parallel processor(s) 2512 incorporate circuitry optimized for graphics and video processing, including, for example, video output circuitry, and constitutes a graphics processing unit (“GPU”). In at least one embodiment, one or more parallel processor(s) 2512 incorporate circuitry optimized for general purpose processing. In at least embodiment, components of computing system 2500 may be integrated with one or more other system elements on a single integrated circuit. For example, in at least one embodiment, one or more parallel processor(s) 2512, memory hub 2505, processor(s) 2502, and I/O hub 2507 can be integrated into an SoC integrated circuit. In at least one embodiment, components of computing system 2500 can be integrated into a single package to form a system in package (“SIP”) configuration. In at least one embodiment, at least a portion of the components of computing system 2500 can be integrated into a multi-chip module (“MCM”), which can be interconnected with other multi-chip modules into a modular computing system. In at least one embodiment, I/O subsystem 2511 and display devices 2510B are omitted from computing system 2500. In at least one embodiment, one or more parallel processor(s) 2512 include one or more tensor memory accelerators (TMA) units that can transfer blocks of data between global memory and shared memory. In at least one embodiment, one or more processors uses or access one or more TMAs to perform bi-directional copy operations, e.g., from global to shared memory and vice versa.

### Processing Systems

The following figures set forth, without limitation, exemplary processing systems that can be used to implement at least one embodiment. In at least one embodiment, one or more processing systems of following figures implements one or more aspects of one or more embodiments described with respect to one or more of FIGS. 1-19B. In at least one embodiment, one or more processing systems include one or more components of computing device 102 of FIG. 1 (e.g., CPU 104, PPU 106, asynchronous data movement H/W 114, cache 116, and/or API 108). In at least one embodiment, one or more processing systems include one or more components of computer system 202 of FIG. 2 (e.g., processor 204, GPU 210, asynchronous data movement H/W 222, cache 224, set of APIs 232, prefetch tensor map API 234, set of instructions 246, prefetch tensor map instruction 248, and/or one or more components of set of nodes 258). In at least one embodiment, one or more processing systems perform one or more aspects of API 300 of FIG. 3 and/or one or more aspects of technique 400 of FIG. 4. In at least one embodiment, one or more processing systems include processor 500 of FIG. 5 and/or one or more modules shown or described with respect to FIG. 5. In at least one embodiment, one or more processing systems include and/or perform one or more aspects of environment 600 of FIG. 6 (e.g., drivers and/or runtimes 604, one or more APIs 610, and/or one or more functions of functions 612).

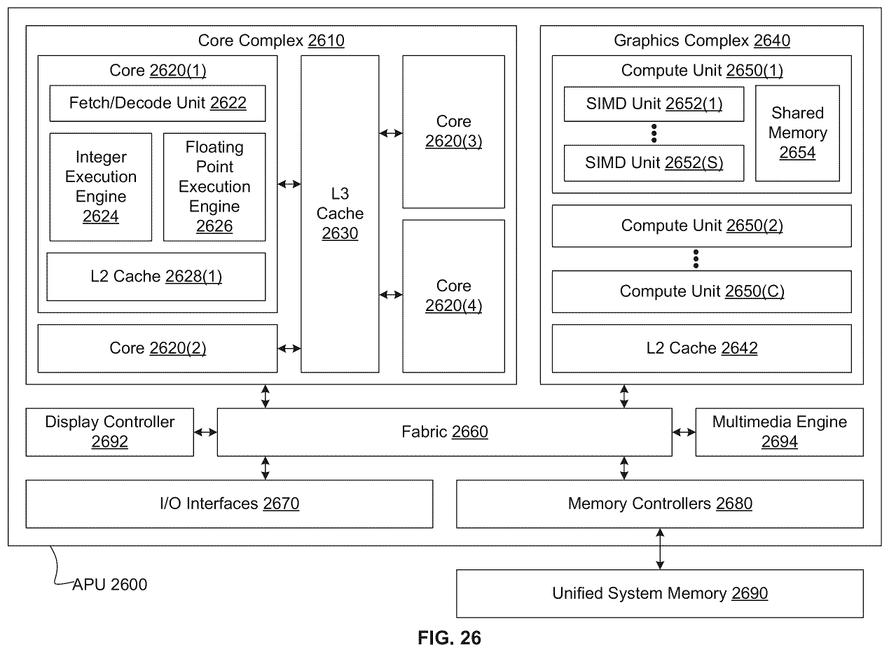

FIG. 26 illustrates an accelerated processing unit (“APU”) 2600, in accordance with at least one embodiment. In at least one embodiment, APU 2600 is developed by AMD Corporation of Santa Clara, CA. In at least one embodiment, APU 2600 can be configured to execute an application program, such as a CUDA program. In at least one embodiment, APU 2600 includes, without limitation, a core complex 2610, a graphics complex 2640, fabric 2660, I/O interfaces 2670, memory controllers 2680, a display controller 2692, and a multimedia engine 2694. In at least one embodiment, APU 2600 may include, without limitation, any number of core complexes 2610, any number of graphics complexes 2650, any number of display controllers 2692, and any number of multimedia engines 2694 in any combination. For explanatory purposes, multiple instances of like objects are denoted herein with reference numbers identifying the object and parenthetical numbers identifying the instance where needed.

In at least one embodiment, core complex 2610 is a CPU, graphics complex 2640 is a GPU, and APU 2600 is a processing unit that integrates, without limitation, 2610 and 2640 onto a single chip. In at least one embodiment, some tasks may be assigned to core complex 2610 and other tasks may be assigned to graphics complex 2640. In at least one embodiment, core complex 2610 is configured to execute main control software associated with APU 2600, such as an operating system. In at least one embodiment, core complex 2610 is the master processor of APU 2600, controlling and coordinating operations of other processors. In at least one embodiment, core complex 2610 issues commands that control the operation of graphics complex 2640. In at least one embodiment, core complex 2610 can be configured to execute host executable code derived from CUDA source code, and graphics complex 2640 can be configured to execute device executable code derived from CUDA source code.

In at least one embodiment, core complex 2610 includes, without limitation, cores 2620(1)-2620(4) and an L3 cache 2630. In at least one embodiment, core complex 2610 may include, without limitation, any number of cores 2620 and any number and type of caches in any combination. In at least one embodiment, cores 2620 are configured to execute instructions of a particular instruction set architecture (“ISA”). In at least one embodiment, each core 2620 is a CPU core. In at least one embodiment, core 2620 is referred to as a computing unit or compute unit.

In at least one embodiment, each core 2620 includes, without limitation, a fetch/decode unit 2622, an integer execution engine 2624, a floating point execution engine 2626, and an L2 cache 2628. In at least one embodiment, fetch/decode unit 2622 fetches instructions, decodes such instructions, generates micro-operations, and dispatches separate micro-instructions to integer execution engine 2624 and floating point execution engine 2626. In at least one embodiment, fetch/decode unit 2622 can concurrently dispatch one micro-instruction to integer execution engine 2624 and another micro-instruction to floating point execution engine 2626. In at least one embodiment, integer execution engine 2624 executes, without limitation, integer and memory operations. In at least one embodiment, floating point engine 2626 executes, without limitation, floating point and vector operations. In at least one embodiment, fetch-decode unit 2622 dispatches micro-instructions to a single execution engine that replaces both integer execution engine 2624 and floating point execution engine 2626.

In at least one embodiment, each core 2620(i), where i is an integer representing a particular instance of core 2620, may access L2 cache 2628(i) included in core 2620(i). In at least one embodiment, each core 2620 included in core complex 2610(j), where j is an integer representing a particular instance of core complex 2610, is connected to other cores 2620 included in core complex 2610(j) via L3 cache 2630(j) included in core complex 2610(j). In at least one embodiment, cores 2620 included in core complex 2610(j), where j is an integer representing a particular instance of core complex 2610, can access all of L3 cache 2630(j) included in core complex 2610(j). In at least one embodiment, L3 cache 2630 may include, without limitation, any number of slices.

In at least one embodiment, graphics complex 2640 can be configured to perform compute operations in a highly-parallel fashion. In at least one embodiment, graphics complex 2640 is configured to execute graphics pipeline operations such as draw commands, pixel operations, geometric computations, and other operations associated with rendering an image to a display. In at least one embodiment, graphics complex 2640 is configured to execute operations unrelated to graphics. In at least one embodiment, graphics complex 2640 is configured to execute both operations related to graphics and operations unrelated to graphics.

In at least one embodiment, graphics complex 2640 includes, without limitation, any number of compute units 2650 and an L2 cache 2642. In at least one embodiment, compute units 2650 share L2 cache 2642. In at least one embodiment, L2 cache 2642 is partitioned. In at least one embodiment, graphics complex 2640 includes, without limitation, any number of compute units 2650 and any number (including zero) and type of caches. In at least one embodiment, graphics complex 2640 includes, without limitation, any amount of dedicated graphics hardware.

In at least one embodiment, each compute unit 2650 includes, without limitation, any number of SIMD units 2652 and a shared memory 2654. In at least one embodiment, each SIMD unit 2652 implements a SIMD architecture and is configured to perform operations in parallel. In at least one embodiment, each compute unit 2650 may execute any number of thread blocks, but each thread block executes on a single compute unit 2650. In at least one embodiment, a thread block includes, without limitation, any number of threads of execution. In at least one embodiment, a workgroup is a thread block. In at least one embodiment, each SIMD unit 2652 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 2654. In at least one embodiment, each compute unit 2650 includes one or more thread block clusters, where a thread block cluster can enable programmatic control of locality at a granularity larger than a single thread block of a single streaming multiprocessor (SM). In at least one embodiment, thread block clusters (also referred to as “clusters”) enables multiple thread blocks running concurrently across streaming multiprocessors to synchronize and collaboratively fetch, exchange, or otherwise use data.

In at least one embodiment, fabric 2660 is a system interconnect that facilitates data and control transmissions across core complex 2610, graphics complex 2640, I/O interfaces 2670, memory controllers 2680, display controller 2692, and multimedia engine 2694. In at least one embodiment, APU 2600 may include, without limitation, any amount and type of system interconnect in addition to or instead of fabric 2660 that facilitates data and control transmissions across any number and type of directly or indirectly linked components that may be internal or external to APU 2600. In at least one embodiment, I/O interfaces 2670 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 2670 In at least one embodiment, peripheral devices that are coupled to I/O interfaces 2670 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 2694 includes, without limitation, any amount and type of circuitry that is related to multimedia, such as a video decoder, a video encoder, an image signal processor, etc. In at least one embodiment, memory controllers 2680 facilitate data transfers between APU 2600 and a unified system memory 2690. In at least one embodiment, core complex 2610 and graphics complex 2640 share unified system memory 2690.

In at least one embodiment, APU 2600 implements a memory subsystem that includes, without limitation, any amount and type of memory controllers 2680 and memory devices (e.g., shared memory 2654) that may be dedicated to one component or shared among multiple components. In at least one embodiment, APU 2600 implements a cache subsystem that includes, without limitation, one or more cache memories (e.g., L2 caches 2728, L3 cache 2630, and L2 cache 2642) that may each be private to or shared between any number of components (e.g., cores 2620, core complex 2610, SIMD units 2652, compute units 2650, and graphics complex 2640).

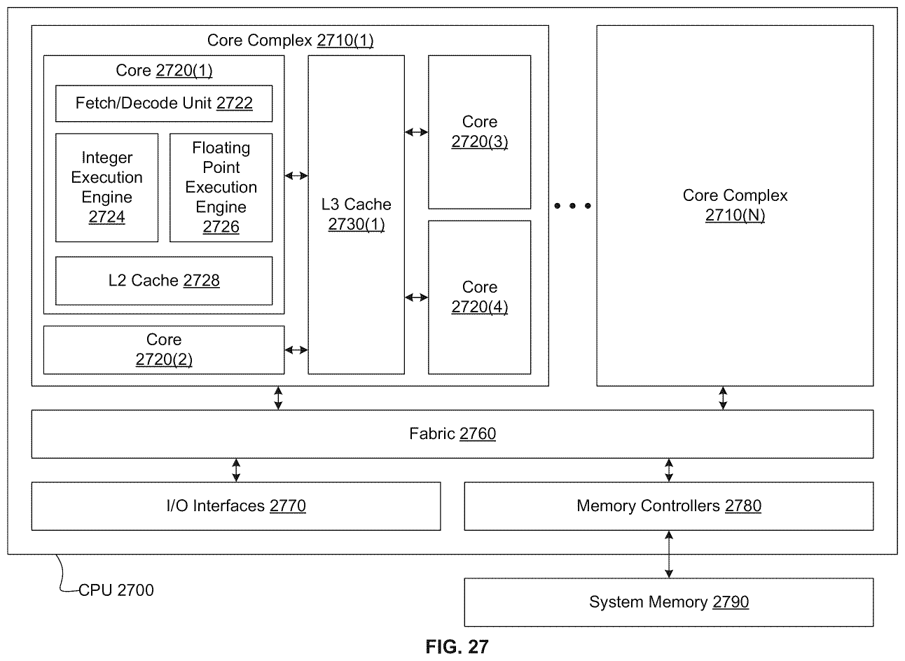

FIG. 27 illustrates a CPU 2700, in accordance with at least one embodiment. In at least one embodiment, CPU 2700 is developed by AMD Corporation of Santa Clara, CA. In at least one embodiment, CPU 2700 can be configured to execute an application program. In at least one embodiment, CPU 2700 is configured to execute main control software, such as an operating system. In at least one embodiment, CPU 2700 issues commands that control the operation of an external GPU (not shown). In at least one embodiment, CPU 2700 can be configured to execute host executable code derived from CUDA source code, and an external GPU can be configured to execute device executable code derived from such CUDA source code. In at least one embodiment, CPU 2700 includes, without limitation, any number of core complexes 2710, fabric 2760, I/O interfaces 2770, and memory controllers 2780.

In at least one embodiment, core complex 2710 includes, without limitation, cores 2720(1)-2720(4) and an L3 cache 2730. In at least one embodiment, core complex 2710 may include, without limitation, any number of cores 2720 and any number and type of caches in any combination. In at least one embodiment, cores 2720 are configured to execute instructions of a particular ISA. In at least one embodiment, each core 2720 is a CPU core.

In at least one embodiment, each core 2720 includes, without limitation, a fetch/decode unit 2722, an integer execution engine 2724, a floating point execution engine 2726, and an L2 cache 2728. In at least one embodiment, fetch/decode unit 2722 fetches instructions, decodes such instructions, generates micro-operations, and dispatches separate micro-instructions to integer execution engine 2724 and floating point execution engine 2726. In at least one embodiment, fetch/decode unit 2722 can concurrently dispatch one micro-instruction to integer execution engine 2724 and another micro-instruction to floating point execution engine 2726. In at least one embodiment, integer execution engine 2724 executes, without limitation, integer and memory operations. In at least one embodiment, floating point engine 2726 executes, without limitation, floating point and vector operations. In at least one embodiment, fetch-decode unit 2722 dispatches micro-instructions to a single execution engine that replaces both integer execution engine 2724 and floating point execution engine 2726.

In at least one embodiment, each core 2720(i), where i is an integer representing a particular instance of core 2720, may access L2 cache 2728(i) included in core 2720(i). In at least one embodiment, each core 2720 included in core complex 2710(j), where j is an integer representing a particular instance of core complex 2710, is connected to other cores 2720 in core complex 2710(j) via L3 cache 2730(j) included in core complex 2710(j). In at least one embodiment, cores 2720 included in core complex 2710(j), where j is an integer representing a particular instance of core complex 2710, can access all of L3 cache 2730(j) included in core complex 2710(j). In at least one embodiment, L3 cache 2730 may include, without limitation, any number of slices.

In at least one embodiment, fabric 2760 is a system interconnect that facilitates data and control transmissions across core complexes 2710(1)-2710(N) (where N is an integer greater than zero), I/O interfaces 2770, and memory controllers 2780. In at least one embodiment, CPU 2700 may include, without limitation, any amount and type of system interconnect in addition to or instead of fabric 2760 that facilitates data and control transmissions across any number and type of directly or indirectly linked components that may be internal or external to CPU 2700. In at least one embodiment, I/O interfaces 2770 are representative of any number and type of I/O interfaces (e.g., PCI, PCI-X, PCIe, GBE, USB, etc.). In at least one embodiment, various types of peripheral devices are coupled to I/O interfaces 2770 In at least one embodiment, peripheral devices that are coupled to I/O interfaces 2770 may include, without limitation, displays, keyboards, mice, printers, scanners, joysticks or other types of game controllers, media recording devices, external storage devices, network interface cards, and so forth.

In at least one embodiment, memory controllers 2780 facilitate data transfers between CPU 2700 and a system memory 2790. In at least one embodiment, core complex 2710 and graphics complex 2740 share system memory 2790. In at least one embodiment, CPU 2700 implements a memory subsystem that includes, without limitation, any amount and type of memory controllers 2780 and memory devices that may be dedicated to one component or shared among multiple components. In at least one embodiment, CPU 2700 implements a cache subsystem that includes, without limitation, one or more cache memories (e.g., L2 caches 2728 and L3 caches 2730) that may each be private to or shared between any number of components (e.g., cores 2720 and core complexes 2710).

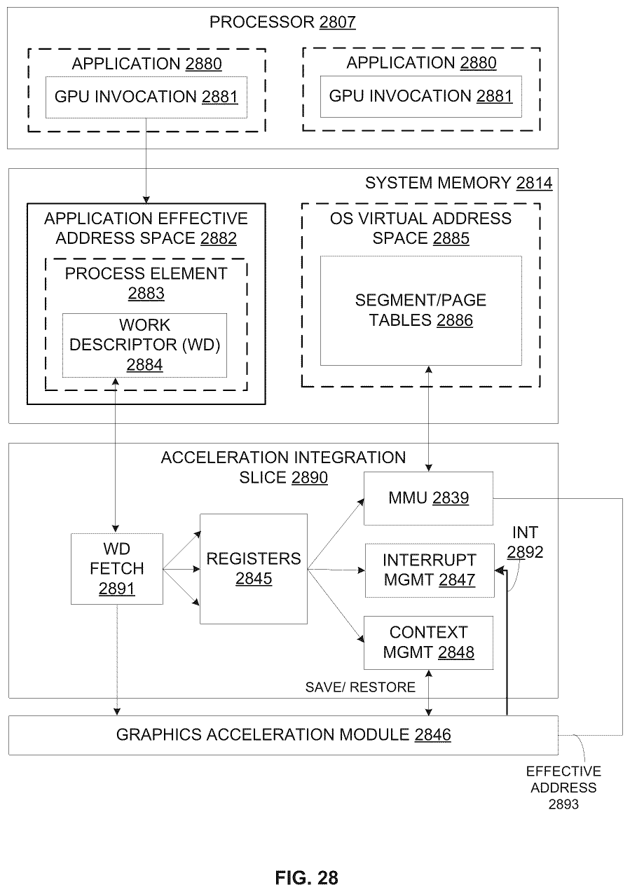

FIG. 28 illustrates an exemplary accelerator integration slice 2890, in accordance with at least one embodiment. As used herein, a “slice” comprises a specified portion of processing resources of an accelerator integration circuit. In at least one embodiment, the accelerator integration circuit provides cache management, memory access, context management, and interrupt management services on behalf of multiple graphics processing engines included in a graphics acceleration module. The graphics processing engines may each comprise a separate GPU. Alternatively, the graphics processing engines may comprise different types of graphics processing engines within a GPU such as graphics execution units, media processing engines (e.g., video encoders/decoders), samplers, and blit engines. In at least one embodiment, the graphics acceleration module may be a GPU with multiple graphics processing engines. In at least one embodiment, the graphics processing engines may be individual GPUs integrated on a common package, line card, or chip.

An application effective address space 2882 within system memory 2814 stores process elements 2883. In one embodiment, process elements 2883 are stored in response to GPU invocations 2881 from applications 2880 executed on processor 2807. A process element 2883 contains process state for corresponding application 2880. A work descriptor (“WD”) 2884 contained in process element 2883 can be a single job requested by an application or may contain a pointer to a queue of jobs. In at least one embodiment, WD 2884 is a pointer to a job request queue in application effective address space 2882.

Graphics acceleration module 2846 and/or individual graphics processing engines can be shared by all or a subset of processes in a system. In at least one embodiment, an infrastructure for setting up process state and sending WD 2884 to graphics acceleration module 2846 to start a job in a virtualized environment may be included.

In at least one embodiment, a dedicated-process programming model is implementation-specific. In this model, a single process owns graphics acceleration module 2846 or an individual graphics processing engine. Because graphics acceleration module 2846 is owned by a single process, a hypervisor initializes an accelerator integration circuit for an owning partition and an operating system initializes accelerator integration circuit for an owning process when graphics acceleration module 2846 is assigned.

In operation, a WD fetch unit 2891 in accelerator integration slice 2890 fetches next WD 2884 which includes an indication of work to be done by one or more graphics processing engines of graphics acceleration module 2846. Data from WD 2884 may be stored in registers 2845 and used by a memory management unit (“MMU”) 2839, interrupt management circuit 2847 and/or context management circuit 2848 as illustrated. For example, one embodiment of MMU 2839 includes segment/page walk circuitry for accessing segment/page tables 2886 within OS virtual address space 2885. Interrupt management circuit 2847 may process interrupt events (“INT”) 2892 received from graphics acceleration module 2846. When performing graphics operations, an effective address 2893 generated by a graphics processing engine is translated to a real address by MMU 2839.

In one embodiment, a same set of registers 2845 are duplicated for each graphics processing engine and/or graphics acceleration module 2846 and may be initialized by a hypervisor or operating system. Each of these duplicated registers may be included in accelerator integration slice 2890. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 2884 is specific to a particular graphics acceleration module 2846 and/or a particular graphics processing engine. It contains all information required by a graphics processing engine to do work or it can be a pointer to a memory location where an application has set up a command queue of work to be completed.

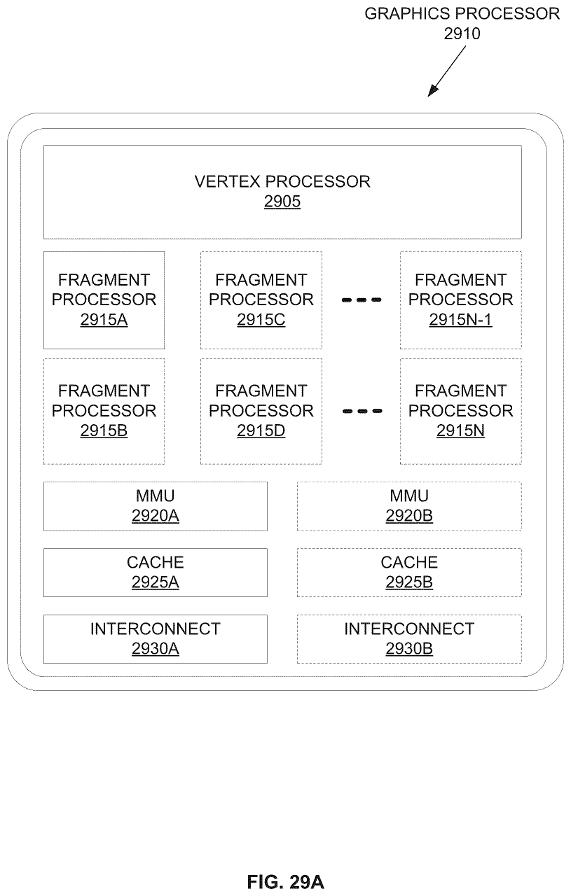

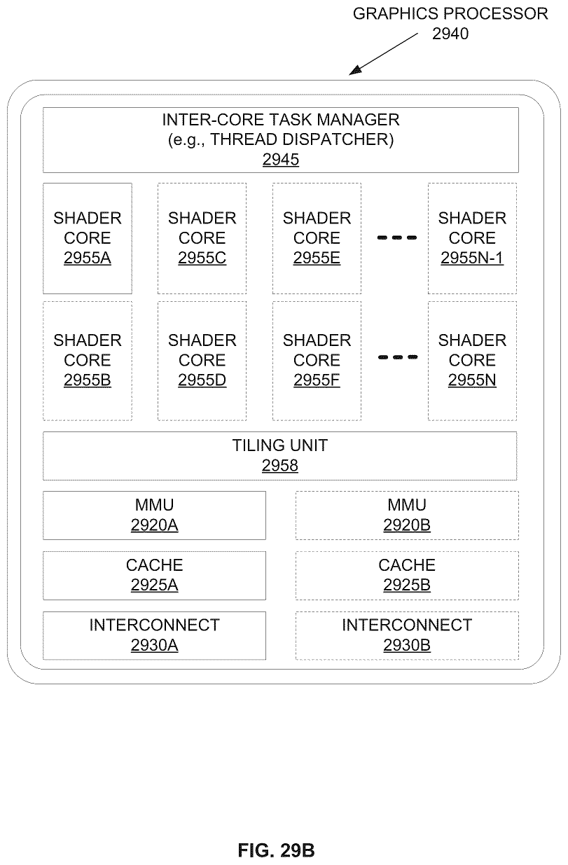

FIGS. 29A-29B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

FIG. 29A illustrates an exemplary graphics processor 2910 of an SoC integrated circuit that may be fabricated using one or more IP cores, in accordance with at least one embodiment. FIG. 29B illustrates an additional exemplary graphics processor 2940 of an SoC integrated circuit that may be fabricated using one or more IP cores, in accordance with at least one embodiment. In at least one embodiment, graphics processor 2910 of FIG. 29A is a low power graphics processor core. In at least one embodiment, graphics processor 2940 of FIG. 29B is a higher performance graphics processor core. In at least one embodiment, each of graphics processors 2910, 2940 can be variants of graphics processor 2410 of FIG. 24.

In at least one embodiment, graphics processor 2910 includes a vertex processor 2905 and one or more fragment processor(s) 2915A-2915N (e.g., 2915A, 2915B, 2915C, 2915D, through 2915N-1, and 2915N). In at least one embodiment, graphics processor 2910 can execute different shader programs via separate logic, such that vertex processor 2905 is optimized to execute operations for vertex shader programs, while one or more fragment processor(s) 2915A-2915N execute fragment (e.g., pixel) shading operations for fragment or pixel shader programs. In at least one embodiment, vertex processor 2905 performs a vertex processing stage of a 3D graphics pipeline and generates primitives and vertex data. In at least one embodiment, fragment processor(s) 2915A-2915N use primitive and vertex data generated by vertex processor 2905 to produce a framebuffer that is displayed on a display device. In at least one embodiment, fragment processor(s) 2915A-2915N are optimized to execute fragment shader programs as provided for in an OpenGL API, which may be used to perform similar operations as a pixel shader program as provided for in a Direct 3D API.

In at least one embodiment, graphics processor 2910 additionally includes one or more MMU(s) 2920A-2920B, cache(s) 2925A-2925B, and circuit interconnect(s) 2930A-2930B. In at least one embodiment, one or more MMU(s) 2920A-2920B provide for virtual to physical address mapping for graphics processor 2910, including for vertex processor 2905 and/or fragment processor(s) 2915A-2915N, which may reference vertex or image/texture data stored in memory, in addition to vertex or image/texture data stored in one or more cache(s) 2925A-2925B. In at least one embodiment, one or more MMU(s) 2920A-2920B may be synchronized with other MMUs within a system, including one or more MMUs associated with one or more application processor(s) 2405, image processors 2415, and/or video processors 2420 of FIG. 24, such that each processor 2405-2420 can participate in a shared or unified virtual memory system. In at least one embodiment, one or more circuit interconnect(s) 2930A-2930B enable graphics processor 2910 to interface with other IP cores within an SoC, either via an internal bus of the SoC or via a direct connection.

In at least one embodiment, graphics processor 2940 includes one or more MMU(s) 2920A-2920B, caches 2925A-2925B, and circuit interconnects 2930A-2930B of graphics processor 2910 of FIG. 29A. In at least one embodiment, graphics processor 2940 includes one or more shader core(s) 2955A-2955N (e.g., 2955A, 2955B, 2955C, 2955D, 2955E, 2955F, through 2955N-1, and 2955N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 2940 includes an inter-core task manager 2945, which acts as a thread dispatcher to dispatch execution threads to one or more shader cores 2955A-2955N and a tiling unit 2958 to accelerate tiling operations for tile-based rendering, in which rendering operations for a scene are subdivided in image space, for example to exploit local spatial coherence within a scene or to optimize use of internal caches.

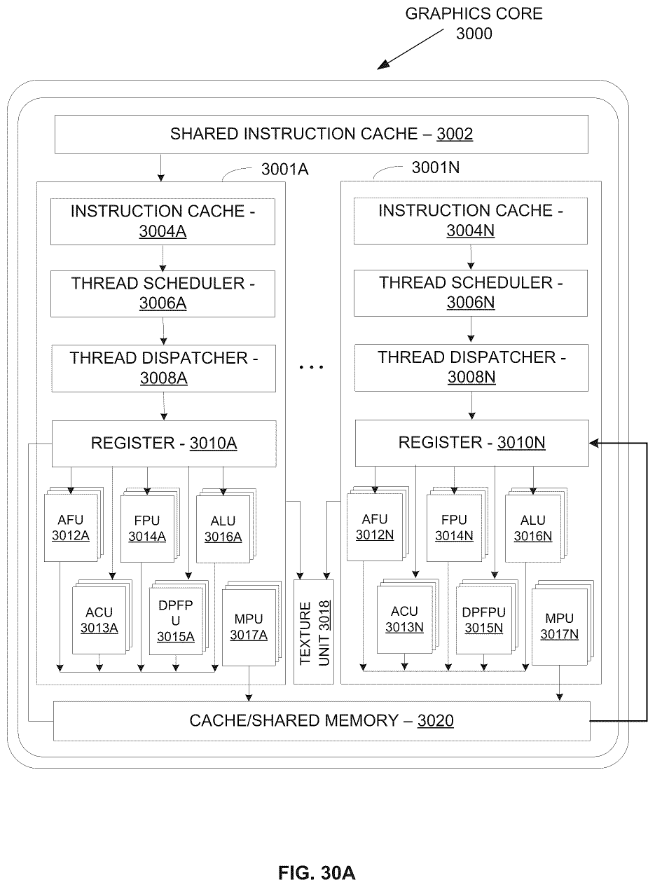

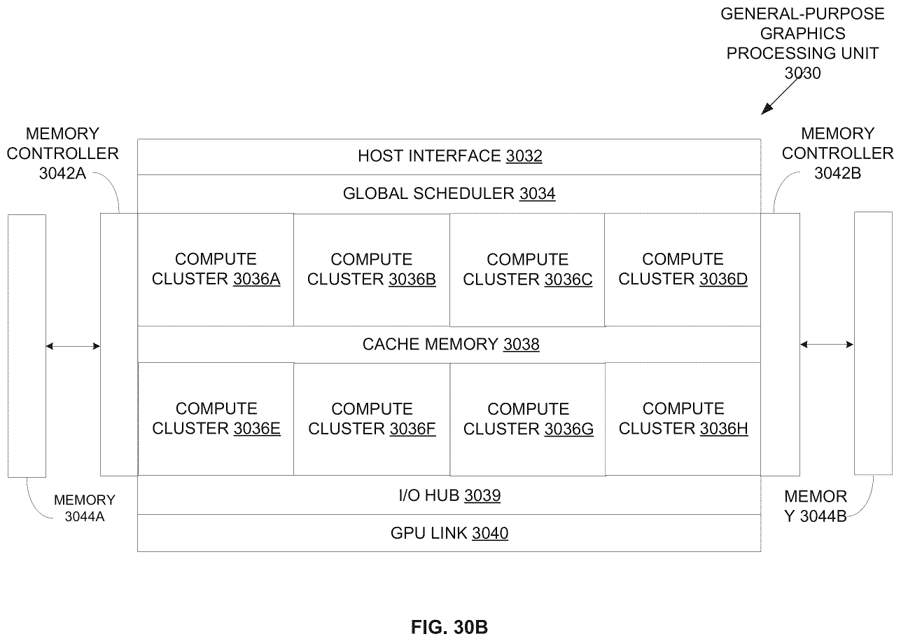

FIG. 30A illustrates a graphics core 3000, in accordance with at least one embodiment. In at least one embodiment, graphics core 3000 may be included within graphics processor 2410 of FIG. 24. In at least one embodiment, graphics core 3000 may be a unified shader core 2955A-2955N as in FIG. 29B. In at least one embodiment, graphics core 3000 includes a shared instruction cache 3002, a texture unit 3018, and a cache/shared memory 3020 that are common to execution resources within graphics core 3000. In at least one embodiment, graphics core 3000 can include multiple slices 3001A-3001N or partition for each core, and a graphics processor can include multiple instances of graphics core 3000. Slices 3001A-3001N can include support logic including a local instruction cache 3004A-3004N, a thread scheduler 3006A-3006N, a thread dispatcher 3008A-3008N, and a set of registers 3010A-3010N. In at least one embodiment, slices 3001A-3001N can include a set of additional function units (“AFUs”) 3012A-3012N, floating-point units (“FPUs”) 3014A-3014N, integer arithmetic logic units (“ALUs”) 3016-3016N, address computational units (“ACUs”) 3013A-3013N, double-precision floating-point units (“DPFPUs”) 3015A-3015N, and matrix processing units (“MPUs”) 3017A-3017N. In at least one embodiment, a graphics core 3000 is referred to as a compute unit or computing unit.

In at least one embodiment, FPUs 3014A-3014N can perform single-precision (32-bit) and half-precision (16-bit) floating point operations, while DPFPUs 3015A-3015N perform double precision (64-bit) floating point operations. In at least one embodiment, ALUs 3016A-3016N can perform variable precision integer operations at 8-bit, 16-bit, and 32-bit precision, and can be configured for mixed precision operations. In at least one embodiment, MPUs 3017A-3017N can also be configured for mixed precision matrix operations, including half-precision floating point and 8-bit integer operations. In at least one embodiment, MPUs 3017-3017N can perform a variety of matrix operations to accelerate CUDA programs, including enabling support for accelerated general matrix to matrix multiplication (“GEMM”). In at least one embodiment, AFUs 3012A-3012N can perform additional logic operations not supported by floating-point or integer units, including trigonometric operations (e.g., Sine, Cosine, etc.).

FIG. 30B illustrates a general-purpose graphics processing unit (“GPGPU”) 3030, in accordance with at least one embodiment. In at least one embodiment, GPGPU 3030 is highly-parallel and suitable for deployment on a multi-chip module. In at least one embodiment, GPGPU 3030 can be configured to enable highly-parallel compute operations to be performed by an array of GPUs. In at least one embodiment, GPGPU 3030 can be linked directly to other instances of GPGPU 3030 to create a multi-GPU cluster to improve execution time for CUDA programs. In at least one embodiment, GPGPU 3030 includes a host interface 3032 to enable a connection with a host processor. In at least one embodiment, host interface 3032 is a PCIe interface. In at least one embodiment, host interface 3032 can be a vendor specific communications interface or communications fabric. In at least one embodiment, GPGPU 3030 receives commands from a host processor and uses a global scheduler 3034 to distribute execution threads associated with those commands to a set of compute clusters 3036A-3036H. In at least one embodiment, compute clusters 3036A-3036H share a cache memory 3038. In at least one embodiment, cache memory 3038 can serve as a higher-level cache for cache memories within compute clusters 3036A-3036H.

In at least one embodiment, GPGPU 3030 includes memory 3044A-3044B coupled with compute clusters 3036A-3036H via a set of memory controllers 3042A-3042B. In at least one embodiment, memory 3044A-3044B can include various types of memory devices including DRAM or graphics random access memory, such as synchronous graphics random access memory (“SGRAM”), including graphics double data rate (“GDDR”) memory.

In at least one embodiment, compute clusters 3036A-3036H each include a set of graphics cores, such as graphics core 3000 of FIG. 30A, which can include multiple types of integer and floating point logic units that can perform computational operations at a range of precisions including suited for computations associated with CUDA programs. For example, in at least one embodiment, at least a subset of floating point units in each of compute clusters 3036A-3036H can be configured to perform 16-bit or 32-bit floating point operations, while a different subset of floating point units can be configured to perform 64-bit floating point operations.

In at least one embodiment, multiple instances of GPGPU 3030 can be configured to operate as a compute cluster. Compute clusters 3036A-3036H may implement any technically feasible communication techniques for synchronization and data exchange. In at least one embodiment, multiple instances of GPGPU 3030 communicate over host interface 3032. In at least one embodiment, GPGPU 3030 includes an I/O hub 3039 that couples GPGPU 3030 with a GPU link 3040 that enables a direct connection to other instances of GPGPU 3030. In at least one embodiment, GPU link 3040 is coupled to a dedicated GPU-to-GPU bridge that enables communication and synchronization between multiple instances of GPGPU 3030. In at least one embodiment GPU link 3040 couples with a high speed interconnect to transmit and receive data to other GPGPUs 3030 or parallel processors. In at least one embodiment, multiple instances of GPGPU 3030 are located in separate data processing systems and communicate via a network device that is accessible via host interface 3032. In at least one embodiment GPU link 3040 can be configured to enable a connection to a host processor in addition to or as an alternative to host interface 3032. In at least one embodiment, GPGPU 3030 can be configured to execute a CUDA program.

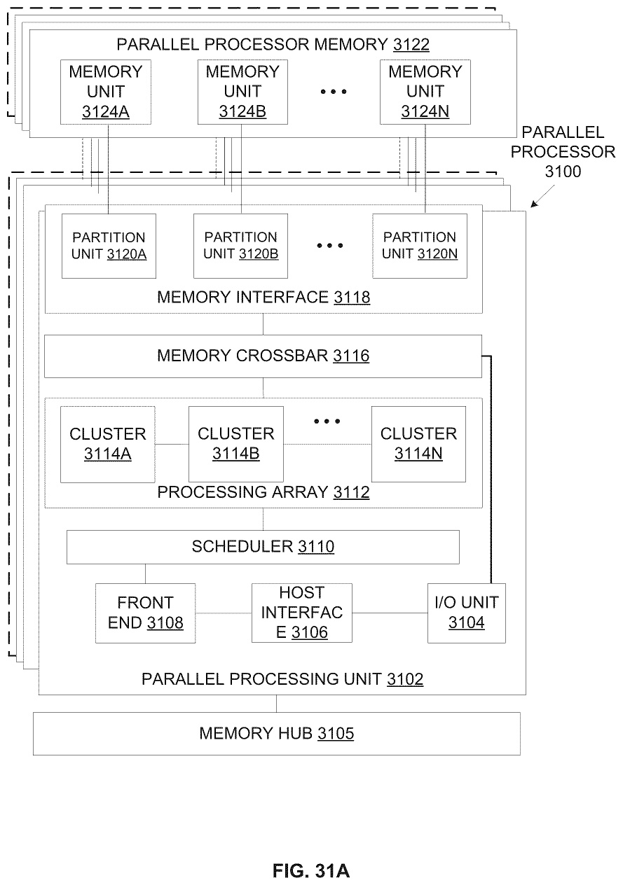

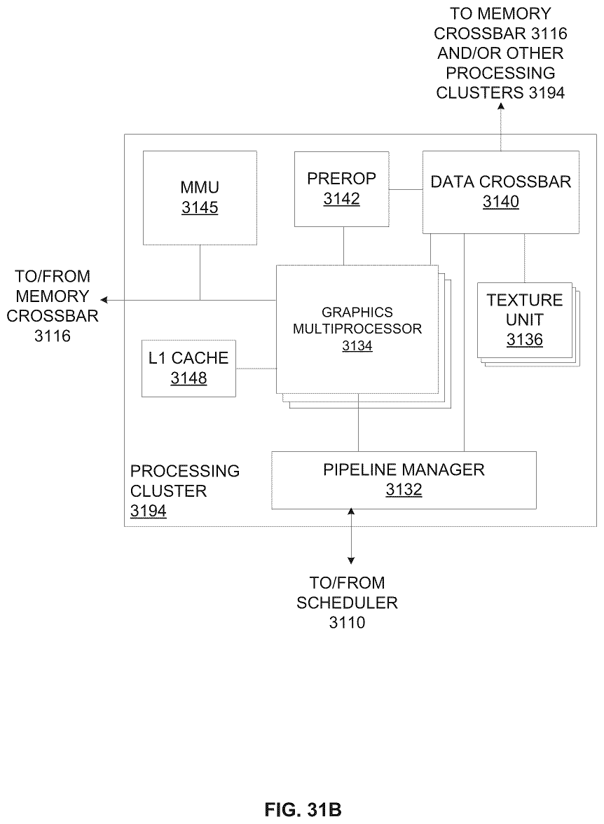

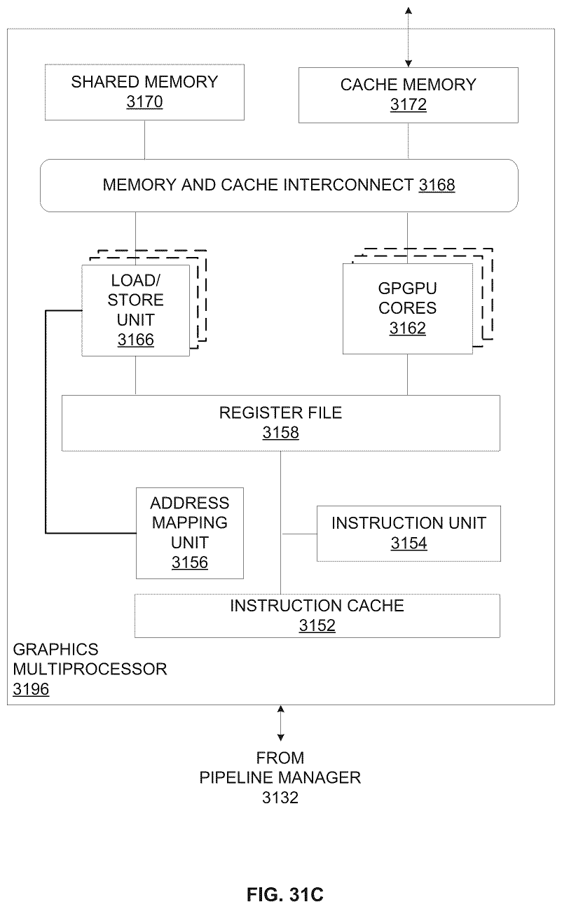

FIG. 31A illustrates a parallel processor 3100, in accordance with at least one embodiment. In at least one embodiment, various components of parallel processor 3100 may be implemented using one or more integrated circuit devices, such as programmable processors, application specific integrated circuits (“ASICs”), or FPGAs.

In at least one embodiment, parallel processor 3100 includes a parallel processing unit 3102. In at least one embodiment, parallel processing unit 3102 includes an I/O unit 3104 that enables communication with other devices, including other instances of parallel processing unit 3102. In at least one embodiment, I/O unit 3104 may be directly connected to other devices. In at least one embodiment, I/O unit 3104 connects with other devices via use of a hub or switch interface, such as memory hub 3105. In at least one embodiment, connections between memory hub 3105 and I/O unit 3104 form a communication link. In at least one embodiment, I/O unit 3104 connects with a host interface 3106 and a memory crossbar 3116, where host interface 3106 receives commands directed to performing processing operations and memory crossbar 3116 receives commands directed to performing memory operations.

In at least one embodiment, when host interface 3106 receives a command buffer via I/O unit 3104, host interface 3106 can direct work operations to perform those commands to a front end 3108. In at least one embodiment, front end 3108 couples with a scheduler 3110, which is configured to distribute commands or other work items to a processing array 3112. In at least one embodiment, scheduler 3110 ensures that processing array 3112 is properly configured and in a valid state before tasks are distributed to processing array 3112. In at least one embodiment, scheduler 3110 is implemented via firmware logic executing on a microcontroller. In at least one embodiment, microcontroller implemented scheduler 3110 is configurable to perform complex scheduling and work distribution operations at coarse and fine granularity, enabling rapid preemption and context switching of threads executing on processing array 3112. In at least one embodiment, host software can prove workloads for scheduling on processing array 3112 via one of multiple graphics processing doorbells. In at least one embodiment, workloads can then be automatically distributed across processing array 3112 by scheduler 3110 logic within a microcontroller including scheduler 3110.

In at least one embodiment, processing array 3112 can include up to “N” clusters (e.g., cluster 3114A, cluster 3114B, through cluster 3114N). In at least one embodiment, each cluster 3114A-3114N of processing array 3112 can execute a large number of concurrent threads. In at least one embodiment, scheduler 3110 can allocate work to clusters 3114A-3114N of processing array 3112 using various scheduling and/or work distribution algorithms, which may vary depending on the workload arising for each type of program or computation. In at least one embodiment, scheduling can be handled dynamically by scheduler 3110, or can be assisted in part by compiler logic during compilation of program logic configured for execution by processing array 3112. In at least one embodiment, different clusters 3114A-3114N of processing array 3112 can be allocated for processing different types of programs or for performing different types of computations.

In at least one embodiment, processing array 3112 can be configured to perform various types of parallel processing operations. In at least one embodiment, processing array 3112 is configured to perform general-purpose parallel compute operations. For example, in at least one embodiment, processing array 3112 can include logic to execute processing tasks including filtering of video and/or audio data, performing modeling operations, including physics operations, and performing data transformations.

In at least one embodiment, processing array 3112 is configured to perform parallel graphics processing operations. In at least one embodiment, processing array 3112 can include additional logic to support execution of such graphics processing operations, including, but not limited to texture sampling logic to perform texture operations, as well as tessellation logic and other vertex processing logic. In at least one embodiment, processing array 3112 can be configured to execute graphics processing related shader programs such as, but not limited to vertex shaders, tessellation shaders, geometry shaders, and pixel shaders. In at least one embodiment, parallel processing unit 3102 can transfer data from system memory via I/O unit 3104 for processing. In at least one embodiment, during processing, transferred data can be stored to on-chip memory (e.g., a parallel processor memory 3122) during processing, then written back to system memory.

In at least one embodiment, when parallel processing unit 3102 is used to perform graphics processing, scheduler 3110 can be configured to divide a processing workload into approximately equal sized tasks, to better enable distribution of graphics processing operations to multiple clusters 3114A-3114N of processing array 3112. In at least one embodiment, portions of processing array 3112 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 3114A-3114N may be stored in buffers to allow intermediate data to be transmitted between clusters 3114A-3114N for further processing.

In at least one embodiment, processing array 3112 can receive processing tasks to be executed via scheduler 3110, which receives commands defining processing tasks from front end 3108. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 3110 may be configured to fetch indices corresponding to tasks or may receive indices from front end 3108. In at least one embodiment, front end 3108 can be configured to ensure processing array 3112 is configured to a valid state before a workload specified by incoming command buffers (e.g., batch-buffers, push buffers, etc.) is initiated.

In at least one embodiment, each of one or more instances of parallel processing unit 3102 can couple with parallel processor memory 3122. In at least one embodiment, parallel processor memory 3122 can be accessed via memory crossbar 3116, which can receive memory requests from processing array 3112 as well as I/O unit 3104. In at least one embodiment, memory crossbar 3116 can access parallel processor memory 3122 via a memory interface 3118. In at least one embodiment, memory interface 3118 can include multiple partition units (e.g., a partition unit 3120A, partition unit 3120B, through partition unit 3120N) that can each couple to a portion (e.g., memory unit) of parallel processor memory 3122. In at least one embodiment, a number of partition units 3120A-3120N is configured to be equal to a number of memory units, such that a first partition unit 3120A has a corresponding first memory unit 3124A, a second partition unit 3120B has a corresponding memory unit 3124B, and an Nth partition unit 3120N has a corresponding Nth memory unit 3124N. In at least one embodiment, a number of partition units 3120A-3120N may not be equal to a number of memory devices.

In at least one embodiment, memory units 3124A-3124N can include various types of memory devices, including DRAM or graphics random access memory, such as SGRAM, including GDDR memory. In at least one embodiment, memory units 3124A-3124N may also include 3D stacked memory, including but not limited to high bandwidth memory (“HBM”). In at least one embodiment, render targets, such as frame buffers or texture maps may be stored across memory units 3124A-3124N, allowing partition units 3120A-3120N to write portions of each render target in parallel to efficiently use available bandwidth of parallel processor memory 3122. In at least one embodiment, a local instance of parallel processor memory 3122 may be excluded in favor of a unified memory design that utilizes system memory in conjunction with local cache memory.

In at least one embodiment, any one of clusters 3114A-3114N of processing array 3112 can process data that will be written to any of memory units 3124A-3124N within parallel processor memory 3122. In at least one embodiment, memory crossbar 3116 can be configured to transfer an output of each cluster 3114A-3114N to any partition unit 3120A-3120N or to another cluster 3114A-3114N, which can perform additional processing operations on an output. In at least one embodiment, each cluster 3114A-3114N can communicate with memory interface 3118 through memory crossbar 3116 to read from or write to various external memory devices. In at least one embodiment, memory crossbar 3116 has a connection to memory interface 3118 to communicate with I/O unit 3104, as well as a connection to a local instance of parallel processor memory 3122, enabling processing units within different clusters 3114A-3114N to communicate with system memory or other memory that is not local to parallel processing unit 3102. In at least one embodiment, memory crossbar 3116 can use virtual channels to separate traffic streams between clusters 3114A-3114N and partition units 3120A-3120N.

In at least one embodiment, multiple instances of parallel processing unit 3102 can be provided on a single add-in card, or multiple add-in cards can be interconnected. In at least one embodiment, different instances of parallel processing unit 3102 can be configured to interoperate even if different instances have different numbers of processing cores, different amounts of local parallel processor memory, and/or other configuration differences. For example, in at least one embodiment, some instances of parallel processing unit 3102 can include higher precision floating point units relative to other instances. In at least one embodiment, systems incorporating one or more instances of parallel processing unit 3102 or parallel processor 3100 can be implemented in a variety of configurations and form factors, including but not limited to desktop, laptop, or handheld personal computers, servers, workstations, game consoles, and/or embedded systems.

FIG. 31B illustrates a processing cluster 3194, in accordance with at least one embodiment. In at least one embodiment, processing cluster 3194 is included within a parallel processing unit. In at least one embodiment, processing cluster 3194 is one of processing clusters 3114A-3114N of FIG. 31. In at least one embodiment, processing cluster 3194 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 3194.

In at least one embodiment, operation of processing cluster 3194 can be controlled via a pipeline manager 3132 that distributes processing tasks to SIMT parallel processors. In at least one embodiment, pipeline manager 3132 receives instructions from scheduler 3110 of FIG. 31 and manages execution of those instructions via a graphics multiprocessor 3134 and/or a texture unit 3136. In at least one embodiment, graphics multiprocessor 3134 is an exemplary instance of a SIMT parallel processor. However, in at least one embodiment, various types of SIMT parallel processors of differing architectures may be included within processing cluster 3194. In at least one embodiment, one or more instances of graphics multiprocessor 3134 can be included within processing cluster 3194. In at least one embodiment, graphics multiprocessor 3134 can process data and a data crossbar 3140 can be used to distribute processed data to one of multiple possible destinations, including other shader units. In at least one embodiment, pipeline manager 3132 can facilitate distribution of processed data by specifying destinations for processed data to be distributed via data crossbar 3140.

In at least one embodiment, each graphics multiprocessor 3134 within processing cluster 3194 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 3194 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 3134. In at least one embodiment, a thread group may include fewer threads than a number of processing engines within graphics multiprocessor 3134. In at least one embodiment, when a thread group includes fewer threads than a number of processing engines, one or more of the processing engines may be idle during cycles in which that thread group is being processed. In at least one embodiment, a thread group may also include more threads than a number of processing engines within graphics multiprocessor 3134. In at least one embodiment, when a thread group includes more threads than the number of processing engines within graphics multiprocessor 3134, processing can be performed over consecutive clock cycles. In at least one embodiment, multiple thread groups can be executed concurrently on graphics multiprocessor 3134.

In at least one embodiment, graphics multiprocessor 3134 includes an internal cache memory to perform load and store operations. In at least one embodiment, graphics multiprocessor 3134 can forego an internal cache and use a cache memory (e.g., L1 cache 3148) within processing cluster 3194. In at least one embodiment, each graphics multiprocessor 3134 also has access to Level 2 (“L2”) caches within partition units (e.g., partition units 3120A-3120N of FIG. 31A) that are shared among all processing clusters 3194 and may be used to transfer data between threads. In at least one embodiment, graphics multiprocessor 3134 may also access off-chip global memory, which can include one or more of local parallel processor memory and/or system memory. In at least one embodiment, any memory external to parallel processing unit 3102 may be used as global memory. In at least one embodiment, processing cluster 3194 includes multiple instances of graphics multiprocessor 3134 that can share common instructions and data, which may be stored in L1 cache 3148.

In at least one embodiment, each processing cluster 3194 may include an MMU 3145 that is configured to map virtual addresses into physical addresses. In at least one embodiment, one or more instances of MMU 3145 may reside within memory interface 3118 of FIG. 31. In at least one embodiment, MMU 3145 includes a set of page table entries (“PTEs”) used to map a virtual address to a physical address of a tile and optionally a cache line index. In at least one embodiment, MMU 3145 may include address translation lookaside buffers (“TLBs”) or caches that may reside within graphics multiprocessor 3134 or L1 cache 3148 or processing cluster 3194. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 3194 may be configured such that each graphics multiprocessor 3134 is coupled to a texture unit 3136 for performing texture mapping operations, e.g., determining texture sample positions, reading texture data, and filtering texture data. In at least one embodiment, texture data is read from an internal texture L1 cache (not shown) or from an L1 cache within graphics multiprocessor 3134 and is fetched from an L2 cache, local parallel processor memory, or system memory, as needed. In at least one embodiment, each graphics multiprocessor 3134 outputs a processed task to data crossbar 3140 to provide the processed task to another processing cluster 3194 for further processing or to store the processed task in an L2 cache, a local parallel processor memory, or a system memory via memory crossbar 3116. In at least one embodiment, a pre-raster operations unit (“preROP”) 3142 is configured to receive data from graphics multiprocessor 3134, direct data to ROP units, which may be located with partition units as described herein (e.g., partition units 3120A-3120N of FIG. 31). In at least one embodiment, PreROP 3142 can perform optimizations for color blending, organize pixel color data, and perform address translations.

FIG. 31C illustrates a graphics multiprocessor 3196, in accordance with at least one embodiment. In at least one embodiment, graphics multiprocessor 3196 is graphics multiprocessor 3134 of FIG. 31B. In at least one embodiment, graphics multiprocessor 3196 couples with pipeline manager 3132 of processing cluster 3194. In at least one embodiment, graphics multiprocessor 3196 has an execution pipeline including but not limited to an instruction cache 3152, an instruction unit 3154, an address mapping unit 3156, a register file 3158, one or more GPGPU cores 3162, and one or more LSUs 3166. GPGPU cores 3162 and LSUs 3166 are coupled with cache memory 3172 and shared memory 3170 via a memory and cache interconnect 3168.

In at least one embodiment, instruction cache 3152 receives a stream of instructions to execute from pipeline manager 3132. In at least one embodiment, instructions are cached in instruction cache 3152 and dispatched for execution by instruction unit 3154. In at least one embodiment, instruction unit 3154 can dispatch instructions as thread groups (e.g., warps), with each thread of a thread group assigned to a different execution unit within GPGPU core 3162. In at least one embodiment, an instruction can access any of a local, shared, or global address space by specifying an address within a unified address space. In at least one embodiment, address mapping unit 3156 can be used to translate addresses in a unified address space into a distinct memory address that can be accessed by LSUs 3166.

In at least one embodiment, register file 3158 provides a set of registers for functional units of graphics multiprocessor 3196. In at least one embodiment, register file 3158 provides temporary storage for operands connected to data paths of functional units (e.g., GPGPU cores 3162, LSUs 3166) of graphics multiprocessor 3196. In at least one embodiment, register file 3158 is divided between each of functional units such that each functional unit is allocated a dedicated portion of register file 3158. In at least one embodiment, register file 3158 is divided between different thread groups being executed by graphics multiprocessor 3196.

In at least one embodiment, GPGPU cores 3162 can each include FPUs and/or integer ALUs that are used to execute instructions of graphics multiprocessor 3196. GPGPU cores 3162 can be similar in architecture or can differ in architecture. In at least one embodiment, a first portion of GPGPU cores 3162 include a single precision FPU and an integer ALU while a second portion of GPGPU cores 3162 include a double precision FPU. In at least one embodiment, FPUs can implement IEEE 754-2008 standard for floating point arithmetic or enable variable precision floating point arithmetic. In at least one embodiment, graphics multiprocessor 3196 can additionally include one or more fixed function or special function units to perform specific functions such as copy rectangle or pixel blending operations. In at least one embodiment one or more of GPGPU cores 3162 can also include fixed or special function logic.

In at least one embodiment, GPGPU cores 3162 include SIMD logic capable of performing a single instruction on multiple sets of data. In at least one embodiment GPGPU cores 3162 can physically execute SIMD4, SIMD8, and SIMD16 instructions and logically execute SIMD1, SIMD2, and SIMD32 instructions. In at least one embodiment, SIMD instructions for GPGPU cores 3162 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 3168 is an interconnect network that connects each functional unit of graphics multiprocessor 3196 to register file 3158 and to shared memory 3170. In at least one embodiment, memory and cache interconnect 3168 is a crossbar interconnect that allows LSU 3166 to implement load and store operations between shared memory 3170 and register file 3158. In at least one embodiment, register file 3158 can operate at a same frequency as GPGPU cores 3162, thus data transfer between GPGPU cores 3162 and register file 3158 is very low latency. In at least one embodiment, shared memory 3170 can be used to enable communication between threads that execute on functional units within graphics multiprocessor 3196. In at least one embodiment, cache memory 3172 can be used as a data cache for example, to cache texture data communicated between functional units and texture unit 3136. In at least one embodiment, shared memory 3170 can also be used as a program managed cached. In at least one embodiment, threads executing on GPGPU cores 3162 can programmatically store data within shared memory in addition to automatically cached data that is stored within cache memory 3172.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high speed interconnect such as PCIe or NVLink). In at least one embodiment, a GPU may be integrated on the same package or chip as cores and communicatively coupled to cores over a processor bus/interconnect that is internal to a package or a chip. In at least one embodiment, regardless of the manner in which a GPU is connected, processor cores may allocate work to the GPU in the form of sequences of commands/instructions contained in a WD. In at least one embodiment, the GPU then uses dedicated circuitry/logic for efficiently processing these commands/instructions.

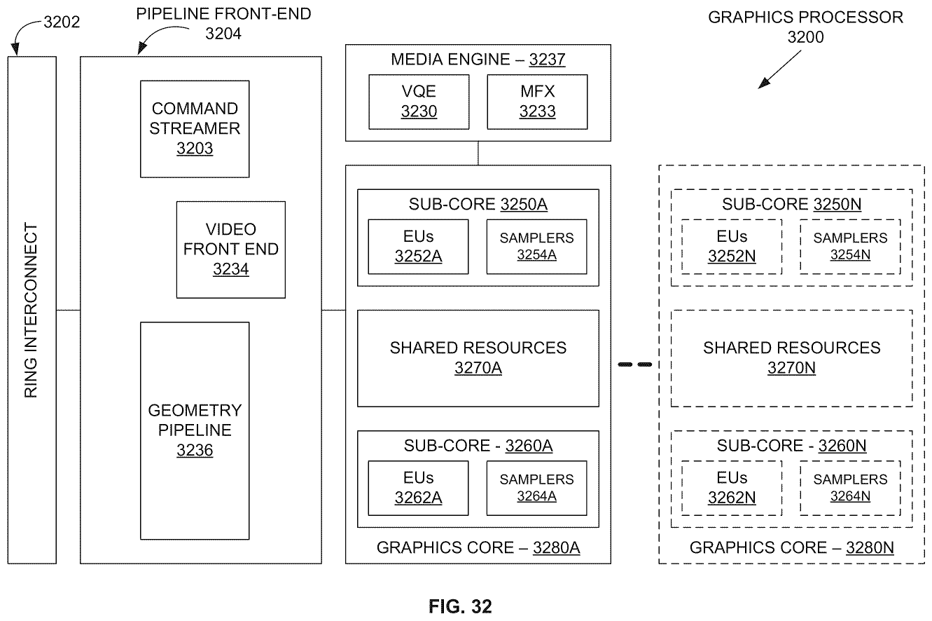

FIG. 32 illustrates a graphics processor 3200, in accordance with at least one embodiment. In at least one embodiment, graphics processor 3200 includes a ring interconnect 3202, a pipeline front-end 3204, a media engine 3237, and graphics cores 3280A-3280N. In at least one embodiment, ring interconnect 3202 couples graphics processor 3200 to other processing units, including other graphics processors or one or more general-purpose processor cores. In at least one embodiment, graphics processor 3200 is one of many processors integrated within a multi-core processing system.

In at least one embodiment, graphics processor 3200 receives batches of commands via ring interconnect 3202. In at least one embodiment, incoming commands are interpreted by a command streamer 3203 in pipeline front-end 3204. In at least one embodiment, graphics processor 3200 includes scalable execution logic to perform 3D geometry processing and media processing via graphics core(s) 3280A-3280N. In at least one embodiment, for 3D geometry processing commands, command streamer 3203 supplies commands to geometry pipeline 3236. In at least one embodiment, for at least some media processing commands, command streamer 3203 supplies commands to a video front end 3234, which couples with a media engine 3237. In at least one embodiment, media engine 3237 includes a Video Quality Engine (“VQE”) 3230 for video and image post-processing and a multi-format encode/decode (“MFX”) engine 3233 to provide hardware-accelerated media data encode and decode. In at least one embodiment, geometry pipeline 3236 and media engine 3237 each generate execution threads for thread execution resources provided by at least one graphics core 3280A.

In at least one embodiment, graphics processor 3200 includes scalable thread execution resources featuring modular graphics cores 3280A-3280N (sometimes referred to as core slices), each having multiple sub-cores 3250A-550N, 3260A-3260N (sometimes referred to as core sub-slices). In at least one embodiment, graphics processor 3200 can have any number of graphics cores 3280A through 3280N. In at least one embodiment, graphics processor 3200 includes a graphics core 3280A having at least a first sub-core 3250A and a second sub-core 3260A. In at least one embodiment, graphics processor 3200 is a low power processor with a single sub-core (e.g., sub-core 3250A). In at least one embodiment, graphics processor 3200 includes multiple graphics cores 3280A-3280N, each including a set of first sub-cores 3250A-3250N and a set of second sub-cores 3260A-3260N. In at least one embodiment, each sub-core in first sub-cores 3250A-3250N includes at least a first set of execution units (“EUs”) 3252A-3252N and media/texture samplers 3254A-3254N. In at least one embodiment, each sub-core in second sub-cores 3260A-3260N includes at least a second set of execution units 3262A-3262N and samplers 3264A-3264N. In at least one embodiment, each sub-core 3250A-3250N, 3260A-3260N shares a set of shared resources 3270A-3270N. In at least one embodiment, shared resources 3270 include shared cache memory and pixel operation logic.

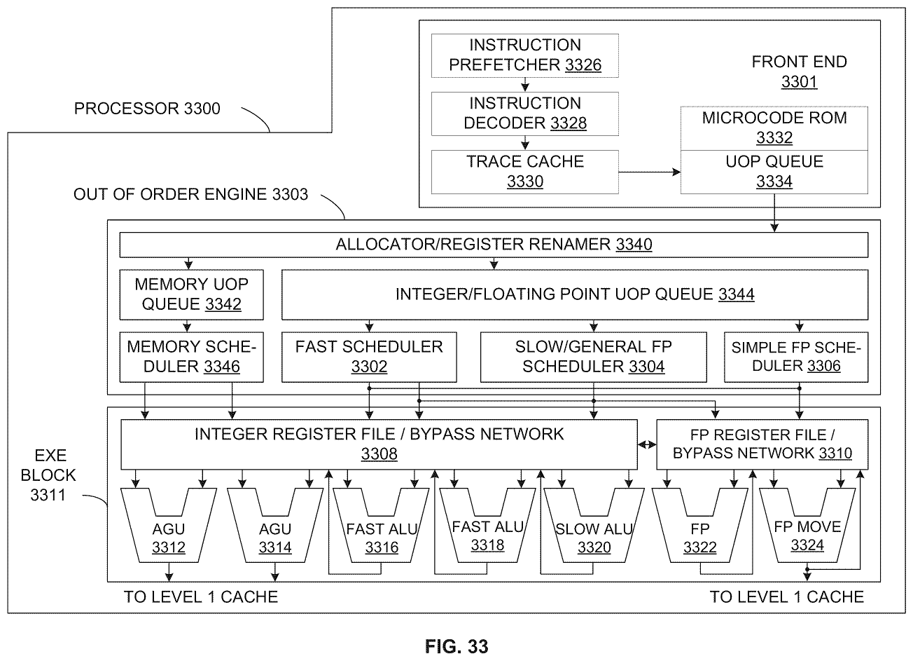

FIG. 33 illustrates a processor 3300, in accordance with at least one embodiment. In at least one embodiment, processor 3300 may include, without limitation, logic circuits to perform instructions. In at least one embodiment, processor 3300 may perform instructions, including x86 instructions, ARM instructions, specialized instructions for ASICs, etc. In at least one embodiment, processor 3310 may include registers to store packed data, such as 64-bit wide MMX™ registers in microprocessors enabled with MMX technology from Intel Corporation of Santa Clara, Calif. In at least one embodiment, MMX registers, available in both integer and floating point forms, may operate with packed data elements that accompany SIMD and streaming SIMD extensions (“SSE”) instructions. In at least one embodiment, 128-bit wide XMM registers relating to SSE2, SSE3, SSE4, AVX, or beyond (referred to generically as “SSEx”) technology may hold such packed data operands. In at least one embodiment, processors 3310 may perform instructions to accelerate CUDA programs.

In at least one embodiment, processor 3300 includes an in-order front end (“front end”) 3301 to fetch instructions to be executed and prepare instructions to be used later in processor pipeline. In at least one embodiment, front end 3301 may include several units. In at least one embodiment, an instruction prefetcher 3326 fetches instructions from memory and feeds instructions to an instruction decoder 3328 which in turn decodes or interprets instructions. For example, in at least one embodiment, instruction decoder 3328 decodes a received instruction into one or more operations called “micro-instructions” or “micro-operations” (also called “micro ops” or “uops”) for execution. In at least one embodiment, instruction decoder 3328 parses instruction into an opcode and corresponding data and control fields that may be used by micro-architecture to perform operations. In at least one embodiment, a trace cache 3330 may assemble decoded uops into program ordered sequences or traces in a uop queue 3334 for execution. In at least one embodiment, when trace cache 3330 encounters a complex instruction, a microcode ROM 3332 provides uops needed to complete an operation.

In at least one embodiment, some instructions may be converted into a single micro-op, whereas others need several micro-ops to complete full operation. In at least one embodiment, if more than four micro-ops are needed to complete an instruction, instruction decoder 3328 may access microcode ROM 3332 to perform instruction. In at least one embodiment, an instruction may be decoded into a small number of micro-ops for processing at instruction decoder 3328. In at least one embodiment, an instruction may be stored within microcode ROM 3332 should a number of micro-ops be needed to accomplish operation. In at least one embodiment, trace cache 3330 refers to an entry point programmable logic array (“PLA”) to determine a correct micro-instruction pointer for reading microcode sequences to complete one or more instructions from microcode ROM 3332. In at least one embodiment, after microcode ROM 3332 finishes sequencing micro-ops for an instruction, front end 3301 of machine may resume fetching micro-ops from trace cache 3330.

In at least one embodiment, out-of-order execution engine (“out of order engine”) 3303 may prepare instructions for execution. In at least one embodiment, out-of-order execution logic has a number of buffers to smooth out and re-order the flow of instructions to optimize performance as they go down a pipeline and get scheduled for execution. Out-of-order execution engine 3303 includes, without limitation, an allocator/register renamer 3340, a memory uop queue 3342, an integer/floating point uop queue 3344, a memory scheduler 3346, a fast scheduler 3302, a slow/general floating point scheduler (“slow/general FP scheduler”) 3304, and a simple floating point scheduler (“simple FP scheduler”) 3306. In at least one embodiment, fast schedule 3302, slow/general floating point scheduler 3304, and simple floating point scheduler 3306 are also collectively referred to herein as “uop schedulers 3302, 3304, 3306.” Allocator/register renamer 3340 allocates machine buffers and resources that each uop needs in order to execute. In at least one embodiment, allocator/register renamer 3340 renames logic registers onto entries in a register file. In at least one embodiment, allocator/register renamer 3340 also allocates an entry for each uop in one of two uop queues, memory uop queue 3342 for memory operations and integer/floating point uop queue 3344 for non-memory operations, in front of memory scheduler 3346 and uop schedulers 3302, 3304, 3306. In at least one embodiment, uop schedulers 3302, 3304, 3306, determine when a uop is ready to execute based on readiness of their dependent input register operand sources and availability of execution resources uops need to complete their operation. In at least one embodiment, fast scheduler 3302 of at least one embodiment may schedule on each half of main clock cycle while slow/general floating point scheduler 3304 and simple floating point scheduler 3306 may schedule once per main processor clock cycle. In at least one embodiment, uop schedulers 3302, 3304, 3306 arbitrate for dispatch ports to schedule uops for execution.

In at least one embodiment, execution block 3311 includes, without limitation, an integer register file/bypass network 3308, a floating point register file/bypass network (“FP register file/bypass network”) 3310, address generation units (“AGUs”) 3312 and 3314, fast ALUs 3316 and 3318, a slow ALU 3320, a floating point ALU (“FP”) 3322, and a floating point move unit (“FP move”) 3324. In at least one embodiment, integer register file/bypass network 3308 and floating point register file/bypass network 3310 are also referred to herein as “register files 3308, 3310.” In at least one embodiment, AGUSs 3312 and 3314, fast ALUs 3316 and 3318, slow ALU 3320, floating point ALU 3322, and floating point move unit 3324 are also referred to herein as “execution units 3312, 3314, 3316, 3318, 3320, 3322, and 3324.” In at least one embodiment, an execution block may include, without limitation, any number (including zero) and type of register files, bypass networks, address generation units, and execution units, in any combination.

In at least one embodiment, register files 3308, 3310 may be arranged between uop schedulers 3302, 3304, 3306, and execution units 3312, 3314, 3316, 3318, 3320, 3322, and 3324. In at least one embodiment, integer register file/bypass network 3308 performs integer operations. In at least one embodiment, floating point register file/bypass network 3310 performs floating point operations. In at least one embodiment, each of register files 3308, 3310 may include, without limitation, a bypass network that may bypass or forward just completed results that have not yet been written into register file to new dependent uops. In at least one embodiment, register files 3308, 3310 may communicate data with each other. In at least one embodiment, integer register file/bypass network 3308 may include, without limitation, two separate register files, one register file for low-order thirty-two bits of data and a second register file for high order thirty-two bits of data. In at least one embodiment, floating point register file/bypass network 3310 may include, without limitation, 128-bit wide entries because floating point instructions typically have operands from 64 to 128 bits in width.

In at least one embodiment, execution units 3312, 3314, 3316, 3318, 3320, 3322, 3324 may execute instructions. In at least one embodiment, register files 3308, 3310 store integer and floating point data operand values that micro-instructions need to execute. In at least one embodiment, processor 3300 may include, without limitation, any number and combination of execution units 3312, 3314, 3316, 3318, 3320, 3322, 3324. In at least one embodiment, floating point ALU 3322 and floating point move unit 3324 may execute floating point, MMX, SIMD, AVX and SSE, or other operations. In at least one embodiment, floating point ALU 3322 may include, without limitation, a 64-bit by 64-bit floating point divider to execute divide, square root, and remainder micro ops. In at least one embodiment, instructions involving a floating point value may be handled with floating point hardware. In at least one embodiment, ALU operations may be passed to fast ALUs 3316, 3318. In at least one embodiment, fast ALUS 3316, 3318 may execute fast operations with an effective latency of half a clock cycle. In at least one embodiment, most complex integer operations go to slow ALU 3320 as slow ALU 3320 may include, without limitation, integer execution hardware for long-latency type of operations, such as a multiplier, shifts, flag logic, and branch processing. In at least one embodiment, memory load/store operations may be executed by AGUs 3312, 3314. In at least one embodiment, fast ALU 3316, fast ALU 3318, and slow ALU 3320 may perform integer operations on 64-bit data operands. In at least one embodiment, fast ALU 3316, fast ALU 3318, and slow ALU 3320 may be implemented to support a variety of data bit sizes including sixteen, thirty-two, 128, 256, etc. In at least one embodiment, floating point ALU 3322 and floating point move unit 3324 may be implemented to support a range of operands having bits of various widths. In at least one embodiment, floating point ALU 3322 and floating point move unit 3324 may operate on 128-bit wide packed data operands in conjunction with SIMD and multimedia instructions.

In at least one embodiment, uop schedulers 3302, 3304, 3306 dispatch dependent operations before parent load has finished executing. In at least one embodiment, as uops may be speculatively scheduled and executed in processor 3300, processor 3300 may also include logic to handle memory misses. In at least one embodiment, if a data load misses in a data cache, there may be dependent operations in flight in pipeline that have left a scheduler with temporarily incorrect data. In at least one embodiment, a replay mechanism tracks and re-executes instructions that use incorrect data. In at least one embodiment, dependent operations might need to be replayed and independent ones may be allowed to complete. In at least one embodiment, schedulers and replay mechanisms of at least one embodiment of a processor may also be designed to catch instruction sequences for text string comparison operations.

In at least one embodiment, the term “registers” may refer to on-board processor storage locations that may be used as part of instructions to identify operands. In at least one embodiment, registers may be those that may be usable from outside of a processor (from a programmer's perspective). In at least one embodiment, registers might not be limited to a particular type of circuit. Rather, in at least one embodiment, a register may store data, provide data, and perform functions described herein. In at least one embodiment, registers described herein may be implemented by circuitry within a processor using any number of different techniques, such as dedicated physical registers, dynamically allocated physical registers using register renaming, combinations of dedicated and dynamically allocated physical registers, etc. In at least one embodiment, integer registers store 32-bit integer data. A register file of at least one embodiment also contains eight multimedia SIMD registers for packed data.

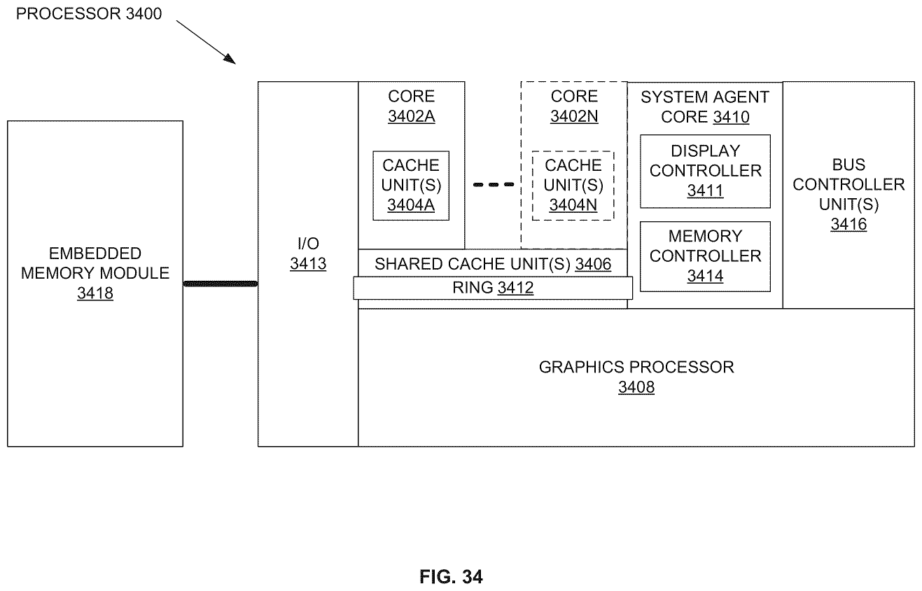

FIG. 34 illustrates a processor 3400, in accordance with at least one embodiment. In at least one embodiment, processor 3400 includes, without limitation, one or more processor cores (“cores”) 3402A-3402N, an integrated memory controller 3414, and an integrated graphics processor 3408. In at least one embodiment, processor 3400 can include additional cores up to and including additional processor core 3402N represented by dashed lined boxes. In at least one embodiment, each of processor cores 3402A-3402N includes one or more internal cache units 3404A-3404N. In at least one embodiment, each processor core also has access to one or more shared cached units 3406. In at least one embodiment, one or more processor cores 3402A-3402N are referred to as one or more compute units or computing units.

In at least one embodiment, internal cache units 3404A-3404N and shared cache units 3406 represent a cache memory hierarchy within processor 3400. In at least one embodiment, cache memory units 3404A-3404N may include at least one level of instruction and data cache within each processor core and one or more levels of shared mid-level cache, such as an L2, L3, Level 4 (“L4”), or other levels of cache, where a highest level of cache before external memory is classified as an LLC. In at least one embodiment, cache coherency logic maintains coherency between various cache units 3406 and 3404A-3404N.

In at least one embodiment, processor 3400 may also include a set of one or more bus controller units 3416 and a system agent core 3410. In at least one embodiment, one or more bus controller units 3416 manage a set of peripheral buses, such as one or more PCI or PCI express buses. In at least one embodiment, system agent core 3410 provides management functionality for various processor components. In at least one embodiment, system agent core 3410 includes one or more integrated memory controllers 3414 to manage access to various external memory devices (not shown).

In at least one embodiment, one or more of processor cores 3402A-3402N include support for simultaneous multi-threading. In at least one embodiment, system agent core 3410 includes components for coordinating and operating processor cores 3402A-3402N during multi-threaded processing. In at least one embodiment, system agent core 3410 may additionally include a power control unit (“PCU”), which includes logic and components to regulate one or more power states of processor cores 3402A-3402N and graphics processor 3408.

In at least one embodiment, processor 3400 additionally includes graphics processor 3408 to execute graphics processing operations. In at least one embodiment, graphics processor 3408 couples with shared cache units 3406, and system agent core 3410, including one or more integrated memory controllers 3414. In at least one embodiment, system agent core 3410 also includes a display controller 3411 to drive graphics processor output to one or more coupled displays. In at least one embodiment, display controller 3411 may also be a separate module coupled with graphics processor 3408 via at least one interconnect, or may be integrated within graphics processor 3408.

In at least one embodiment, a ring based interconnect unit 3412 is used to couple internal components of processor 3400. In at least one embodiment, an alternative interconnect unit may be used, such as a point-to-point interconnect, a switched interconnect, or other techniques. In at least one embodiment, graphics processor 3408 couples with ring interconnect 3412 via an I/O link 3413.

In at least one embodiment, I/O link 3413 represents at least one of multiple varieties of I/O interconnects, including an on package I/O interconnect which facilitates communication between various processor components and a high-performance embedded memory module 3418, such as an eDRAM module. In at least one embodiment, each of processor cores 3402A-3402N and graphics processor 3408 use embedded memory modules 3418 as a shared LLC.

In at least one embodiment, processor cores 3402A-3402N are homogeneous cores executing a common instruction set architecture. In at least one embodiment, processor cores 3402A-3402N are heterogeneous in terms of ISA, where one or more of processor cores 3402A-3402N execute a common instruction set, while one or more other cores of processor cores 3402A-34-02N executes a subset of a common instruction set or a different instruction set. In at least one embodiment, processor cores 3402A-3402N are heterogeneous in terms of microarchitecture, where one or more cores having a relatively higher power consumption couple with one or more cores having a lower power consumption. In at least one embodiment, processor 3400 can be implemented on one or more chips or as an SoC integrated circuit.

FIG. 35 illustrates a graphics processor core 3500, in accordance with at least one embodiment described. In at least one embodiment, graphics processor core 3500 is included within a graphics core array. In at least one embodiment, graphics processor core 3500, sometimes referred to as a core slice, can be one or multiple graphics cores within a modular graphics processor. In at least one embodiment, graphics processor core 3500 is exemplary of one graphics core slice, and a graphics processor as described herein may include multiple graphics core slices based on target power and performance envelopes. In at least one embodiment, each graphics core 3500 can include a fixed function block 3530 coupled with multiple sub-cores 3501A-3501F, also referred to as sub-slices, that include modular blocks of general-purpose and fixed function logic.

In at least one embodiment, fixed function block 3530 includes a geometry/fixed function pipeline 3536 that can be shared by all sub-cores in graphics processor 3500, for example, in lower performance and/or lower power graphics processor implementations. In at least one embodiment, geometry/fixed function pipeline 3536 includes a 3D fixed function pipeline, a video front-end unit, a thread spawner and thread dispatcher, and a unified return buffer manager, which manages unified return buffers.

In at least one embodiment, fixed function block 3530 also includes a graphics SoC interface 3537, a graphics microcontroller 3538, and a media pipeline 3539. Graphics SoC interface 3537 provides an interface between graphics core 3500 and other processor cores within an SoC integrated circuit. In at least one embodiment, graphics microcontroller 3538 is a programmable sub-processor that is configurable to manage various functions of graphics processor 3500, including thread dispatch, scheduling, and pre-emption. In at least one embodiment, media pipeline 3539 includes logic to facilitate decoding, encoding, pre-processing, and/or post-processing of multimedia data, including image and video data. In at least one embodiment, media pipeline 3539 implements media operations via requests to compute or sampling logic within sub-cores 3501-3501F.

In at least one embodiment, SoC interface 3537 enables graphics core 3500 to communicate with general-purpose application processor cores (e.g., CPUs) and/or other components within an SoC, including memory hierarchy elements such as a shared LLC memory, system RAM, and/or embedded on-chip or on-package DRAM. In at least one embodiment, SoC interface 3537 can also enable communication with fixed function devices within an SoC, such as camera imaging pipelines, and enables use of and/or implements global memory atomics that may be shared between graphics core 3500 and CPUs within an SoC. In at least one embodiment, SoC interface 3537 can also implement power management controls for graphics core 3500 and enable an interface between a clock domain of graphic core 3500 and other clock domains within an SoC. In at least one embodiment, SoC interface 3537 enables receipt of command buffers from a command streamer and global thread dispatcher that are configured to provide commands and instructions to each of one or more graphics cores within a graphics processor. In at least one embodiment, commands and instructions can be dispatched to media pipeline 3539, when media operations are to be performed, or a geometry and fixed function pipeline (e.g., geometry and fixed function pipeline 3536, geometry and fixed function pipeline 3514) when graphics processing operations are to be performed.

In at least one embodiment, graphics microcontroller 3538 can be configured to perform various scheduling and management tasks for graphics core 3500. In at least one embodiment, graphics microcontroller 3538 can perform graphics and/or compute workload scheduling on various graphics parallel engines within execution unit (EU) arrays 3502A-3502F, 3504A-3504F within sub-cores 3501A-3501F. In at least one embodiment, host software executing on a CPU core of an SoC including graphics core 3500 can submit workloads one of multiple graphic processor doorbells, which invokes a scheduling operation on an appropriate graphics engine. In at least one embodiment, scheduling operations include determining which workload to run next, submitting a workload to a command streamer, pre-empting existing workloads running on an engine, monitoring progress of a workload, and notifying host software when a workload is complete. In at least one embodiment, graphics microcontroller 3538 can also facilitate low-power or idle states for graphics core 3500, providing graphics core 3500 with an ability to save and restore registers within graphics core 3500 across low-power state transitions independently from an operating system and/or graphics driver software on a system.

In at least one embodiment, graphics core 3500 may have greater than or fewer than illustrated sub-cores 3501A-3501F, up to N modular sub-cores. For each set of N sub-cores, in at least one embodiment, graphics core 3500 can also include shared function logic 3510, shared and/or cache memory 3512, a geometry/fixed function pipeline 3514, as well as additional fixed function logic 3516 to accelerate various graphics and compute processing operations. In at least one embodiment, shared function logic 3510 can include logic units (e.g., sampler, math, and/or inter-thread communication logic) that can be shared by each N sub-cores within graphics core 3500. Shared and/or cache memory 3512 can be an LLC for N sub-cores 3501A-3501F within graphics core 3500 and can also serve as shared memory that is accessible by multiple sub-cores. In at least one embodiment, geometry/fixed function pipeline 3514 can be included instead of geometry/fixed function pipeline 3536 within fixed function block 3530 and can include same or similar logic units.

In at least one embodiment, graphics core 3500 includes additional fixed function logic 3516 that can include various fixed function acceleration logic for use by graphics core 3500. In at least one embodiment, additional fixed function logic 3516 includes an additional geometry pipeline for use in position only shading. In position-only shading, at least two geometry pipelines exist, whereas in a full geometry pipeline within geometry/fixed function pipeline 3516, 3536, and a cull pipeline, which is an additional geometry pipeline which may be included within additional fixed function logic 3516. In at least one embodiment, cull pipeline is a trimmed down version of a full geometry pipeline. In at least one embodiment, a full pipeline and a cull pipeline can execute different instances of an application, each instance having a separate context. In at least one embodiment, position only shading can hide long cull runs of discarded triangles, enabling shading to be completed earlier in some instances. For example, in at least one embodiment, cull pipeline logic within additional fixed function logic 3516 can execute position shaders in parallel with a main application and generally generates critical results faster than a full pipeline, as a cull pipeline fetches and shades position attribute of vertices, without performing rasterization and rendering of pixels to a frame buffer. In at least one embodiment, a cull pipeline can use generated critical results to compute visibility information for all triangles without regard to whether those triangles are culled. In at least one embodiment, a full pipeline (which in this instance may be referred to as a replay pipeline) can consume visibility information to skip culled triangles to shade only visible triangles that are finally passed to a rasterization phase.

In at least one embodiment, additional fixed function logic 3516 can also include general purpose processing acceleration logic, such as fixed function matrix multiplication logic, for accelerating CUDA programs.

In at least one embodiment, each graphics sub-core 3501A-3501F includes a set of execution resources that may be used to perform graphics, media, and compute operations in response to requests by graphics pipeline, media pipeline, or shader programs. In at least one embodiment, graphics sub-cores 3501A-3501F include multiple EU arrays 3502A-3502F, 3504A-3504F, thread dispatch and inter-thread communication (“TD/IC”) logic 3503A-3503F, a 3D (e.g., texture) sampler 3505A-3505F, a media sampler 3506A-3506F, a shader processor 3507A-3507F, and shared local memory (“SLM”) 3508A-3508F. EU arrays 3502A-3502F, 3504A-3504F each include multiple execution units, which are GPGPUs capable of performing floating-point and integer/fixed-point logic operations in service of a graphics, media, or compute operation, including graphics, media, or compute shader programs. In at least one embodiment, TD/IC logic 3503A-3503F performs local thread dispatch and thread control operations for execution units within a sub-core and facilitate communication between threads executing on execution units of a sub-core. In at least one embodiment, 3D sampler 3505A-3505F can read texture or other 3D graphics related data into memory. In at least one embodiment, 3D sampler can read texture data differently based on a configured sample state and texture format associated with a given texture. In at least one embodiment, media sampler 3506A-3506F can perform similar read operations based on a type and format associated with media data. In at least one embodiment, each graphics sub-core 3501A-3501F can alternately include a unified 3D and media sampler. In at least one embodiment, threads executing on execution units within each of sub-cores 3501A-3501F can make use of shared local memory 3508A-3508F within each sub-core, to enable threads executing within a thread group to execute using a common pool of on-chip memory.

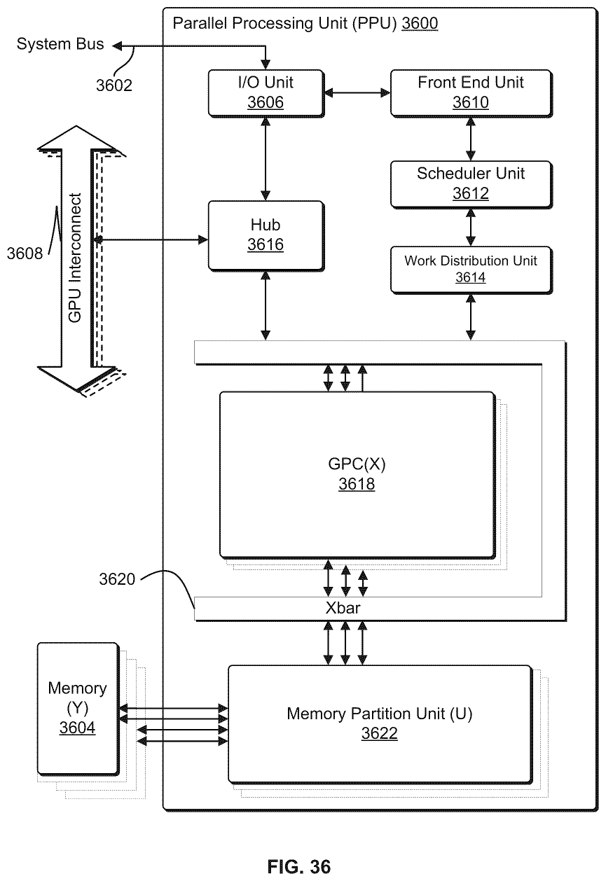

FIG. 36 illustrates a parallel processing unit (“PPU”) 3600, in accordance with at least one embodiment. In at least one embodiment, PPU 3600 is configured with machine-readable code that, if executed by PPU 3600, causes PPU 3600 to perform some or all of processes and techniques described herein. In at least one embodiment, PPU 3600 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, a thread refers to a thread of execution and is an instantiation of a set of instructions configured to be executed by PPU 3600. In at least one embodiment, PPU 3600 is a GPU configured to implement a graphics rendering pipeline for processing three-dimensional (“3D”) graphics data in order to generate two-dimensional (“2D”) image data for display on a display device such as an LCD device. In at least one embodiment, PPU 3600 is utilized to perform computations such as linear algebra operations and machine-learning operations. FIG. 36 illustrates an example parallel processor for illustrative purposes only and should be construed as a non-limiting example of a processor architecture that may be implemented in at least one embodiment.

In at least one embodiment, one or more PPUs 3600 are configured to accelerate High Performance Computing (“HPC”), data center, and machine learning applications. In at least one embodiment, one or more PPUs 3600 are configured to accelerate CUDA programs. In at least one embodiment, PPU 3600 includes, without limitation, an I/O unit 3606, a front-end unit 3610, a scheduler unit 3612, a work distribution unit 3614, a hub 3616, a crossbar (“Xbar”) 3620, one or more general processing clusters (“GPCs”) 3618, and one or more partition units (“memory partition units”) 3622. In at least one embodiment, PPU 3600 is connected to a host processor or other PPUs 3600 via one or more high-speed GPU interconnects (“GPU interconnects”) 3608. In at least one embodiment, PPU 3600 is connected to a host processor or other peripheral devices via a system bus or interconnect 3602. In at least one embodiment, PPU 3600 is connected to a local memory comprising one or more memory devices (“memory”) 3604. In at least one embodiment, memory devices 3604 include, without limitation, one or more dynamic random access memory (DRAM) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 3608 may refer to a wire-based multi-lane communications link that is used by systems to scale and include one or more PPUs 3600 combined with one or more CPUs, supports cache coherence between PPUs 3600 and CPUs, and CPU mastering. In at least one embodiment, data and/or commands are transmitted by high-speed GPU interconnect 3608 through hub 3616 to/from other units of PPU 3600 such as one or more copy engines, video encoders, video decoders, power management units, and other components which may not be explicitly illustrated in FIG. 36.

In at least one embodiment, I/O unit 3606 is configured to transmit and receive communications (e.g., commands, data) from a host processor (not illustrated in FIG. 36) over system bus 3602. In at least one embodiment, I/O unit 3606 communicates with host processor directly via system bus 3602 or through one or more intermediate devices such as a memory bridge. In at least one embodiment, I/O unit 3606 may communicate with one or more other processors, such as one or more of PPUs 3600 via system bus 3602. In at least one embodiment, I/O unit 3606 implements a PCIe interface for communications over a PCIe bus. In at least one embodiment, I/O unit 3606 implements interfaces for communicating with external devices.

In at least one embodiment, I/O unit 3606 decodes packets received via system bus 3602. In at least one embodiment, at least some packets represent commands configured to cause PPU 3600 to perform various operations. In at least one embodiment, I/O unit 3606 transmits decoded commands to various other units of PPU 3600 as specified by commands. In at least one embodiment, commands are transmitted to front-end unit 3610 and/or transmitted to hub 3616 or other units of PPU 3600 such as one or more copy engines, a video encoder, a video decoder, a power management unit, etc. (not explicitly illustrated in FIG. 36). In at least one embodiment, I/O unit 3606 is configured to route communications between and among various logical units of PPU 3600.

In at least one embodiment, a program executed by host processor encodes a command stream in a buffer that provides workloads to PPU 3600 for processing. In at least one embodiment, a workload comprises instructions and data to be processed by those instructions. In at least one embodiment, buffer is a region in a memory that is accessible (e.g., read/write) by both a host processor and PPU 3600 a host interface unit may be configured to access buffer in a system memory connected to system bus 3602 via memory requests transmitted over system bus 3602 by I/O unit 3606. In at least one embodiment, a host processor writes a command stream to a buffer and then transmits a pointer to the start of the command stream to PPU 3600 such that front-end unit 3610 receives pointers to one or more command streams and manages one or more command streams, reading commands from command streams and forwarding commands to various units of PPU 3600.

In at least one embodiment, front-end unit 3610 is coupled to scheduler unit 3612 that configures various GPCs 3618 to process tasks defined by one or more command streams. In at least one embodiment, scheduler unit 3612 is configured to track state information related to various tasks managed by scheduler unit 3612 where state information may indicate which of GPCs 3618 a task is assigned to, whether task is active or inactive, a priority level associated with task, and so forth. In at least one embodiment, scheduler unit 3612 manages execution of a plurality of tasks on one or more of GPCs 3618.

In at least one embodiment, scheduler unit 3612 is coupled to work distribution unit 3614 that is configured to dispatch tasks for execution on GPCs 3618. In at least one embodiment, work distribution unit 3614 tracks a number of scheduled tasks received from scheduler unit 3612 and work distribution unit 3614 manages a pending task pool and an active task pool for each of GPCs 3618. In at least one embodiment, pending task pool comprises a number of slots (e.g., 32 slots) that contain tasks assigned to be processed by a particular GPC 3618; active task pool may comprise a number of slots (e.g., 4 slots) for tasks that are actively being processed by GPCs 3618 such that as one of GPCs 3618 completes execution of a task, that task is evicted from active task pool for GPC 3618 and one of other tasks from pending task pool is selected and scheduled for execution on GPC 3618. In at least one embodiment, if an active task is idle on GPC 3618, such as while waiting for a data dependency to be resolved, then the active task is evicted from GPC 3618 and returned to a pending task pool while another task in the pending task pool is selected and scheduled for execution on GPC 3618.

In at least one embodiment, work distribution unit 3614 communicates with one or more GPCs 3618 via XBar 3620. In at least one embodiment, XBar 3620 is an interconnect network that couples many units of PPU 3600 to other units of PPU 3600 and can be configured to couple work distribution unit 3614 to a particular GPC 3618. In at least one embodiment, one or more other units of PPU 3600 may also be connected to XBar 3620 via hub 3616.

In at least one embodiment, tasks are managed by scheduler unit 3612 and dispatched to one of GPCs 3618 by work distribution unit 3614. GPC 3618 is configured to process task and generate results. In at least one embodiment, results may be consumed by other tasks within GPC 3618, routed to a different GPC 3618 via XBar 3620, or stored in memory 3604. In at least one embodiment, results can be written to memory 3604 via partition units 3622, which implement a memory interface for reading and writing data to/from memory 3604. In at least one embodiment, results can be transmitted to another PPU 3604 or CPU via high-speed GPU interconnect 3608. In at least one embodiment, PPU 3600 includes, without limitation, a number U of partition units 3622 that is equal to number of separate and distinct memory devices 3604 coupled to PPU 3600.

In at least one embodiment, a host processor executes a driver kernel that implements an application programming interface (“API”) that enables one or more applications executing on host processor to schedule operations for execution on PPU 3600. In at least one embodiment, multiple compute applications are simultaneously executed by PPU 3600 and PPU 3600 provides isolation, quality of service (“QoS”), and independent address spaces for multiple compute applications. In at least one embodiment, an application generates instructions (e.g., in the form of API calls) that cause a driver kernel to generate one or more tasks for execution by PPU 3600 and the driver kernel outputs tasks to one or more streams being processed by PPU 3600. In at least one embodiment, each task comprises one or more groups of related threads, which may be referred to as a warp. In at least one embodiment, a warp comprises a plurality of related threads (e.g., 32 threads) that can be executed in parallel. In at least one embodiment, cooperating threads can refer to a plurality of threads including instructions to perform a task and that exchange data through shared memory.

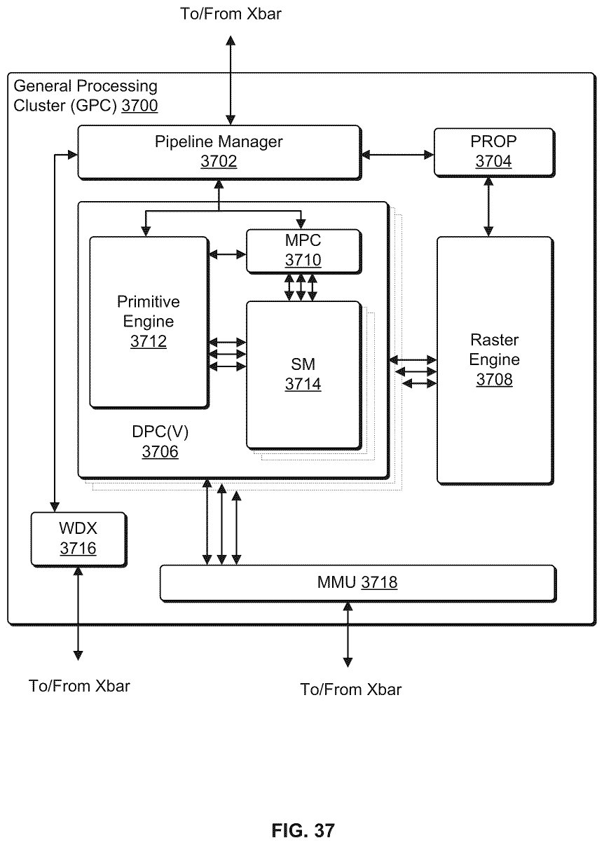

FIG. 37 illustrates a GPC 3700, in accordance with at least one embodiment. In at least one embodiment, GPC 3700 is GPC 3618 of FIG. 36. In at least one embodiment, each GPC 3700 includes, without limitation, a number of hardware units for processing tasks and each GPC 3700 includes, without limitation, a pipeline manager 3702, a pre-raster operations unit (“PROP”) 3704, a raster engine 3708, a work distribution crossbar (“WDX”) 3716, an MMU 3718, one or more Data Processing Clusters (“DPCs”) 3706, and any suitable combination of parts.

In at least one embodiment, operation of GPC 3700 is controlled by pipeline manager 3702. In at least one embodiment, pipeline manager 3702 manages configuration of one or more DPCs 3706 for processing tasks allocated to GPC 3700. In at least one embodiment, pipeline manager 3702 configures at least one of one or more DPCs 3706 to implement at least a portion of a graphics rendering pipeline. In at least one embodiment, DPC 3706 is configured to execute a vertex shader program on a programmable streaming multiprocessor (“SM”) 3714. In at least one embodiment, pipeline manager 3702 is configured to route packets received from a work distribution unit to appropriate logical units within GPC 3700 and, in at least one embodiment, some packets may be routed to fixed function hardware units in PROP 3704 and/or raster engine 3708 while other packets may be routed to DPCs 3706 for processing by a primitive engine 3712 or SM 3714. In at least one embodiment, pipeline manager 3702 configures at least one of DPCs 3706 to implement a computing pipeline. In at least one embodiment, pipeline manager 3702 configures at least one of DPCs 3706 to execute at least a portion of a CUDA program.

In at least one embodiment, PROP unit 3704 is configured to route data generated by raster engine 3708 and DPCs 3706 to a Raster Operations (“ROP”) unit in a partition unit, such as memory partition unit 3622 described in more detail above in conjunction with FIG. 36. In at least one embodiment, PROP unit 3704 is configured to perform optimizations for color blending, organize pixel data, perform address translations, and more. In at least one embodiment, raster engine 3708 includes, without limitation, a number of fixed function hardware units configured to perform various raster operations and, in at least one embodiment, raster engine 3708 includes, without limitation, a setup engine, a coarse raster engine, a culling engine, a clipping engine, a fine raster engine, a tile coalescing engine, and any suitable combination thereof. In at least one embodiment, a setup engine receives transformed vertices and generates plane equations associated with geometric primitive defined by vertices; plane equations are transmitted to a coarse raster engine to generate coverage information (e.g., an x, y coverage mask for a tile) for a primitive; the output of the coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, the output of raster engine 3708 comprises fragments to be processed by any suitable entity such as by a fragment shader implemented within DPC 3706.

In at least one embodiment, each DPC 3706 included in GPC 3700 comprise, without limitation, an M-Pipe Controller (“MPC”) 3710; primitive engine 3712; one or more SMs 3714; and any suitable combination thereof. In at least one embodiment, MPC 3710 controls operation of DPC 3706, routing packets received from pipeline manager 3702 to appropriate units in DPC 3706. In at least one embodiment, packets associated with a vertex are routed to primitive engine 3712, which is configured to fetch vertex attributes associated with vertex from memory; in contrast, packets associated with a shader program may be transmitted to SM 3714.

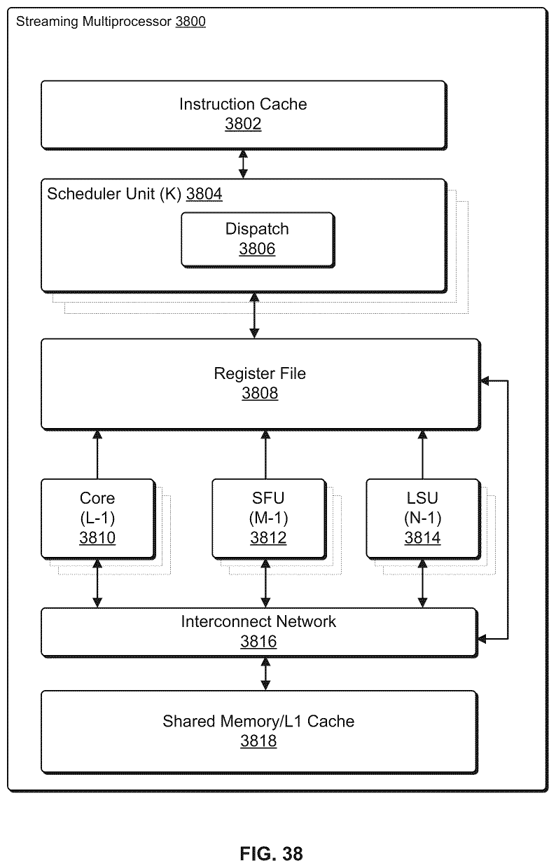

In at least one embodiment, SM 3714 comprises, without limitation, a programmable streaming processor that is configured to process tasks represented by a number of threads. In at least one embodiment, SM 3714 is multi-threaded and configured to execute a plurality of threads (e.g., 32 threads) from a particular group of threads concurrently and implements a SIMD architecture where each thread in a group of threads (e.g., a warp) is configured to process a different set of data based on same set of instructions. In at least one embodiment, all threads in group of threads execute same instructions. In at least one embodiment, SM 3714 implements a SIMT architecture wherein each thread in a group of threads is configured to process a different set of data based on same set of instructions, but where individual threads in group of threads are allowed to diverge during execution. In at least one embodiment, a program counter, a call stack, and an execution state is maintained for each warp, enabling concurrency between warps and serial execution within warps when threads within a warp diverge. In another embodiment, a program counter, a call stack, and an execution state is maintained for each individual thread, enabling equal concurrency between all threads, within and between warps. In at least one embodiment, an execution state is maintained for each individual thread and threads executing the same instructions may be converged and executed in parallel for better efficiency. At least one embodiment of SM 3714 is described in more detail in conjunction with FIG. 38.

In at least one embodiment, MMU 3718 provides an interface between GPC 3700 and a memory partition unit (e.g., partition unit 3622 of FIG. 36) and MMU 3718 provides translation of virtual addresses into physical addresses, memory protection, and arbitration of memory requests. In at least one embodiment, MMU 3718 provides one or more translation lookaside buffers (TLBs) for performing translation of virtual addresses into physical addresses in memory.

FIG. 38 illustrates a streaming multiprocessor (“SM”) 3800, in accordance with at least one embodiment. In at least one embodiment, SM 3800 is SM 3714 of FIG. 37. In at least one embodiment, SM 3800 includes, without limitation, an instruction cache 3802; one or more scheduler units 3804; a register file 3808; one or more processing cores (“cores”) 3810; one or more special function units (“SFUs”) 3812; one or more LSUs 3814; an interconnect network 3816; a shared memory/L1 cache 3818; and any suitable combination thereof. In at least one embodiment, a work distribution unit dispatches tasks for execution on GPCs of parallel processing units (PPUs) and each task is allocated to a particular Data Processing Cluster (DPC) within a GPC and, if a task is associated with a shader program, then the task is allocated to one of SMs 3800. In at least one embodiment, scheduler unit 3804 receives tasks from a work distribution unit and manages instruction scheduling for one or more thread blocks assigned to SM 3800. In at least one embodiment, scheduler unit 3804 schedules thread blocks for execution as warps of parallel threads, wherein each thread block is allocated at least one warp. In at least one embodiment, each warp executes threads. In at least one embodiment, scheduler unit 3804 manages a plurality of different thread blocks, allocating warps to different thread blocks and then dispatching instructions from a plurality of different cooperative groups to various functional units (e.g., processing cores 3810, SFUs 3812, and LSUs 3814) during each clock cycle. In at least one embodiment, SM 3800 includes one or more thread block clusters, where a thread block cluster can enable programmatic control of locality at a granularity larger than a single thread block of a single streaming multiprocessor (SM). In at least one embodiment, thread block clusters (also referred to as “clusters”) enables multiple thread blocks running concurrently across streaming multiprocessors to synchronize and collaboratively fetch, exchange, or otherwise use data.

In at least one embodiment, “cooperative groups” may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, APIs of conventional programming models provide a single, simple construct for synchronizing cooperating threads: a barrier across all threads of a thread block (e.g., syncthreads( ) function). However, in at least one embodiment, programmers may define groups of threads at smaller than thread block granularities and synchronize within defined groups to enable greater performance, design flexibility, and software reuse in the form of collective group-wide function interfaces. In at least one embodiment, cooperative groups enable programmers to define groups of threads explicitly at sub-block and multi-block granularities, and to perform collective operations such as synchronization on threads in a cooperative group. In at least one embodiment, a sub-block granularity is as small as a single thread. In at least one embodiment, a programming model supports clean composition across software boundaries, so that libraries and utility functions can synchronize safely within their local context without having to make assumptions about convergence. In at least one embodiment, cooperative group primitives enable new patterns of cooperative parallelism, including, without limitation, producer-consumer parallelism, opportunistic parallelism, and global synchronization across an entire grid of thread blocks.

In at least one embodiment, a dispatch unit 3806 is configured to transmit instructions to one or more of functional units and scheduler unit 3804 includes, without limitation, two dispatch units 3806 that enable two different instructions from same warp to be dispatched during each clock cycle. In at least one embodiment, each scheduler unit 3804 includes a single dispatch unit 3806 or additional dispatch units 3806.

In at least one embodiment, each SM 3800, in at least one embodiment, includes, without limitation, register file 3808 that provides a set of registers for functional units of SM 3800. In at least one embodiment, register file 3808 is divided between each of the functional units such that each functional unit is allocated a dedicated portion of register file 3808. In at least one embodiment, register file 3808 is divided between different warps being executed by SM 3800 and register file 3808 provides temporary storage for operands connected to data paths of functional units. In at least one embodiment, each SM 3800 comprises, without limitation, a plurality of L processing cores 3810. In at least one embodiment, SM 3800 includes, without limitation, a large number (e.g., 128 or more) of distinct processing cores 3810. In at least one embodiment, each processing core 3810 includes, without limitation, a fully-pipelined, single-precision, double-precision, and/or mixed precision processing unit that includes, without limitation, a floating point arithmetic logic unit and an integer arithmetic logic unit. In at least one embodiment, floating point arithmetic logic units implement IEEE 754-2008 standard for floating point arithmetic. In at least one embodiment, processing cores 3810 include, without limitation, 64 single-precision (32-bit) floating point cores, 64 integer cores, 32 double-precision (64-bit) floating point cores, and 8 tensor cores.

In at least one embodiment, tensor cores are configured to perform matrix operations. In at least one embodiment, one or more tensor cores are included in processing cores 3810. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA-C++ API, exposes specialized matrix load, matrix multiply and accumulate, and matrix store operations to efficiently use tensor cores from a CUDA-C++ program. In at least one embodiment, at the CUDA level, a warp-level interface assumes 16×16 size matrices spanning all 32 threads of a warp.

In at least one embodiment, each SM 3800 comprises, without limitation, M SFUs 3812 that perform special functions (e.g., attribute evaluation, reciprocal square root, and like). In at least one embodiment, SFUs 3812 include, without limitation, a tree traversal unit configured to traverse a hierarchical tree data structure. In at least one embodiment, SFUs 3812 include, without limitation, a texture unit configured to perform texture map filtering operations. In at least one embodiment, texture units are configured to load texture maps (e.g., a 2D array of texels) from memory and sample texture maps to produce sampled texture values for use in shader programs executed by SM 3800. In at least one embodiment, texture maps are stored in shared memory/L1 cache 3818. In at least one embodiment, texture units implement texture operations such as filtering operations using mip-maps (e.g., texture maps of varying levels of detail). In at least one embodiment, each SM 3800 includes, without limitation, two texture units.

In at least one embodiment, each SM 3800 comprises, without limitation, N LSUs 3814 that implement load and store operations between shared memory/L1 cache 3818 and register file 3808. In at least one embodiment, each SM 3800 includes, without limitation, interconnect network 3816 that connects each of the functional units to register file 3808 and LSU 3814 to register file 3808 and shared memory/L1 cache 3818. In at least one embodiment, interconnect network 3816 is a crossbar that can be configured to connect any of the functional units to any of the registers in register file 3808 and connect LSUs 3814 to register file 3808 and memory locations in shared memory/L1 cache 3818.

In at least one embodiment, shared memory/L1 cache 3818 is an array of on-chip memory that allows for data storage and communication between SM 3800 and a primitive engine and between threads in SM 3800. In at least one embodiment, shared memory/L1 cache 3818 comprises, without limitation, 128 KB of storage capacity and is in a path from SM 3800 to a partition unit. In at least one embodiment, shared memory/L1 cache 3818 is used to cache reads and writes. In at least one embodiment, one or more of shared memory/L1 cache 3818, L2 cache, and memory are backing stores.

In at least one embodiment, combining data cache and shared memory functionality into a single memory block provides improved performance for both types of memory accesses. In at least one embodiment, capacity is used or is usable as a cache by programs that do not use shared memory, such as if shared memory is configured to use half of capacity, texture and load/store operations can use remaining capacity. In at least one embodiment, integration within shared memory/L1 cache 3818 enables shared memory/L1 cache 3818 to function as a high-throughput conduit for streaming data while simultaneously providing high-bandwidth and low-latency access to frequently reused data. In at least one embodiment, when configured for general purpose parallel computation, a simpler configuration can be used compared with graphics processing. In at least one embodiment, fixed function GPUs are bypassed, creating a much simpler programming model. In at least one embodiment and in a general purpose parallel computation configuration, a work distribution unit assigns and distributes blocks of threads directly to DPCs. In at least one embodiment, threads in a block execute the same program, using a unique thread ID in a calculation to ensure each thread generates unique results, using SM 3800 to execute a program and perform calculations, shared memory/L1 cache 3818 to communicate between threads, and LSU 3814 to read and write global memory through shared memory/L1 cache 3818 and a memory partition unit. In at least one embodiment, when configured for general purpose parallel computation, SM 3800 writes commands that scheduler unit 3804 can use to launch new work on DPCs. In at least one embodiment, SM 3800 includes one or more distributed shared memories (or distributed shared memory) that enable direct SM-to-SM operations such as loading, storing, and performing atomics across multiple SM shared memory blocks.

In at least one embodiment, SM 3800 includes one or more asynchronous execution functions that include a tensor memory accelerator (TMA) unit that can transfer blocks of data between global memory and shared memory. In at least one embodiment, one or more processors uses or access one or more TMAs to perform bi-directional copy operations, e.g., from global to shared memory and vice versa. In at least one embodiment, SM 3800 includes one or more TMAs to asynchronously copy between thread blocks in a cluster. In at least one embodiment, SM 3800 includes one or more asynchronous transaction barriers to perform atomic data movement and synchronization. In at least one embodiment, SM 3800 includes a tensor core transformer engine, which includes software and one or more cores to accelerate transformer model training and inferencing. In at least one embodiment, a transformer one or more processor cores performing one or more tensor core transformer engines manage and dynamically choose between FP8 and 16-bit calculations by re-casting and scaling between FP8 and 16-bit in each layer of one or more neural networks.

In at least one embodiment, PPU is included in or coupled to a desktop computer, a laptop computer, a tablet computer, servers, supercomputers, a smart-phone (e.g., a wireless, hand-held device), a PDA, a digital camera, a vehicle, a head mounted display, a hand-held electronic device, and more. In at least one embodiment, PPU is embodied on a single semiconductor substrate. In at least one embodiment, PPU is included in an SoC along with one or more other devices such as additional PPUs, memory, a RISC CPU, an MMU, a digital-to-analog converter (“DAC”), and like.

In at least one embodiment, PPU may be included on a graphics card that includes one or more memory devices. In at least one embodiment, a graphics card may be configured to interface with a PCIe slot on a motherboard of a desktop computer. In at least one embodiment, PPU may be an integrated GPU (“iGPU”) included in chipset of motherboard.

### Software Constructions for General-Purpose Computing

The following figures set forth, without limitation, exemplary software constructs for implementing at least one embodiment.

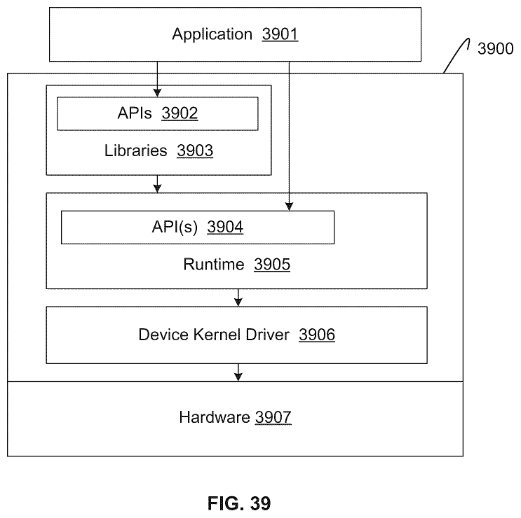

FIG. 39 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 3900 of a programming platform provides an execution environment for an application 3901. In at least one embodiment, application 3901 may include any computer software capable of being launched on software stack 3900. In at least one embodiment, application 3901 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 3901 and software stack 3900 run on hardware 3907. Hardware 3907 may include one or more GPUs, CPUs, FPGAs, AI engines, and/or other types of compute devices that support a programming platform, in at least one embodiment. In at least one embodiment, such as with CUDA, software stack 3900 may be vendor specific and compatible with only devices from particular vendor(s). In at least one embodiment, such as in with OpenCL, software stack 3900 may be used with devices from different vendors. In at least one embodiment, hardware 3907 includes a host connected to one more devices that can be accessed to perform computational tasks via application programming interface (“API”) calls. A device within hardware 3907 may include, but is not limited to, a GPU, FPGA, AI engine, or other compute device (but may also include a CPU) and its memory, as opposed to a host within hardware 3907 that may include, but is not limited to, a CPU (but may also include a compute device) and its memory, in at least one embodiment.

In at least one embodiment, software stack 3900 of a programming platform includes, without limitation, a number of libraries 3903, a runtime 3905, and a device kernel driver 3906. Each of libraries 3903 may include data and programming code that can be used by computer programs and leveraged during software development, in at least one embodiment. In at least one embodiment, libraries 3903 may include, but are not limited to, pre-written code and subroutines, classes, values, type specifications, configuration data, documentation, help data, and/or message templates. In at least one embodiment, libraries 3903 include functions that are optimized for execution on one or more types of devices. In at least one embodiment, libraries 3903 may include, but are not limited to, functions for performing mathematical, deep learning, and/or other types of operations on devices. In at least one embodiment, libraries 3903 are associated with corresponding APIs 3902, which may include one or more APIs, that expose functions implemented in libraries 3903. In at least one embodiment, a processor (e.g. CPU, GPU) performs, calls, or otherwise uses one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. In at least one embodiment, a processor performs an API or calls an API from memory to be performed to support dynamic stream priority (e.g., updating priority while a stream is being used to perform operations). For example, when a processor performs said API, it allows a programmer to copy stream priority from one stream to one or more other streams.

In at least one embodiment, software stack 3900 includes an API to support dynamic stream priority (e.g., updating priority while a stream is being used to perform operations), which allows a programmer to set priority of a stream at any time after creation. In at least one embodiment, software stack 3900 includes an API to support dynamic stream priority (e.g., updating priority while the stream is being used to perform operations), which allows a programmer to obtain current priority of a stream, where the priority is one of a plurality of attributes of a stream. In at least one embodiment, software stack 3900 includes an API to support dynamic stream priority (e.g., updating priority while the stream is being used to perform operations), which allows a programmer to obtain current priority of a stream as a single attribute. In at least one embodiment, software stack 3900 includes an API to support dynamic stream priority (e.g., updating priority while the stream is being used to perform operations), which allows a programmer to launch a kernel to perform operations on a stream at a set priority, which may be different from the stream priority. In at least one embodiment, software stack 3900 includes an API to indicate whether an object (e.g., a thread synchronization object such as a barrier) tracks whether all data movement operations for a set of threads operating on a GPU are complete has a specified state after a specified period of time, where a specified state can be a state indicating that data has been moved and is ready for use, and is specified using an expected parity value as an input to the API.

In at least one embodiment, software stack 3900 includes one or more APIs to updated kernels. In at least one embodiment, a processor performs an API or calls an API from memory to be performed to update to an existing API is to support context-free kernels, which allows a programmer to add a kernel node to a graph without a graphics context, so that a graphics context can be dynamically associated with a kernel at runtime. In at least one embodiment, software stack 3900 includes one or more APIs to allow a programmer to obtain a kernel identifier and a graphics context as separate parameters from a kernel node, so that parameters to be obtained from kernels and from context-free kernels. In at least one embodiment, software stack 3900 includes one or more APIs to use parallel processor(s), such as one or more graphics processing units, to launch task graphs (e.g., task graphs) and to execute one or more task graphs (e.g., including one or more programs).

In at least one embodiment, software stack 3900 includes one or more APIs to associate one or more instructions with one or more memory ordering operations, such as a fence or membar operation. In at least one embodiment, instructions are associated with one or more domains such that a memory ordering operation is executed in association to one or more particular domains without interfering with instructions of other domains. an API to indicate a thread has arrived (e.g., at a thread synchronization barrier), or finished a stage of work in relation to asynchronous data movement operations on a GPU. In at least one embodiment, software stack 3900 includes one or more to allow programmers to manually indicate an expected transaction count when a thread has finished a stage of work, which is used to update an object that tracks whether all data movement operations for a set of threads are complete.

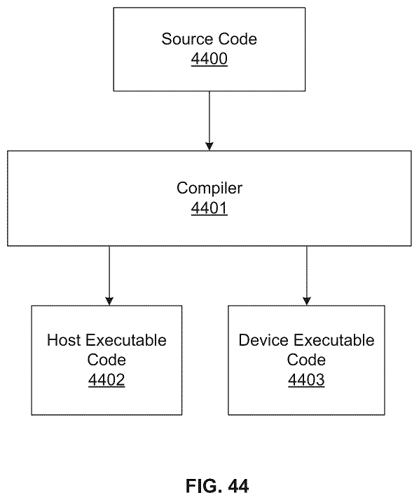

In at least one embodiment, application 3901 is written as source code that is compiled into executable code, as discussed in greater detail below in conjunction with FIGS. 44-46. Executable code of application 3901 may run, at least in part, on an execution environment provided by software stack 3900, in at least one embodiment. In at least one embodiment, during execution of application 3901, code may be reached that needs to run on a device, as opposed to a host. In such a case, runtime 3905 may be called to load and launch requisite code on the device, in at least one embodiment. In at least one embodiment, runtime 3905 may include any technically feasible runtime system that is able to support execution of application S01.

In at least one embodiment, runtime 3905 is implemented as one or more runtime libraries associated with corresponding APIs, which are shown as API(s) 3904. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 3904 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, one or more processors disclosed in “processing systems” can perform, access, or otherwise use software stack 3900. For example, APU 2600, CPU 2700, 29A-29B exemplary graphics processors, general-purpose graphics processing unit (“GPGPU”) 3030, parallel processor 3100, processing cluster 3194, graphics multiprocessor 3134, graphics multiprocessor 3196, graphics processor 3200, processor 3300, processor 3400, parallel processing unit (“PPU”) 3600, GPC 3700, and/or streaming multiprocessor (“SM”) 3800 can perform, use, call, or otherwise implement (e.g., through accessing a memory) one or more APIs included in software stack 3900.

In at least one embodiment, device kernel driver 3906 is configured to facilitate communication with an underlying device. In at least one embodiment, device kernel driver 3906 may provide low-level functionalities upon which APIs, such as API(s) 3904, and/or other software relies. In at least one embodiment, device kernel driver 3906 may be configured to compile intermediate representation (“IR”) code into binary code at runtime. For CUDA, device kernel driver 3906 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 3906 to compile IR code at runtime.

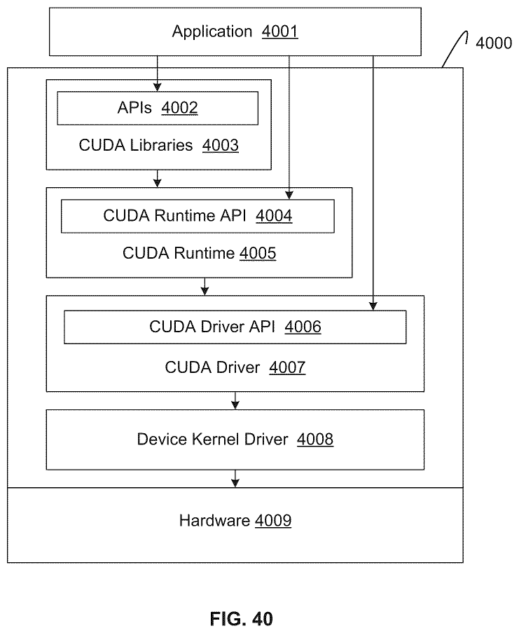

FIG. 40 illustrates a CUDA implementation of software stack 3900 of FIG. 39, in accordance with at least one embodiment. In at least one embodiment, a CUDA software stack 4000, on which an application 4001 may be launched, includes CUDA libraries 4003, a CUDA runtime 4005, a CUDA driver 4007, and a device kernel driver 4008. In at least one embodiment, CUDA software stack 4000 executes on hardware 4009, which may include a GPU that supports CUDA and is developed by NVIDIA Corporation of Santa Clara, CA.

In at least one embodiment, application 4001, CUDA runtime 4005, and device kernel driver 4008 may perform similar functionalities as application 3901, runtime 3905, and device kernel driver 3906, respectively, which are described above in conjunction with FIG. 39. In at least one embodiment, CUDA driver 4007 includes a library (libcuda.so) that implements a CUDA driver API 4006. Similar to a CUDA runtime API 4004 implemented by a CUDA runtime library (cudart), CUDA driver API 4006 may, without limitation, expose functions for memory management, execution control, device management, error handling, synchronization, and/or graphics interoperability, among other things, in at least one embodiment. In at least one embodiment, CUDA driver API 4006 differs from CUDA runtime API 4004 in that CUDA runtime API 4004 simplifies device code management by providing implicit initialization, context (analogous to a process) management, and module (analogous to dynamically loaded libraries) management. In contrast to high-level CUDA runtime API 4004, CUDA driver API 4006 is a low-level API providing more fine-grained control of the device, particularly with respect to contexts and module loading, in at least one embodiment. In at least one embodiment, CUDA driver API 4006 may expose functions for context management that are not exposed by CUDA runtime API 4004. In at least one embodiment, CUDA driver API 4006 is also language-independent and supports, e.g., OpenCL in addition to CUDA runtime API 4004. Further, in at least one embodiment, development libraries, including CUDA runtime 4005, may be considered as separate from driver components, including user-mode CUDA driver 4007 and kernel-mode device driver 4008 (also sometimes referred to as a “display” driver).

In at least one embodiment, CUDA libraries 4003 may include, but are not limited to, mathematical libraries, deep learning libraries, parallel algorithm libraries, and/or signal/image/video processing libraries, which parallel computing applications such as application 4001 may utilize. In at least one embodiment, CUDA libraries 4003 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 4003 may include deep learning libraries such as a cuDNN library of primitives for deep neural networks and a TensorRT platform for high-performance deep learning inference, among others.

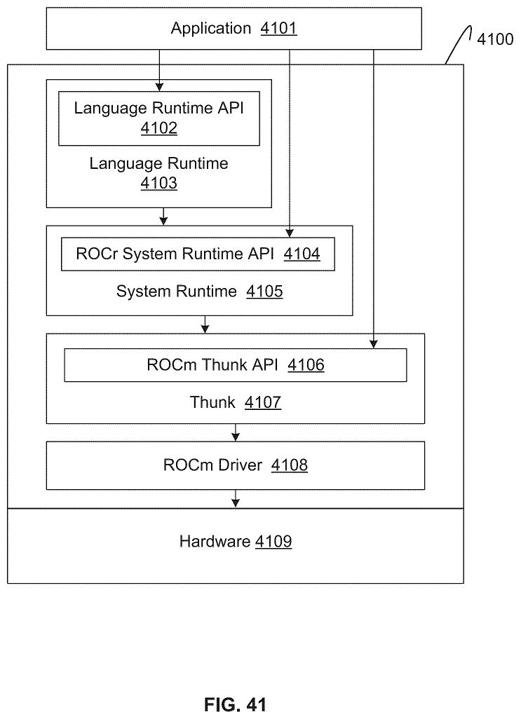

FIG. 41 illustrates a ROCm implementation of software stack 3900 of FIG. 39, in accordance with at least one embodiment. In at least one embodiment, a ROCm software stack 4100, on which an application 4101 may be launched, includes a language runtime 4103, a system runtime 4105, a thunk 4107, and a ROCm kernel driver 4108. In at least one embodiment, ROCm software stack 4100 executes on hardware 4109, which may include a GPU that supports ROCm and is developed by AMD Corporation of Santa Clara, CA.

In at least one embodiment, application 4101 may perform similar functionalities as application 3901 discussed above in conjunction with FIG. 39. In addition, language runtime 4103 and system runtime 4105 may perform similar functionalities as runtime 3905 discussed above in conjunction with FIG. 39, in at least one embodiment. In at least one embodiment, language runtime 4103 and system runtime 4105 differ in that system runtime 4105 is a language-independent runtime that implements a ROCr system runtime API 4104 and makes use of a Heterogeneous System Architecture (“HSA”) Runtime API. HSA runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 4105, language runtime 4103 is an implementation of a language-specific runtime API 4102 layered on top of ROCr system runtime API 4104, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 4004 discussed above in conjunction with FIG. 40, such as functions for memory management, execution control, device management, error handling, and synchronization, among other things.

In at least one embodiment, thunk (ROCt) 4107 is an interface 4106 that can be used to interact with underlying ROCm driver 4108. In at least one embodiment, ROCm driver 4108 is a ROCk driver, which is a combination of an AMDGPU driver and a HSA kernel driver (amdkfd). In at least one embodiment, AMDGPU driver is a device kernel driver for GPUs developed by AMD that performs similar functionalities as device kernel driver 3906 discussed above in conjunction with FIG. 39. In at least one embodiment, HSA kernel driver is a driver permitting different types of processors to share system resources more effectively via hardware features.

In at least one embodiment, various libraries (not shown) may be included in ROCm software stack 4100 above language runtime 4103 and provide functionality similarity to CUDA libraries 4003, discussed above in conjunction with FIG. 40. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

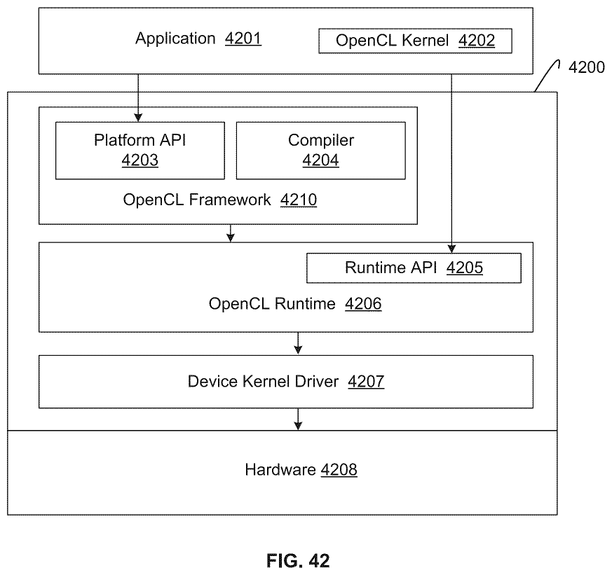

FIG. 42 illustrates an OpenCL implementation of software stack 3900 of FIG. 39, in accordance with at least one embodiment. In at least one embodiment, an OpenCL software stack 4200, on which an application 4201 may be launched, includes an OpenCL framework 4210, an OpenCL runtime 4206, and a driver 4207. In at least one embodiment, OpenCL software stack 4200 executes on hardware 4009 that is not vendor-specific. As OpenCL is supported by devices developed by different vendors, specific OpenCL drivers may be required to interoperate with hardware from such vendors, in at least one embodiment.

In at least one embodiment, application 4201, OpenCL runtime 4206, device kernel driver 4207, and hardware 4208 may perform similar functionalities as application 3901, runtime 3905, device kernel driver 3906, and hardware 3907, respectively, that are discussed above in conjunction with FIG. 39. In at least one embodiment, application 4201 further includes an OpenCL kernel 4202 with code that is to be executed on a device.

In at least one embodiment, OpenCL defines a “platform” that allows a host to control devices connected to the host. In at least one embodiment, an OpenCL framework provides a platform layer API and a runtime API, shown as platform API 4203 and runtime API 4205. In at least one embodiment, runtime API 4205 uses contexts to manage execution of kernels on devices. In at least one embodiment, each identified device may be associated with a respective context, which runtime API 4205 may use to manage command queues, program objects, and kernel objects, share memory objects, among other things, for that device. In at least one embodiment, platform API 4203 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 4204 is also included in OpenCL frame-work 4210. Source code may be compiled offline prior to executing an application or online during execution of an application, in at least one embodiment. In contrast to CUDA and ROCm, OpenCL applications in at least one embodiment may be compiled online by compiler 4204, which is included to be representative of any number of compilers that may be used to compile source code and/or IR code, such as Standard Portable Intermediate Representation (“SPIR-V”) code, into binary code. Alternatively, in at least one embodiment, OpenCL ap-plications may be compiled offline, prior to execution of such applications.

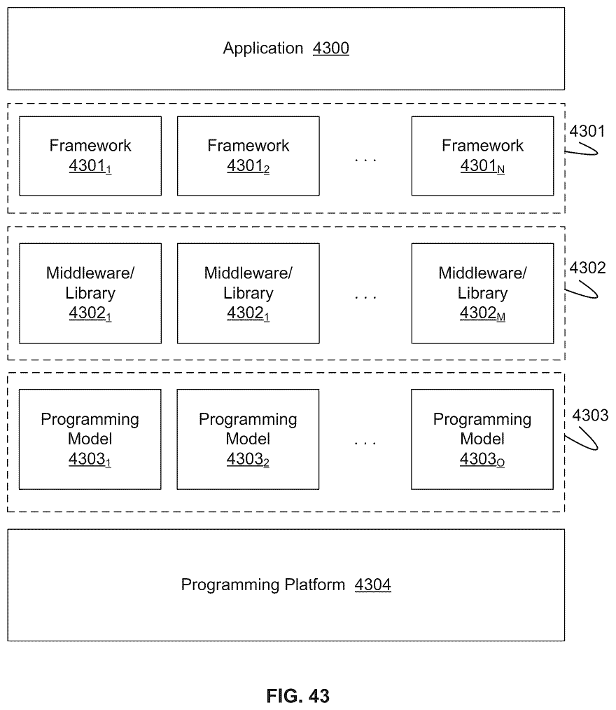

FIG. 43 illustrates software that is supported by a programming platform, in accordance with at least one embodiment. In at least one embodiment, a programming platform 4304 is configured to support various programming models 4303, middlewares and/or libraries 4302, and frameworks 4301 that an application 4300 may rely upon. In at least one embodiment, application 4300 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 4304 may be one of a CUDA, ROCm, or OpenCL platform described above in conjunction with FIG. 40, FIG. 41, and FIG. 42, respectively. In at least one embodiment, programming platform 4304 supports multiple programming models 4303, which are abstractions of an underlying computing system permitting expressions of algorithms and data structures. Programming models 4303 may expose features of underlying hardware in order to improve performance, in at least one embodiment. In at least one embodiment, programming models 4303 may include, but are not limited to, CUDA, HIP, OpenCL, C++ Accelerated Massive Parallelism (“C++AMP”), Open Multi-Processing (“OpenMP”), Open Accelerators (“OpenACC”), and/or Vulcan Compute.

In at least one embodiment, libraries and/or middlewares 4302 provide implementations of abstractions of programming models 4304. In at least one embodiment, such libraries include data and programming code that may be used by computer programs and leveraged during software development. In at least one embodiment, such middlewares include software that provides services to applications beyond those available from programming platform 4304. In at least one embodiment, libraries and/or middlewares 4302 may include, but are not limited to, cuBLAS, cuFFT, cuRAND, and other CUDA libraries, or rocBLAS, rocFFT, rocRAND, and other ROCm libraries. In addition, in at least one embodiment, libraries and/or middlewares 4302 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 4301 depend on libraries and/or middlewares 4302. In at least one embodiment, each of application frameworks 4301 is a software framework used to implement a standard structure of application software. Returning to the AI/ML example discussed above, an AI/ML application may be implemented using a framework such as Caffe, Caffe2, TensorFlow, Keras, PyTorch, or MxNet deep learning frameworks, in at least one embodiment.

FIG. 44 illustrates compiling code to execute on one of programming platforms of FIGS. 39-42, in accordance with at least one embodiment. In at least one embodiment, a compiler 4401 receives source code 4400 that includes both host code as well as device code. In at least one embodiment, complier 4401 is configured to convert source code 4400 into host executable code 4402 for execution on a host and device executable code 4403 for execution on a device. In at least one embodiment, source code 4400 may either be compiled offline prior to execution of an application, or online during execution of an application. In at least one embodiment, compiler 4401 includes or has access to one or more libraries to recognize a sequence of API calls to perform a single fused API, where a single fused API is a combined API for two or more APIs.

In at least one embodiment, source code 4400 may include code in any programming language supported by compiler 4401, such as C++, C, Fortran, etc. In at least one embodiment, source code 4400 may be included in a single-source file having a mixture of host code and device code, with locations of device code being indicated therein. In at least one embodiment, a single-source file may be a .cu file that includes CUDA code or a .hip.cpp file that includes HIP code. Alternatively, in at least one embodiment, source code 4400 may include multiple source code files, rather than a single-source file, into which host code and device code are separated.

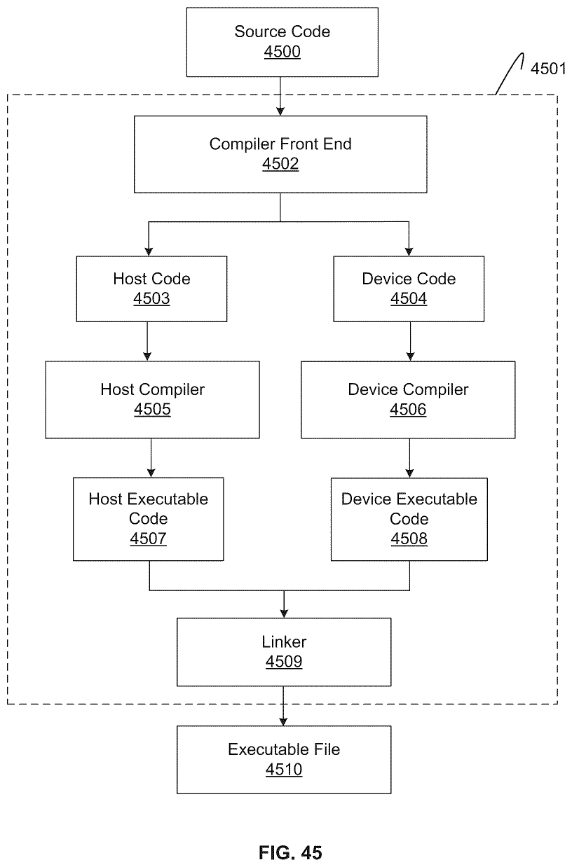

In at least one embodiment, compiler 4401 is configured to compile source code 4400 into host executable code 4402 for execution on a host and device executable code 4403 for execution on a device. In at least one embodiment, compiler 4401 performs operations including parsing source code 4400 into an abstract system tree (AST), performing optimizations, and generating executable code. In at least one embodiment in which source code 4400 includes a single-source file, compiler 4401 may separate device code from host code in such a single-source file, compile device code and host code into device executable code 4403 and host executable code 4402, respectively, and link device executable code 4403 and host executable code 4402 together in a single file, as discussed in greater detail below with respect to FIG. 45.

In at least one embodiment, host executable code 4402 and device executable code 4403 may be in any suitable format, such as binary code and/or IR code. In the case of CUDA, host executable code 4402 may include native object code and device executable code 4403 may include code in PTX intermediate representation, in at least one embodiment. In the case of ROCm, both host executable code 4402 and device executable code 4403 may include target binary code, in at least one embodiment.

FIG. 45 is a more detailed illustration of compiling code to execute on one of programming platforms of FIGS. 39-42, in accordance with at least one embodiment. In at least one embodiment, a compiler 4501 is configured to receive source code 4500, compile source code 4500, and output an executable file 4510. In at least one embodiment, source code 4500 is a single-source file, such as a .cu file, a .hip.cpp file, or a file in another format, that includes both host and device code. In at least one embodiment, compiler 4501 may be, but is not limited to, an NVIDIA CUDA compiler (“NVCC”) for compiling CUDA code in .cu files, or a HCC compiler for compiling HIP code in .hip.cpp files.

In at least one embodiment, compiler 4501 includes a compiler front end 4502, a host compiler 4505, a device compiler 4506, and a linker 4509. In at least one embodiment, compiler front end 4502 is configured to separate device code 4504 from host code 4503 in source code 4500. Device code 4504 is compiled by device compiler 4506 into device executable code 4508, which as described may include binary code or IR code, in at least one embodiment. Separately, host code 4503 is compiled by host compiler 4505 into host executable code 4507, in at least one embodiment. For NVCC, host compiler 4505 may be, but is not limited to, a general purpose C/C++ compiler that outputs native object code, while device compiler 4506 may be, but is not limited to, a Low Level Virtual Machine (“LLVM”)-based compiler that forks a LLVM compiler infrastructure and outputs PTX code or binary code, in at least one embodiment. For HCC, both host compiler 4505 and device compiler 4506 may be, but are not limited to, LLVM-based compilers that output target binary code, in at least one embodiment.

Subsequent to compiling source code 4500 into host executable code 4507 and device executable code 4508, linker 4509 links host and device executable code 4507 and 4508 together in executable file 4510, in at least one embodiment. In at least one embodiment, native object code for a host and PTX or binary code for a device may be linked together in an Executable and Linkable Format (“ELF”) file, which is a container format used to store object code.

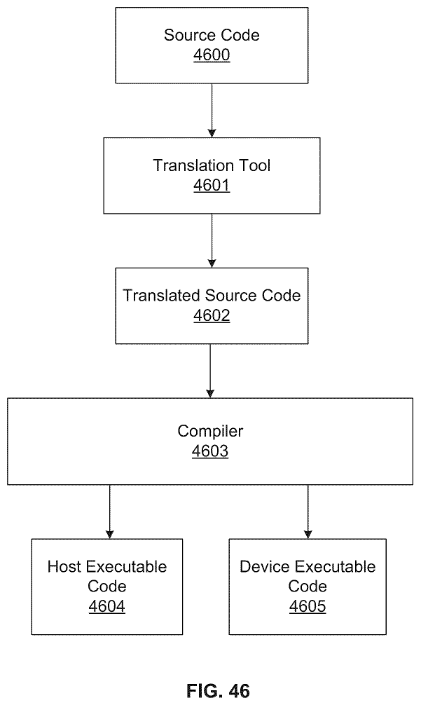

FIG. 46 illustrates translating source code prior to compiling source code, in accordance with at least one embodiment. In at least one embodiment, source code 4600 is passed through a translation tool 4601, which translates source code 4600 into translated source code 4602. In at least one embodiment, a compiler 4603 is used to compile translated source code 4602 into host executable code 4604 and device executable code 4605 in a process that is similar to compilation of source code 4400 by compiler 4401 into host executable code 4402 and device executable 4403, as discussed above in conjunction with FIG. 44.

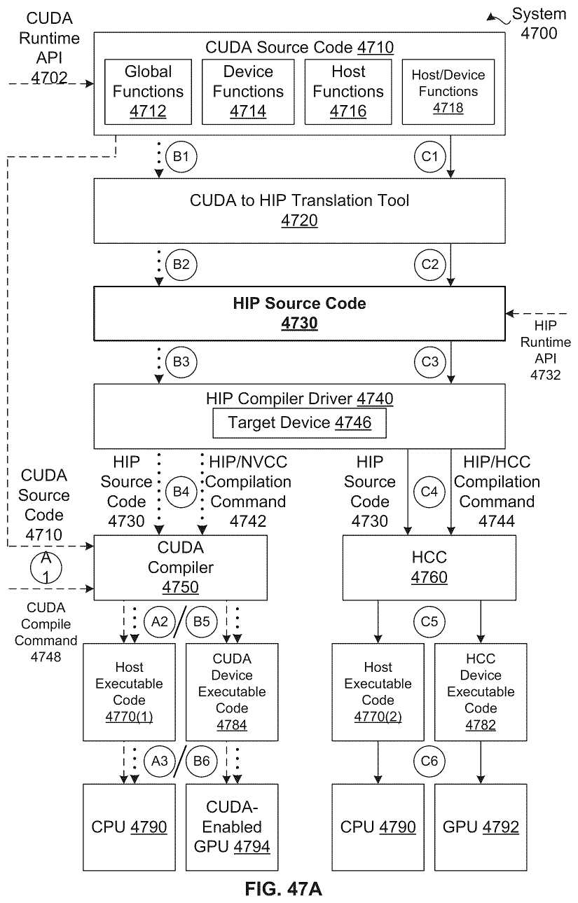

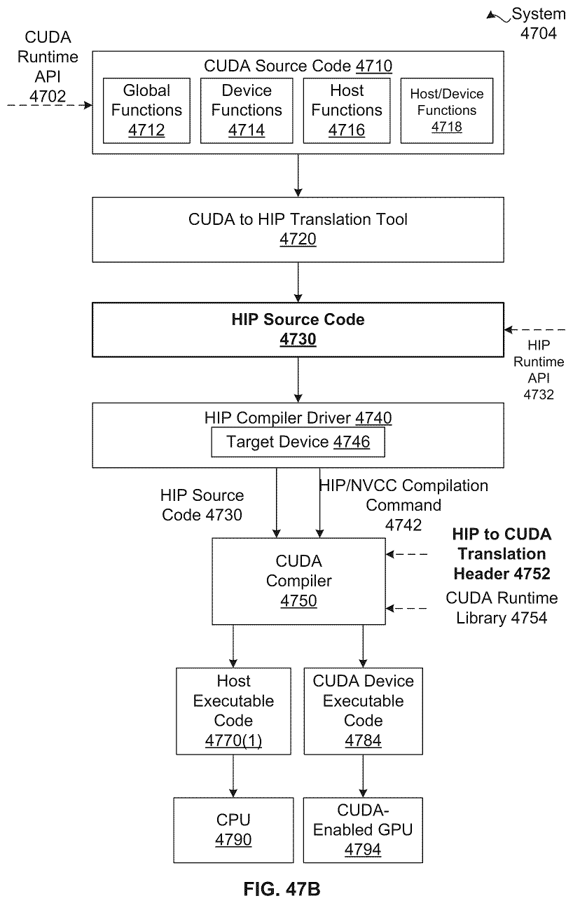

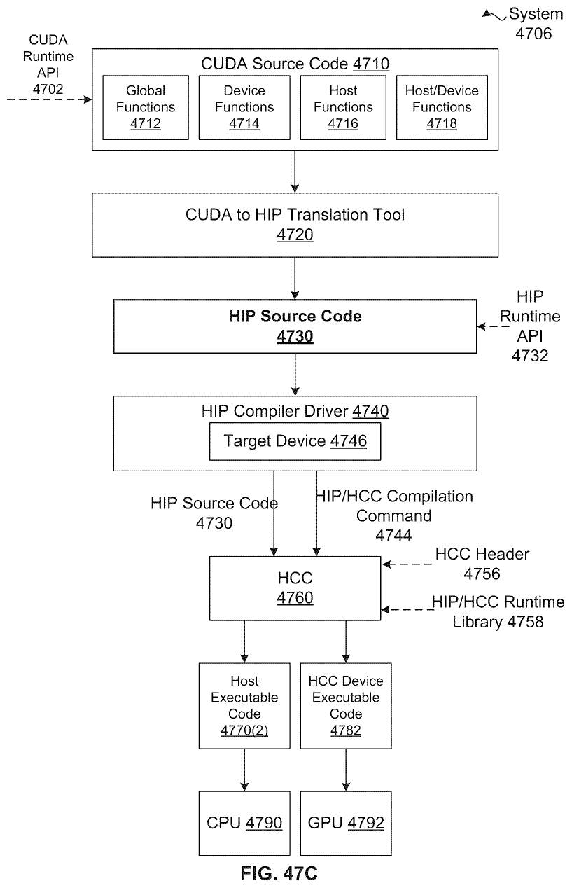

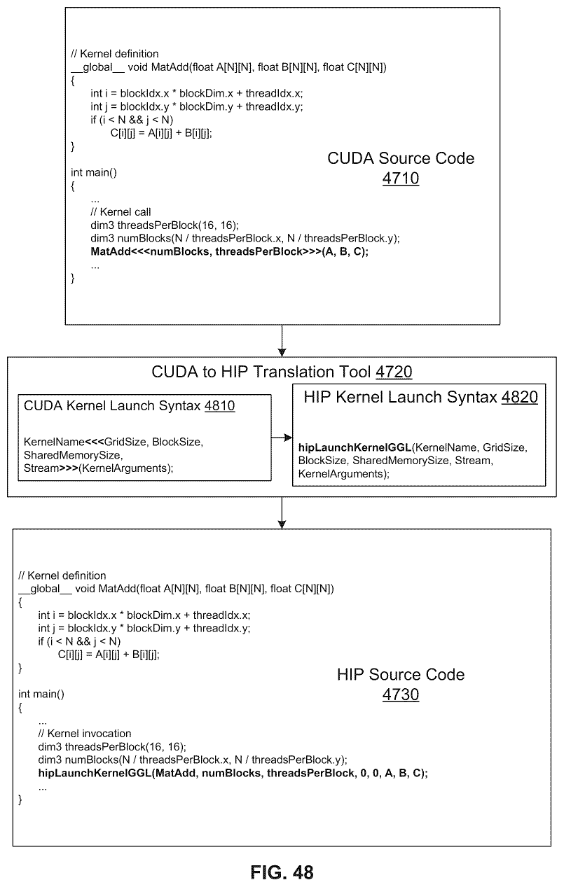

In at least one embodiment, a translation performed by translation tool 4601 is used to port source 4600 for execution in a different environment than that in which it was originally intended to run. In at least one embodiment, translation tool 4601 may include, but is not limited to, a HIP translator that is used to “hipify” CUDA code intended for a CUDA platform into HIP code that can be compiled and executed on a ROCm platform. In at least one embodiment, translation of source code 4600 may include parsing source code 4600 and converting calls to API(s) provided by one programming model (e.g., CUDA) into corresponding calls to API(s) provided by another programming model (e.g., HIP), as discussed in greater detail below in conjunction with FIGS. 47A-48. Returning to the example of hipifying CUDA code, calls to CUDA runtime API, CUDA driver API, and/or CUDA libraries may be converted to corresponding HIP API calls, in at least one embodiment. In at least one embodiment, automated translations performed by translation tool 4601 may sometimes be incomplete, requiring additional, manual effort to fully port source code 4600.

### Configuring GPUs for General-Purpose Computing

The following figures set forth, without limitation, exemplary architectures for compiling and executing compute source code, in accordance with at least one embodiment.

FIG. 47A illustrates a system 4700 configured to compile and execute CUDA source code 4710 using different types of processing units, in accordance with at least one embodiment. In at least one embodiment, system 4700 includes, without limitation, CUDA source code 4710, a CUDA compiler 4750, host executable code 4770(1), host executable code 4770(2), CUDA device executable code 4784, a CPU 4790, a CUDA-enabled GPU 4794, a GPU 4792, a CUDA to HIP translation tool 4720, HIP source code 4730, a HIP compiler driver 4740, an HCC 4760, and HCC device executable code 4782.

In at least one embodiment, CUDA source code 4710 is a collection of human-readable code in a CUDA programming language. In at least one embodiment, CUDA code is human-readable code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable in parallel on a device. In at least one embodiment, a device may be a processor that is optimized for parallel instruction processing, such as CUDA-enabled GPU 4790, GPU 47192, or another GPGPU, etc. In at least one embodiment, host code is source code that, after compilation, is executable on a host. In at least one embodiment, a host is a processor that is optimized for sequential instruction processing, such as CPU 4790.

In at least one embodiment, CUDA source code 4710 includes, without limitation, any number (including zero) of global functions 4712, any number (including zero) of device functions 4714, any number (including zero) of host functions 4716, and any number (including zero) of host/device functions 4718. In at least one embodiment, global functions 4712, device functions 4714, host functions 4716, and host/device functions 4718 may be mixed in CUDA source code 4710. In at least one embodiment, each of global functions 4712 is executable on a device and callable from a host. In at least one embodiment, one or more of global functions 4712 may therefore act as entry points to a device. In at least one embodiment, each of global functions 4712 is a kernel. In at least one embodiment and in a technique known as dynamic parallelism, one or more of global functions 4712 defines a kernel that is executable on a device and callable from such a device. In at least one embodiment, a kernel is executed N (where N is any positive integer) times in parallel by N different threads on a device during execution.

In at least one embodiment, each of device functions 4714 is executed on a device and callable from such a device only. In at least one embodiment, each of host functions 4716 is executed on a host and callable from such a host only. In at least one embodiment, each of host/device functions 4716 defines both a host version of a function that is executable on a host and callable from such a host only and a device version of the function that is executable on a device and callable from such a device only.

In at least one embodiment, CUDA source code 4710 may also include, without limitation, any number of calls to any number of functions that are defined via a CUDA runtime API 4702. In at least one embodiment, CUDA runtime API 4702 may include, without limitation, any number of functions that execute on a host to allocate and deallocate device memory, transfer data between host memory and device memory, manage systems with multiple devices, etc. In at least one embodiment, CUDA source code 4710 may also include any number of calls to any number of functions that are specified in any number of other CUDA APIs. In at least one embodiment, a CUDA API may be any API that is designed for use by CUDA code. In at least one embodiment, CUDA APIs include, without limitation, CUDA runtime API 4702, a CUDA driver API, APIs for any number of CUDA libraries, etc. In at least one embodiment and relative to CUDA runtime API 4702, a CUDA driver API is a lower-level API but provides finer-grained control of a device. In at least one embodiment, examples of CUDA libraries include, without limitation, cuBLAS, cuFFT, cuRAND, cuDNN, etc.

In at least one embodiment, CUDA compiler 4750 compiles input CUDA code (e.g., CUDA source code 4710) to generate host executable code 4770(1) and CUDA device executable code 4784. In at least one embodiment, CUDA compiler 4750 is NVCC. In at least one embodiment, host executable code 4770(1) is a compiled version of host code included in input source code that is executable on CPU 4790. In at least one embodiment, CPU 4790 may be any processor that is optimized for sequential instruction processing.

In at least one embodiment, CUDA device executable code 4784 is a compiled version of device code included in input source code that is executable on CUDA-enabled GPU 4794. In at least one embodiment, CUDA device executable code 4784 includes, without limitation, binary code. In at least one embodiment, CUDA device executable code 4784 includes, without limitation, IR code, such as PTX code, that is further compiled at runtime into binary code for a specific target device (e.g., CUDA-enabled GPU 4794) by a device driver. In at least one embodiment, CUDA-enabled GPU 4794 may be any processor that is optimized for parallel instruction processing and that supports CUDA. In at least one embodiment, CUDA-enabled GPU 4794 is developed by NVIDIA Corporation of Santa Clara, CA.

In at least one embodiment, CUDA to HIP translation tool 4720 is configured to translate CUDA source code 4710 to functionally similar HIP source code 4730. In a least one embodiment, HIP source code 4730 is a collection of human-readable code in a HIP programming language. In at least one embodiment, HIP code is human-readable code in a HIP programming language. In at least one embodiment, a HIP programming language is an extension of the C++ programming language that includes, without limitation, functionally similar versions of CUDA mechanisms to define device code and distinguish between device code and host code. In at least one embodiment, a HIP programming language may include a subset of functionality of a CUDA programming language. In at least one embodiment, for example, a HIP programming language includes, without limitation, mechanism(s) to define global functions 4712, but such a HIP programming language may lack support for dynamic parallelism and therefore global functions 4712 defined in HIP code may be callable from a host only.

In at least one embodiment, HIP source code 4730 includes, without limitation, any number (including zero) of global functions 4712, any number (including zero) of device functions 4714, any number (including zero) of host functions 4716, and any number (including zero) of host/device functions 4718. In at least one embodiment, HIP source code 4730 may also include any number of calls to any number of functions that are specified in a HIP runtime API 4732. In at least one embodiment, HIP runtime API 4732 includes, without limitation, functionally similar versions of a subset of functions included in CUDA runtime API 4702. In at least one embodiment, HIP source code 4730 may also include any number of calls to any number of functions that are specified in any number of other HIP APIs. In at least one embodiment, a HIP API may be any API that is designed for use by HIP code and/or ROCm. In at least one embodiment, HIP APIs include, without limitation, HIP runtime API 4732, a HIP driver API, APIs for any number of HIP libraries, APIs for any number of ROCm libraries, etc.

In at least one embodiment, CUDA to HIP translation tool 4720 converts each kernel call in CUDA code from a CUDA syntax to a HIP syntax and converts any number of other CUDA calls in CUDA code to any number of other functionally similar HIP calls. In at least one embodiment, a CUDA call is a call to a function specified in a CUDA API, and a HIP call is a call to a function specified in a HIP API. In at least one embodiment, CUDA to HIP translation tool 4720 converts any number of calls to functions specified in CUDA runtime API 4702 to any number of calls to functions specified in HIP runtime API 4732.

In at least one embodiment, CUDA to HIP translation tool 4720 is a tool known as hipify-perl that executes a text-based translation process. In at least one embodiment, CUDA to HIP translation tool 4720 is a tool known as hipify-clang that, relative to hipify-perl, executes a more complex and more robust translation process that involves parsing CUDA code using clang (a compiler front-end) and then translating resulting symbols. In at least one embodiment, properly converting CUDA code to HIP code may require modifications (e.g., manual edits) in addition to those performed by CUDA to HIP translation tool 4720.

In at least one embodiment, HIP compiler driver 4740 is a front end that determines a target device 4746 and then configures a compiler that is compatible with target device 4746 to compile HIP source code 4730. In at least one embodiment, target device 4746 is a processor that is optimized for parallel instruction processing. In at least one embodiment, HIP compiler driver 4740 may determine target device 4746 in any technically feasible fashion.

In at least one embodiment, if target device 4746 is compatible with CUDA (e.g., CUDA-enabled GPU 4794), then HIP compiler driver 4740 generates a HIP/NVCC compilation command 4742. In at least one embodiment and as described in greater detail in conjunction with FIG. 47B, HIP/NVCC compilation command 4742 configures CUDA compiler 4750 to compile HIP source code 4730 using, without limitation, a HIP to CUDA translation header and a CUDA runtime library. In at least one embodiment and in response to HIP/NVCC compilation command 4742, CUDA compiler 4750 generates host executable code 4770(1) and CUDA device executable code 4784.

In at least one embodiment, if target device 4746 is not compatible with CUDA, then HIP compiler driver 4740 generates a HIP/HCC compilation command 4744. In at least one embodiment and as described in greater detail in conjunction with FIG. 47C, HIP/HCC compilation command 4744 configures HCC 4760 to compile HIP source code 4730 using, without limitation, an HCC header and a HIP/HCC runtime library. In at least one embodiment and in response to HIP/HCC compilation command 4744, HCC 4760 generates host executable code 4770(2) and HCC device executable code 4782. In at least one embodiment, HCC device executable code 4782 is a compiled version of device code included in HIP source code 4730 that is executable on GPU 4792. In at least one embodiment, GPU 4792 may be any processor that is optimized for parallel instruction processing, is not compatible with CUDA, and is compatible with HCC. In at least one embodiment, GPU 4792 is developed by AMD Corporation of Santa Clara, CA. In at least one embodiment GPU, 4792 is a non-CUDA-enabled GPU 4792.

For explanatory purposes only, three different flows that may be implemented in at least one embodiment to compile CUDA source code 4710 for execution on CPU 4790 and different devices are depicted in FIG. 47A. In at least one embodiment, a direct CUDA flow compiles CUDA source code 4710 for execution on CPU 4790 and CUDA-enabled GPU 4794 without translating CUDA source code 4710 to HIP source code 4730. In at least one embodiment, an indirect CUDA flow translates CUDA source code 4710 to HIP source code 4730 and then compiles HIP source code 4730 for execution on CPU 4790 and CUDA-enabled GPU 4794. In at least one embodiment, a CUDA/HCC flow translates CUDA source code 4710 to HIP source code 4730 and then compiles HIP source code 4730 for execution on CPU 4790 and GPU 4792.

A direct CUDA flow that may be implemented in at least one embodiment is depicted via dashed lines and a series of bubbles annotated A1-A3. In at least one embodiment and as depicted with bubble annotated A1, CUDA compiler 4750 receives CUDA source code 4710 and a CUDA compile command 4748 that configures CUDA compiler 4750 to compile CUDA source code 4710. In at least one embodiment, CUDA source code 4710 used in a direct CUDA flow is written in a CUDA programming language that is based on a programming language other than C++ (e.g., C, Fortran, Python, Java, etc.). In at least one embodiment and in response to CUDA compile command 4748, CUDA compiler 4750 generates host executable code 4770(1) and CUDA device executable code 4784 (depicted with bubble annotated A2). In at least one embodiment and as depicted with bubble annotated A3, host executable code 4770(1) and CUDA device executable code 4784 may be executed on, respectively, CPU 4790 and CUDA-enabled GPU 4794. In at least one embodiment, CUDA device executable code 4784 includes, without limitation, binary code. In at least one embodiment, CUDA device executable code 4784 includes, without limitation, PTX code and is further compiled into binary code for a specific target device at runtime.

An indirect CUDA flow that may be implemented in at least one embodiment is depicted via dotted lines and a series of bubbles annotated B1-B6. In at least one embodiment and as depicted with bubble annotated B1, CUDA to HIP translation tool 4720 receives CUDA source code 4710. In at least one embodiment and as depicted with bubble annotated B2, CUDA to HIP translation tool 4720 translates CUDA source code 4710 to HIP source code 4730. In at least one embodiment and as depicted with bubble annotated B3, HIP compiler driver 4740 receives HIP source code 4730 and determines that target device 4746 is CUDA-enabled.

In at least one embodiment and as depicted with bubble annotated B4, HIP compiler driver 4740 generates HIP/NVCC compilation command 4742 and transmits both HIP/NVCC compilation command 4742 and HIP source code 4730 to CUDA compiler 4750. In at least one embodiment and as described in greater detail in conjunction with FIG. 47B, HIP/NVCC compilation command 4742 configures CUDA compiler 4750 to compile HIP source code 4730 using, without limitation, a HIP to CUDA translation header and a CUDA runtime library. In at least one embodiment and in response to HIP/NVCC compilation command 4742, CUDA compiler 4750 generates host executable code 4770(1) and CUDA device executable code 4784 (depicted with bubble annotated B5). In at least one embodiment and as depicted with bubble annotated B6, host executable code 4770(1) and CUDA device executable code 4784 may be executed on, respectively, CPU 4790 and CUDA-enabled GPU 4794. In at least one embodiment, CUDA device executable code 4784 includes, without limitation, binary code. In at least one embodiment, CUDA device executable code 4784 includes, without limitation, PTX code and is further compiled into binary code for a specific target device at runtime.

A CUDA/HCC flow that may be implemented in at least one embodiment is depicted via solid lines and a series of bubbles annotated C1-C6. In at least one embodiment and as depicted with bubble annotated C1, CUDA to HIP translation tool 4720 receives CUDA source code 4710. In at least one embodiment and as depicted with bubble annotated C2, CUDA to HIP translation tool 4720 translates CUDA source code 4710 to HIP source code 4730. In at least one embodiment and as depicted with bubble annotated C3, HIP compiler driver 4740 receives HIP source code 4730 and determines that target device 4746 is not CUDA-enabled.

In at least one embodiment, HIP compiler driver 4740 generates HIP/HCC compilation command 4744 and transmits both HIP/HCC compilation command 4744 and HIP source code 4730 to HCC 4760 (depicted with bubble annotated C4). In at least one embodiment and as described in greater detail in conjunction with FIG. 47C, HIP/HCC compilation command 4744 configures HCC 4760 to compile HIP source code 4730 using, without limitation, an HCC header and a HIP/HCC runtime library. In at least one embodiment and in response to HIP/HCC compilation command 4744, HCC 4760 generates host executable code 4770(2) and HCC device executable code 4782 (depicted with bubble annotated C5). In at least one embodiment and as depicted with bubble annotated C6, host executable code 4770(2) and HCC device executable code 4782 may be executed on, respectively, CPU 4790 and GPU 4792.

In at least one embodiment, after CUDA source code 4710 is translated to HIP source code 4730, HIP compiler driver 4740 may subsequently be used to generate executable code for either CUDA-enabled GPU 4794 or GPU 4792 without re-executing CUDA to HIP translation tool 4720. In at least one embodiment, CUDA to HIP translation tool 4720 translates CUDA source code 4710 to HIP source code 4730 that is then stored in memory. In at least one embodiment, HIP compiler driver 4740 then configures HCC 4760 to generate host executable code 4770(2) and HCC device executable code 4782 based on HIP source code 4730. In at least one embodiment, HIP compiler driver 4740 subsequently configures CUDA compiler 4750 to generate host executable code 4770(1) and CUDA device executable code 4784 based on stored HIP source code 4730.

FIG. 47B illustrates a system 4704 configured to compile and execute CUDA source code 4710 of FIG. 47A using CPU 4790 and CUDA-enabled GPU 4794, in accordance with at least one embodiment. In at least one embodiment, system 4704 includes, without limitation, CUDA source code 4710, CUDA to HIP translation tool 4720, HIP source code 4730, HIP compiler driver 4740, CUDA compiler 4750, host executable code 4770(1), CUDA device executable code 4784, CPU 4790, and CUDA-enabled GPU 4794.

In at least one embodiment and as described previously herein in conjunction with FIG. 47A, CUDA source code 4710 includes, without limitation, any number (including zero) of global functions 4712, any number (including zero) of device functions 4714, any number (including zero) of host functions 4716, and any number (including zero) of host/device functions 4718. In at least one embodiment, CUDA source code 4710 also includes, without limitation, any number of calls to any number of functions that are specified in any number of CUDA APIs.

In at least one embodiment, CUDA to HIP translation tool 4720 translates CUDA source code 4710 to HIP source code 4730. In at least one embodiment, CUDA to HIP translation tool 4720 converts each kernel call in CUDA source code 4710 from a CUDA syntax to a HIP syntax and converts any number of other CUDA calls in CUDA source code 4710 to any number of other functionally similar HIP calls.

In at least one embodiment, HIP compiler driver 4740 determines that target device 4746 is CUDA-enabled and generates HIP/NVCC compilation command 4742. In at least one embodiment, HIP compiler driver 4740 then configures CUDA compiler 4750 via HIP/NVCC compilation command 4742 to compile HIP source code 4730. In at least one embodiment, HIP compiler driver 4740 provides access to a HIP to CUDA translation header 4752 as part of configuring CUDA compiler 4750. In at least one embodiment, HIP to CUDA translation header 4752 translates any number of mechanisms (e.g., functions) specified in any number of HIP APIs to any number of mechanisms specified in any number of CUDA APIs. In at least one embodiment, CUDA compiler 4750 uses HIP to CUDA translation header 4752 in conjunction with a CUDA runtime library 4754 corresponding to CUDA runtime API 4702 to generate host executable code 4770(1) and CUDA device executable code 4784. In at least one embodiment, host executable code 4770(1) and CUDA device executable code 4784 may then be executed on, respectively, CPU 4790 and CUDA-enabled GPU 4794. In at least one embodiment, CUDA device executable code 4784 includes, without limitation, binary code. In at least one embodiment, CUDA device executable code 4784 includes, without limitation, PTX code and is further compiled into binary code for a specific target device at runtime.

FIG. 47C illustrates a system 4706 configured to compile and execute CUDA source code 4710 of FIG. 47A using CPU 4790 and non-CUDA-enabled GPU 4792, in accordance with at least one embodiment. In at least one embodiment, system 4706 includes, without limitation, CUDA source code 4710, CUDA to HIP translation tool 4720, HIP source code 4730, HIP compiler driver 4740, HCC 4760, host executable code 4770(2), HCC device executable code 4782, CPU 4790, and GPU 4792.

In at least one embodiment and as described previously herein in conjunction with FIG. 47A, CUDA source code 4710 includes, without limitation, any number (including zero) of global functions 4712, any number (including zero) of device functions 4714, any number (including zero) of host functions 4716, and any number (including zero) of host/device functions 4718. In at least one embodiment, CUDA source code 4710 also includes, without limitation, any number of calls to any number of functions that are specified in any number of CUDA APIs.

In at least one embodiment, CUDA to HIP translation tool 4720 translates CUDA source code 4710 to HIP source code 4730. In at least one embodiment, CUDA to HIP translation tool 4720 converts each kernel call in CUDA source code 4710 from a CUDA syntax to a HIP syntax and converts any number of other CUDA calls in source code 4710 to any number of other functionally similar HIP calls.

In at least one embodiment, HIP compiler driver 4740 subsequently determines that target device 4746 is not CUDA-enabled and generates HIP/HCC compilation command 4744. In at least one embodiment, HIP compiler driver 4740 then configures HCC 4760 to execute HIP/HCC compilation command 4744 to compile HIP source code 4730. In at least one embodiment, HIP/HCC compilation command 4744 configures HCC 4760 to use, without limitation, a HIP/HCC runtime library 4758 and an HCC header 4756 to generate host executable code 4770(2) and HCC device executable code 4782. In at least one embodiment, HIP/HCC runtime library 4758 corresponds to HIP runtime API 4732. In at least one embodiment, HCC header 4756 includes, without limitation, any number and type of interoperability mechanisms for HIP and HCC. In at least one embodiment, host executable code 4770(2) and HCC device executable code 4782 may be executed on, respectively, CPU 4790 and GPU 4792.

FIG. 48 illustrates an exemplary kernel translated by CUDA-to-HIP translation tool 4720 of FIG. 47C, in accordance with at least one embodiment. In at least one embodiment, CUDA source code 4710 partitions an overall problem that a given kernel is designed to solve into relatively coarse sub-problems that can independently be solved using thread blocks. In at least one embodiment, each thread block includes, without limitation, any number of threads. In at least one embodiment, each sub-problem is partitioned into relatively fine pieces that can be solved cooperatively in parallel by threads within a thread block. In at least one embodiment, threads within a thread block can cooperate by sharing data through shared memory and by synchronizing execution to coordinate memory accesses.

In at least one embodiment, CUDA source code 4710 organizes thread blocks associated with a given kernel into a one-dimensional, a two-dimensional, or a three-dimensional grid of thread blocks. In at least one embodiment, each thread block includes, without limitation, any number of threads, and a grid includes, without limitation, any number of thread blocks.

In at least one embodiment, a kernel is a function in device code that is defined using a “global” declaration specifier. In at least one embodiment, the dimension of a grid that executes a kernel for a given kernel call and associated streams are specified using a CUDA kernel launch syntax 4810. In at least one embodiment, CUDA kernel launch syntax 4810 is specified as “KernelName<<<GridSize, BlockSize, SharedMemorySize, Stream>>>(KernelArguments);”. In at least one embodiment, an execution configuration syntax is a “<<< . . . >>>” construct that is inserted between a kernel name (“KernelName”) and a parenthesized list of kernel arguments (“KernelArguments”). In at least one embodiment, CUDA kernel launch syntax 4810 includes, without limitation, a CUDA launch function syntax instead of an execution configuration syntax.

In at least one embodiment, “GridSize” is of a type dim3 and specifies the dimension and size of a grid. In at least one embodiment, type dim3 is a CUDA-defined structure that includes, without limitation, unsigned integers x, y, and z. In at least one embodiment, if z is not specified, then z defaults to one. In at least one embodiment, if y is not specified, then y defaults to one. In at least one embodiment, the number of thread blocks in a grid is equal to the product of GridSize.x, GridSize.y, and GridSize.z. In at least one embodiment, “BlockSize” is of type dim3 and specifies the dimension and size of each thread block. In at least one embodiment, the number of threads per thread block is equal to the product of BlockSize.x, BlockSize.y, and BlockSize.z. In at least one embodiment, each thread that executes a kernel is given a unique thread ID that is accessible within the kernel through a built-in variable (e.g., “threadIdx”).

In at least one embodiment and with respect to CUDA kernel launch syntax 4810, “SharedMemorySize” is an optional argument that specifies a number of bytes in a shared memory that is dynamically allocated per thread block for a given kernel call in addition to statically allocated memory. In at least one embodiment and with respect to CUDA kernel launch syntax 4810, SharedMemorySize defaults to zero. In at least one embodiment and with respect to CUDA kernel launch syntax 4810, “Stream” is an optional argument that specifies an associated stream and defaults to zero to specify a default stream. In at least one embodiment, a stream is a sequence of commands (possibly issued by different host threads) that execute in order. In at least one embodiment, different streams may execute commands out of order with respect to one another or concurrently.

In at least one embodiment, CUDA source code 4710 includes, without limitation, a kernel definition for an exemplary kernel “MatAdd” and a main function. In at least one embodiment, main function is host code that executes on a host and includes, without limitation, a kernel call that causes kernel MatAdd to execute on a device. In at least one embodiment and as shown, kernel MatAdd adds two matrices A and B of size N×N, where N is a positive integer, and stores the result in a matrix C. In at least one embodiment, main function defines a threadsPerBlock variable as 16 by 16 and a numBlocks variable as N/16 by N/16. In at least one embodiment, main function then specifies kernel call “MatAdd<<<numBlocks, threadsPerBlock>>>(A, B, C);”. In at least one embodiment and as per CUDA kernel launch syntax 4810, kernel MatAdd is executed using a grid of thread blocks having a dimension N/16 by N/16, where each thread block has a dimension of 16 by 16. In at least one embodiment, each thread block includes 256 threads, a grid is created with enough blocks to have one thread per matrix element, and each thread in such a grid executes kernel MatAdd to perform one pair-wise addition.

In at least one embodiment, while translating CUDA source code 4710 to HIP source code 4730, CUDA to HIP translation tool 4720 translates each kernel call in CUDA source code 4710 from CUDA kernel launch syntax 4810 to a HIP kernel launch syntax 4820 and converts any number of other CUDA calls in source code 4710 to any number of other functionally similar HIP calls. In at least one embodiment, HIP kernel launch syntax 4820 is specified as “hipLaunchKernelGGL(KernelName,GridSize, BlockSize, SharedMemorySize, Stream, KernelArguments);”. In at least one embodiment, each of KernelName, GridSize, BlockSize, ShareMemorySize, Stream, and KernelArguments has the same meaning in HIP kernel launch syntax 4820 as in CUDA kernel launch syntax 4810 (described previously herein). In at least one embodiment, arguments SharedMemorySize and Stream are required in HIP kernel launch syntax 4820 and are optional in CUDA kernel launch syntax 4810.

In at least one embodiment, a portion of HIP source code 4730 depicted in FIG. 48 is identical to a portion of CUDA source code 4710 depicted in FIG. 48 except for a kernel call that causes kernel MatAdd to execute on a device. In at least one embodiment, kernel MatAdd is defined in HIP source code 4730 with the same “_global_” declaration specifier with which kernel MatAdd is defined in CUDA source code 4710. In at least one embodiment, a kernel call in HIP source code 4730 is “hipLaunchKernelGGL(MatAdd, numBlocks, threadsPerBlock, 0, 0, A, B, C);”, while a corresponding kernel call in CUDA source code 4710 is “MatAdd<<<numBlocks, threadsPerBlock>>>(A, B, C);”.

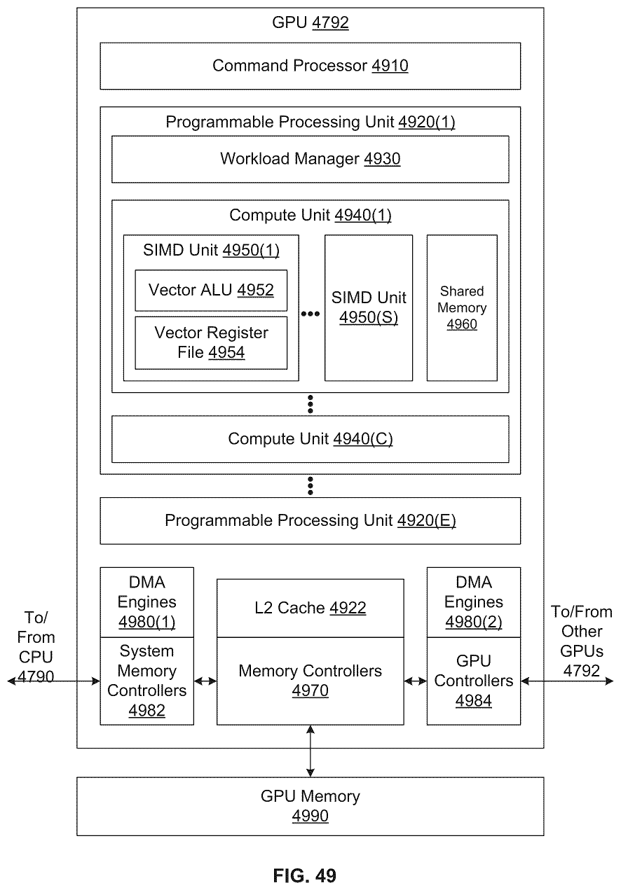

FIG. 49 illustrates non-CUDA-enabled GPU 4792 of FIG. 47C in greater detail, in accordance with at least one embodiment. In at least one embodiment, GPU 4792 is developed by AMD corporation of Santa Clara. In at least one embodiment, GPU 4792 can be configured to perform compute operations in a highly-parallel fashion. In at least one embodiment, GPU 4792 is configured to execute graphics pipeline operations such as draw commands, pixel operations, geometric computations, and other operations associated with rendering an image to a display. In at least one embodiment, GPU 4792 is configured to execute operations unrelated to graphics. In at least one embodiment, GPU 4792 is configured to execute both operations related to graphics and operations unrelated to graphics. In at least one embodiment, GPU 4792 can be configured to execute device code included in HIP source code 4730.

In at least one embodiment, GPU 4792 includes, without limitation, any number of programmable processing units 4920, a command processor 4910, an L2 cache 4922, memory controllers 4970, DMA engines 4980(1), system memory controllers 4982, DMA engines 4980(2), and GPU controllers 4984. In at least one embodiment, each programmable processing unit 4920 includes, without limitation, a workload manager 4930 and any number of compute units 4940. In at least one embodiment, command processor 4910 reads commands from one or more command queues (not shown) and distributes commands to workload managers 4930. In at least one embodiment, for each programmable processing unit 4920, associated workload manager 4930 distributes work to compute units 4940 included in programmable processing unit 4920. In at least one embodiment, each compute unit 4940 may execute any number of thread blocks, but each thread block executes on a single compute unit 4940. In at least one embodiment, a workgroup is a thread block.

In at least one embodiment, each compute unit 4940 includes, without limitation, any number of SIMD units 4950 and a shared memory 4960. In at least one embodiment, each SIMD unit 4950 implements a SIMD architecture and is configured to perform operations in parallel. In at least one embodiment, each SIMD unit 4950 includes, without limitation, a vector ALU 4952 and a vector register file 4954. In at least one embodiment, each SIMD unit 4950 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 4960. In at least one embodiment, compute unit 4940 includes one or more distributed shared memories (or distributed shared memory) that enable direct streaming multiprocessor (SM) to streaming multiple processor (SM) for operations related to loading, storing, and performing atomics across multiple SM shared memory blocks. compute unit 4940 includes one or more cluster distributed shared memories (DSMEM), which are blocks of memory within a cluster that enabled to access each other's shared memory directly.

In at least one embodiment, programmable processing units 4920 are referred to as “shader engines.” In at least one embodiment, each programmable processing unit 4920 includes, without limitation, any amount of dedicated graphics hardware in addition to compute units 4940. In at least one embodiment, each programmable processing unit 4920 includes, without limitation, any number (including zero) of geometry processors, any number (including zero) of rasterizers, any number (including zero) of render back ends, workload manager 4930, and any number of compute units 4940.

In at least one embodiment, compute units 4940 share L2 cache 4922. In at least one embodiment, L2 cache 4922 is partitioned. In at least one embodiment, a GPU memory 4990 is accessible by all compute units 4940 in GPU 4792. In at least one embodiment, memory controllers 4970 and system memory controllers 4982 facilitate data transfers between GPU 4792 and a host, and DMA engines 4980(1) enable asynchronous memory transfers between GPU 4792 and such a host. In at least one embodiment, memory controllers 4970 and GPU controllers 4984 facilitate data transfers between GPU 4792 and other GPUs 4792, and DMA engines 4980(2) enable asynchronous memory transfers between GPU 4792 and other GPUs 4792.

In at least one embodiment, GPU 4792 includes, without limitation, any amount and type of system interconnect that facilitates data and control transmissions across any number and type of directly or indirectly linked components that may be internal or external to GPU 4792. In at least one embodiment, GPU 4792 includes, without limitation, any number and type of I/O interfaces (e.g., PCIe) that are coupled to any number and type of peripheral devices. In at least one embodiment, GPU 4792 may include, without limitation, any number (including zero) of display engines and any number (including zero) of multimedia engines. In at least one embodiment, GPU 4792 implements a memory subsystem that includes, without limitation, any amount and type of memory controllers (e.g., memory controllers 4970 and system memory controllers 4982) and memory devices (e.g., shared memories 4960) that may be dedicated to one component or shared among multiple components. In at least one embodiment, GPU 4792 implements a cache subsystem that includes, without limitation, one or more cache memories (e.g., L2 cache 4922) that may each be private to or shared between any number of components (e.g., SIMD units 4950, compute units 4940, and programmable processing units 4920).

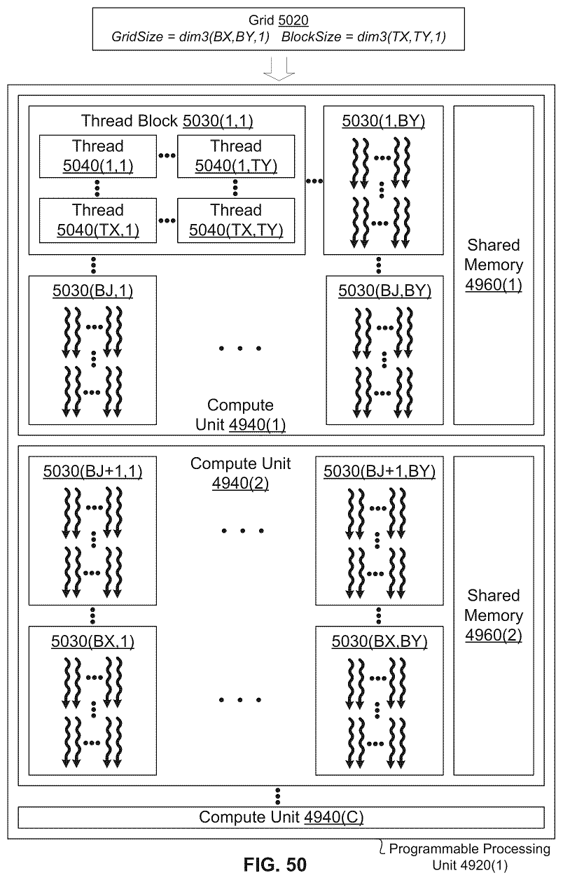

FIG. 50 illustrates how threads of an exemplary CUDA grid 5020 are mapped to different compute units 4940 of FIG. 49, in accordance with at least one embodiment. In at least one embodiment and for explanatory purposes only, grid 5020 has a GridSize of BX by BY by 1 and a BlockSize of TX by TY by 1. In at least one embodiment, grid 5020 therefore includes, without limitation, (BX*BY) thread blocks 5030 and each thread block 5030 includes, without limitation, (TX*TY) threads 5040. Threads 5040 are depicted in FIG. 50 as squiggly arrows.

In at least one embodiment, grid 5020 is mapped to programmable processing unit 4920(1) that includes, without limitation, compute units 4940(1)-4940(C). In at least one embodiment and as shown, (BJ*BY) thread blocks 5030 are mapped to compute unit 4940(1), and the remaining thread blocks 5030 are mapped to compute unit 4940(2). In at least one embodiment, each thread block 5030 may include, without limitation, any number of warps, and each warp is mapped to a different SIMD unit 4950 of FIG. 49.

In at least one embodiment, warps in a given thread block 5030 may synchronize together and communicate through shared memory 4960 included in associated compute unit 4940. For example and in at least one embodiment, warps in thread block 5030(BJ,1) can synchronize together and communicate through shared memory 4960(1). For example and in at least one embodiment, warps in thread block 5030(BJ+1,1) can synchronize together and communicate through shared memory 4960(2).

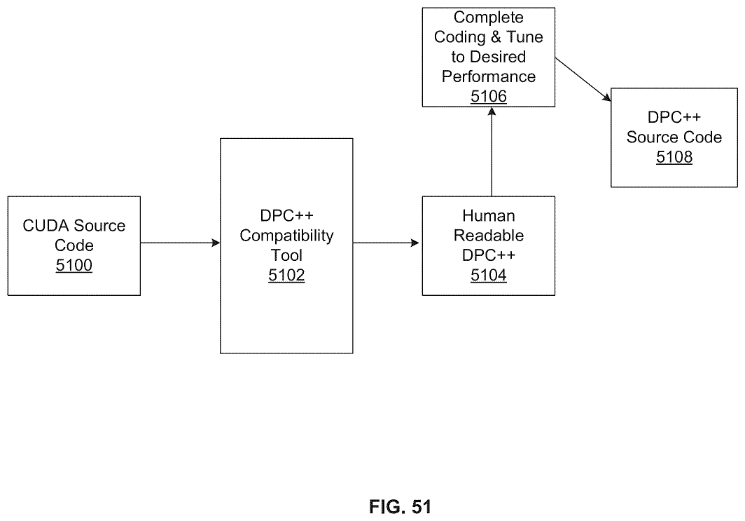

FIG. 51 illustrates how to migrate existing CUDA code to Data Parallel C++ code, in accordance with at least one embodiment. Data Parallel C++ (DPC++) may refer to an open, standards-based alternative to single-architecture proprietary languages that allows developers to reuse code across hardware targets (CPUs and accelerators such as GPUs and FPGAs) and also perform custom tuning for a specific accelerator. DPC++ use similar and/or identical C and C++ constructs in accordance with ISO C++ which developers may be familiar with. DPC++ incorporates standard SYCL from The Khronos Group to support data parallelism and heterogeneous programming. SYCL refers to a cross-platform abstraction layer that builds on underlying concepts, portability and efficiency of OpenCL that enables code for heterogeneous processors to be written in a “single-source” style using standard C++. SYCL may enable single source development where C++ template functions can contain both host and device code to construct complex algorithms that use OpenCL acceleration, and then re-use them throughout their source code on different types of data.

In at least one embodiment, a DPC++ compiler is used to compile DPC++ source code which can be deployed across diverse hardware targets. In at least one embodiment, a DPC++ compiler is used to generate DPC++ applications that can be deployed across diverse hardware targets and a DPC++ compatibility tool can be used to migrate CUDA applications to a multiplatform program in DPC++. In at least one embodiment, a DPC++ base tool kit includes a DPC++ compiler to deploy applications across diverse hardware targets; a DPC++ library to increase productivity and performance across CPUs, GPUs, and FPGAs; a DPC++ compatibility tool to migrate CUDA applications to multi-platform applications; and any suitable combination thereof.

In at least one embodiment, a DPC++ programming model is utilized to simply one or more aspects relating to programming CPUs and accelerators by using modern C++ features to express parallelism with a programming language called Data Parallel C++. DPC++ programming language may be utilized to code reuse for hosts (e.g., a CPU) and accelerators (e.g., a GPU or FPGA) using a single source language, with execution and memory dependencies being clearly communicated. Mappings within DPC++ code can be used to transition an application to run on a hardware or set of hardware devices that best accelerates a workload. A host may be available to simplify development and debugging of device code, even on platforms that do not have an accelerator available.

In at least one embodiment, CUDA source code 5100 is provided as an input to a DPC++ compatibility tool 5102 to generate human readable DPC++ 5104. In at least one embodiment, human readable DPC++ 5104 includes inline comments generated by DPC++ compatibility tool 5102 that guides a developer on how and/or where to modify DPC++ code to complete coding and tuning to desired performance 5106, thereby generating DPC++ source code 5108.

In at least one embodiment, CUDA source code 5100 is or includes a collection of human-readable source code in a CUDA programming language. In at least one embodiment, CUDA source code 5100 is human-readable source code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable on a device (e.g., GPU or FPGA) and may include or more parallelizable workflows that can be executed on one or more processor cores of a device. In at least one embodiment, a device may be a processor that is optimized for parallel instruction processing, such as CUDA-enabled GPU, GPU, or another GPGPU, etc. In at least one embodiment, host code is source code that, after compilation, is executable on a host. In least one embodiment, some or all of host code and device code can be executed in parallel across a CPU and GPU/FPGA. In at least one embodiment, a host is a processor that is optimized for sequential instruction processing, such as CPU. CUDA source code 5100 described in connection with FIG. 51 may be in accordance with those discussed elsewhere in this document.

In at least one embodiment, DPC++ compatibility tool 5102 refers to an executable tool, program, application, or any other suitable type of tool that is used to facilitate migration of CUDA source code 5100 to DPC++ source code 5108. In at least one embodiment, DPC++ compatibility tool 5102 is a command-line-based code migration tool available as part of a DPC++ tool kit that is used to port existing CUDA sources to DPC++. In at least one embodiment, DPC++ compatibility tool 5102 converts some or all source code of a CUDA application from CUDA to DPC++ and generates a resulting file that is written at least partially in DPC++, referred to as human readable DPC++ 5104. In at least one embodiment, human readable DPC++ 5104 includes comments that are generated by DPC++ compatibility tool 5102 to indicate where user intervention may be necessary. In at least one embodiment, user intervention is necessary when CUDA source code 5100 calls a CUDA API that has no analogous DPC++ API; other examples where user intervention is required are discussed later in greater detail.

In at least one embodiment, a workflow for migrating CUDA source code 5100 (e.g., application or portion thereof) includes creating one or more compilation database files; migrating CUDA to DPC++ using a DPC++ compatibility tool 5102; completing migration and verifying correctness, thereby generating DPC++ source code 5108; and compiling DPC++ source code 5108 with a DPC++ compiler to generate a DPC++ application. In at least one embodiment, a compatibility tool provides a utility that intercepts commands used when Makefile executes and stores them in a compilation database file. In at least one embodiment, a file is stored in JSON format. In at least one embodiment, an intercept-built command converts Makefile command to a DPC compatibility command.

In at least one embodiment, intercept-build is a utility script that intercepts a build process to capture compilation options, macro defs, and include paths, and writes this data to a compilation database file. In at least one embodiment, a compilation database file is a JSON file. In at least one embodiment, DPC++ compatibility tool 5102 parses a compilation database and applies options when migrating input sources. In at least one embodiment, use of intercept-build is optional, but highly recommended for Make or CMake based environments. In at least one embodiment, a migration database includes commands, directories, and files: command may include necessary compilation flags; directory may include paths to header files; file may include paths to CUDA files.

In at least one embodiment, DPC++ compatibility tool 5102 migrates CUDA code (e.g., applications) written in CUDA to DPC++ by generating DPC++ wherever possible. In at least one embodiment, DPC++ compatibility tool 5102 is available as part of a tool kit. In at least one embodiment, a DPC++ tool kit includes an intercept-build tool. In at least one embodiment, an intercept-built tool creates a compilation database that captures compilation commands to migrate CUDA files. In at least one embodiment, a compilation database generated by an intercept-built tool is used by DPC++ compatibility tool 5102 to migrate CUDA code to DPC++. In at least one embodiment, non-CUDA C++ code and files are migrated as is. In at least one embodiment, DPC++ compatibility tool 5102 generates human readable DPC++ 5104 which may be DPC++ code that, as generated by DPC++ compatibility tool 5102, cannot be compiled by DPC++ compiler and requires additional plumbing for verifying portions of code that were not migrated correctly, and may involve manual intervention, such as by a developer. In at least one embodiment, DPC++ compatibility tool 5102 provides hints or tools embedded in code to help developers manually migrate additional code that could not be migrated automatically. In at least one embodiment, migration is a one-time activity for a source file, project, or application.

In at least one embodiment, DPC++ compatibility tool 51002 is able to successfully migrate all portions of CUDA code to DPC++ and there may simply be an optional step for manually verifying and tuning performance of DPC++ source code that was generated. In at least one embodiment, DPC++ compatibility tool 5102 directly generates DPC++ source code 5108 which is compiled by a DPC++ compiler without requiring or utilizing human intervention to modify DPC++ code generated by DPC++ compatibility tool 5102. In at least one embodiment, DPC++ compatibility tool generates compile-able DPC++ code which can be optionally tuned by a developer for performance, readability, maintainability, other various considerations; or any combination thereof.

In at least one embodiment, one or more CUDA source files are migrated to DPC++ source files at least partially using DPC++ compatibility tool 5102. In at least one embodiment, CUDA source code includes one or more header files which may include CUDA header files. In at least one embodiment, a CUDA source file includes a <cuda.h> header file and a <stdio.h> header file which can be used to print text. In at least one embodiment, a portion of a vector addition kernel CUDA source file may be written as or related to:

```
#include <cuda.h>
#include <stdio.h>
#define VECTOR_SIZE 256
[ ] global_{——} void VectorAddKernel(float* A, float* B, float* C)
{
  A[threadIdx.x] = threadIdx.x + 1.0f;
  B[threadIdx.x] = threadIdx.x + 1.0f;
  C[threadIdx.x] = A[threadIdx.x] + B[threadIdx.x];
}
int main( )
{
  float *d_A, *d_B, *d_C;
  cudaMalloc(&d_A, VECTOR_SIZE*sizeof(float));
  cudaMalloc(&d_B, VECTOR_SIZE*sizeof(float));
  cudaMalloc(&d_C, VECTOR_SIZE*sizeof(float));
  VectorAddKernel<<<1, VECTOR_SIZE>>>(d_A, d_B, d_C);
  float Result[VECTOR_SIZE] = { };
  cudaMemcpy(Result, d_C, VECTOR_SIZE*sizeof(float),
cudaMemcpyDeviceToHost);
  cudaFree(d_A);
  cudaFree(d_B);
  cudaFree(d_C);
  for (int i=0; i<VECTOR_SIZE; i++ {
    if (i % 16 == 0) {
      printf(“\n”);
    }
    printf(“%f ”, Result[i]);
  }
  return 0;
}
```

In at least one embodiment and in connection with CUDA source file presented above, DPC++ compatibility tool 5102 parses a CUDA source code and replaces header files with appropriate DPC++ and SYCL header files. In at least one embodiment, DPC++ header files includes helper declarations. In CUDA, there is a concept of a thread ID and correspondingly, in DPC++ or SYCL, for each element there is a local identifier.

In at least one embodiment and in connection with CUDA source file presented above, there are two vectors A and B which are initialized and a vector addition result is put into vector C as part of VectorAddKernel( ). In at least one embodiment, DPC++ compatibility tool 5102 converts CUDA thread IDs used to index work elements to SYCL standard addressing for work elements via a local ID as part of migrating CUDA code to DPC++ code. In at least one embodiment, DPC++ code generated by DPC++ compatibility tool 5102 can be optimized—for example, by reducing dimensionality of an nd_item, thereby increasing memory and/or processor utilization.

In at least one embodiment and in connection with CUDA source file presented above, memory allocation is migrated. In at least one embodiment, cudaMalloc( ) is migrated to a unified shared memory SYCL call malloc_device( ) to which a device and context is passed, relying on SYCL concepts such as platform, device, context, and queue. In at least one embodiment, a SYCL platform can have multiple devices (e.g., host and GPU devices); a device may have multiple queues to which jobs can be submitted; each device may have a context; and a context may have multiple devices and manage shared memory objects.

In at least one embodiment and in connection with CUDA source file presented above, a main( ) function invokes or calls VectorAddKernel(to add two vectors A and B together and store result in vector C. In at least one embodiment, CUDA code to invoke VectorAddKernel( ) is replaced by DPC++ code to submit a kernel to a command queue for execution. In at least one embodiment, a command group handler cgh passes data, synchronization, and computation that is submitted to the queue, parallel_for is called for a number of global elements and a number of work items in that work group where VectorAddKernel(is called.

In at least one embodiment and in connection with CUDA source file presented above, CUDA calls to copy device memory and then free memory for vectors A, B, and C are migrated to corresponding DPC++ calls. In at least one embodiment, C++ code (e.g., standard ISO C++ code for printing a vector of floating point variables) is migrated as is, without being modified by DPC++ compatibility tool 5102. In at least one embodiment, DPC++ compatibility tool 5102 modify CUDA APIs for memory setup and/or host calls to execute kernel on the acceleration device. In at least one embodiment and in connection with CUDA source file presented above, a corresponding human readable DPC++ 5104 (e.g., which can be compiled) is written as or related to:

```
#include <CL/sycl.hpp>
#include <dpct/dpct.hpp>
#define VECTOR_SIZE 256
void VectorAddKernel(float* A, float* B, float* C,
                sycl::nd_item<3>item_ct1)
{
  A[item_ct1.get_local_id(2)] = item_ct1.get_local_id(2) + 1.0f;
  B[item_ct1.get_local_id(2)] = item_ct1.get_local_id(2) + 1.0f;
  C[item_ct1.get_local_id(2)] =
    A[item_ct1.get_local_id(2)] + B[item_ct1.get_local_id(2)];
}
int main( )
{
  float *d_A, *d_B, *d_C;
  d_A = (float *)sycl::malloc_device(VECTOR_SIZE * sizeof(float),
    dpct::get_current_device( ),
    dpct::get_default_context( ));
  d_B = (float *)sycl::malloc_device(VECTOR_SIZE * sizeof(float),
    dpct::get_current_device( ),
    dpct::get_default_context( ));
  d_C = (float *)sycl::malloc_device(VECTOR_SIZE * sizeof(float),
    dpct::get_current_device( ),
    dpct::get_default_context( ));
  dpct::get_default_queue_wait( ).submit([&](sycl::handler &cgh) {
    cgh.parallel_for(
    sycl::nd_range<3>(sycl::range<3>(1, 1, 1) *
                sycl::range<3>(1, 1, VECTOR_SIZE) *
                sycl::range<3>(1, 1, VECTOR_SIZE)),
    [=](sycl::nd_items<3> item_ct1) {
      VectorAddKernel(d_A, d_B, d_C, item_ct1);
    });
  });
  float Result[VECTOR_SIZE] = { };
  dpct::get_default_queue_wait( )
    .memcpy(Result, d_C, VECTOR_SIZE * sizeof(float))
    .wait( );
  sycl::free(d_A, dpct::get_default_context( ));
  sycl::free(d_B, dpct::get_default_context( ));
  sycl::free(d_C, dpct::get_default_context( ));
  for (int i=0; i<VECTOR_SIZE; i++ {
    if (i % 16 == 0) {
      printf(“\n”);
    }
    printf(“%f ”, Result[i]);
  }
  return 0;
}
```

In at least one embodiment, human readable DPC++ 5104 refers to output generated by DPC++ compatibility tool 5102 and may be optimized in one manner or another. In at least one embodiment, human readable DPC++ 5104 generated by DPC++ compatibility tool 5102 can be manually edited by a developer after migration to make it more maintainable, performance, or other considerations. In at least one embodiment, DPC++ code generated by DPC++ compatibility tool 51002 such as DPC++ disclosed can be optimized by removing repeat calls to get current_device( ) and/or get_default_context( ) for each malloc_device( ) call. In at least one embodiment, DPC++ code generated above uses a 3 dimensional nd_range which can be refactored to use only a single dimension, thereby reducing memory usage. In at least one embodiment, a developer can manually edit DPC++ code generated by DPC++ compatibility tool 5102 replace uses of unified shared memory with accessors. In at least one embodiment, DPC++ compatibility tool 5102 has an option to change how it migrates CUDA code to DPC++ code. In at least one embodiment, DPC++ compatibility tool 5102 is verbose because it is using a general template to migrate CUDA code to DPC++ code that works for a large number of cases.

In at least one embodiment, a CUDA to DPC++ migration workflow includes steps to: prepare for migration using intercept-build script; perform migration of CUDA projects to DPC++ using DPC++ compatibility tool 5102; review and edit migrated source files manually for completion and correctness; and compile final DPC++ code to generate a DPC++ application. In at least one embodiment, manual review of DPC++ source code may be required in one or more scenarios including but not limited to: migrated API does not return error code (CUDA code can return an error code which can then be consumed by the application but SYCL uses exceptions to report errors, and therefore does not use error codes to surface errors); CUDA compute capability dependent logic is not supported by DPC++; statement could not be removed. In at least one embodiment, scenarios in which DPC++ code requires manual intervention may include, without limitation: error code logic replaced with (*,0) code or commented out; equivalent DPC++ API not available; CUDA compute capability-dependent logic; hardware-dependent API (clock( )); missing features unsupported API; execution time measurement logic; handling built-in vector type conflicts; migration of cuBLAS API; and more.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

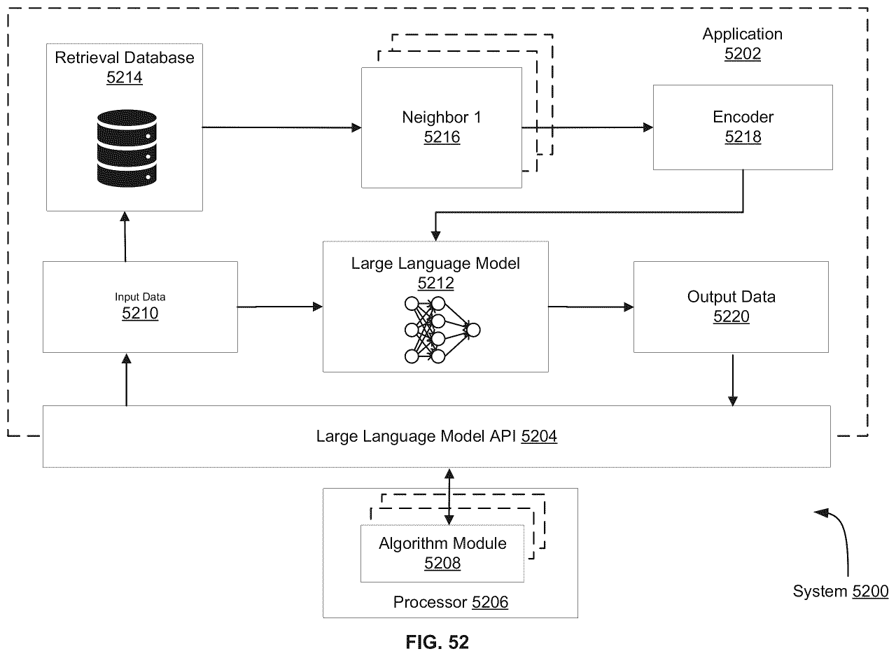

FIG. 52 is a system diagram illustrating system 5200 for interfacing with an application 5202 to process data, according to at least one embodiment. In at least one embodiment, application 5202 uses large language model (LLM) 5212 to generate output data 5220 based, at least in part, on input data 5210. In at least one embodiment, input data 5210 is a text prompt. In at least one embodiment, input data 5210 includes unstructured text. In at least one embodiment, input data 5210 includes a sequence of tokens. In at least one embodiment, a token is a portion of input data. In at least one embodiment, a token is a word. In at least one embodiment, a token is a character. In at least one embodiment, a token is a subword. In at least one embodiment, input data 5210 is formatted in Chat Markup Language (ChatML). In at least one embodiment, input data 5210 is an image. In at least one embodiment, input data 5210 is one or more video frames. In at least one embodiment, input data 5210 is any other expressive medium.

In at least one embodiment, large language model 5212 comprises a deep neural network. In at least one embodiment, a deep neural network is a neural network with two or more layers. In at least one embodiment, large language model 5212 comprises a transformer model. In at least one embodiment, large language model 5212 comprises a neural network configured to perform natural language processing. In at least one embodiment, large language model 5212 is configured to process one or more sequences of data. In at least one embodiment, large language model 5212 is configured to process text. In at least one embodiment, weights and biases of a large language model 5212 are configured to process text. In at least one embodiment, large language model 5212 is configured to determine patterns in data to perform one or more natural language processing tasks. In at least one embodiment, a natural language processing task comprises text generation. In at least one embodiment, a natural language processing task comprises question answering. In at least one embodiment, performing a natural language processing task results in output data 5220.

In at least one embodiment, a processor uses input data 5210 to query retrieval database 5214. In at least one embodiment, retrieval database 5214 is a key-value store. In at least one embodiment, retrieval database 5214 is a corpus used to train large language model 5212. In at least one embodiment, a processor uses retrieval database 5214 to provide large language model 5212 with updated information. In at least one embodiment, retrieval database 5214 comprises data from an internet source. In at least one embodiment, large language model 5212 does not use retrieval database 5214 to perform inferencing.

In at least one embodiment, an encoder encodes input data 5210 into one or more feature vectors. In at least one embodiment, an encoder encodes input data 5210 into a sentence embedding vector. In at least one embodiment, a processor uses said sentencing embedding vector to perform a nearest neighbor search to generate one or more neighbors 5216. In at least one embodiment, one or more neighbors 5216 is value in retrieval database 5214 corresponding to a key comprising input data 5210. In at least one embodiment, one or more neighbors 5216 comprise text data. In at least one embodiment, encoder 5218 encodes one or more neighbors 5216. In at least one embodiment, encoder 5218 encodes one or more neighbors 5216 into a text embedding vector. In at least one embodiment, encoder 5218 encodes one or more neighbors 5216 into a sentence embedding vector. In at least one embodiment, large language model 5212 uses input data 5210 and data generated by encoder 5218 to generate output data 5220. In at least one embodiment, processor 5206 interfaces with application 5202 using large language model (LLM) application programming interface(s) (API(s)) 5204. In at least one embodiment, processor 5206 accesses large language model 5212 using large language model (LLM) application programming interface(s) (API(s)) 5204.

In at least one embodiment, output data 5220 comprise computer instructions. In at least one embodiment, output data 5220 comprise instructions written in CUDA programming language. In at least one embodiment, output data 5220 comprise instructions to be performed by processor 5206. In at least one embodiment, output data 5220 comprise instructions to control execution of one or more algorithm modules 5208. In at least one embodiment, one or more algorithm modules 5208 comprise, for example, one or more neural networks to perform pattern recognition. In at least one embodiment, one or more algorithm modules 5208 comprise, for example, one or more neural networks to perform frame generation. In at least one embodiment, one or more algorithm modules 5208 comprise, for example, one or more neural networks to generate a drive path. In at least one embodiment, one or more algorithm modules 5208 comprise, for example, one or more neural networks to generate a 5G signal. In at least one embodiment, processor 5206 interfaces with application 5202 using large language model (LLM) application programming interface(s) (API(s)) 5204. In at least one embodiment, processor 5206 may use one or more parallel computing platforms and/or programming models (e.g., NVIDIA's CUDA model).

In at least one embodiment, aspects of systems and techniques described herein in relation to FIG. 52 are incorporated into aspects of preceding figure(s). For example, in at least one embodiment, an apparatus depicted in preceding figure(s) includes processor 5206.

For example, in at least one embodiment, system 5200 uses ChatGPT to write CUDA code. For example, in at least one embodiment, system 5200 uses ChatGPT to train an object classification neural network. For example, in at least one embodiment, system 5200 uses ChatGPT and a neural network to identify a driving path. For example, in at least one embodiment, system 5200 uses ChatGPT and a neural network to generate a 5G signal.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

At least one embodiment of the disclosure can be described in view of the following clauses:
1. A processor, comprising: one or more tensor acceleration logic circuits to cause one or more tensor maps to be stored in one or more cache storages.
2. The processor of clause 1, wherein the one or more tensor acceleration logic circuits are to cause the one or more tensor maps to be stored in one or more cache storages based, at least in part, on an instruction.
3. The processor of any one of clauses 1-2, wherein the one or more tensor acceleration logic circuits are to cause the one or more tensor maps to be stored in one or more cache storages based, at least in part, on an application programming interface (API).
4. The processor of any one of clauses 1-3, wherein the one or more tensor acceleration logic circuits are to cause the one or more tensor maps to be stored in one or more cache storages based, at least in part, on one or more addresses of the one or more tensor maps in global memory of a graphics processing unit (GPU).
5. The processor of any one of clauses 1-4, wherein the one or more cache storages include an asynchronous data movement hardware cache.
6. The processor of any one of clauses 1-5, wherein the one or more tensor maps include a first tensor map that includes information that indicates a structure of a first tensor stored in a first memory of a graphics processing unit (GPU), and indicates a structure of a second tensor to be stored in a second memory of the GPU based, at least in part, on the first tensor map and the first tensor.
7. The processor of any one of clauses 1-6, wherein the one or more tensor maps include one or more image-to-column transformations.
8. A system, comprising: one or more processors to cause one or more tensor maps to be stored in one or more cache storages.
9. The system of clause 8, wherein the one or more processors are to cause the one or more tensor maps to be stored in one or more cache storages based, at least in part, on an application programming interface (API) that uses one or more addresses of the one or more tensor maps in memory.
10. The system of any one of clauses 8-9, wherein the one or more processors are to cause the one or more tensor maps to be stored in one or more cache storages of a graphics processing unit (GPU).
11. The system of any one of clauses 8-10, wherein the one or more processors are to cause the one or more tensor maps to be stored in one or more cache storages based, at least in part, on an instruction that uses one or more addresses of the one or more tensor maps.
12. The system of any one of clauses 8-11, wherein the one or more cache storages include a graphics processing unit (GPU) asynchronous data movement hardware cache.
13. The system of any one of clauses 8-12, wherein the one or more tensor maps include a first tensor map that includes information that indicates a structure of a first tensor stored in a first memory, and indicates a structure of a second tensor to be stored in a second memory based, at least in part, on the first tensor map and the first tensor.
14. A method, comprising: storing one or more tensor maps in one or more cache storages using one or more tensor acceleration logic circuits.
15. The method of clause 14, wherein storing the one or more tensor maps in one or more cache storages includes performing an application programming interface (API) to cause the one or more tensor maps to be stored.
16. The method of any one of clauses 14-15, wherein storing the one or more tensor maps in one or more cache storages includes performing an instruction to cause the one or more tensor maps to be stored in an asynchronous data movement hardware cache.
17. The method of any one of clauses 14-16, wherein the one or more tensor maps include a first tensor map that includes information that indicates a structure of a first tensor stored in a first memory, and indicates a structure of a second tensor to be stored in a second memory based, at least in part, on the first tensor map and the first tensor.
18. The method of any one of clauses 14-17, wherein storing the one or more tensor maps in one or more cache storages includes performing an application programming interface (API) to cause the one or more tensor maps to be stored in an asynchronous data movement hardware cache of a graphics processing unit (GPU) based, at least in part, on one or more addresses of the one or more tensor maps in global memory of the GPU.
19. The method of any one of clauses 14-18, wherein storing the one or more tensor maps in one or more cache storages includes performing an instruction based, at least in part, on one or more addresses of the one or more tensor maps in memory accessible by a graphics processing unit (GPU).
20. A non-transitory computer-readable medium having stored thereon a set of instructions, which if performed by one or more processors, cause the one or more processors to at least perform the method of any one of clauses 14-19.
21. A processor comprising: one or more circuits to perform an application programming interface (API) to cause a tensor mapping to be stored into one or more caches.
22. The processor of clause 21, wherein an input to the API indicates an address of the tensor mapping in global memory of a graphics processing unit (GPU).
23. The processor of any one of clauses 21-22, wherein the one or more caches comprise an asynchronous data movement hardware cache.
24. The processor of any one of clauses 21-23, wherein the tensor mapping includes information that indicates a structure of a first tensor stored in a first memory of the GPU, and indicates a structure of a second tensor to be stored in a second memory of the GPU based, at least in part, on the tensor mapping and the first tensor.
25. The processor of any one of clauses 21-24, wherein the tensor mapping includes one or more image-to-column transformations.
26. The processor of any one of clauses 21-25, wherein an input to the API indicates a subset of memory in which the tensor mapping is stored.
27. The processor of any one of clauses 21-26, wherein the API is to cause the tensor mapping to be stored asynchronously.
28. A system, comprising: one or more processors to perform an application programming interface (API) to cause a tensor mapping to be stored into one or more caches.
29. The system of clause 28, wherein an input to the API indicates an address of the tensor mapping.
30. The system of any one of clauses 28-29, wherein the one or more caches comprise an asynchronous data movement hardware cache.
31. The system of any one of clauses 28-30, wherein the tensor mapping includes information that indicates a structure of a first tensor stored in a first memory of the GPU, and indicates a structure of a second tensor to be stored in a second memory of the GPU based, at least in part, on the tensor mapping and the first tensor.
32. The system of any one of clauses 28-31, wherein the tensor mapping includes one or more image-to-column transformations.
33. The system of any one of clauses 28-32, wherein an input to the API indicates a subset of memory in which the tensor mapping is stored.
34. A method, comprising: performing an application programming interface (API) to cause a tensor mapping to be stored into one or more caches.
35. The method of clause 34, wherein an input to the API indicates an address of the tensor mapping in a memory of a graphics processing unit (GPU).
36. The method of any one of clauses 34-35, wherein the one or more caches include an asynchronous data movement hardware cache.
37. The method of any one of clauses 34-36, wherein the tensor mapping includes information that indicates a structure of a first tensor stored in a first memory of the GPU, and indicates a structure of a second tensor to be stored in a second memory of the GPU based, at least in part, on the tensor mapping and the first tensor.
38. The method of any one of clauses 34-37, wherein the tensor mapping includes one or more image-to-column transformations.
39. The method of any one of clauses 34-38, wherein an input to the API indicates a subset of memory in which the tensor mapping is stored.
40. A non-transitory computer-readable medium having stored thereon a set of instructions, which if performed by one or more processors, cause the one or more processors to at least perform the method of any one of clauses 34-39.
41. A graphics processing unit (GPU), comprising: one or more circuits to perform a tensor mapping prefetch instruction to cause a tensor mapping to be stored into a GPU cache.
42. The GPU of clause 41, wherein an input to the tensor mapping prefetch instruction indicates an address of the tensor mapping in global memory of a graphics processing unit (GPU).
43. The GPU of any one of clauses 41-42, wherein the GPU cache is an asynchronous data movement hardware cache.
44. The GPU of any one of clauses 41-43, wherein the tensor mapping includes information that indicates a structure of a first tensor stored in a first memory of the GPU, and indicates a structure of a second tensor to be stored in a second memory of the GPU based, at least in part, on the tensor mapping and the first tensor.
45. The GPU of any one of clauses 41-44, wherein the tensor mapping includes one or more image-to-column transformations.
46. The GPU of any one of clauses 41-45, wherein an input to the tensor mapping prefetch instruction indicates a subset of memory in which the tensor mapping is stored.
47. The GPU of any one of clauses 41-46, wherein the tensor mapping prefetch instruction is to cause the tensor mapping to be stored asynchronously.
48. A system, comprising: one or more processors to perform a tensor mapping prefetch instruction to cause a tensor mapping stored into a graphics processing unit (GPU) cache.
49. The system of clause 48, wherein an input to the tensor mapping prefetch instruction indicates an address of the tensor mapping in global memory of the GPU.
50. The system of any one of clauses 48-49, wherein the GPU cache is an asynchronous data movement hardware cache.
51. The system of any one of clauses 48-50, wherein the tensor mapping includes information that indicates a structure of a first tensor stored in a first memory of the GPU, and indicates a structure of a second tensor to be stored in a second memory of the GPU based, at least in part, on the tensor mapping and the first tensor.
52. The system of any one of clauses 48-51, wherein the tensor mapping includes one or more image-to-column transformations.
53. The system of any one of clauses 48-52, wherein an input to the tensor mapping prefetch instruction indicates a subset of memory in which the tensor mapping is stored.
54. A method, comprising: performing a tensor mapping prefetch instruction to cause a tensor mapping to be stored in a cache.
55. The method of clause 54, wherein an input to the tensor mapping prefetch instruction indicates an address of the tensor mapping in a memory of a graphics processing unit (GPU).
56. The method of any one of clauses 54-55, wherein the cache is a graphics processing unit (GPU) asynchronous data movement hardware cache.
57. The method of any one of clauses 54-56, wherein the tensor mapping includes information that indicates a structure of a first tensor stored in a first memory of the GPU, and indicates a structure of a second tensor to be stored in a second memory of the GPU based, at least in part, on the tensor mapping and the first tensor.
58. The method of any one of clauses 54-57, wherein the tensor mapping includes one or more image-to-column transformations.
59. The method of any one of clauses 54-58, wherein an input to the tensor mapping prefetch instruction indicates a subset of memory in which the tensor mapping is stored.
60. A non-transitory computer-readable medium having stored thereon a set of instructions, which if performed by one or more processors, cause the one or more processors to at least perform the method of any one of clauses 54-59.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). A number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In present document, references may be made to obtaining, acquiring, receiving, or inputting analog or digital data into a subsystem, computer system, or computer-implemented machine. Process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising: one or more tensor acceleration logic circuits to cause one or more tensor maps to be stored in one or more cache storages.

2. The processor of claim 1, wherein the one or more tensor acceleration logic circuits are to cause the one or more tensor maps to be stored in one or more cache storages based, at least in part, on an instruction.

3. The processor of claim 1, wherein the one or more tensor acceleration logic circuits are to cause the one or more tensor maps to be stored in one or more cache storages based, at least in part, on an application programming interface (API).

4. The processor of claim 1, wherein the one or more tensor acceleration logic circuits are to cause the one or more tensor maps to be stored in one or more cache storages based, at least in part, on one or more addresses of the one or more tensor maps in global memory of a graphics processing unit (GPU).

5. The processor of claim 1, wherein the one or more cache storages include an asynchronous data movement hardware cache.

6. The processor of claim 1, wherein the one or more tensor maps include a first tensor map that includes information that indicates a structure of a first tensor stored in a first memory of a graphics processing unit (GPU), and indicates a structure of a second tensor to be stored in a second memory of the GPU based, at least in part, on the first tensor map and the first tensor.

7. The processor of claim 1, wherein the one or more tensor maps include one or more image-to-column transformations.

8. A system, comprising: one or more processors to cause one or more tensor maps to be stored in one or more cache storages.

9. The system of claim 8, wherein the one or more processors are to cause the one or more tensor maps to be stored in one or more cache storages based, at least in part, on an application programming interface (API) that uses one or more addresses of the one or more tensor maps in memory.

10. The system of claim 8, wherein the one or more processors are to cause the one or more tensor maps to be stored in one or more cache storages of a graphics processing unit (GPU).

11. The system of claim 8, wherein the one or more processors are to cause the one or more tensor maps to be stored in one or more cache storages based, at least in part, on an instruction that uses one or more addresses of the one or more tensor maps.

12. The system of claim 8, wherein the one or more cache storages include a graphics processing unit (GPU) asynchronous data movement hardware cache.

13. The system of claim 8, wherein the one or more tensor maps include a first tensor map that includes information that indicates a structure of a first tensor stored in a first memory, and indicates a structure of a second tensor to be stored in a second memory based, at least in part, on the first tensor map and the first tensor.

14. A method, comprising: storing one or more tensor maps in one or more cache storages using one or more tensor acceleration logic circuits.

15. The method of claim 14, wherein storing the one or more tensor maps in one or more cache storages includes performing an application programming interface (API) to cause the one or more tensor maps to be stored.

16. The method of claim 14, wherein storing the one or more tensor maps in one or more cache storages includes performing an instruction to cause the one or more tensor maps to be stored in an asynchronous data movement hardware cache.

17. The method of claim 14, wherein the one or more tensor maps include a first tensor map that includes information that indicates a structure of a first tensor stored in a first memory, and indicates a structure of a second tensor to be stored in a second memory based, at least in part, on the first tensor map and the first tensor.

18. The method of claim 14, wherein storing the one or more tensor maps in one or more cache storages includes performing an application programming interface (API) to cause the one or more tensor maps to be stored in an asynchronous data movement hardware cache of a graphics processing unit (GPU) based, at least in part, on one or more addresses of the one or more tensor maps in global memory of the GPU.

19. The method of claim 14, wherein storing the one or more tensor maps in one or more cache storages includes performing an instruction based, at least in part, on one or more addresses of the one or more tensor maps in memory accessible by a graphics processing unit (GPU).

20. A non-transitory computer-readable medium having stored thereon a set of instructions, which if performed by one or more processors, cause the one or more processors to at least perform the method of claim 14.
